(19) United States
(12) Patent Application Publication
(10) Pub. No.: US 2025/0063619 A1
(43) Pub. Date: Feb. 20, 2025

(54) WIRELESS COMMUNICATION METHOD USING MULTIPLE LINKS, AND WIRELESS COMMUNICATION TERMINAL USING SAME

(71) Applicant: WILUS INSTITUTE OF STANDARDS AND TECHNOLOGY INC., Gyeonggi-do (KR)

(72) Inventors: Sanghyun KIM, Gyeonggi-do (KR); Geonjung KO, Gyeonggi-do (KR); Juhyung SON, Gyeonggi-do (KR); Jinsam KWAK, Gyeonggi-do (KR)

(21) Appl. No.: 18/938,358

(22) Filed: Nov. 6, 2024

Related U.S. Application Data
(63) Continuation of application No. PCT/KR2023/021434, filed on Dec. 22, 2023.

(30) Foreign Application Priority Data
Jan. 20, 2023 (KR) 10-2023-0009076
Mar. 2, 2023 (KR) 10-2023-0027711
May 18, 2023 (KR) 10-2023-0064679
Aug. 9, 2023 (KR) 10-2023-0104422

(51) Int. Cl. H04W 76/15; H04W 74/0816; H04W 76/20

(52) U.S. Cl. CPC H04W 76/15; H04W 74/0816; H04W 76/20

(57) ABSTRACT

Disclosed are a method and a device for transmitting or receiving a frame performed by a first multi-link device (MLD) including a first plurality of stations in a wireless communication system. Specifically, a non-AP MLD according to the present disclosure may perform a multi-link configuration procedure for setting up at least one link with an AP MLD including a plurality of APs, and change an operating channel from a first channel to a second channel in a first link with a first AP among the plurality of APs. In this case, the second channel is one of at least one channel excluding a channel which overlaps one or more operating channels for one or more other non-AP MLDs combined with the AP MLD.

### TECHNICAL FIELD

The present disclosure relates to a wireless communication method using multiple links, and a wireless communication terminal using the same.

### BACKGROUND ART

Technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11 n has come into the spotlight. Among them, IEEE 802.11ac supports a wide bandwidth (80 to 160 MHZ) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHZ), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHZ, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

### DISCLOSURE OF INVENTION

### Technical Problem

An embodiment of the present disclosure is to provide a wireless communication method using multiple links, and a wireless communication terminal using the same.

Technical tasks to be achieved in the specification are not limited to the technical tasks mentioned above, and other technical tasks that are not mentioned may be clearly understood by those skilled in the art on the basis of the following descriptions.

### Solution to Problem

In a non-access point (AP) multi-link device (MLD) including multiple stations according to the present disclosure, a processor is configured to perform a multi-link setup procedure for setting up at least one link with an AP MLD including multiple APs, and switch an operating channel from a first channel to a second channel on a first link with a first AP among the multiple APs, wherein the second channel is selected from at least one channel satisfying a first condition related to the non-AP MLD and a second condition related to at least one other non-AP MLD which has set up a link with the AP MLD.

Furthermore, in the present disclosure, the first condition is whether there is no overlap with an operating channel of another link, excluding the first link, among the at least one link.

Furthermore, in the present disclosure, the second condition is whether there is no overlap with operating channels of one or more links set up in the at least one other non-AP MLD.

Furthermore, in the present disclosure, the processor is configured to receive a specific frame for switching the operating channel from the first channel to the second channel, wherein the specific frame includes a Channel Switch Announcement element or an Extended Channel Switch Announcement element for switching the operating channel.

Furthermore, in the present disclosure, the Channel Switch Announcement element or the Expanded Channel Switch Announcement element includes a channel switch mode field, a new channel number field indicating a channel number of the operating channel being switched, and a Channel Switch Count field.

Furthermore, in the present disclosure, the channel switch mode field indicates information necessary for switching the operating channel, and the Channel Switch Count field indicates the number of target beacon transmission times (TBTTs) until the operating channel is switched.

Furthermore, in the present disclosure, the processor is configured to transmit a link reconfiguration request frame for changing a configuration of the at least one link, and receive a link reconfiguration response frame in response to the link reconfiguration request frame, wherein the link reconfiguration response frame is received on a specific link, among the at least one link, on which the link reconfiguration request frame has been transmitted.

Furthermore, in the present disclosure, in case that the link reconfiguration request frame requests one or more links to be deleted, the link reconfiguration request frame is transmitted on one of links, other than the one or more links which are requested to be deleted, among the at least one link.

Furthermore, in the present disclosure, in case that the link reconfiguration request frame requests one or more links to be deleted and that only one link is set up between the non-AP MLD and the AP MLD, the link reconfiguration request frame is transmitted via the one link that has been set up.

The present disclosure provides a method including: performing a multi-link setup procedure for setting up at least one link with an AP MLD including multiple APs; and switching an operating channel from a first channel to a second channel on a first link with a first AP among the multiple APs, wherein the second channel is selected from at least one channel satisfying a first condition related to the non-AP MLD and a second condition related to at least one other non-AP MLD which has set up a link with the AP MLD.

### Advantageous Effects of Invention

An embodiment of the present disclosure provides a wireless communication method efficiently using multiple links, and a wireless communication terminal using the same.

The effects obtainable in the present disclosure are not limited to the above-mentioned effects, and other effects that are not mentioned may be clearly understood by those skilled in the art to which the present disclosure belongs, from descriptions below.

### BRIEF DESCRIPTION OF DRAWINGS

FIG. 1 illustrates a wireless LAN system according to an embodiment of the present disclosure.

FIG. 2 illustrates a wireless LAN system according to another embodiment of the present disclosure.

FIG. 3 illustrates a configuration of a station according to an embodiment of the present disclosure.

FIG. 4 illustrates a configuration of an access point according to an embodiment of the present disclosure.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates an example of a format of a physical layer protocol data unit (PPDU) for each of various standard generations.

FIG. 8 illustrates an example of various extremely high throughput (EHT) physical protocol data unit (PPDU) formats and a method for indicating the same according to an embodiment of the present disclosure.

FIG. 9 illustrates a multi-link device according to an embodiment of the present disclosure.

FIG. 10 illustrates a case in which transmissions in different links are simultaneously performed in a multi-link operation according to an embodiment of the present disclosure.

FIG. 11 illustrates an example of beacon frame contents transmitted by an AP of an AP MLD, and a target beacon transmission time (TBTT) information field format included in a reduced neighbor report (RNR) element according to an embodiment of the present disclosure.

FIG. 12 illustrates another example of a TBTT information field format according to an embodiment of the present disclosure.

FIG. 13 illustrates an example of a TBTT information length subfield indicating a TBTT information field including an MLD AP TBTT offset subfield according to an embodiment of the present disclosure.

FIG. 14 illustrates an example of a per-STA profile subelement format according to an embodiment of the present disclosure.

FIG. 15 illustrates an example of a process of updating information of a non-primary link by a non-AP MLD having performed setup with a non-simultaneous transmission and reception (NSTR) soft AP MLD according to an embodiment of the present disclosure.

FIG. 16 is a flow chart illustrating an example of a procedure of updating a parameter of a non-primary link by a non-AP STA MLD associated with an NSTR AP MLD according to an embodiment of the present disclosure.

FIG. 17 illustrates an example of formats of elements according to an embodiment of the present disclosure.

FIG. 18 illustrates an example of a process of configuring (defining) a quiet interval in a non-primary link by an NSTR AP MLD according to an embodiment of the present disclosure.

FIG. 19 illustrates an example of a method of performing non-primary channel switching by an NSTR AP MLD according to an embodiment of the present disclosure.

FIG. 20 illustrates an example of a probe request frame, an association request frame, and an association response frame transmitted by a station operating in a specific bandwidth.

FIG. 21 illustrates an example of a method of exchanging high throughput (HT)/very high throughput (VHT)-related element information in a link other than a specific bandwidth and performing multi-link configuration according to an embodiment of the present disclosure.

FIG. 22 illustrates an example of a part of a configuration of a management frame for describing an inheritance method of a complete per-STA profile according to an embodiment of the present disclosure.

FIG. 23 illustrates an example of a method of changing the state of a multi-link association between an AP MLD and a non-AP MLD through a reconfiguration procedure according to an embodiment of the present disclosure.

FIG. 24 illustrates an embodiment of a reconfiguration multi-link element included in a reconfiguration request frame according to an embodiment of the present disclosure.

FIG. 25 illustrates an example of a case where an inheritance rule is applied between pieces of information of STAs included in a reconfiguration multi-link element according to an embodiment of the present disclosure.

FIG. 26 illustrates an example of a case in which information on a reporting STA, included in a reconfiguration multi-link element, is inherited to information on reported STAs according to an embodiment of the present disclosure.

FIG. 27 illustrates an example of a case in which information on an STA for a link reconfigured by a reconfiguration multi-link element is inherited to information on another STA of another reconfigured link according to an embodiment of the present disclosure.

FIG. 28 illustrates an example of a case where an element positioned outside a reconfiguration multi-link element included in a reconfiguration request frame is inherited to information of other STAs according to an embodiment of the prevent invention.

FIG. 29 illustrates an example of a method by which an AP MLD according to an embodiment of the present disclosure switches the channel of a specific link.

FIG. 30 illustrates an example of a method in which a multi-link reconfiguration is performed by a non-AP MLD that has performed a multi-link setup with an AP MLD according to an embodiment of the present disclosure.

FIG. 31 illustrates an example of a Multi-Link element that includes a padding value to be included in an initial trigger frame of a frame exchange procedure according to an embodiment of the present disclosure.

FIG. 32 illustrates an example of a TXOP operation method managed in consideration of the characteristics of an EMLSR MLD according to an embodiment of the present disclosure.

FIG. 33 illustrates an example of an operation in which an EMLSR MLD according to an embodiment of the present disclosure switches to a reception (transmission/reception) support mode for another EMLSR link after a frame exchange procedure is terminated on a specific EMLSR link.

FIG. 34 illustrates an example of a TXOP (frame exchange sequence) management method on an EMLSR link according to an embodiment of the present disclosure.

FIG. 35 illustrates an example in which an EMLSR MLD according to an embodiment of the present disclosure transitions to a listening operation when receiving a specific frame in a specific link.

FIG. 36 illustrates various EML control field formats according to embodiments of the present disclosure.

FIG. 37 illustrates an example in which an EMLSR link is removed after performing TID-to-link mapping according to an embodiment of the present disclosure.

FIG. 38 illustrates an example in which an EMLSR mode of a non-AP MLD is released after performing TID-to-link mapping according to an embodiment of the present disclosure.

FIG. 39 illustrates an example of an operation in which a non-AP MLD and an AP MLD set up an EMLSR link in consideration of changed TID-to-link mapping according to an embodiment of the present disclosure.

FIG. 40 illustrates one example of an operation in which a non-AP MLD and an AP MLD set up an EMLSR link in consideration of a changed link configuration of the AP MLD according to an embodiment of the present disclosure.

FIG. 41 illustrates an example of a method by which a non-AP STA on an EMLSR link, according to an embodiment of the present disclosure, terminates a TXOP acquired thereby in consideration of an R-TWT SP started on another EMLSR link.

FIG. 42 illustrates an example of a procedure in which a non-AP STA operating in an EMLSR link supports a frame exchange operation without receiving an Initial Control frame during an R-TWT SP according to an embodiment of the present disclosure.

FIG. 43 illustrates an example of an EMLSR operation according to an embodiment of the present disclosure.

FIG. 44 illustrates another example of an EMLSR operation according to an embodiment of the present disclosure.

FIG. 45 illustrates another example of an EMLSR operation according to an embodiment of the present disclosure.

FIG. 46 illustrates an example of a triggered TXOP sharing procedure according to an embodiment of the present disclosure.

FIG. 47 illustrates another example of a triggered TXOP sharing procedure on an EMLSR link according to an embodiment of the present disclosure.

FIG. 48 illustrates an example of an operation on EMLSR links according to an embodiment of the present disclosure.

FIG. 49 illustrates another example of a TXOP sharing procedure triggered on an EMLSR link according to an embodiment of the present disclosure.

FIG. 50 is a flowchart illustrating one example of an operation performed by a non-AP MLD according to an embodiment of the present disclosure.

### BEST MODE FOR CARRYING OUT THE INVENTION

Terms used in the specification adopt general terms which are currently widely used by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively.

Hereinafter, in the present disclosure, a field and a subfield may be interchangeably used.

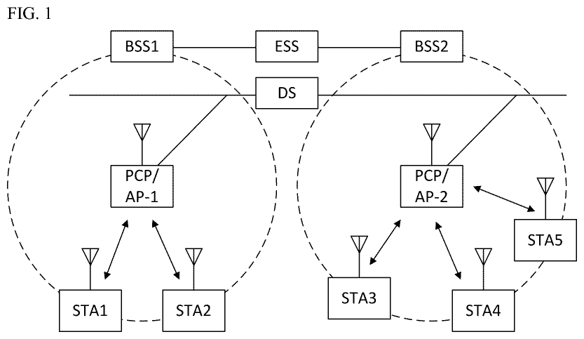

FIG. 1 illustrates a wireless LAN system according to an embodiment of the present disclosure.

FIG. 1 is a diagram illustrating a wireless LAN system according to an embodiment of the present disclosure. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present disclosure, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present disclosure, the AP is used as a concept including a personal BSS coordination point (PCP) and may include concepts including a centralized controller, a base station (BS), a node-B, a base transceiver system (BTS), and a site controller in a broad sense. In the present disclosure, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

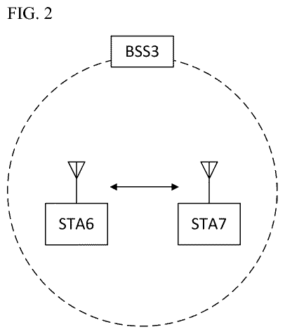

FIG. 2 illustrates an independent BSS which is a wireless LAN system according to another embodiment of the present disclosure. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

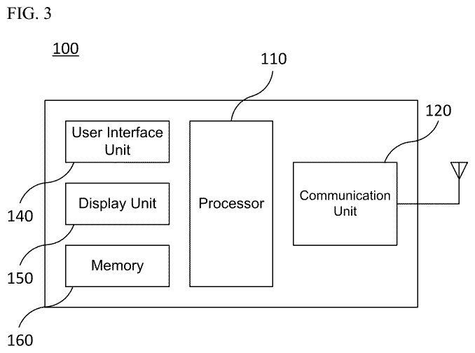

FIG. 3 is a block diagram illustrating a configuration of a station 100 according to an embodiment of the present disclosure. As illustrated in FIG. 3, the station 100 according to the embodiment of the present disclosure may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHZ, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present disclosure, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present disclosure may execute various commands or programs and process data in the station 100. Further, the processor 110 may control the respective units of the station 100 and control data transmission/reception among the units. According to the embodiment of the present disclosure, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present disclosure may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present disclosure. A detailed embodiment thereof will be described below.

The station 100 illustrated in FIG. 3 is a block diagram according to an embodiment of the present disclosure, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present disclosure, some components of the station 100, for example, the user interface unit 140 and the display unit 150 may be optionally provided in the station 100.

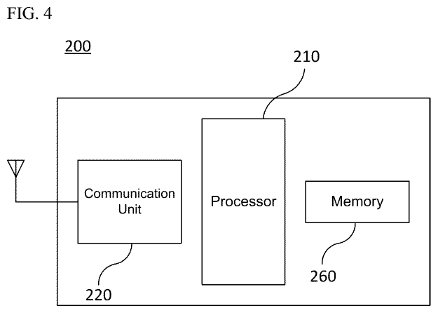

FIG. 4 is a block diagram illustrating a configuration of an AP 200 according to an embodiment of the present disclosure. As illustrated in FIG. 4, the AP 200 according to the embodiment of the present disclosure may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present disclosure includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present disclosure may include two or more communication modules among different frequency bands, for example, 2.4 GHz, 5 GHZ, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present disclosure, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present disclosure, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present disclosure. A detailed embodiment thereof will be described below.

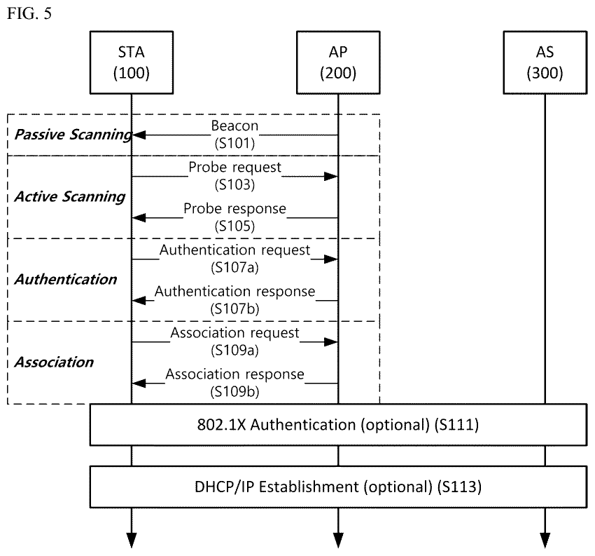

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present disclosure is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

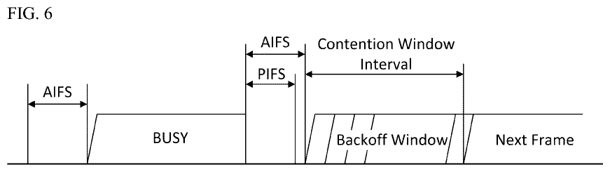

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval. In this case, the random number may be referred to as a backoff counter. That is, an initial value of the backoff counter is configured by an integer corresponding to a random number acquired by the terminal. When the terminal detects that the channel is idle during a slot time, the terminal may reduce the backoff counter by 1. In addition, when the backoff counter reaches 0, the terminal may be allowed to perform channel access in the corresponding channel. Therefore, when the channel is idle for a slot time of the backoff counter or an AIFS time, transmission of the terminal may be allowed.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

### <Examples of Various PPDU Formats>

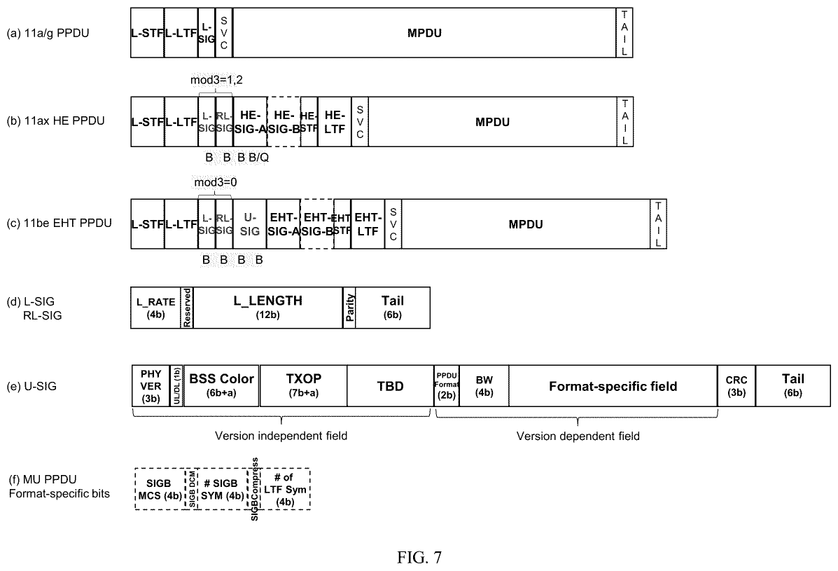

FIG. 7 illustrates an example of a format of a Physical layer Protocol Data Unit (PPDU) for each of various standard generations. More specifically, FIG. 7(a) illustrates an embodiment of a legacy PPDU format based on 802.11a/g, FIG. 7(b) illustrates an embodiment of an HE PPDU format based on 802.11ax, and FIG. 7(c) illustrates an embodiment of a non-legacy PPDU (i.e., EHT PPDU) format based on 802.11be. FIG. 7(d) illustrates detailed field configurations of RL-SIG and L-SIG commonly used in the PPDU formats.

Referring to FIG. 7(a), a preamble of the legacy PPDU includes a legacy short training field (L-STF), a legacy long training field (L-LTF), and a legacy signal field (L-SIG). In an embodiment of the present disclosure, the L-STF, the L-LTF, and the L-SIG may be referred to as a legacy preamble.

Referring to FIG. 7(b), a preamble of the HE PPDU additionally includes, in the legacy preamble, a repeated legacy short training field (RL-SIG), a high efficiency signal A field (HE-SIG-A), a high efficiency signal B field (HE-SIG-B), a high efficiency short training field (HE-STF), and a high efficiency long training field (HE-LTF). In an embodiment of the present disclosure, the RL-SIG, HE-SIG-A, the HE-SIG-B, the HE-STF and the HE-LTF may be referred to as an HE preamble. A specific configuration of the HE preamble may be modified according to an HE PPDU format. For example, HE-SIG-B may be used only in an HE MU PPDU format.

Referring to FIG. 7(c), a preamble of the EHT PPDU additionally includes, in the legacy preamble, a repeated legacy short training field (RL-SIG), a universal signal field (U-SIG), and an extremely high throughput signal A field (EHT-SIG-A), an extremely high throughput signal B field (EHT-SIG-B), an extremely high throughput short training field (EHT-STF), and an extremely high throughput long training field (EHT-LTF). In an embodiment of the present disclosure, the RL-SIG, EHT-SIG-A, the EHT-SIG-B, the EHT-STF and the EHT-LTF may be referred to as an EHT preamble. A specific configuration of a non-legacy preamble may be modified according to an EHT PPDU format. For example, EHT-SIG-A and EHT-SIG-B may be used only in a part of the EHT PPDU format.

64-FFT OFDM is applied in an L-SIG field included in the preamble of the PPDU, and the L-SIG field includes a total of 64 subcarriers. Among 64 subcarriers, 48 subcarriers excluding a guard subcarrier, a DC subcarrier, and a pilot subcarrier are used for transmission of L-SIG data. BPSK and a modulation and coding scheme (MCS) of rate=1/2 are applied in L-SIG, and therefore the L-SIG may include a total of 24 bits of information. FIG. 7(d) illustrates a 24-bit information configuration of L-SIG.

Referring to FIG. 7(d), the L-SIG includes an L_RATE field and an L_LENGTH field. The L_RATE field includes 4 bits and indicates an MCS used for data transmission. Specifically, the L_RATE field indicates one value among transmission rates of Jun. 9, 2012/18/24/36/48/54 Mbps obtained by combining a modulation scheme of BPSK/QPSK/16-QAM/64-QAM, etc. and an inefficiency of 1/2, 2/3, 3/4, etc. A total length of a corresponding PPDU may be indicated by combining information of the L_RATE field and information of the L_LENGTH field. In a non-legacy PPDU format, the L_RATE field is configured to a minimum rate of 6 Mbps.

A unit of an L_LENGTH field is a byte, and a total of 12 bits may be allocated and signaling can be performed up to 4095. The length of the corresponding PPDU may be indicated by a combination of the L_LENGTH field and an L_RATE field. In this case, a legacy terminal and a non-legacy terminal may interpret the L_LENGTH field in different methods.

First, a method for interpreting the length of the corresponding PPDU by the legacy terminal or the non-legacy terminal by using the L_LENGTH field is as follows. When a value of the L_RATE field is configured to indicate 6 Mbps, three bytes (i.e., 24 bits) may be transmitted during 4 us corresponding to a 64 FFT symbol duration. Accordingly, the number of 64 FFT reference symbols after the L-SIG is acquired by adding three bytes corresponding to the SVC field and the tail field to the value of the L_LENGTH field and then dividing the same by three bytes corresponding to a transmission amount of one symbol. The length of the corresponding PPDU, i.e., a reception time (RXTIME) is acquired by multiplying the acquired number of symbols by 4 us corresponding to one symbol duration and then adding 20 us corresponding to a time required to transmit the L-STF, the L-LTF, and the L-SIG. This is represented as shown in equation 1 below.

$$RXTIME ( u s ) = ( ⌈ \frac{L\_LENGTH + 3}{3} ⌉ ) \times 4 + 20 \qquad [ Equation 1 ]$$

In this case, ┌x┐ denotes the smallest natural number greater than or equal to x. Since the maximum value of the L_LENGTH field is 4095, the length of the PPDU can be set up to 5.464 ms. The non-legacy terminal transmitting the PPDU should set the L_LENGTH field as shown in Equation 2 below.

$$L\_LENGTH ( byte ) = ( ⌈ \frac{TXTIME - 20}{4} ⌉ ) \times 3 - 3 \qquad [ Equation 2 ]$$

Herein, TXTIME is the total transmission time constituting the corresponding PPDU, and is expressed by Equation 3 below. In this case, TX represents the transmission time of X.

$$TXTIME ( us ) = {T}_{L - STF} + {T}_{L - LTF} + {T}_{L - SIG} + {T}_{RL - SIG} + {T}_{U - SIG} + ( {T}_{EHT - SIG - A} ) + ( {T}_{EHT - SIG - B} ) + {T}_{EHT - STF} + {N}_{EHT - LTF} \cdot {T}_{EHT - LTF} + {T}_{DATA} \qquad [ Equation 3 ]$$

Referring to the above equations, the length of the PPDU is calculated based on a rounded up value of L_LENGTH/3. Therefore, for a random value of k, three different values of L_LENGTH={3 k+1, 3 k+2, 3 (k+1)} indicate the same PPDU length.

Referring to FIG. 7(e), a universal SIG (U-SIG) field continues to exist in an EHT PPDU and a WLAN PPDU of a subsequent generation, and serves to classify a generation of a PPDU, which includes 11be. U-SIG is a 64 FFT-based OFDM 2 symbol and may transfer a total of 52 bits of information. In 52 bits, 43 bits excluding 9 bits for CRC/Tail are largely divided into a version independent (VI) field and a version dependent (VD) field.

A VI bit enables a current bit configuration to be maintained even later on, so that even if a PPDU of a subsequent generation is defined, current 11be terminals may obtain information on the PPDU via the VI fields of the PPDU. To this end, the VI field includes PHY version, UL/DL, BSS color, TXOP, and reserved fields. The PHY version field is 3 bits, and serves to sequentially classify 11be and subsequent generation wireless LAN standards into versions. 11be has a value of 000b. The UL/DL field identifies whether the PPDU is an uplink/downlink PPDU. BSS color indicates an identifier for each BSS defined in 11ax, and has a value of 6 bits or more. TXOP indicates transmit opportunity duration transmitted in a MAC header, wherein, by adding the TXOP to a PHY header, the PPDU may infer a length of the TXOP included therein without having to decode an MPDU, and the TXOP has a value of 7 bits or more.

The VD field is signaling information useful only for an 11be version of the PPDU, and may include a field commonly used in any PPDU format, such as PPDU format and BW, and a field defined differently for each PPDU format. The PPDU format is a classifier that classifies EHT single user (SU), EHT multiple user (MU), EHT trigger-based (TB), EHT extended range (ER) PPDU, etc. The BW field signals five basic PPDU BW options (BW, which is expressible in the form of an exponential power of 20*2, may be referred to as basic BW) of 20, 40, 80, 160 (80+80), and 320 (160+160) MHz and various remaining PPDU BWs configured via preamble puncturing. After being signaled at 320 MHz, signaling may be performed in a form in which some 80 MHz is punctured. A punctured and modified channel type may be signaled directly in the BW field, or may be signaled using the BW field with a field (e.g., a field within the EHT-SIG field) appearing after the BW field. If the BW field is configured to 3 bits, a total of 8 BW signaling may be performed, and therefore only up to 3 signaling may be performed in a puncturing mode. If the BW field is configured to 4 bits, a total of 16 BW signaling may be performed, and therefore up to 11 signaling may be performed in the puncturing mode.

A field located after the BW field varies depending on the type and format of the PPDU, an MU PPDU and an SU PPDU may be signaled in the same PPDU format, a field for classification between the MU PPDU and the SU PPDU may be located before an EHT-SIG field, and additional signaling may be performed for the same. Both the SU PPDU and the MU PPDU include the EHT-SIG field, but some fields that are not required in the SU PPDU may be compressed. Information on the field to which the compression has been applied may be omitted or may have a size smaller than a size of an original field included in the MU PPDU. For example, in a case of the SU PPDU, a common field of the EHT-SIG may be omitted or replaced, or the SU PPDU may have a different configuration in which a user specific field is replaced, reduced to one, or the like.

Alternatively, the SU PPDU may further include a compression field indicating whether compression is performed, and a part of field (e.g., RA fields, etc.) may be omitted according to a value of the compressed field.

If a part of the EHT-SIG field of the SU PPDU is compressed, information to be included in the compressed field may be signaled also in an uncompressed field (e.g., the common field, etc.). The MU PPDU corresponds to a PPDU format for concurrent reception by multiple users, and therefore the EHT-SIG field is required to be transmitted subsequently to the U-SIG field, and the amount of signaled information may vary. That is, a plurality of MU PPDUs are transmitted to a plurality of STAs, so that the respective STAs should recognize locations of RUs, at which the MU PPDUs are transmitted, the STAs to which the RUs have been allocated respectively, and whether the transmitted MU PPDUs have been transmitted to the STAs themselves. Therefore, an AP should transmit information described above, by including the same in the EHT-SIG field. To this end, information for efficient transmission of the EHT-SIG field is signaled in the U-SIG field, and this may correspond to an MCS that is a modulation method and/or the number of symbols in the EHT-SIG field. The EHT-SIG field may include information on a size and location of an RU allocated to each user.

In the case of the SU PPDU, a plurality of RUs may be allocated to an STA, and the plurality of RUs may be continuous or discontinuous. If the RUs allocated to the STA are discontinuous, the STA should recognize a punctured RU in the middle in order to efficiently receive the SU PPDU. Accordingly, the AP may transmit the SU PPDU including information (e.g., a puncturing pattern of the RUs, etc.) of punctured RUs among the RUs allocated to the STA. That is, in the case of the SU PPDU, a puncturing mode field, which includes information indicating, in a bitmap format, etc., a puncturing pattern and whether the puncturing mode is applied, may be included in the EHT-SIG field, and the puncturing mode field may signal a discontinuous channel type appearing within a bandwidth.

The signaled discontinuous channel type is limited, and indicates discontinuous channel information and BW of the SU PPDU in combination with a value of the BW field. For example, the SU PPDU is a PPDU transmitted only to a single terminal, so that the STA may recognize a bandwidth allocated to itself via the BW field included in the PPDU, and the SU PPDU may recognize a punctured resource in the allocated bandwidth via the puncturing mode field of the EHT-SIG field or the U-SIG field included in the PPDU. In this case, the terminal may receive the PPDU in resource units remaining after excluding a specific channel of the punctured resource unit. The plurality of RUs allocated to the STA may be configured by different frequency bands or tones.

Only a limited discontinuous channel type is signaled in order to reduce signaling overhead of the SU PPDU. Puncturing may be performed for each 20 MHz sub-channel, so that if puncturing is performed for BW having a large number of 20 MHz sub-channels, such as 80, 160, and 320 MHz, a discontinuous channel (if puncturing of only edge 20 MHz is considered to be discontinuous) type should be signaled in the case of 320 MHz by expressing whether each of 15 20 MHz sub-channels remaining after excluding a primary channel is used. As such, allocating 15 bits to signal a discontinuous channel type of single user transmission may act as excessively large signaling overhead in consideration of a low transmission rate of a signaling part.

The present disclosure proposes a technique for signaling a discontinuous channel type of an SU PPDU, and illustrates a discontinuous channel type determined according to the proposed technique. The present disclosure also proposes a technique for signaling each of puncturing types of primary 160 MHz and secondary 160 MHz in a 320 MHz BW configuration of an SU PPDU.

An embodiment of the present disclosure proposes a technique for differently configuring a PPDU indicated by preamble puncturing BW values according to a PPDU format signaled in a PPDU format field. It is assumed that a BW field is 4 bits, and in a case of an EHT SU PPDU or a TB PPDU, EHT-SIG-A of 1 symbol may be additionally signaled after U-SIG, or EHT-SIG-A may not be signaled at all, so that, in consideration of this, it is necessary to completely signal up to 11 puncturing modes via only the BW field of U-SIG. However, in a case of an EHT MU PPDU, EHT-SIG-B is additionally signaled after U-SIG, so that up to 11 puncturing modes may be signaled in a method different from that of the SU PPDU. In a case of an EHT ER PPDU, a BW field may be configured to 1 bit to signal whether the EHT ER PPDU is a PPDU using a 20 MHz or 10 MHz band.

FIG. 7(f) illustrates a configuration of a format-specific field of a VD field when the EHT MU PPDU is indicated in the PPDU format field of U-SIG. In the case of the MU PPDU, SIG-B, which is a signaling field for concurrent reception by multiple users, is essentially required, and SIG-B may be transmitted without separate SIG-A after U-SIG. To this end, information for decoding of SIG-B should be signaled in U-SIG. These fields include SIG-B MCS, SIG-B DCM, Number of SIG-B Symbols, SIG-B Compression, and Number of EHT-LTF Symbols.

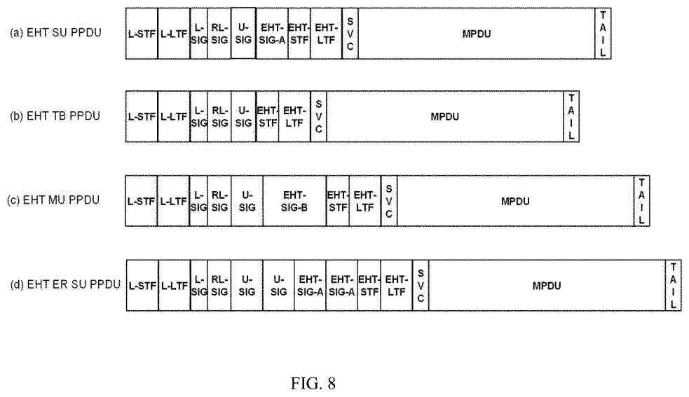

FIG. 8 illustrates an example of various extremely high throughput (EHT) Physical layer Protocol Data Unit (PPDU) formats and a method for indicating the same according to an embodiment of the present disclosure.

Referring to FIG. 8, a PPDU may include a preamble and a data part, and an EHT PPDU format, that is a PPDU type, may be classified according to a U-SIG field included in the preamble. Specifically, based on a PPDU format field included in the U-SIG field, whether the format of the PPDU is an EHT PPDU may be indicated.

FIG. 8(a) shows an example of an EHT SU PPDU format for a single STA. An EHT SU PPDU is a PPDU used for single user (SU) transmission between an AP and a single STA, and an EHT-SIG-A field for additional signaling may be located after the U-SIG field.

FIG. 8(b) shows an example of an EHT trigger-based PPDU format which corresponds to an EHT PPDU transmitted based on a trigger frame. An EHT Trigger-based PPDU is an EHT PPDU transmitted based on a trigger frame and is an uplink PPDU used for a response to the trigger frame. Unlike in the EHT SU PPDU, an EHT-SIG-A field is not located after a U-SIG field in the EHT PPDU.

FIG. 8(c) shows an example of an EHT MU PPDU format which corresponds to an EHT PPDU for multiple users. An EHT MU PPDU is a PPDU used to transmit the PPDU to one or more STAs. In the EHT MU PPDU format, an HE-SIG-B field may be located after a U-SIG field.

FIG. 8(d) shows an example of an EHT ER SU PPDU format used for single user transmission with an STA in an extended range. An EHT ER SU PPDU may be used for single user transmission with an STA of a wider range compared to the EHT SU PPDU described in FIG. 8(a), and a U-SIG field may be repeatedly located on a time axis.

The EHT MU PPDU described in FIG. 8(c) may be used by an AP to perform downlink transmission to a plurality of STAs. Here, the EHT MU PPDU may include scheduling information so that the plurality of STAs may concurrently receive the PPDU transmitted from the AP. The EHT MU PPDU may transfer, to the STAs, AID information of a transmitter and/or a receiver of the PPDU transmitted via a user specific field of EHT-SIG-B. Accordingly, the plurality of terminals having received the EHT MU PPDU may perform a spatial reuse operation based on the AID information of the user specific field included in a preamble of the received PPDU.

Specifically, a resource unit allocation (RA) field of the HE-SIG-B field included in the HE MU PPDU may include information on a configuration of a resource unit (e.g., a division form of the resource unit) in a specific bandwidth (e.g., 20 MHz, etc.) of a frequency axis. That is, the RA field may indicate configurations of resource units segmented in a bandwidth for transmission of the HE MU PPDU, in order for the STA to receive the PPDU. Information on the STA allocated (or designated) to each segmented resource unit may be included in the user specific field of EHT-SIG-B so as to be transmitted to the STA. That is, the user specific field may include one or more user fields corresponding to the respective segmented resource units.

For example, a user field corresponding to at least one resource unit used for data transmission among the plurality of segmented resource units may include an AID of a receiver or a transmitter, and a user field corresponding to the remaining resource unit(s) which is not used for data transmission may include a preconfigured null STA ID.

For convenience of description, a frame or a MAC frame may be interchangeably used with an MPDU in the disclosure.

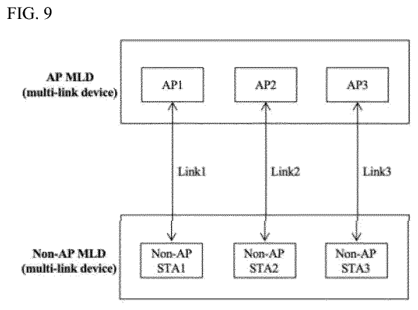

When one wireless communication device performs communication using multiple links, the communication efficiency of the wireless communication device may be increased. In this case, the link, as a physical path, may be configured as a wireless medium that can be used to deliver a MAC service data unit (MSDU). For example, in a case where frequency band of one link is in use by another wireless communication device, the wireless communication device may continue to perform communication through another link. As such, the wireless communication device may usefully use multiple channels. In addition, when the wireless communication device simultaneously performs communication using multiple links, the overall throughput may be increased. However, in the existing wireless LAN, it has been stipulated that one wireless communication device uses one link. Therefore, a WLAN operation method for using multiple links is required. A wireless communication method of a wireless communication device using multiple links will be described through FIGS. 9 to 26. First, a specific form of a wireless communication device using multiple links will be described through FIG. 9

FIG. 9 illustrates a multi-link device according to an embodiment of the present disclosure.

A multi-link device (MLD) may be defined for a wireless communication method using the multiple links described above. The multi-link device may represent a device having one or more affiliated stations. According to a specific embodiment, the multi-link device may represent a device having two or more affiliated stations. In addition, the multi-link device may exchange multi-link elements. The multi-link element includes information on one or more stations or one or more links. The multi-link element may include a multi-link setup element, which will be described below. In this case, the multi-link device may be a logical entity. Specifically, the multi-link device may have multiple affiliated stations. The multi-link device may be referred to as a multi-link logical entity (MLLE) or a multi-link entity (MLE). The multi-link device may have one medium access control (MAC) service access point (SAP) up to logical link control (LLC). In addition, the MLD may also have one MAC data service.

The multiple stations included in the multi-link device may operate in multiple links. In addition, the multiple stations included in the multi-link device may operate on multiple channels. Specifically, the multiple stations included in the multi-link device may operate in multiple different links or on multiple different channels. For example, the multiple stations included in the multi-link device may operate on multiple different channels of 2.4 GHz, 5 GHZ, and 6 GHz.

The operation of the multi-link device may be referred to as a multi-link operation, an MLD operation, or a multi-band operation. In addition, when a station affiliated with the multi-link device is an AP, the multi-link device may be referred to as the AP MLD. In addition, when a station affiliated with the multi-link device is a non-AP station, the multi-link device may be referred to as a non-AP MLD.

FIG. 9 illustrates an operation in which a non-AP MLD and an AP-MLD communicate with each other. Specifically, the non-AP MLD and the AP-MLD perform communication by using three links, respectively. The AP MLD includes a first AP (AP 1), a second AP (AP 2), and a third AP (AP 3). The non-AP MLD includes a first non-AP STA (non-AP STA 1), a second non-AP STA (non-AP STA 2), and a third non-AP STA (non-AP STA 3). The first AP (AP 1) and the first non-AP STA (non-AP STA 1) communicate through a first link (Link 1). In addition, the second AP (AP 2) and the second non-AP STA (non-AP STA 2) communicate through a second link (Link 2). In addition, the third AP (AP 3) and the third non-AP STA (non-AP STA 3) communicate through a third link (Link 3).

The multi-link operation may include a multi-link setup operation. The multi-link setup may correspond to an association operation of the single link operation described above and may need to be performed first for frame exchange in the multiple links. The multi-link device may obtain information necessary for the multi-link setup from a multi-link setup element. Specifically, the multi-link setup element may include capability information associated with the multiple links. In this case, the capability information may include information indicating whether any one of multiple of devices included in the multi-link device performs transmission and simultaneously, another device may perform reception. In addition, the capability information may include information on the links available for each station included in the MLD. In addition, the capability information may include information on the channels available for each station included in the MLD.

The multi-link setup may be set up through agreement between peer stations. Specifically, the multi-link setup may be performed through communication between stations without communication with the AP. In addition, the multi-link setup may be set up through any one link. For example, even if the first link to the third link are set up through the multi-link, the multi-link setup may be performed through the first link.

In addition, mapping between a traffic identifier (TID) and a link may be set up. Specifically, frames corresponding to a TID of a particular value may only be exchanged through a pre-specified link. The mapping between the TID and the link may be performed as a directional-based setup. For example, when multiple links are set up between a first multi-link device and a second multi-link device, the first multi-link device may be set up to transmit a frame of the first TID to the multiple first links, and the second multi-link device may be set up to transmit a frame of the second TID to the first link. In addition, there may be a default setup for the mapping between the TID and the link. Specifically, when there is no additional setup in the multi-link setup, the multi-link device may exchange frames corresponding to the TID at each link according to the default setup. In this case, the default setup may be that all the TIDs are exchanged in any one link.

A TID will be described in detail. The TID is an ID for classifying traffic and data in order to support quality of service (QOS). In addition, the TID may be used or allocated in a higher layer than a MAC layer. In addition, the TID may indicate a traffic category (TC) or a traffic stream (TS). In addition, the TID may be classified as 16 types. For example, the TID may be designated as one of the values in the range from 0 to 15. A TID value to be used may be differently designated according to an access policy and a channel access or medium access method. For example, in a case that enhanced distributed channel access (EDCA) or hybrid coordination function contention-based channel access (HCAF) is used, the TID may be allocated with a value in the range of 0 to 7. In a case where the EDCA is used, the TID may indicate a user priority (UP). In this case, the UP may be designated according to a TC or a TS. The UP may be allocated in a higher layer than MAC. In addition, in a case where HCF controlled channel access (HCCA) or SPCA is used, the TID may be allocated with a value in the range of 8 to 15. In a case where the HCCA or SPCA is used, the TID may indicate a TSID. In addition, in a case where the HEMM or the SEMM is used, the TID may be allocated with a value in the range of 8 to 15. In a case where the HEMM or SEMM is used, the TID may indicate a TSID.

A UP and an AC may be mapped. The AC may be a label for providing a QoS in EDCA. The AC may be a label for indicating an EDCA parameter set. An EDCA parameter or an EDCA parameter set may be a parameter used for EDCA channel contention. A QoS station may guarantee a QoS using the AC. In addition, the AC may include AC_BK, AC_BE, AC_VI, and AC_VO. The AC_BK, AC_BE, AC_VI, and AC_VO may indicate a background, a best effort, a video, and a voice, respectively. In addition, each of the AC_BK, AC_BE, AC_VI, and AC_VO may be classified into subordinate ACs. For example, the AC_VI may be subdivided into AC_VI primary and AC_VI alternate. In addition, the AC_VO may be subdivided into AC_VO primary and AC_VO alternate. In addition, a UP or a TID may be mapped to an AC. For example, a UP or TID having a value of 1, 2, 0, 3, 4, 5, 6, and 7 may be mapped to AC_BK, AC_BK, AC_BE, AC_BE, AC_VI, AC_VI, AC_VO, and AC_VO, respectively. In addition, a UP or TID having a value of 1, 2, 0, 3, 4, 5, 6, and 7 may be mapped to AC_BK, AC_BK, AC_BE, AC_BE, AC_VI alternate, AC_VI primary, AC_VO primary, and AC_VO alternate, respectively. In addition, a UP or TID having a value of 1, 2, 0, 3, 4, 5, 6, and 7 may sequentially have higher priorities. That is, 1 denotes a low priority and 7 denotes a high priority. Therefore, AC_BK, AC_BE, AC_VI, and AC_VO may sequentially have higher priorities. In addition, AC_BK, AC_BE, AC_VI, and AC_VO may correspond to an AC index (ACI) 0, 1, 2, and 3, respectively. Due to such characteristics of a TID, mapping between a TID and a link may indicate mapping between an AC and a link. In addition, mapping between a link and an AC may indicate mapping between a TID and a link.

As described above, a TID may be mapped to each of multiple links. The mapping may be designating a link in which traffic corresponding to a predetermined TID or AC can be exchanged. In addition, a TID or AC that is transmittable for each transmission direction in a link may be designated. As described above, there may be a default setup for mapping between a TID and a link. Specifically, in a case where there is no additional setup for a multi-link setup, a multi-link device may exchange a frame corresponding to a TID in each link according to the default setup. In this case, the default setup may be exchanging all TIDs in any one link. Any TID or AC at any time point may be always mapped to at least any one link. A management frame and a control frame may be transmitted in all links.

In a case where a link is mapped to a TID or an AC, only a data frame corresponding to the TID or AC mapped to the corresponding link may be transmitted in the corresponding link. Therefore, in a case where a link is mapped to a TID or an AC, a frame that does not correspond to the TID or AC mapped to the corresponding link may not be transmitted in the corresponding link. In a case where a link is mapped to a TID or an AC, an ACK may also be transmitted on the basis of the link to which the TID or the AC is mapped. For example, a block ACK agreement may be determined on the basis of mapping between a TID and a link. According to another embodiment, mapping between a TID and a link may be determined on the basis of a block ACK agreement. Particularly, a block ACK agreement may be set up for a TID mapped to a particular link.

A QoS may be guaranteed via the above-described mapping between a TID and a link. Specifically, an AC or TID having a high priority may be mapped to a link in which a relatively small number of stations operate or a link having a good channel condition. In addition, via the above-described mapping between a TID and a link, a station may maintain a power-saving state for a longer time interval.

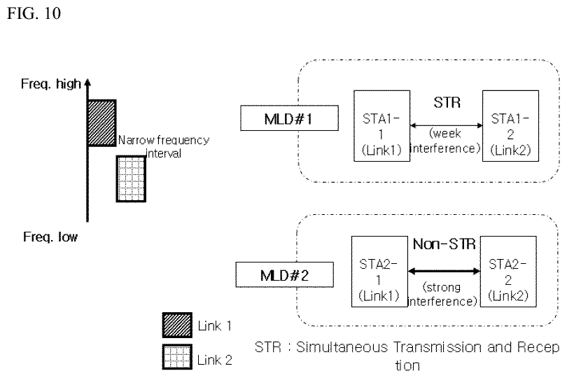

FIG. 10 illustrates a case in which transmissions in different links are simultaneously performed in a multi-link operation according to an embodiment of the present disclosure.

According to implementation of a multi-link device, a simultaneous operation may not be supported in multiple links. For example, it may not be supported that the multi-link device simultaneously performs transmission in multiple links, performs reception in multiple links, or performs transmission in any one link and simultaneously performs reception in another link. This is because reception or transmission performed in any one link may affect reception or transmission performed in another link. Specifically, transmission in one link may act as interference in another link. Interference from one link of a single multi-link device applied to another link may be referred to as an internal leakage. The smaller the frequency interval between links, the higher the internal leakage. In a case where the internal leakage is not too high while transmission is performed in any one link, transmission may be performed in another link. In a case where the internal leakage is too high while transmission is performed in any one link, transmission cannot be performed in another link. As such, when the multi-link device simultaneously operates in multiple links, it may be referred to as simultaneous transmit and receive or simultaneous transmission and reception (STR). For example, when the multi-link device simultaneously performs transmission in multiple links, the multi-link device performs transmission in any one link and simultaneously performs reception in another link, or simultaneously performs reception in multiple links, it may be referred to as STR.

If STR is not supported due to interference among multiple stations constituting the MLD, the STAs may be represented to be in a non-STR relationship or an NSTR relationship (a relationship in which STR is not supported).

In this case, whether two STAs (STA 1 and STA 2) support STR may vary according to an interval distance of a pair of links in which the STAs are operated (link 1 in which STA 1 is operated and link 2 in which STA 2 is operated).

Accordingly, if STR is supported between two STAs operated in a specific link pair when the MLD operates each STA in the specific link pair, the specific link pair may be considered as an STR link pair by the MLD. However, if STR is not supported between two STAs operated in different link pairs when the MLD operate STAs in the different link pairs, respectively, the different link pairs may be considered as NSTR link pairs by the MLD.

As such, whether STR between STAs of the MLD is supported is determined according to whether a link pair of the operating STAs corresponds to an STR link pair or an NSTR link pair. However, as described above, the characteristic (the shielding performance, etc.) of each MLD may vary, and thus a specific link pair may be considered as a link pair for which STR is supported for a specific MLD, and may be considered as an NSTR link pair for which STR is not supported for other MLDs.

In embodiments of the present disclosure to be described below, for convenience of description, STAs operated in an STR link pair of an MLD are referred to (specified) as STAs of an STR MLD, and STAs operated in an NSTR link pair of the MLD are referred to (specified) as STAs of an NSTR (and non-STR) MLD. That is, in the embodiments to be described below, it may be interpreted that if “STA of a non-STR MLD” is used, the STA refers to one of two STAs operated in the NSTR link of the MLD, and if “STA of STR MLD” is used, the STA refers to one of two STAs operated in the STR link pair of the MLD.

In addition, in regards to the description of whether the STR is supported, the NSTR MLD may have a meaning including not only an MLD having an STA which loses receiving capability but also an MLD having a hardware configuration not supporting transmission/reception.

In other words, when a hardware configuration of a multi-link device (MLD) may correspond to a configuration in which when a specific STA of an MLD performs transmission or reception, hardware resource that can be utilized by other STAs of the MLD are limited. For example, when a specific MLD has a hardware configuration supporting processing for only one PPDU and a specific STA of the specific MLD is performing Rx, the specific MLD cannot support Tx and Rx for another STA in the MLD. Similarly, also in a case where the specific STA of the specific MLD performs Tx, the specific MLD cannot support Tx and Rx for another STA in the MLD

As such, a device, which corresponds to a multi-link device and can operate STAs in two or more links but cannot support transmission/reception for only one STA at a specific time point, may be called a multi-link single radio MLD (MLSR MLD). Alternatively, as a type of operation mode, an operation mode in which an MLD supports transmission/reception for only one STA may be also called an enhanced multi-link single radio (EMLSR) mode. In this case, the MLD operating in the EMLSR mode may be a multi-radio MLD or an enhanced single-radio MLD. The enhanced single-radio MLD may mean a device which supports data transmission/reception for only one link at a time, but supports CCA and low data rate (for example, encoded at 6 MHz or 24 MHz or less) PPDU transmission/reception for two or more links while having a configuration including separate hardware (low-cost PHY front end, etc.).

In addition, as modification of the EMLSR mode, enhanced multi-link multi-radio (EMLMR), in which an MLD supports transmission/reception for each STA but utilizes a part of an RF chain used by a specific STA for transmission/reception of another STA, may be defined. In a case of EMLMR, if the whole RF chain used by the specific STA is utilized for transmission/reception of another STA, the EMLMR may have the same transmission/reception limitation characteristics as the EMLSR. That is, the MLD operating in the EMLMR mode may perform an operation of supporting transmission/reception for only one link (STA) at a specific time point, regardless of whether STR for links are supported or not, and this may be understood as a similar operation to that of the MLD operating in the EMLSR mode.

That is, links of the MLD operated in the EMLSR/EMLMR mode may be considered to correspond an NSTR link pair.

In this case, the above-described transmission/reception has a meaning including transmission/transmission and reception/reception, that is, is irrelevant to whether STR/NSTR is supported for two links.

For convenience of description, the EMLSR/EMLMR MLD below is utilized to have a meaning including an MLD which can support transmission/reception for only one STA at a specific time point due to hardware restrictions, and an MLD which supports high-speed data frame transmission/reception for only one STA at a specific time point, as a type of an operating mode, even though transmission/reception (processing capability regardless of STR) for two or more STAs can be supported.

The operations of the STR MLD in consideration of the performance restrictions of the NSTR MLD, provided through the above-described embodiments of the present disclosure can be utilized without change as an operation of an STR MLD for the MLSR MLD. For example, the STA of the STR MLD may perform transmission to the STA of a multi-link single radio MLD, and then may cancel transmission which has been performed or which is to be performed when the performed transmission is determined to fail or predicted to fail due to the restricted performance of the multi-link single radio MLD STA. In this case, a procedure of identifying whether the transmission has failed due to the restricted performance of the EMLSR/EMLMR MLD may be similar to identifying whether transmission performed for the STA of the NSTR MLD has failed due to the restricted performance of the NSTR NLD STA.

As described above, the multi-link device may not support STR, or may restrictively support STR. Specifically, the multi-link device may support STR only under a predetermined condition. For example, in a case where the multi-link device operates using a single radio, the multi-link device may not be able to perform STR. In addition, in a case where the multi-link device operates using a single antenna, the multi-link device may not be able to perform STR. In addition, in a case where the magnitude of an internal leakage is detected as being greater than or equal to a predetermined magnitude, the multi-link device may not be able to perform STR.

A station may exchange information relating to STR capability of the station with another station. Specifically, the station may exchange, with another station, information relating to whether the capability that the station simultaneously performs transmission in multiple links or simultaneously performs reception in multiple links is restrictive. Specifically, the information relating to whether the capability of performing transmission or reception in multiple links is restrictive may indicate whether simultaneous transmission can be performed in multiple links, simultaneous reception can be performed in multiple links, or simultaneous transmission and reception can be performed in multiple links. In addition, the information relating to whether the capability of performing transmission or reception in multiple links is restrictive may be information indicated for each stage. Specifically, the information relating to whether the capability of performing transmission or reception in multiple links is restrictive may be information indicating a stage representing the magnitude of an internal leakage. In a specific embodiment, the information indicating the stage representing the magnitude of an internal leakage may be information indicating a stage representing the magnitude of interference caused due to the internal leakage.

In another specific embodiment, the information may be information indicating a stage representing a frequency interval between links that may affect an internal leakage. In addition, the information indicating the stage representing the magnitude of an internal leakage may be information indicating the relationship between an internal leakage and a frequency interval between links for each stage.

In FIG. 10, a first station (STA 1) and a second station (STA 2) may be affiliated with a single non-AP multi-link device. In addition, a first AP (AP 1) and a second AP (AP 2) may be affiliated with the single non-AP multi-link device. A first link (Link 1) may be set up between the first AP (AP 1) and the first station (STA 1), and a second link (Link 2) may be set up between the second AP (AP 2) and the second station (STA 2). In FIG. 10, the non-AP multi-link device may restrictively perform STR. In a case where the second station (STA 2) performs transmission in the second link (Link 2), reception performed by the first station (STA 1) in the first link (Link 1) may be disturbed by transmission performed in the second link (Link 2). For example, in the following case, the reception performed by the first station (STA 1) in the first link (Link 1) may be disturbed by transmission performed in the second link (Link 2). The second station (STA 2) may transmit first data (Data 1) in the second link (Link 2), and the first AP (AP 1) transmits, to the first station (STA 1), a response (ACK for Data 1) to the first data (Data 1). The second station (STA 2) transmits second data (Data 2) in the second link (Link 2). In this case, a transmission time of the second data (Data 2) and a transmission time of the response (ACK for Data 1) to the first data (Data 1) may overlap. In this case, due to the transmission to the second station (STA 2) in the second link (Link 2), interference in the first link (Link 1) may occur. Therefore, the first station (STA 1) may fail to receive the response (ACK for Data 1) to the first data (Data 1).

An operation in which a multi-link device performs channel access is described. A multi-link operation for which there is no detailed description may follow the channel access procedure described through FIG. 6.

A multi-link device may independently perform channel access in multiple links. In this case, the channel access may be backoff-based channel access. When the multi-link device independently performs channel access in multiple links and a backoff counter in the multiple links reaches 0, the multi-link device may start simultaneous transmission in the multiple links. According to another detailed embodiment, when the backoff counter of any one link of the multi-link device reaches 0 and a pre-designated condition is satisfied, the multi-link device may perform channel access not only in a link in which the backoff counter has reached 0 but also in another link in which the backoff counter has not reached 0. Specifically, when the backoff counter of any one link of the multi-link device reaches 0, the multi-link device may perform energy detection in another link in which the backoff counter has not reached 0. In this case, energy greater than or equal to a predetermined magnitude is not detected, the multi-link device may perform channel access not only in a link in which the backoff counter has reached 0 but also in a link in which the energy detection has been performed. Through the above, the multi-link device may start simultaneous transmission in multiple links. The magnitude of a threshold value used for energy detection may be less than the magnitude of a threshold value used for determining whether to decrease a backoff counter. In addition, when determining whether to decrease a backoff counter, the multi-link device may detect any type of signal, as well as, a wireless LAN signal. In addition, in the above-described energy detection, the multi-link device may detect any type of signal, as well as, a wireless LAN signal. An internal leakage may not be detected via a wireless LAN signal. In such a case, the multi-link device may sense a signal detected due to an internal leakage via energy detection. In addition, as described above, the magnitude of a threshold value used for energy detection may be less than the magnitude of a threshold value used for determining whether to decrease a backoff counter. Therefore, although transmission is being performed in one link, the multi-link device may reduce a backoff counter in another link.

According to the degree of interference between links used by a multi-link device, the multi-link device may determine whether a station operating in each link may independently operate. In this case, the degree of interference between links may be the size of interference detected by, when one station performs transmission in one link, another station of the multi-link device. When transmission by the first station of the multi-link device in the first link gives interference having a pre-designated size or greater to the second station of the multi-link device operating in the second link, the operation of the second station may be restricted. Specifically, reception or channel access of the second station may be restricted. This is because, when interference occurs, the second station may fail in decoding of the received signal due to the interference. Furthermore, this is because, when interference occurs, the second station may determine that the channel is being used when the second station performs channel access using the backoff.

In addition, when transmission by the first station of the multi-link device in the first link gives interference having a size smaller than a pre-designated size to the second station of the multi-link device operating in the second link, the first station and the second station may independently operate. Specifically, when transmission by the first station of the multi-link device in the first link gives interference having a size smaller than a pre-designated size to the second station of the multi-link device operating in the second link, the first station and the second station may independently perform channel access. Furthermore, when transmission by the first station of the multi-link device gives interference having a size smaller than a pre-designated size to the second station of the multi-link device operating in the second link, the first station and the second station may independently perform transmission or reception. This is because, when interference having the size smaller than the pre-designated size occurs, the second station may succeed in decoding the received signal even when the interference exists. Furthermore, this is because, when interference having the size smaller than the pre-designated size occurs, the second station may determine that the channel is idle when the second station performs channel access using the backoff.

The degree of interference occurring between stations of the multi-link device may vary depending on a hardware characteristic of the multi-link device as well as the interval between frequency bands of the links in which the stations operate. For example, the degree of internal interference occurring in the multi-link device including an expensive radio frequency (RF) device may be less than that of internal interference occurring in the multi-link device including an inexpensive RF device. Accordingly, the degree of interference occurring between the stations of the multi-link device may be determined based on a characteristic of the multi-link device.

FIG. 10 illustrates that a size of occurring interference varies depending on an interval between frequency bands of links and a characteristic of a multi-link device. In the embodiment of FIG. 10, a first multi-link device (MLD #1) includes a first station (STA 1-1) operating in a first link (Link 1) and a second station (STA 1-2) operating in a second link (Link 2). A second multi-link device (MLD #2) includes a first station (STA 2-1) operating in a first link (Link 1) and a second station (STA 2-2) operating in a second link (Link 2). A frequency interval between the first link (Link 1) and the second link (Link 2) in which the first multi-link device (MLD #1) operates is the same as a frequency interval between the first link (Link 1) and the second link (Link 2) in which the second multi-link device (MLD #2) operates. However, the size of occurring interference may be different due to a difference between a characteristic of the first multi-link device (MLD #1) and a characteristic of the second multi-link device (MLD #2). Specifically, the size of interference occurring in the first multi-link device (MLD #1) may be greater than the size of interference generated in the second multi-link device (MLD #2). As described above, the size of occurring interference may vary depending on the characteristic of the multi-link device, and it may be required to exchange information on whether STR is supported when it is considered that whether STR is supported is different according to each multi-link device.

The multi-link device may signal information on whether STR is supported by the station included in the multi-link device. Specifically, an AP multi-link device and a non-AP multi-link device may exchange information on whether STR is supported by the AP included in the AP multi-link device and whether STR is supported by the STA included in the non-AP multi-link device. In such embodiments, an element indicating whether STR is supported may be used. The element indicating whether STR is supported may be referred to as an STR support element. The STR support element may indicate whether STR is supported by the station of the multi-link device transmitting the STR support element through 1 bit. Specifically, the STR support element may indicate whether STR is supported by each station included in the multi-link device transmitting the STR support element by 1 bit. In this case, a value of the bit may be 1 when the station supports STR, and the value of the bit may be 0 when the station does not support STR. When the multi-link device having transmitted the STR support element includes a first station (STA 1), a second station (STA 2), and a third station (STA 3), the first station (STA 1) and the third station (STA 3) support STR, and the second station (STA 2) does not support STR, the STR support element may include a field having 1011b. It is assumed that stations operating in different frequency bands support STR, and the STR support element may omit signaling indicating whether STR is supported between the stations operating in different frequency bands. For example, the first station (STA, 1) operates in a first link of 2.4 GHZ, and the second station (STA 2) and the third station (STA 3) operate in a second link and a third link of 5 GHZ, respectively. In this case, the STR support element may indicate that STR is supported between the second station (STA 2) and the third station (STA 3) by using 1 bit. Furthermore, the STR support element may include only 1 bit when the number of stations signaled by the STR support element is 2.

In a detailed embodiment, the relation between the link located in 2.4 GHz and the link located in 5 GHz or 6 GHz among the links of the multi-link device may be always determined to be STR. Accordingly, signaling for STR of the link located in 2.4 GHz and the link located in 5 GHz or 6 GHz may be omitted.

In the above-described embodiments, the operation described as an operation of a station of a multi-link device may be substituted with an operation of a multi-link device. In addition, in the above-described embodiments, the operation of an AP may be substituted with an operation of a non-AP station, and the operation of a non-AP station may be substituted with an operation of an AP. Accordingly, an operation of an AP of a non-STR multi-link device may be substituted with an operation of a non-AP station of a non-STR multi-link device, and an operation of a non-AP station of an STR multi-link device may be substituted with an operation of an AP of an STR multi-link device. In addition, an operation of a non-AP station of a non-STR multi-link device may be substituted with an operation of an AP of a non-STR multi-link device, and an operation of an AP of an STR multi-link device may be substituted with an operation of a non-AP station of an STR multi-link device.

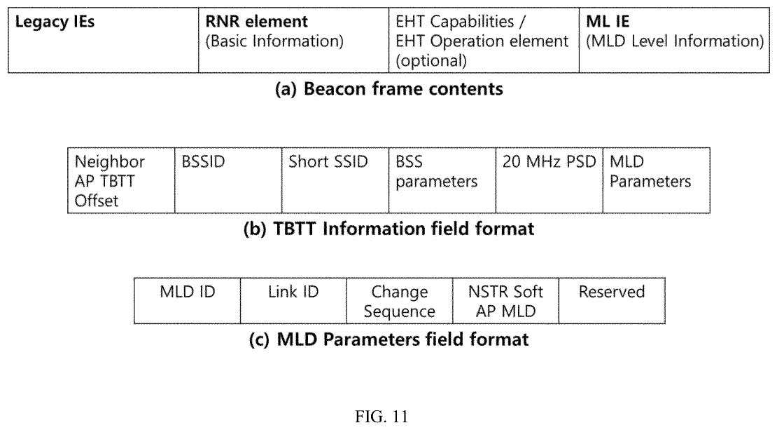

FIG. 11 illustrates an example of beacon frame contents transmitted by an AP of an AP MLD, and a target beacon transmission time (TBTT) information field format included in a reduced neighbor report (RNR) element according to an embodiment of the present disclosure.

Referring to FIG. 11(a), a beacon frame may include, in legacy IEs, the same parameters and elements as those included in the beacon frame disclosed in 802.11ax of the conventional Wi-Fi. For example, the legacy IEs of the beacon frame may include elements such as a timestamp field, a beacon interval field indicating a beacon transmission interval, a TIM, a DSSS parameter set, an IBSS parameter set, a country, a channel switch announcement, an extended channel switch announcement, a wide bandwidth channel switch, transmission power envelop, supported operating classes, IBSS DFS, ERP information, HR capabilities, an HT operation, VHT capabilities, a VHT operation, S1G beacon compatibility, a short beacon interval, SIG capabilities, an S1G operation, HE capabilities, HE 6 GHz band capabilities, an HE operation, a BSS color change announcement, and spatial reuse parameter set.

In this case, the configuration method and the meaning of the elements and fields included in the legacy IEs field are identical to those of the elements and the fields having the same name, included in the beacon frame disclosed in up to 802.11ax of the conventional Wi-Fi.

In addition, the beacon frame may include a reduced neighbor report (RNR) element for indicating information of a neighbor AP. The RNR element may be used to notify a station of the information of the neighbor AP, and the station may receive the beacon frame and recognize the neighbor AP through the RNR element included in the beacon frame.

Specifically, the RNR element may include an element ID field, a length field, and a neighbor AP information field. Each neighbor AP information field may include a TBTT information header field (2 octet), an operation class field (1 octet), a channel number field (1 octet), and a TBTT information set (variable length) field. In this case, the RNR element transmitted by an AP included an AP MLD may include a TBTT information field format as illustrated in FIG. 11(b) to indicate basic information of another AP included in the same MLD. Unlike the TBTT information field of the RNR element transmitted by the AP in 802.11ax of the conventional Wi-Fi, an RNR element transmitted by an AP included an EHT AP MLD may include an MLD parameters field.

The MLD parameters field may include an MLD ID subfield, a link ID subfield, and a change sequence subfield as illustrated in FIG. 11(c). In this case, when an AP MLD indicates another AP information of the same MLD through a specific neighbor AP information field of the RNR element, an MLD ID subfield included in the specific neighbor AP information field may be configured as 0. That is, to notify to the station that the neighbor AP information field indicates an AP included in the same AP MLD, the AP may configure the MLD ID subfield as a specific value, and the station having received the neighbor AP information field may recognize through a value of the MLD ID subfield that the AP corresponding to the neighbor AP information field and the AP having transmitted the neighbor AP information field are included in the same MLD.

The link ID subfield may correspond to a subfield in which an index determined by an AP MLD is indicated to indicate a link managed by another AP to be indicated through neighbor AP information. The change sequence subfield may be a subfield used to indicate information relating to an update (for example, a critical update) related to a link of another AP. For example, when a value of the change sequence subfield is changed, the station having received the same may recognize that a parameter related to a BSS (or, link) of the corresponding AP has been updated, and may request an updated parameter from the AP to update the corresponding parameter. In this case, when the AP MLD is an NSTR AP MLD corresponding to an MLD not supporting simultaneous transmission or reception (for example, when the AP MLD is an NSTR mobile AP MLD or an NSTR soft AP MLD, that is, when a mobile or the like operates as a soft AP MLD for tethering, etc.), an STA included in an STA MLD may perform a procedure of updating the parameter only through a primary link. That is, to update a parameter of another link (for example, a non-primary link) of another neighbor AP, other than the primary link of the AP MLD, a frame for parameter updating may be transmitted or received only through the primary link.

Hereinafter in the present disclosure, the NSTR AP MLD may be referred to as an NSTR soft AP MLD or an NSTR mobile AP MLD.

In addition, when the AP is an NSTR AP MLD not supporting simultaneous transmission or reception (for example, when the AP is an NSTR mobile AP MLD or an NSTR soft AP MLD, that is, when a mobile terminal, or the like operates as a soft AP MLD for tethering, etc.), the NSTR AP MLD may include, in a beacon frame, information indicating that the NSTR AP MLD itself is an NSTR AP MLD, and transmit the same. For example, the NSTR AP MLD may configure a value of a specific subfield included in the beacon frame as a specific value (for example, “0” or “1”), and a non-AP STA MLD having received the beacon frame may recognize that the AP MLD having transmitted the beacon frame is the NSTR AP MLD. Accordingly, in a case of not indicating the NSTR AP MLD (for example, in a case of an STR AP MLD, another AP MLD, etc.), the specific subfield for indicating the NSTR AP MLD may be configured as a value (for example, “1” or “0”) other than the specific value.

The specific subfield for indicating the NSTR AP MLD may be indicated together with a subfield (for example, MLD level capability) related to capability of the beacon frame, or may be included in a neighbor AP information field related to an AP of a non-primary link of an NSTR AP MLD, and transmitted. For example, the specific subfield for indicating the NSTR AP MLD may be encoded together with a frequency separation for STR/AP MLD type indication corresponding to a capability-related subfield, and indicated. That is, the specific subfield may be encoded together with the frequency separation for STA/AP MLD type indication indicating the distance for supporting STR, and indicated through the beacon frame. In this case, when the corresponding indicator indicates the type of the AP MLD, it may be indicated that the AP MLD having transmitted the beacon frame is the NSTR AP MLD or is not the NSTR AP MLD according to a configured value (for example, when the configured value is “0”, it may indicate that the AP MLD is not the NSTR AP MLD, and when the configured value is “1”, it may indicate that the AP MLD is the NSTR AP MLD).

As such, a method in which the subfield indicating the NSTR AP MLD is utilized may be used as a method for explicitly indicating whether the AP MLD is the NSTR AP MLD.

In another example, the NSTR AP MLD may indicate that the NSTR AP MLD itself is the NSTR AP MLD in an implicit method, without directly indicating, through the specific subfield, that the NSTR AP MLD itself is the NSTR AP MLD. Specifically, the NSTR AP MLD may indicate that there are two links supportable by the NSTR AP MLD itself, and simultaneously, may implicitly indicate that the NSTR AP MLD itself is the NSTR AP MLD by indicating that the NSTR AP MLD itself has an NSTR link pair. In this case, to indicate that there are two links supportable by the NSTR AP MLD itself, the NSTR AP MLD may configure a maximum number of simultaneous links subfield included in the beacon frame as 1 (or a pre-promised value indicating two). In this case, to indicate that the NSTR AP MLD itself has the NSTR link pair, the NSTR AP MLD may configure an NSTR link pair present subfield included in the beacon frame as 1 or 0.

The AP MLD may notify, to the non-AP STA MLD through the explicit method or the implicit method, that the AP MLD itself is the NSTR AP MLD, by transmitting the beacon frame as in the above-described method. The non-AP STA MLD may implicitly or explicitly recognize, through the received beacon frame, whether the AP MLD having transmitted the beacon frame is the NSTR AP MLD. If the AP MLD having transmitted the beacon frame is the NSTR AP MLD (that is, when the beacon frame indicates, in the explicit or implicit method, that the AP MLD is the NSTR AP MLD), the non-AP STA MLD may perform a procedure for association or setup with the NSTR AP MLD only through a link in which the beacon frame is received. That is, the non-AP STA MLD may perform transmission or reception of a frame for association or setup with the NSTR AP MLD only through a link (for example, a primary link) in which the beacon frame is received. For example, the transmission or reception of the frame for the association or setup with an AP connected through a link other than the primary link, included in the NSTR AP MLD, may be performed only through the primary link. In this case, an (ML) (re) association request frame transmitted by the non-AP STA MLD may be transmitted through a non-primary link other than the primary link.

In this case, the NSTR AP MLD may not indicate information relating to an AP of the non-primary link in the RNR element of the beacon frame (transmitted in the primary link), so as to prevent the non-AP STA MLDs from attempting the setup procedure in the non-primary link. That is, the beacon frame transmitted by the AP of the NSTR AP MLD may not include/indicate a neighbor AP information field for the AP (of the same MLD) of another link. In this case, after receiving the beacon frame, the non-AP STA MLDs fail to identify information on the AP of the non-primary link, and thus may not attempt step for the NSTR AP MLD in the non-primary link. In this case, the non-AP STA MLD having received the beacon frame not including the neighbor AP information field for the AP of the non-primary link from the NSTR AP MLD may implicitly recognize, as described above, that a counterpart AP is the NSTR AP MLD on the basis that there are two simultaneous support links of the AP having transmitted the beacon frame and no information on another AP of the same MLD is indicated.

When receiving an (ML) (re) association request frame from an STA (MLD), a general AP MLD needs to transmit an (ML) association response frame through a link in which the (ML) association request frame is received. However, the NSTR AP MLD may be allowed to perform, through a primary link, responding to the (ML) association request frame received through a non-primary link (i.e., to respond with the (ML) association response frame in the primary link).

As described above, this may be an operation allowed because an operation in which the NSTR AP MLD performs transmission through the non-primary link is somewhat restricted compared to a general AP. To described in more detail, in a case of the NSTR AP MLD, when a response to the (ML) association response frame is transmitted through the non-primary link, there is an operation restriction that the transmission needs to start together in the primary link. As being considered in other embodiments of the present disclosure, this may be an operation restriction considered to prevent the AP of the primary link from being in a BLIND state.

Therefore, when receiving the (ML) (re) association request frame through the non-primary link, the NSTR AP MLD may respond with the (ML) (re) association response frame through the primary link, or may respond with the (ML) (re) association response frame through both the primary link and the non-primary link. That is, an STA MLD having transmitted the (ML) (re) association request frame through the non-primary link of the NSTR AP MLD may recognize that the response to the request frame having requested by the STA MLD itself is to be received through the primary link, and may wait for the reception of the (ML) (re) association response frame in the primary link.

The RNR element transmitted by the AP through the beacon frame may include a specific TBTT information field including the MLD parameters field. In this case, when an MLD ID of the MLD parameters field is configured as “0”, the STA MLD may recognize that the AP corresponding to the neighbor AP information field including the corresponding MLD parameters field is included in the AP MLD in which the AP having transmitted the beacon frame is included. That is, the STA MLD may recognize that the corresponding neighbor AP information field indicates information on another AP included in the same AP MLD as the AP having transmitted the beacon frame. In this case, a method for interpreting/obtaining the same by the STA MLD may be identical/similar to an operation performed by the conventional STAs after receiving the RNR element

However, in the case of the NSTR soft AP, the beacon frame is not transmitted in the non-primary link, and thus it may be impossible to indicate information related to the beacon frame of another AP (the AP of the non-primary link) through the RNR element. To describe in more detail, the NSTR soft AP MLD does not transmit the beacon frame through the AP of the non-primary link, and thus the NSTR soft AP MLD cannot indicate information on the beacon frame when indicating AP basic information of the non-primary link in the RNR element. For example, in the non-primary link in which the beacon frame is not transmitted, there is no information corresponding to the TBTT information count, TBTT information length, and neighbor AP TBTT offset subfields. Therefore, when transmitting the RNR element through the AP of the primary link, the NSTR soft AP MLD may need to set, to a pre-configured value, the TBTT-related field of the neighbor AP information field corresponding to the AP of the non-primary link.

The neighbor AP TBTT offset subfield of the TBTT information field (see FIG. 11(b)) is a subfield indicating information related to a next TBTT of another AP to be indicated. That is, the neighbor AP TBTT offset subfield included in the neighbor AP information field may include information on the next TBTT of the AP corresponding to the neighbor AP information field. For example, when AP 1 for transmitting a beacon frame indicates information on AP 2 through an RNR element (through a neighbor AP information field), a neighbor AP TBTT offset subfield corresponding to AP 2 indicates that the next TBTT of AP 2 has a difference in time units (TUs) (1024 us) compared to the immediately preceding TBTT of AP 1. In this case, a value indicated by the neighbor AP TBTT offset subfield is a value obtained by rounding down a TBTT offset to a neighboring integer. That is, when the AP indicates a value of 10 in the neighbor AP TBTT offset subfield of another AP, the next TBTT of another AP may have a time interval of 10 TUs or more to 11 TUs or less with reference to the previous TBTT of the AP.

However, when the primary link AP of the NSTR soft AP MLD sets a value for the neighbor AP TBTT offset subfield (1-octet) corresponding to the AP of the non-primary link, the value of the subfield may need to be set to a pre-configured value (for example 254 or 255). This may be because a target beacon transmission time (TBTT) corresponding to a time scheduled for transmission of the next beacon frame cannot be determined due to no transmission of the beacon frame in the non-primary link in a case of the NSTR soft AP. That is, the beacon frame transmitted by the NSTR soft AP MLD in the primary link may need to set, to 254 and/or 255, the neighbor AP TBTT offset subfield corresponding to the AP of the non-primary link through the RNR element. In this case, the neighbor AP TBTT offset subfield corresponding to the non-primary link may exist in the TBTT information field including the MLD parameters field having the MLD ID subfield set to 0.

Accordingly, when the non-AP STA MLD identifies, from the specific neighbor AP information field of the RNR element included in the beacon frame, the TBTT information field having the MLD ID subfield set to 0 and the TBTT offset subfield indicated as 254 and/or 255 after receiving the beacon frame of the NSTR soft AP MLD, the non-STA MLD may recognize that the specific neighbor AP information field indicates information on the AP (NSTR soft AP MLD) operated in the non-primary link of the NSTR soft AP MLD. As such, the non-AP STA MLD having received the beacon frame of the NSTR soft AP MLD should not transmit a probe request frame or an ML probe request frame to the NSTR soft AP MLD through the non-primary link when identifying the information on AP MLD operated in the non-primary link of the corresponding NSTR AP MLD.

In addition, when the non-AP STA MLD has recognized that the received beacon frame is the beacon frame transmitted by the MLD and the neighbor AP TBTT offset subfield corresponding to another AP in the same MLD as the AP (reporting AP) having transmitted the beacon frame is indicated as 254 and/or 255, the non-AP STA MLD should not transmit the probe request frame and the ML probe request frame to another AP.

In addition, when the non-AP STA MLD has recognized that the received beacon frame is the beacon frame transmitted by the MLD and the neighbor AP TBTT offset subfield corresponding to another AP of the same MLD as the AP (reporting AP) having transmitted the beacon frame is indicated as 254 and/or 255, the non-AP STA MLD should not transmit the probe request frame and the ML probe request frame to another AP.

### <MLD AP TBTT Offset Indication>

In the above-described embodiments of the present disclosure, it is mentioned that a beacon frame transmitted by an NSTR soft AP MLD may indicate a neighbor AP TBTT offset subfield corresponding to an AP of a non-primary link as a pre-configured value (254 and/or 255). However, the neighbor AP TBTT offset subfield may be indicated as 254 or 255 not even in a case of corresponding to the AP of the non-primary link of the NSTR soft AP MLD. For example, when a TBTT offset of another AP identified by an AP transmitting the beacon frame is equal to or greater than 254 TUs (254 TUs or greater than 254 TUs), the AP may indicate the neighbor AP TBTT offset subfield corresponding to another AP as 254 in the beacon frame. In addition, when the AP transmitting the beacon frame cannot accurately identify the TBTT offset of another AP, the AP may indicate the neighbor AP TBTT offset subfield corresponding to another AP as 255.

However, since the AP of the MLD may always recognize TBTT offsets of other APs within the MLD, the neighbor AP TBTT offset subfield corresponding to another AP (of the same MLD) should not be indicated (configured) as 255 when being indicated (configured) through an RNR element.

Specifically, the neighbor AP information field included in the RNR element of the beacon frame may include a neighbor AP TBTT offset subfield indicating an offset between times in which the beacon frame is transmitted. In this case, the neighbor AP TBTT offset subfield indicates an offset value between a time point at which the beacon frame is transmitted and a time point at which a next beacon frame is transmitted by an AP corresponding to a neighbor AP TBTT offset subfield among multiple APs included in the AP MLD (NSTR or STR AP MLD). In this case, the neighbor AP TBTT offset subfield cannot be configured as a specific value according to a specific condition.

For example, when being included in the same AP MLD as the AP having transmitted the beacon frame, the neighbor AP TBTT offset subfield cannot be configured as a specific value (for example, “255”). In this case, the size of the neighbor AP TBTT offset subfield may be 8 bits, and in this case, the neighbor AP TBTT offset subfield cannot be configured as the largest value which can be indicated by the neighbor AP TBTT offset subfield (in a case of 8 bits, the subfield corresponds to each of values from 0 to 255, and thus a maximum value of the offset which can be indicated by 8 bits may be 255). However, when not being included in the same AP MLD as the AP having transmitted the beacon frame (for example, when the AP is a legacy AP), the neighbor AP TBTT offset subfield may be configured as a specific value (for example, “255”).

In a similar embodiment, a value configured for the neighbor AP TBTT offset subfield may be differently interpreted according to a specific condition.

For example, when the neighbor AP TBTT offset subfield is configured with a specific value (for example, when the subfield is configured with “254”), the configured value may be differently interpreted as “254” or “254” or greater according to a specific condition.

Specifically, when an AP corresponding to a neighbor AP information field including the neighbor AP TBTT offset subfield is included in the same AP MLD as or a different MLD from the AP having transmitted the beacon frame and the neighbor AP TBTT offset subfield is configured with a specific value (for example, “254”), the station may interpret the value indicated by the neighbor AP TBTT offset as 254 TUs. However, when the AP is not included in the same AP MLD as or a different MLD from the AP having transmitted the beacon frame (for example, the AP is a legacy AP or is an AP not included in the MLD, etc.) and the neighbor AP TBTT offset subfield is configured with a specific value (for example, “254”), the station may interpret the value indicated by the neighbor AP TBTT offset subfield as 254 TUs or 254 TUs or greater.

In general, the reason why the conventional AP includes basic information of neighbor APs together with TBTT offset information and transmit the same through the beacon frame is to assist STAs having received the beacon frame in promptly acquiring basic information of other APs and more efficiently receiving the beacon frame of another AP by using the identified TBTT offset information.

However, the neighbor AP TBTT offset subfield included in the conventional beacon frame includes 1 octet, and is designed in the form in which only a TBTT offset corresponding to a maximum of 254 TUs can be indicated. In consideration of the maximum TBTT offset ((2\hat{ }16) or (2\hat{ }16)−1 TUs in consideration of a configurable beacon interval) that another AP can have, this may be a design of a neighbor AP TBTT offset subfield in the form in which the indicatable information and the overhead of the beacon frame are compromised through exclusion of support for information in a case having a TBTT offset of 254 TUs or more.

However, when the AP MLD indicates information on another AP in the MLD through the beacon frame, an additional MLD AP TBTT offset subfield may be included and transmitted to more accurately notify of the TBTT offset of another AP. When the AP MLD transmits the beacon frame, the MLD AP TBTT offset subfield may be included in the TBTT information field corresponding to another AP in the same MLD. In this case, when both the neighbor AP TBTT offset subfield and the MLD AP TBTT offset subfield are indicated in a specific TBTT information field, the neighbor AP TBTT offset may be indicated by a pre-configured value (254 or 255).

The MLD AP TBTT offset subfield corresponds to a 2-octet sized subfield, and may be utilized to indicate a TBTT offset value when the TBTT offset between an AP (reporting AP) having transmitted the beacon frame and another AP (reported AP) of the same MLD exceeds 254 TUs. More specifically, when the AP MLD transmits the beacon frame, a TBTT offset of another AP in the same MLD exceeds 254 TUs, and an accurate TBTT offset thus cannot be indicated through the existing neighbor AP TBTT offset subfield, the MLD AP TBTT offset subfield may be limitedly included in the TBTT information field.

When the STA MLD has identified the TBTT information field including the MLD AP TBTT offset subfield from the RNR element included in the beacon frame received from a specific AP, the STA MLD may identify the TBTT offset of the AP corresponding to the TBTT information field on the basis of a value indicated by the MLD AP TBTT offset subfield. In this case, to identify whether TBTT information fields included in the beacon frame are included in the MLD AP TBTT offset subfield, the STA may identify the same on the basis of a value of the TBTT information length subfield (in a TBTT information header (sub) field of each neighbor AP information field) corresponding to each TBTT information field. That is, when the STA recognizes that the MLD AP TBTT offset subfield is included in the TBTT information field, on the basis of a value of a TBTT information length subfield, the STA may identify the TBTT offset of the AP corresponding to the TBTT information field on the basis of a value indicated by the MLD AP TBTT offset subfield. In this case, when 0 or a pre-configure value (or a value equal to or less than 254) is indicated through the MLD AP TBTT offset subfield of a specific TBTT information field, the STA MLD may identify the TBTT offset of the AP corresponding to the specific TBTT information field on the basis of a value of the neighbor AP TBTT offset subfield.

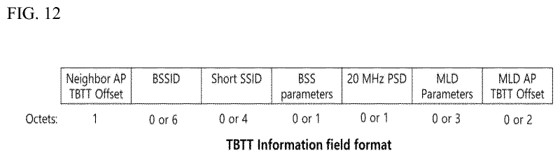

FIG. 12 illustrates another example of a TBTT information field format according to an embodiment of the present disclosure.

Referring to FIG. 12, a TBTT information field may include an MLD AP TBTT offset subfield. The MLD AP TBTT offset subfield may be only included in a beacon frame transmitted by an AP of an AP MLD. In addition, the MLD AP TBTT offset subfield may be included only in a TBTT information field corresponding to another AP of the same MLD as the AP which transmits the beacon frame.

For example, in a beacon frame transmitted by a specific AP of the AP MLD, to indicate that a TBTT offset of another AP of the same MLD is 300 TUs, the TBTT information field corresponding to another AP may be utilized as a format including the MLD AP TBTT offset subfield. In this case, a neighbor AP TBTT offset subfield of the TBTT information field corresponding to another AP may be indicated by 254 or 255, and the MLD AP TBTT offset subfield may be indicated by a value corresponding to 300 TUs (for example, 300, 299, or (300-254)). In this case, the above-described MLD AP TBTT offset subfield is a subfield name provided as an example, and a subfield having the same use may be defined as another name.

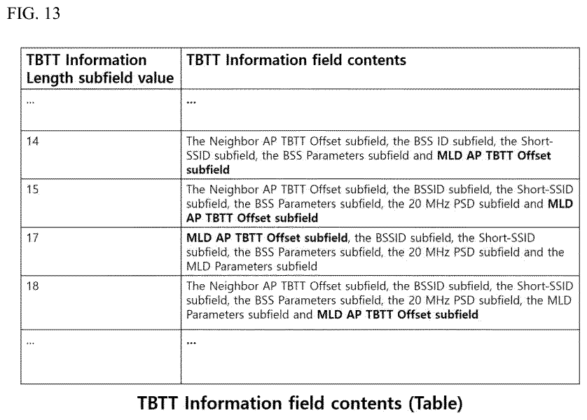

FIG. 13 illustrates an example of a TBTT information length subfield indicating a TBTT information field including an MLD AP TBTT offset subfield according to an embodiment of the present disclosure.

Referring to FIG. 13, according to a TBTT information length subfield, the types of contents included in a TBTT information field may be indicated. The TBTT information length subfield may be a subfield included in a TBTT information header field existing in neighbor AP information fields included in an RNR element. That is, multiple neighbor AP information fields may be included in the RNR element transmitted through a beacon frame, and the TBTT information field included in each neighbor AP information field has a structure including different amounts and types of contents. In this case, since the TBTT information field included in each neighbor AP information field may include different amounts and types of contents, information relating to the content (and format) indicated through each TBTT information field is indicated through the TBTT information header field.

That is, an STA may perform parsing of each neighbor AP information field in the RNR element of the beacon frame received through the AP, on the basis of information indicated by the TBTT information header field. In this case, each parsed neighbor AP information field may indicate information on a neighbor AP or another AP of the same MLD. In this case, when a value of the TBTT information length subfield included in the TBTT information header field means configuration of a content including an MLD AP TBTT offset subfield as illustrated in FIG. 13, the STA may identify a TBTT offset of the AP corresponding to the corresponding TBTT information field, on the basis of the value indicated by the MLD AP TBTT offset subfield.

### <Non-Primary Link Setup and Management>

As described above, an NSTR AP MLD cannot transmit a beacon frame, a probe response frame, and a multi-link (ML) probe response frame through a non-primary link. Accordingly, an STA MLD to be connected to the NSTR AP MLD needs to transmit a (ML) probe request frame through only a link in which the NSTR AP MLD has transmitted a beacon frame.

An ML probe request frame transmitted by an STA of an EHT non-AP STA MLD may include not only information included in a probe request frame transmitted by the conventional HE STA, but also EHT capability information and a multi-link element. In this case, the multi-link element included in the ML probe request frame may take a role of requesting, from an AP MLD, additional information for an AP of another link by an MLD transmitting the ML probe request frame.

For example, when the non-AP STA MLD transmits the ML probe request frame, the non-AP STA MLD may request, from an AP MLD, to additionally respond with complete information or partial information for the AP of another link through the multi-link element of the ML probe request frame. That is, the non-AP STA MLD may request, from the AP MLD, to transmit all or a part of a parameter related to the link of another AP included in the same AP MLD to the AP receiving the ML probe request frame.

For example, when all or a part of the parameter related to the AP connected through a non-primary link is updated, a station included in the non-AP STA MLD may request transmission of all or a part of the updated parameter related to another AP of the non-primary link to the AP connected through a primary link.

In this case, when the complete information is requested/transmitted as a response, it means that information having the same level as an AP (reporting AP) responding with the ML probe response frame is requested from/transmitted as a response to an AP (reported AP) of another link. In this case, when the partial information is requested/transmitted as a response, it means that the information of the AP of another link is transmitted as a response only to the information requested by the STA.

When additional information relating to the AP of another link is requested in the ML probe request frame received through a specific link, the AP MLD transmitting the beacon frame may respond with, through the ML probe response frame, not only information on the AP of the specific link but also the requested additional information relating to the AP of another link.

In this case, when the STA MLD has requested complete information on the AP of another link while transmitting the ML probe request frame in a specific link, the AP MLD may need to provide, through an ML probe response frame transmitted as a response in the specific link, information on the AP of another link at the same level as that of the information on the AP of the specific link. In other words, the STA MLD having received the complete information of the AP of another link through a specific link may acquire, with respect to the AP of another link, information at the same level as that when an ML probe response is directly received from the AP of another link.

In this case, when the STA MLD has requested partial information on the AP of another link while transmitting the ML probe request frame in a specific link, the AP MLD may provide, through an ML probe response frame transmitted as a response in the specific link, only requested information (information of a requested element) among the information of the AP of another link. In other words, the STA MLD having received the partial information of the AP of another link through a specific link may additionally acquire only information requested with respect the AP of another link by the STA MLD itself. In this case, the STA MLD requesting the partial information of the AP of another link may transmit the ML probe request frame by including information (which may be indicated by a requested element IDs field) indicating information to be additionally acquired, together with a link ID corresponding to another link. Accordingly, when the ML probe request frame received through a specific link includes information (request element IDs field) indicating information on another link, the AP MLD may additionally indicate, through the ML probe response frame, information indicated with respect to another link.

In this case, when transmitting an ML probe request frame through a specific link, the STA MLD may configure, as 0 or 1, a complete profile subfield (of a per-STA control field included in a multi-link element) corresponding to another link to indicate whether complete information or partial information for another link is requested.

In this case, additional information (complete and partial) of another AP may be transmitted through a per-STA profile included in a multi-link element of an ML probe response frame. The per-STA profile is a field included in the multi-link element with 0 or more than 0, and may include information of another STA (a non-AP STA of an AP) existing in the same MLD as an STA (a non-AP STA of an AP) transmitting a frame including the multi-link element. In this case, the per-STA profile may include a complete profile subfield, and complete information (information having the same level as the STA (the AP and the non-AP) transmitting the frame including the multi-link element) of another STA (the AP and the non-AP STA) corresponding to the per-STA profile having the complete profile subfield indicated as 1 may be acquired through the corresponding per-STA profile. However, parameters/elements meaning the same information as the STA (the AP and the non-AP) having transmitted the corresponding per-STA profile may be omitted by an inheritance rule. The inheritance rule may mean succession and utilization of values of the already indicated same parameter and element (indicated for another STA (the AP and the non-AP)) in a case where the same parameter and element are not indicated to prevent repeated indication of the corresponding parameter and element. That is, when a value of parameter 1 is indicated for STA 1 and a value of parameter 1 is not indicated for STA 2, it may be interpreted, through the inheritance rule, that the value of parameter 1 for STA 2 is indicated to be identical to the value of parameter 1 for STA 1.

In this case, a per-STA profile subelement included in a multi-link element transmitted by an NSTR AP MLD may not include a beacon interval subfield for indicating an interval at which a beacon is transmitted. That is, when indicating the per-STA profile subelement corresponding to an AP of a non-primary link in the multi-link element, the NSTR AP MLD may need to configure a beacon interval present subfield as 0. This may be because a period of a beacon frame does not separately exist since an AP operated in the non-primary link of the NSTR AP MLD transmits no beacon frame. That is, the per-STA profile subfield (of the probe response and association response frame) corresponding to the non-primary link AP of the NSTR AP MLD may have a beacon interval present subfield indicated as 0 even though a complete profile subfield (of the per-STA control field) is indicated as 1. That is, beacon interval information of the AP of the non-primary link does not exist even when the complete information is indicated.

Similarly, DTIM information (DTIM count and DTIM period information) of the AP of the non-primary link may not exist even when the complete information is indicated. That is, the per-STA profile corresponding to the non-primary link AP of the NSTR AP MLD may have a DTIM info present subfield indicated 0 even though the complete profile subfield (of the per-STA control field) is indicated as 1.

That is, a beacon is not transmitted through a non-primary link, and thus even when the non-AP STA MLD requests all information (or all updated information) of another AP of the non-primary link through the AP of the primary link (that is, when the complete information is configured as “1”), the beacon interval and DTIM information of the AP of the non-primary link may not exist in the ML probe response frame. That is, the beacon interval and DTIM information may not be included in the per-STA profile subelement of the AP of the non-primary link included in the ML probe response frame.

In this case, even though all information (or all updated information) of another AP of the non-primary link is requested, the AP MLD may not include, in the ML probe response frame, the beacon interval and DTIM information of the AP of the non-primary link. Accordingly, in this case, the AP MLD may transmit the beacon interval present subfield and DTIM info present subfield by configuring a value (for example, “0”) indicating that the respective fields are not included.

In a case of the NSTR AP MLD, the beacon frame is not transmitted in the non-primary link, and thus when information on the AP of the non-primary link is indicated, the DTIM information and the beacon interval information may not be indicated. That is, the NSTR AP MLD may need to always indicate, as 0, the DTIM info present subfield of the per-STA profile (more precisely, an STA control field) corresponding to the AP of the non-primary link. That is, the NSTR AP MLD may need to always indicate, as 0, the beacon interval present subfield in the per-STA profile corresponding to the AP of the non-primary link. Accordingly, even when the NSTR AP MLD receives an ML probe request frame for requesting complete information, or receives a (ML) (re) association request frame from the non-AP STA MLD, the NSTR AP MLD may need to always indicate, as 0, the beacon interval present subfield and the DTIM info present subfield of the per-STA profile corresponding to the AP of the non-primary link.

Alternatively, no beacon frame is transmitted in the non-primary link, and thus the NSTR AP MLD may need to configure beacon interval, DTIM count, and DTIM interval subfields as a pre-promised value in the per-STA profile corresponding to the AP of the non-primary link. This may be an operation considered to maintain the same per-STA profile configuration as a general AP MLD (for example, STA AP MLD) when the NSTR AP MLD transmits (responds with) complete information of the AP of the non-primary link. That is, the STA MLD may request complete information of a specific link by using an ML probe request frame, etc. from the AP MLD, and then expect that complete information is to be received as a response to the AP of the specific link in a responding response frame. In this case, when complete information transmitted by the NSTR AP MLD as a response and complete information transmitted as a response have different per-STA profile configures from each other, implementation complexity of a process of acquiring information through the per-STA profile by the STA MLD may be increased. Accordingly, even though the AP of the non-primary link transmits no beacon frame, the NSTR AP MLD may use, when responding with complete information of the non-primary link, a per-STA profile having the same configuration as a per-STA profile used when a general AP MLD responds with complete information. In this case, the per-STA profile corresponding to the non-primary link AP of the NSTR AP MLD may have a beacon interval subfield, a DTIM count subfield, and a DTIM interval subfield, each of which is configured with a pre-configured value. For example, when transmitting complete information of the AP of the non-primary link, the NSTR AP MLD may configure all of the respective bits of the beacon interval subfield of the non-primary link as 0 or 1, or according to a pre-promised scheme. For example, when transmitting complete information of the AP of the non-primary link, the NSTR AP MLD may configure all of the respective bits of the DTIM count subfield of the non-primary link as 0 or 1, or according to a pre-promised scheme. For example, when transmitting complete information of the AP of the non-primary link, the NSTR AP MLD may configure all of the respective bits of the DTIM interval subfield of the non-primary link as 0 or 1, or according to a pre-promised scheme.

Alternatively, no beacon frame is transmitted in the non-primary link, and thus the NSTR AP MLD may configure beacon interval, DTIM count, and DTIM interval subfields with a value related to a beacon frame of the primary link in the per-STA profile corresponding to the AP of the non-primary link. This may be an operation considered to maintain the same per-STA profile configuration as described above. In this case, the per-STA profile corresponding to the non-primary link AP of the NSTR AP MLD may have a beacon interval subfield, a DTIM count subfield, and a DTIM interval subfield, each of which is configured with a value related to a beacon frame transmitted in the primary link. For example, when transmitting complete information of the AP of the non-primary link, the NSTR AP MLD may configure the beacon interval subfield of the non-primary link as a value indicating (meaning) a beacon interval of the primary link. For example, when transmitting complete information of the AP of the non-primary link, the NSTR AP MLD may configure the DTIM count subfield of the non-primary link as a DTIM count value of the primary link. For example, when transmitting complete information of the AP of the non-primary link, the NSTR AP MLD may configure the DTIM interval subfield of the non-primary link as a value indicating (meaning) a DTIM interval of the primary link.

Alternatively, no beacon frame is transmitted in the non-primary link, and thus the NSTR AP MLD may configure beacon interval, DTIM count, and DTIM interval subfields in the per-STA profile corresponding to the AP of the non-primary link with a value having a special purpose. To describe in more detail, the beacon interval subfield of the non-primary link may be configured with a value (a virtual beacon internal) having a special purpose by the AP MLD, for example, a value of calculation. The beacon interval of the conventional Wi-Fi literally means a value related to a time interval in which a beacon frame is transmitted, but is utilized as time units for various BSS operations. For example, a unit such as JointFailureTimeout and QueryFailureTimeout primitive is defined as a beacon interval, and a listen interval field, a PRAW start offset subfield, an AID request interval field, an AID switch count field, an AID response interval field, a minimum transmission interval subfield, a channel quality measurement duration, a color switch countdown subfield (of a BSS color change announcement element), etc. indicate an interval/duration by utilizing a beacon interval (or TBTT) as a basic unit. As such, the beacon interval has a meaning of a value related to an interval in which a beacon frame is actually transmitted, but is a value utilized as a unit of various primitives and fields, and thus even though a beacon frame is not actually transmitted in the non-primary link, a beacon interval for the non-primary link may need to be defined (indicated or configured) for the use of being utilized as units of the above-described primitives/subfields.

That is, even though no beacon frame is transmitted in the non-primary link, the NSTR AP MLD may indicate the beacon interval subfield of the per-STA profile corresponding to the AP of the non-primary link as a beacon interval value for utilizing a time unit of the non-primary link. In this case, the non-AP MLDs may recognize (identify or calculate) a duration and an interval of the above-described primitives and fields (for utilizing the beacon interval as a time unit) on the basis of a value indicated by the beacon interval subfield of the per-STA profile corresponding to the AP of the non-primary link. In this case, the DTIM interval subfield and the DTIM count subfield of the per-STA profile corresponding to the AP of the non-primary link may be also configured according to the operating purpose of the BSS of the AP MLD, and the non-AP MLD operated by the STA in the non-primary link may need to operate on the basis of the configured value when operating the STA of the non-primary link.

The above-described method for configuring a subfield (a beacon interval, a DTIM count, a DTIM interval, etc.) related to the beacon of the non-primary link of the NSTR AP MLD may be also applied the same to not only the per-STA profile transmitted in the primary link but also other frames and subfields (transmitted in the primary link or the non-primary link) including information related to the beacon of the non-primary link.

In addition, the non-AP STA MLD to be associated with the NSTR AP MLD may need to utilize a unit of a listen interval field transmitted when requesting setup of for the primary link and the non-primary link, as a beacon interval of the primary link of the NSTR AP MLD. That is, the non-AP STA MLD transmitting the listen interval field to the NSTR AP MLD may need to calculate and configure the unit of the listen interval field as the beacon interval of the AP operating in the primary link of the NSTR AP MLD. In this case, the listen interval field may be a field indicating information related to a period (time) in which at least one STA switches to a wake state so that the non-AP STA MLD for performing multi-link (re) association receives the beacon frame. In this case, the listen interval field may indicate a value derived when a ListenInterval parameter is indicated in the MLME primitive.

In this case, when transmitting a listen interval field to an AP MLD (for example, an STR AP MLD) other than the NSTR AP NLD, the non-AP STA MLD may need to configure a unit of the listen interval field by using the largest value among beacon intervals of the links (of the AP) for which the non-AP STA MLD itself is to perform setup. For example, when the non-AP STA MLD is to perform multi-link setup of Link 1 or Link 2 with the AP MLD, the non-AP STA MLD may use, as a unit of a listen interval field included in the ML association request frame, a large value a beacon interval of Link 1 (of the AP) and a beacon interval of Link 2. That is, when the beacon interval of Link 1 is 100 ms and the beacon interval of Link 2 is 50 ms, the listen interval subfield unit transmitted by the non-AP STA MLD may be 100 ms.

In general, when the AP and the STA have completed the setup, the STA may receive a beacon frame transmitted by the AP and identify and track (update) a change in the operation parameter and element of the AP. In addition, the beacon frame also performs a role of providing information for adjusting time syncs of STAs within the BSS by including a timestamp field.

However, in a case of the NSTR AP MLD, as described above, no beacon frame is transmitted in the non-primary link, and thus the STA MLD having performed the setup with the NSTR AP MLD may need to perform a separate operation to perform parameter/element tracking (updating) and time sync maintenance for the non-primary link.

According to an embodiment of the present disclosure, a non-AP STA MLD having associated with an NSTR AP MLD may receive a beacon frame in a primary link, and then may identify a change sequence (in an MLD parameter field of an RNR element) of a non-primary link and transmit an ML probe request. In this case, the ML probe request frame transmitted by the non-AP STA MLD may be transmitted for the purpose of requesting changed parameter and element information of the non-primary link. In this case, the ML probe request frame may correspond to requesting complete information of the non-primary link while configuring a complete profile of a per-STA profile corresponding to the non-primary link (and the AP of the non-primary link) as 1 and transmitting the same. Alternatively, the ML probe request frame transmitted for the purpose of updating a parameter/element of the non-primary link by the STA MLD may correspond to a request for updated information rather than complete/partial information for the non-primary link.

In other words, even when multiple links are established between the non-AP STA MLD and the AP MLD, a frame for performing an association, re-association, or a parameter updating procedure may be performed only through the primary link. For example, when an STA has recognized that a parameter for the AP of the non-primary is updated, through a specific field (for example, a change sequence or a BSS parameter change count subfield (BSS parameter change count subfield, etc.)) indicating whether a parameter for another AP included in neighbor AP information included in the beacon frame is updated, the non-AP STA MLD may request transmission of the updated parameter through the primary link rather than the non-primary link of another AP. That is, the non-AP MLD cannot transmit a frame (for example, a probe request frame, etc.) for requesting an updated parameter through the non-primary link.

For example, after performing setup with the NSTR AP MLD, the non-AP STA MLD for requesting information for updating the parameter/element of the non-primary link may request an updated parameter/element for the AP of the non-primary link by configuring an updated profile subfield of the per-STA profile corresponding to the non-primary link as 1 in an ML probe request frame transmitted through the primary link. The NSTR AP MLD may respond with an ML probe response frame including changed information (parameter and element) of the non-primary link when the updated profile subfield is indicated as 1 in the per-STA profile (corresponding to the non-primary link) of the received ML probe request frame.

In this case, the per-STA profile field of the ML probe request frame transmitted by the non-AP STA MLD may include an updated profile subfield and a recorded change sequence subfield. The recorded change sequence subfield may indicate an up-to-date change sequence value maintained for the non-primary link by the non-AP STA MLD, and the AP MLD may identify/determine the type of updated information on the basis of a value indicated through the recorded change sequence subfield.

For example, the NSTR AP MLD may have changed parameter 1 by increasing a change sequence number of the non-primary link from 100 to 101, and have changed parameter 2 by increasing the change sequence number again from 101 to 102. In this case, the STA MLD may request updated information of the non-primary link while transmitting the ML probe request frame. In this case, when the non-AP STA MLD indicates the recorded change sequence subfield as 100, the NSTR AP MLD may respond with an ML probe response frame including both parameter 1 and parameter 2, and when the non-AP STA MLD indicates the recorded change sequence subfield as 101, the NSTR AP MLD may respond with an ML probe response frame including parameter 2 only.

In this case, the non-AP STA MLD may indicate the complete profile subfield as 0 without utilizing a separate updated profile subfield to request the updated profile. That is, a method for requesting an updated profile by a non-AP STA

MLD may be configuring a complete profile subfield as 0, and in this case, a separate updated profile subfield may not be included in a per-STA profile.

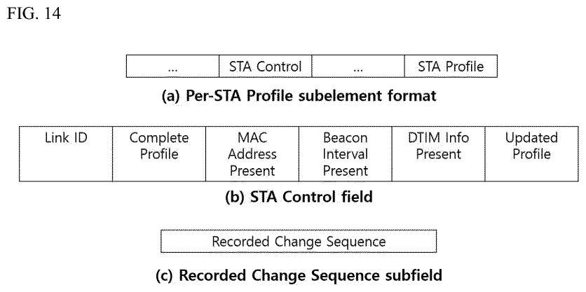

FIG. 14 illustrates an example of a per-STA profile subelement format according to an embodiment of the present disclosure.

Referring to FIG. 14(a), a per-STA profile subelement may include an STA control field. The STA control field (see FIG. 14(b)) indicates information for indicating the type of a field included in an STA profile (see FIG. 14(a)) of the corresponding per-STA profile subelement. In this case, when a complete profile subfield of an STA control field of a specific per-STA profile subelement transmitted by an AP MLD other than an NSTR AP MLD is indicated as 1, all of a MAC address present subfield, a beacon interval present subfield, and a DTIM information present subfield may need to be indicated as 1. However, as described above, the NSTR AP MLD does not transmit a beacon frame in a non-primary link, and thus information related to the beacon frame of the non-primary link may not be indicated in the per-STA profile subelement corresponding to the non-primary link. That is, even though a complete profile subfield of a specific per-STA profile subelement (corresponding to an AP of the non-primary link) transmitted by the NSTR AP MLD is indicated as 1, a beacon interval present subfield and a DTIM information present subfield may be indicated as 0.

In addition, as described in an embodiment above, a non-AP STA MLD for transmitting an ML probe request frame to an NSTR AP MLD may indicate an updated profile subfield of an STA control field (included in a per-STA profile subelement corresponding to an AP of a non-primary link) as 1 to request changed information (updated information) of the non-primary link AP from the AP of the primary link. In this case, the non-AP STA MLD may indicate, using a recorded change sequence subfield (see FIG. 14(c)), a recorded change sequence value corresponding to information related to a time point at which the non-AP STA MLD itself updates the information of the non-primary link AP. In this case, the recorded change sequence subfield may be a subfield included in an STA profile. The NSTR AP MLD may receive the ML probe request frame of the non-AP STA MLD, received through the primary link, and then compare a value of the recorded change sequence subfield included in the ML probe request frame with a change sequence value of a current non-primary link AP, thereby determining non-primary link AP information to be sent as a response to the non-AP STA MLD.

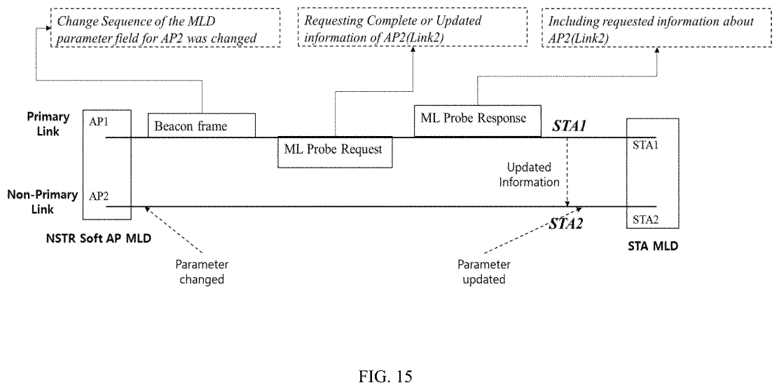

FIG. 15 illustrates an example of a process of updating information of a non-primary link by a non-AP MLD having performed setup with a non-simultaneous transmission and reception (NSTR) soft AP MLD according to an embodiment of the present disclosure.

Referring to FIG. 15, an NSTR AP MLD may change a parameter of AP 2 operating in Link 2 corresponding to a non-primary link, and then indicate that the change of the parameter of AP 2 through a beacon frame transmitted by AP 1 operating in Link 1 corresponding to a primary link. In this case, the information on the change of the parameter of AP 2 may be indicated through an increase, by 1 compared to a value indicated by an immediately preceding beacon frame, in a change sequence subfield value corresponding to AP 2 in an RNR element included in a beacon frame transmitted by AP 1.

After receiving, through STA 1, the beacon frame transmitted by AP 1, the non-AP STA MLD may recognize the fact that the parameter of AP 2 has been updated. To acquire changed parameter information of AP 2, the non-AP STA MLD may transmit an ML probe request frame through STA 1.

The ML probe request frame transmitted through STA 1 by the non-AP STA MLD may include, in an ML element, a per-STA profile subelement corresponding to AP 2, and the per-STA profile subelement may include an indicator for indicating whether a complete profile is requested or an updated profile is requested.

After receiving the ML probe request frame from STA 1 through the primary link, the NSTR AP MLD may respond to STA 1 by including the requested AP 2 information (complete or updated information) in an ML probe response frame.

The non-AP STA MLD having received the AP 2 information requested by the non-AP STA MLD itself from the NSTR AP MLD through the ML probe response frame may update the parameter for AP 2 to complete parameter updating for the non-primary link in which the beacon frame is not transmitted.

### <Broadcast ML Probe Response>

According to an embodiment of the present disclosure, an NSTR AP MLD may transmit a broadcast ML probe response frame through a primary link when information related to an AP operated in a non-primary link is changed. After receiving the broadcast ML probe response frame transmitted by the NSTR AP MLD through the primary link, the non-AP STA MLD may need to update information on the non-primary link (of an AP). In this case, the broadcast ML probe response frame may be an ML probe request frame transmitted by the NSTR AP MLD without a separate request, rather than transmitted as a response to an ML probe request frame transmitted by a specific STA.

The broadcast ML probe response frame takes a role of assisting non-AP STA MLDs in updating changed parameters and elements of the non-primary link, including the per-STA profile subelement corresponding to the AP of the non-primary link. In this case, (recorded) change sequences of the non-primary link maintained by the respective non-AP STAs may be different from each other, and thus the broadcast ML probe response frame may include complete information for the AP of the non-primary link. In this case, the broadcast ML probe response frame may be transmitted together with a DTIM beacon frame.

Accordingly, when a change sequence number corresponding to the AP of the non-primary link is different from the (recorded) change sequence maintained by the non-AP STA MLDs themselves, the non-AP STA MLDs may need to receive the next DTIM frame through the beacon frame and the broadcast ML probe response frame.

In this case, a procedure of updating the parameter of the non-primary link using the above-described broadcast ML probe response frame may need to be performed using a broadcast ML association response frame. In this case, a detailed description of a method for setting up a per-STA profile subelement of the broadcast ML association response frame and a procedure of updating a reception STA MLD is omitted since the description is identical to that of the above-described embodiment of the broadcast ML probe response frame.

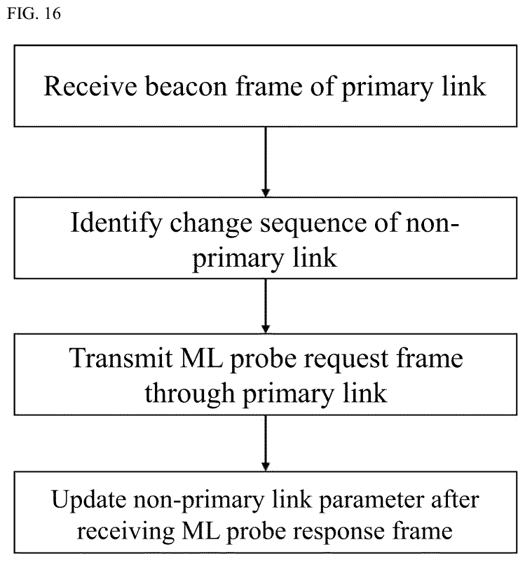

FIG. 16 is a flow chart illustrating an example of a procedure of updating a parameter of a non-primary link by a non-AP STA MLD associated with an NSTR AP MLD according to an embodiment of the present disclosure.

A non-AP STA MLD receives a beacon frame identifies a change sequence (in an MLD parameter field of an RNR element) of a non-primary link after receiving a beacon frame in a primary link. If the identified change sequence value of the non-primary link is different from a (recorded) change sequence value maintained by the non-AP STA MLD itself, the non-AP STA MLD may transmit an ML probe request frame through the primary link. In this case, the ML probe request frame may include a subfield indicating whether complete information or updated information for the non-primary link AP is requested. In addition, the ML probe request frame requesting updated information may be configured to also include a subfield indicating a (recorded) change sequence value maintained by the non-AP STA MLD itself. Thereafter, the non-AP STA MLD having received an ML probe response frame from the AP MLD performs parameter updating on the basis of information on the non-primary link AP, included in the ML probe response frame received as a response.

### <Time Sync Management of Non-Primary Link>

As described above, a beacon frame transmitted by an AP takes a role of transferring information on various types of parameters and elements, and assisting STAs in the BSS in adjusting time syncs. A TimeStamp field included in the beacon frame may indicate a timing synchronization function (TSF) timer value at a time point at which a data symbol including a first bit of the TimeStamp field is shown on a transmission antenna connector, and an STA having received the TimeStamp field may synchronize its own TSF timer with the AP on the basis of the received TimeStamp field value.

As such, the AP and the STA may operate while maintaining the time sync on the basis of the TimeStamp value included in the beacon frame, and may perform a timing-based operation. However, the NSTR AP MLD cannot transmit the beacon frame through a non-primary link, and accordingly, an STA associated with a non-primary link AP of the NSTR AP MLD among STAs of the non-AP STA MLD needs to use a method other than the beacon frame in order to maintain the time sync with the AP.

To maintain the time sync with the non-primary link AP of the NSTR AP MLD, the associated non-AP STA may need to you TimeStamp of a TIM frame transmitted by the AP. The TIM frame includes a TimeStamp field having the same function as the beacon frame, and thus an STA having received the TIM frame from the non-primary link of the NSTR AP MLD may need to manage a TFS timer by using the TimeStamp field included in the TIM frame. However, in a case of the NSTR AP MLD, initiating transmission in the non-primary link without occupying the primary link may be restricted, and thus when the beacon frame is transmitted in the primary link, the TIM frame may need to be simultaneously transmitted in the non-primary link. That is, the non-AP STA MLD associated with the NSTR AP MLD may need to prepare to receive the TIM frame in the non-primary link in accordance with a TBTT of the primary link.

In another embodiment of the present disclosure, when the AP MLD corresponds to an NSTR AP MLD not supporting simultaneous transmission or reception, the same TSF time may be used in the respective links for multiple APs included in the NSTR AP MLD, and the TSF timer used in this case may be a TSF timer of the primary link. That is, when the AP MLD is the NSTR AP MLD, links (non-primary links) for the APs affiliated with the NSTR AP MLD may use the TSF timer of the primary link.

That is, the non-AP STA MLD associated with the NSTR soft AP MLD may need to use the TSF timer of the primary link in common with the non-primary link. In other words, the non-AP STA MLD associated with the NSTR AP MLD may use the TSF timer managed using the primary link, without having a separate TSF time for the non-primary liked (based on the NSTR soft AP MLD). That is, in an aspect of the present disclosure, the NSTR AP MLD and the non-AP STA MLD associated with the NSTR AP MLD may use an MLD level (MLD unit, MLD common) timer. In this case, for a stable operation of the NSTR AP MLD and the non-AP STA MLD associated with the NSTR AP MLD, it may be required to maintain that time synchronization between the respective APs of the NSTR AP MLD and/or the respective STAs of the non-AP STA MLD associated with the NSTR AP has an error equal to or less than a pre-promised value. For example, it may be required for the NSTR AP MLD to maintain that a TimeStamp difference (or a difference between timers) maintained between the AP of the primary link and the AP of the non-primary link is equal to or less than a pre-promised/configured value. For example, it may be required for the NSTR soft AP MLD to maintain that a TimeStamp difference maintained between the AP of the primary link and the AP of the non-primary link is equal to or less than a pre-promised/configured value.

In other words, the TSF timer of the primary link may be maintained (or applied or used) the same in links for all of the APs affiliated with or included in the NSTR AP MLD. In addition, a difference between TSF timers or timestamps or two APs among APs affiliated with or included in the NSTR AP MLD may be restricted to be within a specific value (for example, 30 us).

That is, TSF timers of all of the APs affiliated with or included in the NSTR AP MLD may be identical, and a clock drift or a difference between TSF timers or timestamps between two APs (for example, the AP of the primary link and the AP of the non-primary link) affiliated with or included in the AP MLD or the NSTR AP MLD may be restricted to be within a specific value (for example, ±30 us), and in this case, the AP MLD or the NSTR AP MLD may amend the TSF timer or the timestamp so that the clock drift or the difference between the TSF timers is within the specific value.

In addition, when receiving the TIM frame through the non-primary link, the non-AP STA MLD associated with the NSTR AP MLD may need to receive a next beacon frame transmitted in the primary link. More specifically, when the non-AP STA MLD has received the TIM frame through the STA of the non-primary link and a value indicated by a check beacon field in a TIM frame action field is different from a check beacon value maintained by the non-AP STA MLD itself, the non-AP STA MLD may need to receive a next beacon frame transmitted in the primary link. In this case, the next beacon frame may mean a beacon frame transmitted to correspond to a TBTT of the primary link existing after a time point of receiving a TIM frame in the non-primary link. In this case, when the next beacon frame is received, it may mean that updating a parameter of the non-primary link through a per-STA profile (corresponding to the AP of the non-primary link) included in the beacon frame is accompanied (included). In this case, a parameter to be updated may be restricted to a parameter related to critical update.

### <Channel Switching and Channel Quieting Procedures of Non-Primary Link>

As described above, the NSTR AP MLD transmits no beacon frame in the non-primary link, and accordingly, a BSS operation performed on the basis of a transmission timing of the beacon frame may be performed in a difference manner from that of a BSS operation of a general AP MLD.

In the conventional Wi-Fi, a BSS operation channel frequency (operation frequency band) may be changed according to a procedure pre-promised between the AP and the STA. In this case, the conventional extended channel switching (ECS) operation may be utilized, and a channel switching mechanism newly defined in 11be may also be utilized. When the AP determines to change the BSS operation channel, the AP may transmit a beacon frame, a probe response fame, an extended channel switch announcement frame, etc., and notify of the same so that associated STAs can switch to a new channel or operating class while maintaining the association. In this case, the AP transmits the extended channel switch announcement element through the beacon frame, and a channel switch count field of the corresponding element indicates information on the number of times that the beacon frame will be transmitted before the channel switching (operation channel switching) is performed. If the AP includes, in the beacon frame, a MAX channel switch time element together with the extended channel switch announcement element, the AP may need to transmit the first beacon frame within a switch time field (of the max channel switch time element) in a new channel. That is, the beacon frame transmitted in the new channel needs to be transmitted while having a time interval from the last beacon frame transmitted in the current channel, the time interval shorter than a time interval indicated through the switch time field.

With reference to the above-described channel switching operation of the conventional Wi-Fi BSS, the AP of the BSS may indicate, to the STA through the beacon frame transmitted in the current channel, information on a new channel, information on a time point at which channel switching is performed, and information related to a time point at which the beacon frame first transmitted in the new channel. The STA of the BSS may move to a new channel within a determined time interval (a time interval indicated by the AP) on the basis of the channel switching-related information included in the beacon frame transmitted by the AP, and may thus complete the channel switching while maintaining the association with the AP. As such, the channel switching procedure of the conventional Wi-Fi BSS may be performed in a scheme in which information (a channel switch mode, a new operating class, a new channel number, a channel switch count, etc.) required for channel switching is provided through the beacon frame transmitted by the AP, and accordingly, the non-primary link BSS of the NSTR AP MLD transmitting no beacon frame cannot perform channel switching using the conventional channel switching procedure.

In addition, when the conventional Wi-Fi configures a quiet interval, information on a time interval to which a quiet interval is applied is indicated through elements (a quiet element, a quiet channel element, etc.) included in the beacon frame transmitted by the AP of the BSS, and similar to the channel switching procedure, the non-primary link of the NSTR AP MLD transmitting no beacon frame cannot use the conventional quieting procedure for configuring the quiet interval.

According to an embodiment of the present disclosure, the NSTR AP MLD may indicate, through the beacon frame transmitted in the primary link, information required to switch an operating channel of the non-primary link (information required to perform channel switching) and/or information required to configure a quiet interval. That is, the non-AP STA MLDs associated with the NSTR AP MLD may operate on the basis of the information acquired through the beacon frame of the primary link to perform channel switching of the non-primary link. That is, the non-AP STA MLDs associated with the NSTR AP MLD may acquire information related to the quiet interval of the non-primary link through the beacon frame of the primary link.

More specifically, when performing channel switching of the non-primary link or configuring a quiet interval, the NSTR AP MLD may need to include, in the beacon frame (and the (ML) probe response frame) of the primary link, a per-STA profile for the AP of the non-primary link.

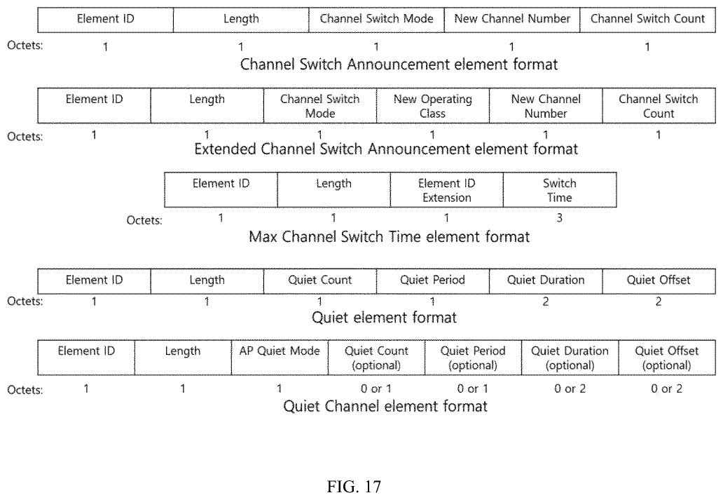

FIG. 17 illustrates an example of formats of elements according to an embodiment of the present disclosure. FIG. 17 illustrates an example of a format of each element described above.

Referring to FIG. 17, a per-STA profile for (corresponding to) an AP of a non-primary link may include a channel switch announcement element, an extended channel switch announcement element, a max channel switch time element, a quiet element, and a quiet channel element.

Timing fields of the elements may need to be configured with reference to a beacon interval and a target beacon transmission time (TBTT) of a primary link.

A primary link AP of an NSTR AP MLD may need to configure timing fields of the channel switch announcement element, the extended channel switch announcement element, the max channel switch time element, the quiet element, and the quiet channel element included in the per-STA profile (included in a beacon frame and a (ML) probe response frame) for the AP of the non-primary link with reference to the beacon interval and the TBTT of the primary link AP itself. In this case, the timing fields are utilized to collectively indicate time-related fields including duration-related fields (switch time field, quiet duration field, etc.) and time point-related fields (channel switch count field, quiet count field, etc.).

Accordingly, non-AP MLDs combined with the NSTR AP MLD may receive a beacon frame from the AP of the NSTR AP MLD operated in the primary link, and then acquire information related to a quiet interval and/or channel switching of the non-primary link from a per-STA profile included in the beacon frame, and may need to interpret the information related to the quiet interval and/or the information related to channel switching of the non-primary link with reference to the TBTT and the beacon interval (BI) of the primary link. In this case, the per-STA profile means a per-STA profile corresponding to the AP of the non-primary link.

The NSTR AP MLD may need to transmit a TIM frame (of the non-primary link) in a new channel within a time indicated through a switch time field (of a max channel switch time element) after completing channel switching (after completing announcement and channel switching) of the non-primary link through the beacon frame of the primary link. That is, the non-primary link AP of the NSTR AP MLD may need to transmit a TIM frame in a new channel after performing channel switching. In this case, the non-primary link AP may need to transmit the TIM frame in the new channel within the time indicated through the switch time field after the beacon frame having indicated the channel switch count subfield as 1 (or o) is transmitted in the primary link. In this case, the channel switch count field and the switch time field may be included in the per-STA profile (corresponding to the non-primary AP) included in the beacon frame transmitted in the primary link. In this case, the TIM frame may be substituted by another frame transmitted in the new channel of the primary link or the non-primary link. For example, the NSTR AP MLD may transmit a beacon frame indicating information related to completion of channel switching in the primary link after completing channel switching of the non-primary link. In this case, the beacon frame may be an additional beacon frame transmitted regardless of the TBTT. In this case, the beacon frame may be a beacon frame having a configuration including complete information for the non-primary link. For example, the beacon frame having a configuration including the complete information for the non-primary link may be a beacon frame having a complete information subfield of the per-STA profile corresponding to the AP of the non-primary link as 1. In this case, the beacon frame of the primary link transmitted after termination of channel switching of the non-primary link and the beacon frame transmitted before the channel switching starts may need to be transmitted within a pre-promised time. In this case, the pre-promised time may be a time indicated through a switch time field (of the max channel switch time element). Alternatively, the beacon frame may be a beacon frame including indication related to channel switching of the non-primary link. For example, the beacon frame of the primary link, transmitted after completion of the channel switching in the non-primary link may include a channel switch complete subfield. In this case, the channel switch complete subfield may be a subfield included in the ML element. A specific switch complete subfield may be a subfield indicated by 1 when channel switching of the AP corresponding to the per-STA profile including the specific subfield is completed. That is, the AP may need to configure the channel switch complete subfield of the per-STA profile (of the beacon frame) corresponding to the AP of the non-primary link as 1 after completing the channel switching in the non-primary link. In this case, the beacon frame related to the channel switching may be also transmitted (utilized) for the same purpose in a case where the AP MLD is not the NSTR AP MLD, that is, by a general AP MLD.

Only in a case where the non-AP MLD associated with the NSTR AP MLD performs channel switching of the non-primary link through the primary link and then receives a frame (a TIM frame or another frame of the non-primary link and/or a beacon frame indicating information related to channel switching completion of the primary link) promised from the AP MLD, the non-AP MLD may perform an operation in consideration that the channel switching of the non-primary link has been completed. If it is considered that the channel switching has not be completed, the non-AP STA MLD may need to consider that the channel switching of the non-primary link has been cancelled and operate (return to the previous channel) in the previous channel (a channel before channel switching is performed).

Alternatively, it may be restricted so that the NSTR AP MLD cannot configure the quiet interval in the non-primary link. In this case, when there is a quiet interval defined (configured) in the primary link, the quiet interval of the non-primary link may be defined (configured) as the same time interval as the quiet interval of the primary link. That is, when the non-AP STA MLD associated with the NSTR AP MLD has recognized the quiet interval of the primary link, the non-AP STA MLD may consider that the quiet interval is also configured in the non-primary link for the same time interval.

In addition, the NSTR AP MLD may not be able to perform channel switching of the non-primary link. However, when the NSTR AP MLD performs channel switching of the non-primary link, an operation such as releasing an AP of the non-primary link operated in the existing channel and adding a new non-primary link AP in a new channel may be performed.

A quiet element for the non-primary link, transmitted through the beacon frame of the primary link, may be configured (indicated) by the NSTR AP MLD as follows.

1. A quiet count field may be configured with the number of remaining TBTTs of a primary link until the next quiet interval starts in a non-primary link.

2. A quiet period field may be configured with a value (a beacon interval unit of a primary link) related to the number of primary link beacon intervals at which a regular (periodic) quiet interval of a non-primary link, defined through a corresponding quiet element, starts (configured as 0 in a case of non-regular quiet interval).

3. A quiet offset field may be configured with a time value (in units of TUs) related to an offset that a quiet interval of a non-primary link has from a TBTT of a primary link specified through a quiet count subfield before the quiet interval starts.

An (extended) channel switch announcement element and a max channel switch time element for the non-primary link transmitted through the beacon frame of the primary link may be configured (indicated) by the NSTR AP MLD as follows.

1. A channel switch count field of a channel switch announcement element may be configured with information related to the number of remaining TBTTs of a primary link before channel switching of a non-primary link starts. If channel switching of a non-primary link AP starts at a next TBTT of the primary link, a beacon frame transmitted at a current TBTT may have a channel switch count field (related to the non-primary link AP) configured as 1 or 0.

2. A switch time field of a max channel switch time element may be configured with a value for a maximum time difference between a primary beacon frame (a beacon frame having the channel switch count field configured 1 or 0 in number 1 above) transmitted at a TBTT immediately before a TBTT at which channel switching of a non-primary link starts and a TIM frame transmitted in a new channel of the non-primary link after the channel switching of the non-primary link is completed. For example, when a beacon interval of the primary link is 100 ms and the switch time field (for the non-primary link AP) is configured as 200 ms, an AP of the non-primary link may need to transmit a TIM frame in a new channel within 200 ms after a beacon frame transmission time point of the primary link in which the AP of the non-primary link itself has started channel switching.

Accordingly, after receiving the beacon frame through the primary link, the non-AP MLD associated with the NSTR AP MLD may acquire information relating to the quiet interval and channel switch time point and interval of the non-primary link on the basis of TBTT and beacon interval information of the primary link and information indicated in the per-STA profile of the non-primary AP included in the beacon frame. In this case, the non-AP MLD may configure (recognize or interpret) a start time point of the quiet interval of the non-primary link on the basis of the TBTT of the primary link. In this case, the non-AP MLD may recognize/interpret a channel switch time point of the non-primary link on the basis of a reception time of the beacon frame received in the primary link.

When an AP performs channel switching, the conventional Wi-Fi non-AP STA may select whether to perform channel switching together to maintain association with the AP. However, when the NSTR AP MLD performs channel switching in the non-primary link, the non-AP STA MLD associated with the NSTR AP MLD may need to mandatorily perform channel switching of the non-primary link.

If the non-AP STA MLD having performed an ML setup (that is, an ML setup using primary and non-primary links) with the NSTR AP MLD determines not to perform channel switching of the non-primary link, the non-AP STA MLD may need to terminate (release or change) the ML setup with the NSTR AP MLD, and switch to a state in which a setup is performed only through the primary link (through a setup after releasing or a re-setup).

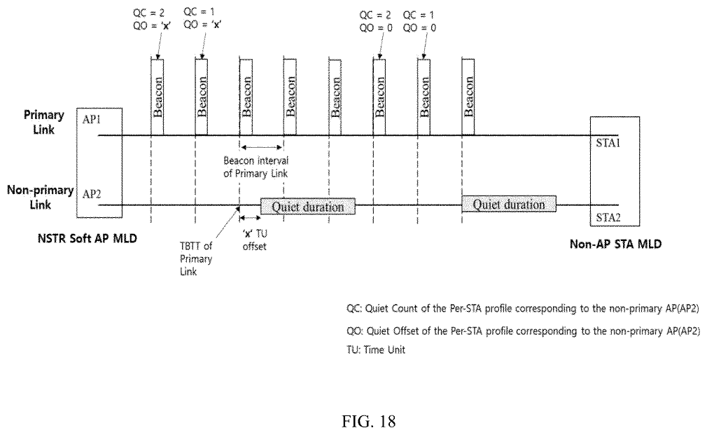

FIG. 18 illustrates an example of a process of configuring (defining) a quiet interval in a non-primary link by an NSTR soft AP MLD according to an embodiment of the present disclosure.

Referring to FIG. 18, the NSTR AP MLD operates AP 1 and AP 2 in a primary link and a non-primary link, respectively, and is combined with each of STA 1 and STA 2 of a non-AP STA MLD.

The NSTR AP MLD may include a per-STA profile corresponding to AP 2 in a beacon frame transmitted through AP 1 of the primary link and transmit the same in order to configure (define) a quiet interval (quiet interval #1 of FIG. 18) in the non-primary link. The per-STA profile corresponding to AP 2 includes a quiet element, and indicates information related to a time point at which the quiet interval (quiet interval #1 of FIG. 18) starts, through quiet count and quiet offset fields. When the quiet element is included in a first beacon frame (beacon #1 of FIG. 18) of the primary link illustrated in FIG. 18, a quiet count field is configured with a value indicating 2, a quiet offset field is configured with a value indicating “x” time units (TUs, 1024 us), and a quiet count field is configured with 1 in a second beacon frame (beacon #2 of FIG. 18).

The non-AP STA MLD having received the first and/or the second beacon frame through the primary link may identify the quiet element included in the per-STA profile (corresponding to AP 2) of the beacon frame, and may recognize that a quiet interval is configured (announced by the AP MLD) in the non-primary link and the quiet interval (quiet interval #1 of FIG. 18) starts from a time point after “x” TUs from a TBTT corresponding to a third beacon frame.

As illustrated in FIG. 18, the NSTR AP MLD may include the per-STA profile corresponding to AP 2 in the beacon frame transmitted through AP 1 of the primary link and transmit the same again in order to additionally configure (define) the next quiet interval (quiet interval #2 of FIG. 18) in the non-primary link. In a sixth beacon frame (beacon #6 of FIG. 18) of the primary link illustrated in FIG. 18, a quiet count field is configured with a value indicating 2, a quiet offset field is configured with a value indicating 0 time unit (TU, 1024 us), and in a seventh beacon frame (beacon #7 of FIG. 18), a quiet count field is configured with 1.

The non-AP STA MLD having received the sixth and/or seventh beacon frame through the primary link may identify the quiet element included in the per-STA profile (corresponding to AP 2) of the beacon frame, thereby recognizing that a quiet interval (quiet interval #2) is configured (announced by the AP MLD) in the non-primary link and the quiet interval (quiet interval #2) starts from a TBTT corresponding to an eighth beacon frame.

In this case, information on the lengths of the quiet intervals is indicated through a quiet duration field indicated together in the quiet element.

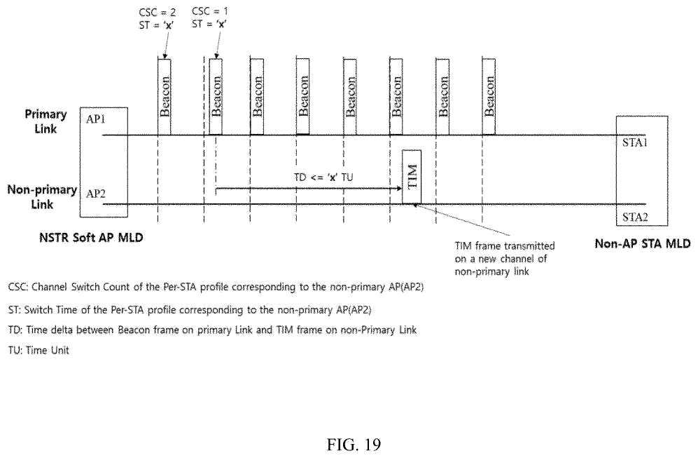

FIG. 19 illustrates an example of a method of performing non-primary channel switching by an NSTR soft AP MLD according to an embodiment of the present disclosure.

Referring to FIG. 19, an NSTR AP MLD may operate AP 1 and AP 2 in a primary link and a non-primary link, respectively, and may be associated with each of STA 1 and STA 2 of a non-AP STA MLD.

The NSTR AP MLD may include, in a beacon frame transmitted through AP 1 of a primary link, a per-STA profile corresponding to AP 2 (non-primary link), to change the non-primary link to a new channel, and transmit the same. The per-STA profile corresponding to AP 2 may include an (extended) channel switch announcement element and a max channel switch time element, and indicates information related to a time interval in which a TIM frame is transmitted in a new channel after channel switching and a time point at which channel switching starts. The (extended) channel switch announcement element is included in a first beacon frame (beacon #1 of FIG. 19) of a primary link illustrated in FIG. 19, a channel switch count field is configured with 2, and a second beacon frame (beacon #2 of FIG. 19) is configured with 1.

The non-AP STA MLD having received the first and/or the second beacon frame through the primary link may identify the (extended) channel switch announcement element included in the per-STA profile (corresponding to AP 2) of the beacon frame, and may recognize that channel switching (of a new channel) of the non-primary link starts after receiving the second beacon frame and the TIM frame of AP 2 is to be received in a new channel within “x” TUs at a time point at which the second beacon frame is received. In this case, the new channel may be a channel corresponding to a value indicated through a new channel number field included in the (extended) channel switch announcement element. In this case, the “x” TUs may be a time value indicated through a switch time field included in a max channel switch time element included in the per-STA profile (corresponding to AP 2).

<Restriction on Operation of Non-AP STA MLD Associated with NSTR AP MLD>

An NSTR AP MLD is an AP MLD corresponding to an NSTR link pair of a primary link and a non-primary link. Accordingly, an AP of the non-primary link may be in a BLIND state while PPDU transmission is performed through an AP of the primary link, and on the other hand, the AP of the primary link may be in a BLIND state when the AP of the non-primary link performs the transmission. In this case, the AP of the NSTR AP MLD, having experienced the BLIND state, may need to configure MediumSyncDelay with a pre-configured value.

MediumSyncDelay is a single timer commonly applied to EDCA functions (EDCAFs) of an STA, and when MediumSyncDelay is not 0, an additional constraint may be applied when the corresponding STA acquires a TXOP. In this case, the additional constraint may include that: (1) first transmission attempted to acquire the TXOP needs to be an RTS frame, (2) TXOP acquisition attempts are allowed only a pre-configured number of times while MediumSyncDelay is applied (until MediumSyncDelay is reduced to 0); and (3) a more strict (even lower: for example, −72 dBm to −62 dBm) CCA energy detection (ED) threshold value is utilized compared to a case where MediumSyncDelay is 0. That is, in terms of acquisition of a TXOP, more constraints are applied to an STA having MediumSyncDelay not corresponding to 0 than an STA having MediumSyncDelay corresponding to 0.

Accordingly, even in a case of the NSTR AP MLD, when the AP has experienced the BLIND state, MediumSyncDelay may need to be applied, and it may be difficult for STAs of a BSS to receive a normal service in a situation where channel access of the AP is restricted. The NSTR AP MLD may determine, as a primary link, one of links of the NSTR link pair for operation of the APs by the NSTR AP MLD itself, thereby managing transmission performed in the non-primary link (a link other than the primary link) in a scheme in which the primary link is not in the BLIND state. For example, the NSTR AP MLD may perform transmission in the non-primary link only when transmission is performed in the primary link, thereby managing the primary link not to be in the BLIND state. For such a purpose, even though receiving a frame for requesting a response frame through the AP of the non-primary link, the NSTR AP MLD may not respond with the request response frame. That is, even when receiving the frame for requesting the response frame through the AP of the non-primary link, the NSTR AP MLD may perform an operation of not responding with the response frame. In this case, the reason why the NSTRA AP MLD does not respond with the response frame through the AP of the non-primary link is to prevent the AP of the primary link from being in the BLIND state.

As described above, the NSTR AP MLD may configure the primary link, and may manage operation (transmission) of the AP operating in the primary link and/or the non-primary link so as to prevent the AP of the primary link from being in the BLIND state. Similarly, non-AP STA MLDs associated with the NSTR AP MLD may need to operate while understanding a primary link management method of the NSTR AP MLD. For example, when the non-AP STA MLD recognizes that the NSTR AP MLD does not respond with the response frame in the non-primary link, the non-AP STA MLD may not transmit a frame for requesting a response of the response frame in the non-primary link. In addition, when the non-AP STA MLD fails to receive a response of the response frame from the NSTR AP MLD after transmitting a frame for requesting the response frame in the non-primary link, the non-AP STA MLD may not retransmit the frame for requesting the response for the response frame. For example, when the non-AP STA MLD fails to receive a CTS frame response after transmitting an RTS frame to the NSTR AP MLD through the non-primary link, the non-AP STA MLD may not retransmit the RTS frame. In this case, the non-AP MLD may not attempt to perform transmission through the non-primary link to the NSTR AP MLD until receiving a trigger frame through the non-primary link.

In addition, even though the non-AP MLD has completed a channel access procedure of the non-primary link to perform UL transmission, the non-AP MLD may suspend transmission performed in the non-primary link until a channel access procedure in the primary link is completed. In this case, the method for suspending transmission performed in the non-primary link by the non-AP MLD may correspond to suspending a backoff procedure performed by an STA (more precisely, an EDCAF of the STA) of the non-primary link until a backoff procedure performed by an STA of the primary link is completed. In this case, the method for suspending the backoff procedure performed by the STA of the non-primary link by the non-AP MLD may correspond to maintaining a state in which a backoff counter is 0.

According to the above-described method, the non-AP STA MLD having completed the channel access procedures both in the primary link and the non-primary link may perform simultaneous transmission (simultaneous UL PPDU transmission) in the primary link and the non-primary link. In this case, the meaning of “simultaneous transmission” is that a time point at which each transmission starts is within a pre-configured time interval. However, when only the channel access procedure of the primary link is completed and the channel access procedure of the non-primary link has not completed yet, the non-AP MLD may start PPDU transmission only in the primary link, or may start simultaneous transmission once the channel access procedure of the non-primary link is completed. That is, when performing transmitting to the NSTR AP MLD, the non-AP MLD may perform transmission using the primary link only, or may perform simultaneous transmission using the primary link and the non-primary link. However, the non-AP MLD may not be allowed to perform PPDU transmission to the NSTR AP MLD using the non-primary link only.

In addition, when performing UL transmission to the NSTR AP MLD by utilizing both the primary link and the non-primary link, the non-AP MLD may need to match end time points of transmission performed in both links. In this case, matching the end time points of the transmissions may mean that the transmissions performed in both links end together within a pre-configured time interval.

In addition, when performing UL transmission by the NSTR AP MLD by utilizing both the primary link and the non-primary link, the non-AP MLD may need to make the same configuration for whether PPDUs transmitted in both links request response frames. To described in more detail, both of two UL PPDUs simultaneously transmitted by the non-AP MLD in the primary link and the non-primary link may need to request the response of the response frame, or both of the two UL PPDUs may need not to request the response of the response frame. This may be a restriction applied because when a response frame is transmitted as a response through in a specific link as a result of UL transmission performed utilizing both the primary link and the non-primary link by the non-AP MLD, the AP operating in another link of the NSTR AP MLD may be in the BLIND state. However, only one of two PPDUs (received through the primary link and the non-primary link, respectively) simultaneously received corresponds to a PPDU requesting the response frame, the NSTR AP MLD may not perform the response of the response frame for both of the two PPDUs.

In addition, when performing transmission to the NSTR AP MLD by using both the primary link and the non-primary link, the non-AP MLD may need to make a configuration so that a TXOP of the non-primary link and a TXOP of the primary link end at the same time point, or the TXOP of the non-primary link ends earlier. In other words, the non-AP MLD may need to configure the TXOP of the non-primary link and the TXOP of the primary link to simultaneously end or the TXOP of the non-primary link to end earlier. However, the non-primary link TXOP of the non-AP STA MLD may be allowed to end later by a time within a pre-configured time interval than the TXOP of the primary link.

In addition, the non-AP STA MLD may recognize that the NSTR AP MLD has experienced the BLIND state in the AP of a specific link, and may assist an operation of the AP. To describe in more detail, when recognizing that the NSTR AP MLD has performed transmission only through one link among the primary link and the non-primary link, the non-AP STA MLD may identify that an AP of another link, which has performed no transmission, has experienced the BLIND state. In this case, in consideration that the AP having experience the BLIND state will be restricted in channel access due to MediumSyncDelay not corresponding to 0, the non-AP STA MLD may perform an operation of assisting the AP in releasing MediumSyncDelay (resetting to 0). In this case, the operation performed by the non-AP STA MLD may be an operation using a characteristic that MediumSyncDelay can be released when a NAV configurable PPDU (including a valid MPDU) is received.

For example, the non-AP STA MLD may transmit an assist frame (a type of a PPDU) capable of configuring a NAV to the AP of the NSTR AP MLD, which is determined to have MediumSyncDelay not corresponding to 0 after experiencing the BLIND state. In this case, the assist frame may mean a frame included in the valid MPDU capable of NAV configuration, regardless of the frame format. In this case, a condition that the non-AP STA MLD transmits the assist frame to the NSTR AP MLD through a specific link is restricted to a case where the state of the specific link identified by the non-AP STA MLD is an IDLE state. In this case, another condition that the non-AP STA MLD transmits the assist frame to the NSTR AP MLD is restricted to a case where the non-AP STA MLD is a non-AP STA MLD having explicitly or implicitly received, from the NSTR AP MLD, a request (indication) on transmission of the assist frame.

### <6 GHz Band-Related ML Discovery (Multi-Link Operation (MLO) Discovery) and ML Setup (Association) Procedure>

Wi-Fi before the 6th generation Wi-Fi has supported operations in 2.4 GHz and 5 GHZ, and a 6 GHz band recently incorporated in an ISM band is a Wi-Fi frequency band (non-license band) initially used by a HE terminal (AP STA and non-AP STA). An IEEE 802.11ax task group (TG) having performed standardization of the HE terminal has regulated that a HE STA (AP STA and non-AP STA) operating in the 6 GHz band performs no backward compatibility operation for a Wi-Fi terminal in a previous generation, in consideration of absence of the conventional Wi-Fi terminal (terminal before 6th generation Wi-Fi) operated in the 6 GHz band. More specifically, it has been restricted for the HE STA operating in 6 GHz not to transmit an HT capabilities element, a VHT capabilities element, ah HT operation element, a VHT operation element, and/or an HE operation element including a VHT operation information field so that support for the terminal before the 6th generation Wi-Fi is excluded, and information included in a beacon frame, and the like is reduced so that overhead is to be reduced.

That is, an AP or a non-AP STA operating in a specific band (for example, a 6 GHz band) cannot transmit a legacy format capabilities element and/or operation element (for example, an HT capabilities element, a VHT capabilities element, an HT operation element, a VHT operation element, and/or an HE operation element including a VHT operation information field).

In another embodiment of the present disclosure, when an AP and/or a non-AP STA operates in a specific band and does not transmit an HT capabilities element, a VHT capabilities element, an HT operation element, and/or a VHT operation element which are capabilities elements and operation elements for its own 2.4 GHz/5 GHz, the AP and/or the non-AP STA may transmit information on other APs and/or non-AP STAs included in the same MLD, other than its own information. In this case, the information on the other APs and/or non-AP STAs may include a capabilities element and an operation element for a band (for example, 2.4 GHz/5 GHZ) other than the specific band. That is, the AP and/or the non-AP STA may transmit capabilities element and/or operation information of a band in which each of the multiple STAs operates, and cannot transmit capabilities element and/or operation information of a band in which each of the multiple STAs does not operate.

That is, the capability and operation information in a case of operating as HT and VHT STAs (AP and non-AP STAs) cannot be included in a beacon frame transmitted by an HE AP operating in 6 GHZ, an association request frame transmitted by a non-AP STA performing setup in 6 GHZ, etc. The HE STA operating in 6 GHz does not need to operate as an HT/HT STA because another HT/VHT STA operating in a 6 GHz band does not exist, and accordingly, the above-described capability and operation information of the HT/VHT STA operation may be unnecessary information. For such a reason, it is restricted in 11ax standard that the HE STA (AP STA and non-AP STA) operating in 6 GHz does not transmit the HT capabilities element, the VHT capabilities element, the HT operation element, the VHT operation element, and the HE operation element including the VHT operation information field, and the same restriction is also applicable to an EHT STA (MLD) inheriting the operation of the HE STA.

In other words, an STA operating in the 6 GHz band cannot transmit the HT capabilities element, the VHT capabilities element, the HT operation element, the VHT operation element, or the HE operation element including the VHT operation information field. That is, the STA operating in the 6 GHz band may not transmit a specific legacy format capabilities/operation element to provide a parameter for its own capability and operation.

However, in this case, the STA operating in 6 GHz may transmit a basic multi-link element including information other STAs. In this case, the basic multi-link element may include an STA profile field including the capabilities element and/or operation element for other STAs reported by the STA operating in 6 GHz. The STAs reported by the STA operating in 6 GHz may operate in the 2.4 GHz or 5 GHz band, and the STA profile field may be included in a per-STA profile subelement corresponding to the reported STA.

However, as being considered in the above-descried embodiment of the present disclosure, the EHT STA corresponding to the MLD needs to perform ML setup by transmitting not only information on the EHT STA itself but also information on other STAs (operating in other links) in the same MLD by including the same in a beacon frame and (ML) probe response frame, an association request frame, and/or an association response frame. In other words, an AP operating in 6 GHz among APs of an AP MLD may need to indicate HT/VHT capabilities/operation elements of APs in 2.4 GHz and 5 GHz to the (ML) probe response frame and the association response frame to provide information on other APs operating in 2.4 GHz and 5 GHz, and accordingly, a restriction regulated to prohibit the 6 GHz STA (AP STA and non-AP STA) from indicating the HT/VHT-related element in 11ax needs to be amended. In this case, the (ML) probe response frame may mean a response frame transmitted as a response the ML probe request frame.

Hereinafter, APs operating in 2.4 GHZ, 5 GHZ, and 6 GHz, respectively, are described as a 2.4 GHz AP, a 5 GHz AP, and a 6 GHz AP, respectively, and STAs performing (attempting to perform) ML setup in 2.4 GHz, 5 GHZ, and 6 GHz, respectively, are a 2.4 GHz STA, a 5 GHz STA, and a 6 GHz STA (non-AP STA), respectively.

According to an embodiment of the present disclosure, a 6 GHz AP/STA (reporting STA) of an EHT MLD may transmit an HT capabilities element, a VHT capabilities element, an HT operation element, a VHT operation element, an HE operation element including a VHT operation information field for the 2.4 GHz and 5 GHz STAs (reported STAs) of the same MLD. In this case, a frame in which the 6 GHz AP/STA may include HT/VHT-related information for the 2.4 GHz and 5 GHz

STAs (AP STA and non-AP STA corresponding to reported STAs) may be a management frame. In this case, a place where the 6 GHz AP/STA includes the HT/VHT-related information for the 2.4 GHZ and 5 GHZ APs/STAs in the management frame may be a multi-link information element (ML IE). In this case, a place where the 6 GHZ AP/STA includes the HT/VHT-related information for the 2.4 GHz and 5 GHz APs/STAs in the management frame may be a per-STA profile subelement corresponding to each of the STAs.

Alternatively, the 6 GHz AP/STA may include, as common information indicated by the ML IE of the management IE, the HT/VHT capabilities/operation element for the 2.4 GHz and 5 GHz STAs (reported STAs).

More specifically, a (re) association response frame transmitted by the 6 GHz AP of the EHT AP MLD to perform (accept) the ML setup by including the 2.4 GHz and/or 5 GHz AP may include an HT/VHT capabilities/operation element.

Similarly, the (re) association request frame transmitted by the 6 GHz STA of the EHT non-AP MLD to perform (request) the ML setup including the 2.4 GHz and/or 5 GHz STA may include an HT/VHT capabilities/operation element.

That is, the 6 GHz STA (of the MLD) may transmit the HT/VHT capabilities/operation element by including the same in the (re) association request frame only in a case of attempting the ML setup by including the 2.4 GHz and/or 5 GHz STA of the same MLD.

In other words, the 6 GHz AP (of the MLD) may transmit the HT/VHT capabilities/operation element by including the same in the (re) association response frame only in a case of performing the ML setup by including the 2.4 GHz and/or 5 GHz AP of the same MLD.

For example, APs or non-AP STAs may operate in various bands (6 GHZ, 2.4 GHz, and 5 GHz), respectively. In this case, an MLD (first MLD) including non-AP STAs may transmit or receive a frame to or from an MLD (second MLD) including APs, for multi-link configuration. In this case, an STA (first STA) operating in 6 GHz, included in the first MLD, may transmit an association request frame (or a reassociation request frame) for multi-link configuration, and an AP (first AP) operating in 6 GHZ, included in the second MLD, may transmit an association response frame (or reassociation response frame) in response to the association request frame (or reassociation request frame).

The first STA may transmit information on the first STA itself and information (for example, multi-link information (or element), etc.) on other STAs included in the same MLD by including the same in an association request message.

The information on the first STA, included in the association request message, may be information on 6 GHz (for example, HE capabilities information, HE operation information, EHT capabilities information, and/or EHT operation information). However, the association request message does not include information (for example, the HT capabilities element, the VHT capabilities element, the HT operation element, the VHT operation element, the HE operation element including the VHT operation information field, or the like) on the first STA for a band (for example, 2.4 GHz or 5 GHZ) other than the 6 GHz band. That is, the first STA cannot transmit information on a band other than the band in which the first STA itself operates.

The information (for example, the multi-link information (or element), etc.) on other STAs, included in the association request message, may include information (for example, the HT capabilities element, the VHT capabilities element, the HT operation element, the VHT operation element, the HE operation element including the VHT operation information field, or the like) on a band (for example, 2.4 GHz or 5 GHZ) other than each of the other STAs operates.

In this case, the information on the other STAs may include a per-STA profile subelement corresponding to each of the STAs.

In addition, the multi-link information (or multi-link element) of the association request message may include a multi-link element including a per-STA profile subelement corresponding to each of the reported STAs, and the per-STA profile subelement may include a complete profile subfield indicating whether all information on a corresponding station among one or more reported stations is requested.

In this case, when the complete profile subfield is configured with a value or a specific value (for example, “1”) indicating a request for all information, all information of the STAs corresponding to the complete profile subfield may be included in the multi-link element. Alternatively, a complete profile may indicate whether the corresponding per-STA profile includes complete information of the corresponding STA.

The first AP may transmit information on the first AP itself and information (for example, multi-link information (or element) on other APs included in the same MLD by including the same in an association response message.

The information on the first AP, included in the association response message, may be information on 6 GHz (for example, the HE capabilities information, the HE operation information, the EHT capabilities information, and/or the EHT operation information). However, the association response message does not include information (for example, the HT capabilities element, the VHT capabilities element, the HT operation element, the VHT operation element, the HE operation element including the VHT operation information field, etc.) on the first AP for a band (for example, 2.4 GHz or 5 GHZ) other than the 6 GHz band. That is, the first AP cannot transmit the information on a band other than the band in which the first AP itself operates.

The information on other APs (for example, multi-link information (or element), etc.), included in the association request message, may include information (for example, the HT capabilities element, the VHT capabilities element, the HT operation element, the VHT operation element, the HE operation element including the VHT operation information field, etc.) on a band (for example, 2.4 GHz or 5 GHz) in which each of the other STAs operates.

In addition, the 6 GHz AP (or the MLD) may transmit the HT/VHT capabilities/operation element by including the same in the ML probe response frame like the above-described association request frame and association response frame. In this case, a condition of transmitting (responding with) the HT/VHT-related information by including the same in the ML probe response frame may be including a multi-link element (probe request variant) in a received probe request frame. In this case, the probe request frame included in the multi-link element may be considered as an ML probe request (frame).

A more detailed condition of transmitting (responding with), by the 6 GHz AP, the ML probe response frame including the HT/VHT capabilities element and/or the HT/VHT operation element may be including a multi-link element by a received ML probe request frame and requesting complete information on the 2.4 GHz and or 5 GHz AP or the HE/VHT capabilities/operation element information.

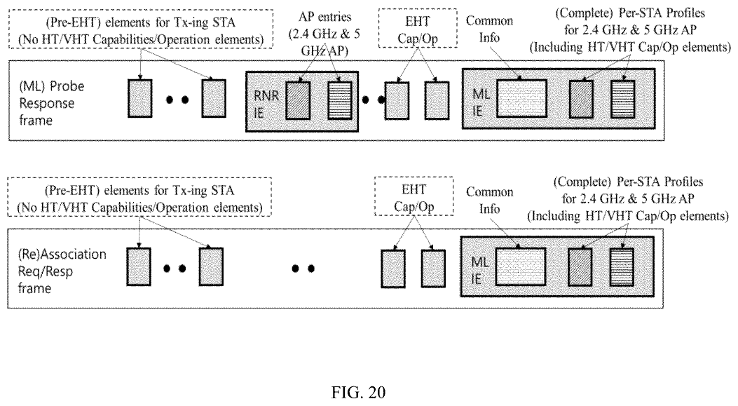

FIG. 20 illustrates an example of a probe request frame, an association request frame, and an association response frame transmitted by a station operating in a specific bandwidth.

Referring to FIG. 20, a 6 GHz AP may transmit an HT/VHT capabilities element and an HT/VHT operation element in an ML IE of a (ML) probe response frame. In this case, the HT/VHT capabilities/operation element may be an element for 2.4 GHz and 5 GHz APs operated by an MLD to which the 6 GHz AP belongs.

That is, according to a 6 GHz band operation regulation, the 6 GHZ AP corresponding to an STA of an AP MLD may transmit a (ML) probe response frame including an HT/VHT-related element in the 6 GHz band for the purpose of indicating complete information for the 2.4 GHz AP and the 5 GHz AP.

In addition, an STA of a non-AP MLD and an AP of an AP MLD for transmitting the (re) association request/response frame in the 6 GHz band may also transmit the (re) association req/resp frame including the HT/VHT-related element in the 6 GHz band according to the purpose.

A case where the 6 GHz STA transmits the HT/VHT-related element by including the same in the (re) association request frame may be limited to a case where there is intention that the ML setup is to be performed both in 6 GHz and 2.4/5 GHz through the (re) association request frame transmitted in 6 GHz.

A case where the 6 GHZ AP transmits the HT/VHT-related element by including the same in the (re) association response frame may be limited to a case where the non-AP STA has transmitted the (re) association request frame through the 6 GHz band and there is intention that the setup is to be made also in 2.4 GHz and/or 5 GHz through acceptance of the ML setup request of the non-AP STA.

In another method, there may be a method of restricting that the 6 GHz STA (AP STA and non-AP STA) does not include the HT/VHT capabilities/operation element in the frame transmitted in the 6 GHz band.

In this case, the 6 GHz AP may not include the HT/VHT capabilities/operation element even when transmitting an ML probe response frame including (per-STA profile) information of the 2.4 GHz and/or 5 GHZ AP and an ML association response frame for accepting the setup of the 2.4 GHz and/or 5 GHz AP. Accordingly, the non-AP MLD which is to perform the ML setup including 2.4 GHz and 5 GHz through the 6 GHz AP may need to transmit the ML probe request frame to the 2.4 GHz AP or the 5 GHz AP to acquire additional information (included in the HT/VHT-related element) of the 2.4 GHz and/or 5 GHz AP.

In consideration of the restriction that the HT/VHT-related element cannot be transmitted/acquired in 6 GHZ, a non-AP EHT MLD for transmitting the ML association request frame to the 6 GHz AP may need to receive the ML probe response frame including complete (or HT/VHT-related element) information of the AP for performing setup through the 2.4 GHz or 5 GHz in advance. That is, the non-AP EHT MLD which is to perform ML setup with both the 2.4 GHz and/or 5 GHz APs through transmission of the ML association request frame to the 6 GHz AP may transmit the ML probe request frame through 2.4 GHz or 5 GHZ, and may need to acquire the complete information (or HT/VHT-related elements) for the 2.4 GHz and/or 5 GHz AP before performing the setup or after completing the setup.

In addition, after completing the ML setup through 6 GHZ, the non-AP MLD may need to transmit, to the AP MLD, complete information (or HT/VHT-related elements) of STAs (2.4 GHz STA and 5 GHz STA) operating in a 2.4 GHz link and a 5 GHz link in which the setup is performed. In this case, to transmit the element of the 2.4/5 GHz STA in which the setup is performed, the non-AP MLD may transmit the HT/VHT capabilities/operation element of the 2.4/5 GHz STA in a PPDU transmitted first after the association.

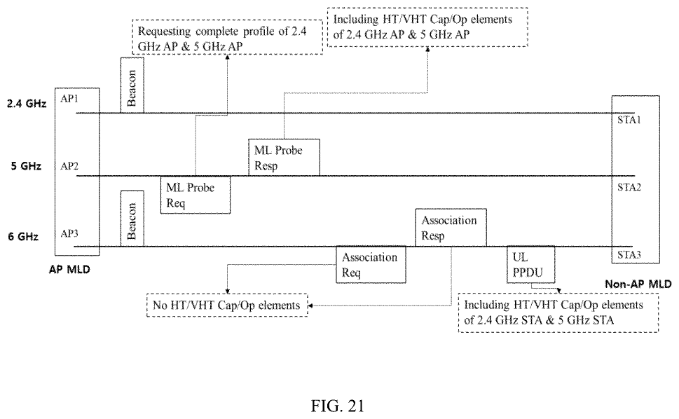

FIG. 21 illustrates an example of a method of exchanging high throughput (HT)/very high throughput (VHT)-related element information in a link other than a specific bandwidth and performing multi-link configuration according to an embodiment of the present disclosure.

Referring to FIG. 21, an AP MLD may operate AP 1 to AP 3 in 2.4 GHz, 5 GHz, and 6 GHz, respectively. A non-AP MLD having received a beacon frame of AP 3 corresponding to a 6 GHz AP may attempt to perform ML setup by exchanging a (re) association req/res frame with the AP MLD by using a 6 GHz band.

In this case, the non-AP MLD may intend to attempt ML setup including a 2.4 GHz AP and a 5 GHz AP, and to this end, may transmit an ML probe request frame to the 5 GHz AP in 5 GHz before transmitting an association request frame in 6 GHz. In this case, the ML probe request frame transmitted by the non-AP MLD through the 5 GHz band may be an ML probe request frame for requesting complete information (or HT/VHT-related element) for the 2.4 GHz AP and the 5 GHz AP among APs for attempting to perform the ML setup.

The non-AP MLD having received a response of the ML probe response frame from the 5 GHz AP may transmit the association request frame for requesting the ML setup including 2.4 GHz/5 GHz to the 6 GHz AP through the 6 GHz STA. In general, the complete information of the STA of the link for requesting the ML setup needs to be included in the association request frame, but the association request frame transmitted by the 6 GHz STA may not include the HT/VHT capabilities/operation element for the 2.4 GHz and 5 GHz STAs. Similarly, in general, the association response frame transmitted (transmitted as a response) for acceptance of the setup for 2.4 GHz and/or 5 GHz may need to include complete information for the AP of the link for accepting the ML setup, but the association response frame transmitted by the 6 GHz AP may not include the HT/VHT capabilities/operation element for the 2.4 GHz and 5 GHz APs.

As such, the non-AP MLD having performed the setup with the AP MLD in 2.4 GHz and/or 5 GHz through the association request/response frame not including the HT/VHT element for 2.4/5 GHz may transmit, to the AP MLD, the HT/VHT capabilities/operation element for the 2.4/5 GHz STA having performed the setup through the first PPDU transmitted after reception of the association response frame.

### <Management Frame Configuration and Inheritance Rule>

There is high possibility that EHT STAs (AP STA and non-AP STA) included in the same MLD have similar capability and operation parameters even though being operated in different links. Accordingly, some elements of an STA (reporting STA) for transmitting a management frame (beacon, (ML) probe req/resp, (ML) association req/resp frames, etc.) may include the same information as some elements of other STAs (reported STAs) within the MLD.

As being considered in the above-described embodiment of the present disclosure, the EHT STA (reporting STA) may transmit complete information of other STAs (reported STAs) within the same MLD by including the same in the management frame, and in consideration the fact that the MLD may operate multiple STAs, there is possibility that the management frame including all complete information of the respective STAs causes a large overhead.

Accordingly, the management frame including the complete information of other STAs within the MLD in a per-STA profile subelement may omit an element of the reporting STA including the same information as the element of the reporting STA. That is, when the management frame including the complete information of a specific STA (reported STA) does not indicate some elements in the per-STA profile subelement corresponding to the specific STA, some elements that are not indicated may be interpreted as inheritance of information of the same element (the same element as some elements) corresponding to the STA (reporting AP) having transmitted the management frame. In this case, the management frame including the complete information of the specific STA (reported STA) may mean a management frame including the same level (same amount) of information as the STA (reporting STA) having transmitted the management frame. In this case, interpreting the per-STA profile subelement by using an inheritance rule may be restricted to a case where the corresponding per-STA profile is a complete profile. In this case, when the per-STA profile is the complete profile, it may mean that a complete profile subfield of the per-STA profile subelement is indicated as 1.

As such, an STA of an MLD may configure the management frame by using the inheritance rule for the purpose of reducing the size of the management frame while including the complete information of other STAs within the MLD in the management frame. In addition, the MLD having received the management frame from the STA of the MLD may acquire (interpret or recognize), using the inheritance rule, information on the reported STA that has been omitted.

In this case, whether the complete information of each reported STA is included in the management frame may be indicated as whether the complete profile subfield (of the STA control field) is indicated as 1 in the per-STA profile subelement corresponding to each reported STA. That is, the reported STA corresponding to the per-STA profile, which has the complete profile subfield indicated as 1, may be an STA, the complete information of which is indicated through the corresponding management frame.

### <Inheritance Rule Applied to Element not Indicated as Element of Reporting STA in Management Frame>

There may be a case where a reporting STA transmitting the management frame has no specific element information. For example, when the reporting STA is a 6 GHz STA (AP STA and non-AP STA), the 6 GHz STA corresponding to the reporting STA may not have an HT/VHT-related element. In this case, when complete information of the 2.4 GHz and 5 GHz STAs needs to be included in the corresponding management frame, the HT/VHT-related information (HT/VHT capabilities/operation elements) which needs to be indicated for the 2.4 GHz and 5 GHz STAs cannot be indicated/interpreted through the inheritance rule. This is because the 6 GHz STA corresponding to the reporting STA has no HT/VHT-related information, and accordingly, for the management frame transmitted by the reporting STA corresponding to the 6 GHz STA, the inheritance rule is not applicable to the elements indicated only for the reported STAs. That is, when complete information of multiple 2.4 GHz and 5 GHz STAs needs to be indicated in the management frame transmitted by the 6 GHz STA, each element may need to be repeatedly indicated in the per-STA profile corresponding to each reported STA even though all of the multiple reported STAs (2.4/5 GHZ STAs) have the same HT/VHT capabilities/operation element value. This means that the application of the inheritance rule in the management frame is restricted when the reporting STA transmitting the management frame does not include information on the specific element, and consequently, the size of the management frame may increase.

Accordingly, due to the restriction that the inheritance rule is not applicable to an element not indicated for the reporting STA, a new inheritance rule for preventing the increase of the size of the management frame may be required.

According to an embodiment of the present disclosure, with respect to information (element, etc.) on a reported STA indicated through a management frame (for example, beacon, (ML), probe response, (ML) association request, (ML) association response frames, etc.), information other than the information on the reporting STA may be inherited.

To describe it in more detail, even though it is indicated that the management frame includes complete information on a specific reported STA, if a specific element corresponding to the specific reported STA is not indicated, it may be considered that the specific element inherited an element other than the element of the reported STA. In this case, a condition in which it is considered that the specific element inherited an element other than the element of the reported STA may not be indicated (included) (in the corresponding management frame) for the reporting STA. In this case, a method of indicating/interpreting that information on the reported STA inherits an element other than the element of the reporting STA may be applicable only when the reporting STA is a 6 GHz STA.

According to an embodiment of the present disclosure, when a specific element of the reported STA through which the complete information (profile) is indicated is not indicated through the management frame, it may be considered that a value of the same element (having the same element IE and extended element ID) as the specific element indicated through the management frame is applied (indicated) the same to the specific element of the reported STA. In this case, the same element inherited to the specific element of the reported STA may not be an element for the reporting STA.

That is, the same element (having the same element ID and extended element ID as the specific element) inherited to the specific element for the reported STA may not be an element for the reporting STA.

That is, the same element (having the same element ID and extended element ID as the specific element) inherited to the specific element for the reported STA may be an element for another reported STA. In such a method, even though the HT/VHT capabilities/operation element for the 6 GHz STA is not indicated in the management frame transmitted by the reporting STA corresponding to the 6 GHz STA, the HT/VHT elements indicated in the per-STA subelement of the reported STA may be inherited to other reported STAs.

Alternatively, the same element (having the same element ID and extended element ID as the specific element) inherited to the specific element for the reported STA may be an additional element indicated for inheritance. In this case, the additional element indicated for inheritance may mean an element not directly corresponding to the reporting STA or the reporting STA.

However, when the specific element (not included in the management frame) is indicated through a non-inheritance element of the per-STA profile subelement corresponding to the reported STA, it may be considered that the specific element for the reported STA does not inherit any value and is not indicated in the management frame.

For example, when a specific element for STA 1 to which complete information is indicated through the management frame is not indicated and there is the same element indicated to STA 2, a value indicated through the same element may be considered (i.e., inherited) the same as being indicated through a specific element of STA 1. In this case, STA 2 may not be a reporting STA.

In addition, the same element (having the same element ID and extended element ID as the specific element) inherited to the specific element of STA 1 may be an additional element indicated for inheritance, rather than an element for the reporting STA and reported STA.

According to an embodiment of the prevent invention, when the specific element of the reported STA to which the complete information (profile) is indicated is not indicated through the management frame, it may be considered that a value of the same element (having the same element ID and extended element ID) as the specific element indicated through the management frame is applied (indicated) the same to the specific element of the reported STA. In this case, the element inherited to the specific element of the reported STA may be determined by the inheritance rule.

As an example of a rule of selecting an inherited element, another element (having the same element ID and extended element ID as the specific element) inherited to the specific element for the reported STA may be determined as the same element first indicated in the management frame.

To describe it in more detail, when a specific element for the reported STA is not indicated in the management frame in which complete information (profile) for the reported STA needs to be included, it may be considered that a value of an element first indicated (in an element order) among other elements having the same element ID and extended element ID as the specific element is inherited to the specific element. That is, when the same element as the specific element is indicated for the reporting STA (first indicated among the same elements), it may be considered that the specific element inherits the same element value of the reporting STA.

As another example of a rule of selecting an inherited element, another element (having the same element ID and extended element ID as the specific element) inherited to the specific element for the reported STA may be determined as the same element that is most recently indicated (in an element order) in the management frame.

To describe it in more detail, when the specific element or the reported STA is not indicated in the management frame in which complete information (profile) for the reported STA needs to be included, it may be considered that a value of the element first indicated (in an element order) among other elements having the same element ID and extended element ID as the specific element is inherited to the specific element. That is, when the same element as the specific element is indicated for three preceding STAs, it may be considered that the specific element inherits the thirdly indicated same element value.

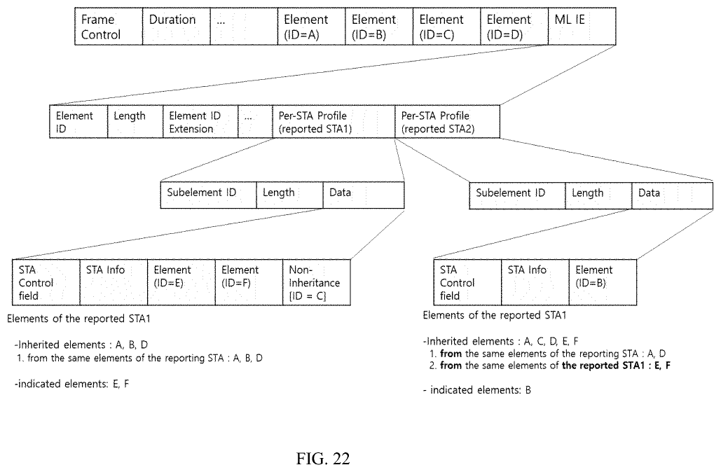

FIG. 22 illustrates an example of a part of a configuration of a management frame for describing an inheritance method of a complete per-STA profile according to an embodiment of the present disclosure.

Referring to FIG. 22, a management frame includes four elements (elements having element IDs A to D in FIG. 22) for a reporting AP and a multi-link information element (ML IE) for indicating complete information of a reporting STA.

An ML IE (multi-link element) includes an element ID subfield, a length subfield, an element ID extension subfield, and two per-STA profile subelements. In this case, a per-STA profile indicated first in order is a per-STA profile included to indicate complete information (profile) for reported STA 1, and a per-STA profile indicated later in order is a per-STA profile included to indicate complete information (profile) for reported STA 2. That is, the per-STA profile indicated first in order is a per-STA profile for reported STA 1, and the per-STA profile indicated later is a per-STA profile for reported STA 2.

The per-STA profile corresponding to reported STA 1 includes two elements (having element IDs E and F) not indicated as elements for the reporting STA. In this case, the per-STA profile corresponding to reported STA 1 is a per-STA profile having a complete profile subfield indicated as 1, and thus it may be considered that three elements (having elements IDs A, B, and D) remaining after excluding an element (having element ID C) indicated in a non-inheritance element from among elements (having element IDs A to D) are indicated to be identical to those for reported STA 1. In this case, with respect to the three elements considered to be indicated to be identical to the reporting STA, a value indicated by each of the elements is also considered to be identical to that of the element for the reporting STA.

Consequently, the per-STA profile for reporting STA 1 has a configuration including only two elements (element IDs E and F), but it may be interpreted that five elements are indicated as a complete profile for reported STA 1 in consideration that three elements (element IDs A, B, and D) of the reporting STA are inherited.

The per-STA profile corresponding to reported STA 2 includes an element of element ID B which has been indicated as an element for the reported STA. A new element value for reported STA 2 may be indicated instead of inheritance of the element of the reporting STA since a value of the element (having element ID B) indicated for the reported STA is different from a value of the element (having element ID B) indicated for the reporting STA.

The per-STA profile corresponding to reported STA 2 is a complete per-STA profile having a complete profile subfield indicated as 1, and thus remaining elements (element IDs A, C, and D except for element ID B) for the reporting STA are considered to be indicated to be identical to those for reported STA 2. In this case, with respect to the three elements considered to be indicated to be identical to the reporting STA, a value indicated by each of the elements is also considered to be identical to that of the element for the reporting STA.

In addition, the per-STA profile corresponding to reported STA 2 may inherit not only an element indicated for the reporting STA but also an element of reported STA 1 indicated first in order. That is, two elements (element IDs E and F) indicated in the per-STA profile of reported STA 1 may be also inherited for the element of reported STA 2. In other words, elements for reported STA 1 may be also inherited to the elements for reported STA 2. That is, two elements (having element IDs E and F) indicated through the per-STA profile of reported STA 1 may be considered to be indicated to be identical to those for reported STA 2.

### <Implicit Non-Inheritance Rule>

As described above, complete information (profile) for the reported STA may be indicated through a management frame transmitted by the reporting STA, and an inheritance rule may be applied to prevent the same element having the same value from being repeatedly indicated within the management frame.

A non-inheritance element included in the per-STA profile subelement of the reported STA has a function of explicitly indicting elements not applying the inheritance among elements not indicated for the reported STA. In other words, when a specific element is indicated through a non-inheritance element included in a per-STA profile subelement of a specific STA, it may be explicitly indicated that a specific element not indicated for the specific STA does not inherit a value of another element. In this case, an MLD having received the management frame may consider (interpret) that the specific element for the specific STA does not exist.

That is, the non-inheritance element may be used for the purpose of solving ambiguity on whether the specific element of the reported STA, not indicated in the management frame, is omitted utilizing the inheritance rule or does not originally exist.

However, only for a specific case, the MLD having received the management frame may recognize that some unindicated elements for the reported STA are elements which do not originally exist for the reported STA.

For example, a non-AP STA MLD having received a (re) association response frame in which a 6 GHz AP is included as a reported STA may already recognize that an HT/VHT capabilities/operation element for the 6 GHz AP cannot be indicated in the (re) association response frame. In this case, even though the AP MLD transmitting the (re) association response frame does not separately indicate, through a non-inheritance element (of a per-STA profile subelement) corresponding to the 6 GHz AP, the fact that the HT/VHT-related element is not inherited, the STA MLD may not interpret the HT/VHT-related element for the 6 GHZ AP as an inheritance rule.

According to an embodiment of the present disclosure, even though the HT/VHT capabilities/operation element is not indicated (listed) in the non-inheritance element corresponding to the 6 GHZ AP corresponding to the reported STA, the elements may not be inherited for the 6 GHZ AP. In this case, when an element is not indicated in the non-inheritance element, it may mean that the non-inheritance element does not appear (is not included) in the per-STA profile subelement, or may mean that the element is not indicated by the non-inheritance element.

For example, when complete information (profile) for a 6 GHz AP is indicated through a management frame (for example, a (re) association response frame) transmitted by a 2.4 GHz AP, an HT capabilities element for the 2.4 GHz AP is not inherited to an HT capabilities element for the 6 GHz AP even though the HT capabilities element for the 6 GHz AP is not indicated and a non-inheritance element is not included in a per-STA profile.

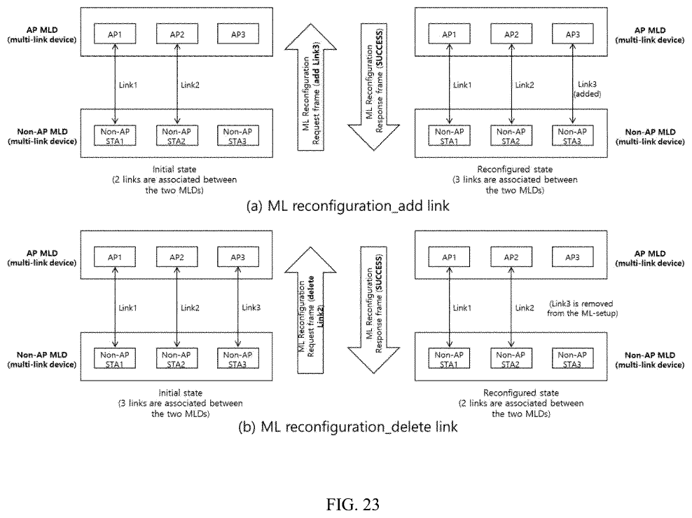

FIG. 23 illustrates an example of a method of changing the state of a multi-link association between an AP MLD and a non-AP MLD through a reconfiguration procedure according to an embodiment of the present disclosure.

As illustrated in FIG. 23(a), an AP MLD and a non-AP MLD are initially multi-link associated through Link 1 and Link 2, i.e., two links.

The non-AP MLD may have an intention to be additionally associated through Link 3 operated by AP 3 by the AP MLD, and to this end, transmits an ML reconfiguration request frame to the AP MLD. In this case, the ML reconfiguration request frame includes information on desiring to be additionally associated through Link 3. The AP MLD may recognize, through the ML reconfiguration request frame received from the non-AP MLD, that the non-AP MLD desires to be additionally associated through Link 3, and respond with an ML reconfiguration response frame including information on acceptance to the association request for Link 3. Link 3, which has not been associated between two MLDs, is newly associated through exchange of ML reconfiguration req/resp frames exchanged between the AP MLD and the non-AP MLD, and consequently, the non-AP MLD is associated with the AP MLD through Link 1, Link 2, and Link 3, i.e., three links.

Referring to FIG. 23(b), an AP MLD and a non-AP MLD are initially multi-link associated through Link 1, Link 2, and Link 3, i.e., three links.

The non-AP MLD may have an intention to release an association of Link 3 in the state of association with the AP MLD, and to this end, transmits an ML reconfiguration request frame to the AP MLD. In this case, the ML reconfiguration request frame includes information on desiring to release the association of Link 3. The AP MLD may recognize, through the ML reconfiguration request frame received from the non-AP MLD, that the non-AP MLD desires to release (delete) the association of Link 3, and responds with an ML reconfiguration response frame including information on acceptance to releasing (deletion) of the association of Link 3. Link 3, which has been associated between two MLDs, is released through exchange of ML reconfiguration req/resp frames exchanged between the AP MLD and the non-AP MLD, and consequently, the non-AP MLD is changed to be associated with the AP MLD through Link 1 and Link 2, i.e., two links only.

### <Reconfiguration Multi-Link Element)>

A reconfiguration request frame may include a reconfiguration multi-link element. In this case, the reconfiguration multi-link element includes an indicator (link indication or link indicator) for a link to which the non-AP MLD for transmitting the reconfirmation request frame is to be associated, and complete information for a non-AP STA operating in the corresponding link. The reconfiguration multi-link element transmitted to request the association with one or more links includes an indicator for one or more links and information on a non-AP STA operating in each of the links. The information on the non-AP STA included in the reconfiguration multi-link element may include all information required for association related to the non-AP STA. That is, the information on the non-AP STA of a link to be added, the information being included in the reconfiguration multi-link element, may be equivalent to information included in a probe request frame and an association request frame transmitted for association with the non-AP STA.

In addition, the reconfiguration request frame may be transmitted to release the association of the already associated link as described above. In this case, the reconfiguration multi-link element included in the reconfiguration request frame may include an indicator for the link to be released. Similarly, when the reconfiguration request frame is transmitted to release the association for multiple links, the reconfiguration multi-link element included in the corresponding frame includes a link indicator for the multiple links.

It is possible to request, through a single reconfiguration request frame, to add a new association for a specific link and release the association for another link, and in this case, an indicator for the specific link, information (complete information) on the non-AP STA to be associated in the specific link, and an indicator of another link may be all included in the reconfiguration multi-link element. In this case, information related to each of the link for which new association is requested and the link for which releasing of the existing association is requested may be included in a per-STA profile subelement corresponding to each of the links. That is, an indicator for a first link for which a new association is requested and information on a non-AP STA operating in the first link may be indicated through a per-STA profile subelement corresponding to the non-AP STA operating in the first link, and an indicator for a second link for which releasing of the association is requested may be indicated through a per-STA profile subelement corresponding to a non-AP STA operating in the second link.

As such, a large amount of information on the non-AP STA may need to be included in the reconfiguration multi-link element because the additional link newly associated through the above-described reconfiguration req/resp frame exchange is to be configured to be used for data frame exchange without a separate association procedure (probing and association req/resp frame exchange, etc.). That is, complete information on the non-AP STA of the link for which new association is requested through the reconfiguration multi-link element is included in the reconfiguration multi-link element.

Accordingly, when the reconfiguration request frame is configured for the purpose of adding an association of a new link, a complete profile subfield or complete information of the non-AP STA corresponding to the new link may be included in the reconfiguration multi-link element included in the reconfiguration request frame. In this case, the information on the non-AP STA of the link to be added, in the reconfiguration multi-link element, may be included in the per-STA profile subelement corresponding to the non-AP STA and transmitted. That is, when there are one or more links for which a new association is request through the reconfiguration request frame, per-STA profile subelements for one or more non-AP STAs operating in the one or more links, respectively, may be included in the reconfiguration multi-link element. Consequently, the reconfiguration multi-link element for requesting additional association for one or more links may include compete information and one or more per-STA profile subelements for one or more non-AP STAs.

### <Association/Releasing Indication Method Using Per-STA Profile Subelement>

According to an embodiment of the present disclosure, whether a new association is requested or releasing of the existing association is requested for a link indicated by a link indicator of each per-STA profile subelement included in a reconfiguration multi-link element may be directly indicated or may be implicitly indicated.

In a direct indication method, whether an association is requested or releasing of the association is requested for a link indicated by a link indicator of a per-STA profile subelement may be indicated by a specific subfield included in the per-STA profile subelement. In this case, the specific subfield may be a request type subfield. More specifically, a per-STA included in the reconfiguration multi-link element may include a subfield indicating an association change method. The subfield indicating the association change method may be configured with a specific value to indicate that a new association is requested for a link corresponding to the corresponding per-STA profile subelement (Add Link), and may be configured with a value other than the specific value to indicate that releasing of the already established association for the link corresponding to the corresponding per-STA profile subelement (Delete Link). That is, the per-STA profile subelement may include subfield having different values for a case where the association is requested and a case where the releasing of the association is requested for the corresponding link. In this case, the link corresponding to the per-STA profile subelement means a link indicated by a link indicator included in the per-STA profile subelement.

However, the link for which the new association is requested needs to be limited to a link for which there is no existing association. That is, when a value of a subfield indicating the association change method of the per-STA profile subelement included in the reconfiguration multi-link element is configured with a value (add link) indicating that a new association is requested, the non-AP MLD should not indicate, through a link indicator of the corresponding per-STA profile subelement, a link for which the association is already established (a link included in the already established ML setup).

For the same reason above, the link for which the releasing of the association is requested needs to be limited to a link for which there is an existing association. That is, when a value of a subfield indicating the association change method of the per-STA profile subelement included in the reconfiguration multi-link element is configured with a value (delete link) indicating that releasing of the existing association is requested, the non-AP MLD should not indicate, through a link indicator of the corresponding per-STA profile subelement, a link for which no association is already established (a link not included in the already established ML setup).

In an implicit indication method, whether a per-STA profile subelement includes a complete profile may be utilized. More specifically, when a specific per-STA profile subelement included in a reconfiguration multi-link element includes a complete profile for a corresponding non-AP STA (that is, when a complete profile subfield is configured as 1), it is possible to indicate/interpret that a new association is requested for a link indicated by the specific per-STA profile subelement. On the other hand, when a specific per-STA profile subelement included in a reconfiguration multi-link element does not include a complete profile for a corresponding non-AP STA (that is, when a complete profile subfield is configured as 0), it is possible to indicate/interpret that releasing of the already established association is requested for a link indicated by the specific per-STA profile subelement.

In another implicit indication method, whether a link indicated by a per-STA profile subelement is a link for which an association is already established. More specifically, when a link indicated by a specific per-STA profile subelement included in a reconfiguration multi-link element indicates a link for which there is no existing association established, it is possible to indicate/interpret that a new association is requested for a link indicated by the specific per-STA profile subelement. On the other hand, when a link indicated by a specific per-STA profile subelement included in a reconfiguration multi-link element indicates a link for which there is an existing association established, it is possible to indicate/interpret that releasing of the already established association is requested for a link indicated by the specific per-STA profile subelement.

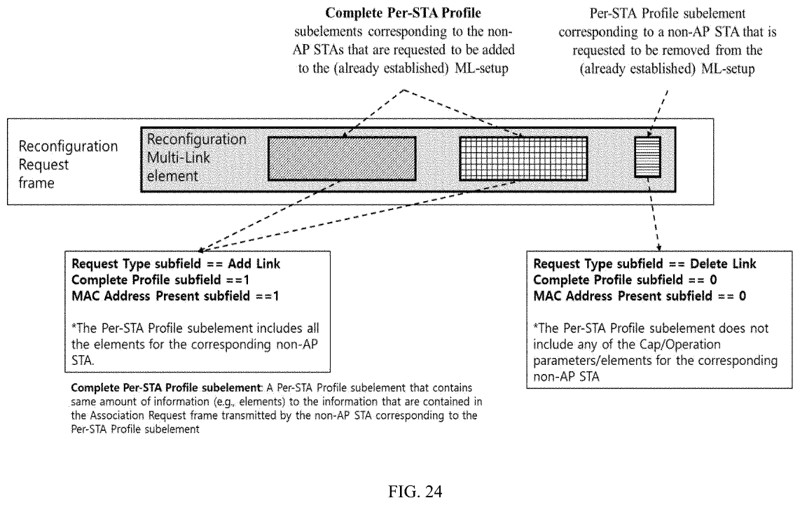

FIG. 24 illustrates an embodiment of a reconfiguration multi-link element included in a reconfiguration request frame according to an embodiment of the present disclosure.

Referring to FIG. 24, a reconfiguration multi-link element included in a reconfiguration request frame includes two complete per-STA profiles and one per-STA profile subelement. The complete per-STA profiles for non-AP STAs corresponding to links, respectively, requested to be added to ML setup, include complete information for the respective corresponding non-AP STAs, and the per-STA profile subelement for the non-AP STA of the link requested to be deleted from ML setup (that is, the link for which releasing of an established association is requested) does not include cap/operation information for the corresponding non-AP STA.

Each of the complete per-STA profiles corresponding to the non-AP STAs of the links requested to be added to the ML setup includes information (link indication or link indicator) on the link to be associated by the corresponding STA, and a request type subfield is configured with a value meaning “Add Link” to indicate that it is desired to be “associated” to each link.

It is described above that when an MLD performing a multi-link setup with another MLD transmits a management frame, an element configured with the same value as that for a reporting STA (an STA for transmitting the management frame) may not be included in a complete per-STA profile subelement of a reported STA, the complete per-STA profile subelement being included in a multi-link element, and an inheritance mechanism, in which it is considered that the unincluded element is indicated, to the reported STA, with the same value as that for an element for the reporting STA, is applied.

A reconfiguration multi-link element transmitted for the purpose of adding a new association to multiple links may include multiple complete per-STA profile subelements for STAs of the multiple links, and accordingly, the application of the inheritance mechanism may be considered.

However, the above-described inheritance mechanism is not applicable to a per-STA profile included in a reconfiguration req/resp frame since the mechanism is a method of inheriting the element (see FIG. 20) for the reporting STA for transmitting the probe response/association request/association response frame in the complete per-STA profile included in the (basic) multi-link element. This is because the element (complete information for the reporting STA) for the reporting STA (AP STA or non-AP STA) for transmitting the corresponding frame is not included in the reconfiguration request/response frame.

That is, the (complete) per-STA profile subelements of the multi-link element included in the probe resp/association req/association resp can inherit the element indicated for the reporting STA, but the (complete) per-STA profile subelement of the multi-link element included in the reconfiguration req/resp frame cannot inherit the element of the reporting STA.

### <Inheritance Method for Reconfiguration Multi-Link Element>

All inheritance-related mechanisms described below is applied to a per-STA profile subelement having a complete profile subfield indicated as 1. In addition, the description below is made mainly for a per-STA profile subelement and a reconfiguration multi-link element included in a reconfiguration request frame, but the same/similar method is also applicable to a reconfiguration response frame transmitted by an AP MLD. For example, a method of applying inheritance between per-STA profile subelements of the reconfiguration multi-link element included in the reconfiguration request frame is applicable the same for per-STA profile subelements of a basic (or reconfiguration) multi-link element included in a reconfiguration response frame.

The above-described inheritance rule applied in the process of configuring an initial link between MLDs (non-AP MLD and AP MLD) including multiple STAs is also applicable to a procedure of reconfiguring a link. However, in a case of the above-described process of initially setting up a link, a link of a reporting STA is also initially set up, and thus information on the reporting STA is inherited to the reporting STAs (that is, information (or element or parameter) of the reported STA having the same value as that of information (or element or parameter) of the reporting STA is omitted), but in the process of reconfiguring a link, the information of the reporting STA cannot be inherited since the link of the reporting STA is already configured. Accordingly, in this case, the inheritance rule between the reported STAs is applicable.

Specifically, an MLD (non-AP MLD or AP MLD) including multiple STAs may transmit a reconfiguration request frame for reconfiguration of a link, through a link configured on the basis of a link setup procedure.

In this case, the reconfiguration request frame may be used not only for the configuration of the link but also for releasing of the configured link and addition of a new link. When the reconfiguration request frame is used for addition of a link, an element and/or a parameter of an STA corresponding to the added link may be included in a per-STA profile subelement included in a multi-link element of a configuration request message and transmitted. The added link may be a link corresponding to an STA included in the same MLD.

When one or more new links are added, the reconfiguration request frame may include a multi-link element, and the multi-link element may include a type subfield for indicating the format of the multi-link element, and one or more per-STA profile elements including information on one or more STAs corresponding to one or more added links. The per-STA profile element may include an element and/or parameter of the corresponding STA. The type subfield may have different format of the multi-link element according to the variant. For example, the format of the multi-link element by the variant according to the value of the type filed may be as follows.

TABLE 1

| Type | | |
|---|---|---|
| subfield | Multi-Link element | |
| value | variant name | Variant specific format |
| 0 | Basic | Basic Multi-Link element |
| 1 | Probe Request | Probe Request Multi-Link element |
| 2 | Reconfiguration | Reconfiguration Multi-Link element |
| 3 | TDLS | TDLS Multi-Link element |
| 4 | Priority Access | EPC |
| 5-7 | Reserved | |

A value of a type field of a multi-link element included in a reconfiguration request frame may be “2′, and in this case, a value of the format of the multi-link element may be a reconfiguration multi-link element. However, when the multi-link element is included in a reconfiguration response frame transmitted as a response to the reconfiguration request frame, the value of the type subfield may be “0”, and in this case, the format of the multi-link element may be “basic multi-link element”.

Each of the multiple per-STA profile subelements included in the multi-link element may further include a complete profile subfield, and an inheritance rule is applicable between per-STA profile subelements each having a value of the complete profile subfield configured with a specific value (for example, “1”).

An inheritance rule between multiple per-STA profile subelements included in a multi-link element for addition of a link may be different from an inheritance rule applied in an initial setup process of a link. Specifically, according to the inheritance rule in the initial setup process of the link, information on a reporting STA is inherited to reported STAs, but the inheritance rule in the process of reconfiguring the link is applicable only between STAs corresponding to links to be added since the link of the reporting STA is already configured. That is, when there is one link to be added, the inheritance rule is not applied. However, when there are two links to be added, the multi-link element included in the reconfiguration request frame may include per-STA profile subelements corresponding to two or more STAs corresponding to two or more links to be added, respectively. In this case, two or more per-STA profile subelements may be included according to corresponding STAs, and the inheritance rule is applicable between the per-STA profile subelements.

The inheritance rule between the per-STA profile subelements is applicable so that at least one element including the same element ID and the same element value as at least one element included in a specific per-STA profile subelement among two or more per-STA profile subelements is not included in the other per-STA profile subelements. That is, the other per-STA profile subelements may include only at least one element remaining after excluding an element having the same element ID and the same element value as the element included in the specific per-STA profile subelement. In this case, the excluded element may be considered to be included in the other per-STA profile subelements. That is, the element included in the specific per-STA profile subelement corresponding to the excluded (omitted) element is applicable to an STA corresponding to the other per-STA profile subelements.

Each of the per-STA profile subelements may include a non-inheritance element, and the non-inheritance element may indicate a list of elements to which the inheritance rule is not applicable. Accordingly, the inheritance rule is not applicable to the element indicated by the non-inheritance element, and the element indicated by the non-inheritance element may be included in the per-STA profile subelement.

In addition, when an element having the same element ID as an element of a specific per-STA profile subelement is included in another per-STA profile subelement, it is considered that the inheritance rule is not applied to the corresponding element.

A specific per-STA profile subelement for application of the inheritance rule may be the first per-STA profile subelement among multiple per-STA profile subelements included in the multi-link element.

The inheritance is applicable to not only the request frame but also the response frame transmitted as a response to the request frame.

According to an embodiment of the present disclosure, when two or more per-STA profile subelements (including complete information for each of different non-AP STAs) for two or more non-AP STAs are included in a reconfiguration multi-link element, an inheritance mechanism is applicable between the per-STA profile subelements. More specifically, at least one parameter/element among parameters/elements included in a (complete) per-STA profile subelement shown first in order within the reconfiguration multi-link element may be inherited to a (complete) per-STA profile subelement shown later in order. In addition, the reconfiguration response frame transmitted by the AP MLD may include a basic multi-link element rather than the reconfiguration multi-link element, and the inheritance method to be described below is also applicable to the (complete) per-STA profile subelement included in the reconfiguration response frame.

For example, in a case where a first per-STA profile subelement and a second per-STA profile subelement are sequentially included in a reconfiguration (or basic) multi-link element, when a specific element included in the first per-STA profile subelement is not included in the second per-STA profile subelement, it may be indicated/interpreted that the same specific element is also indicated in the second per-STA profile subelement. That is, it may be considered (i.e., inherited) that information on an element not indicated in the second per-STA profile subelement is indicated to have the same value as the same element (i.e., having the same element ID and extended element ID) of the first per-STA profile subelement that has been first indicated. In this case, when a specific element is indicated through a non-inheritance element included in the second per-STA profile subelement, a specific element included in the first per-STA profile subelement is not considered (inherited) to be indicated in the second per-STA profile subelement.

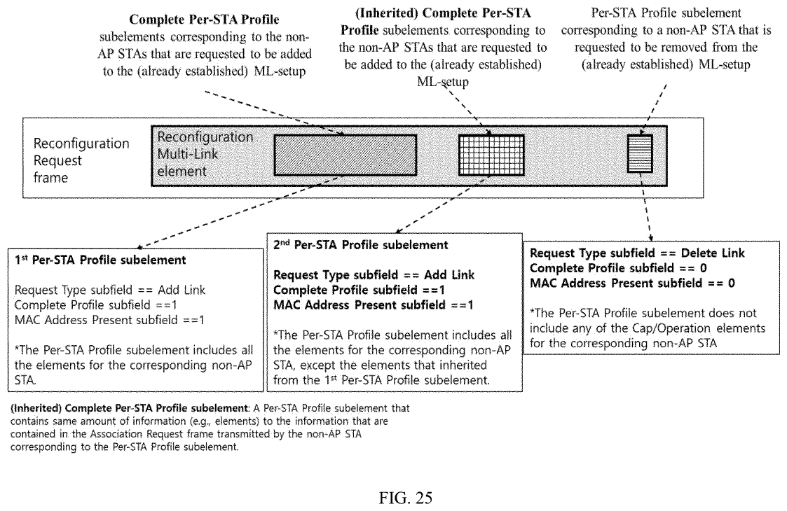

FIG. 25 illustrates an example of a case where an inheritance rule is applied between pieces of information of STAs included in a reconfiguration multi-link element according to an embodiment of the present disclosure.

Hereinafter, a description identical/similar to that made in FIG. 24 is omitted, but is applicable to this embodiment. Referring to FIG. 25, a reconfiguration multi-link element included in a reconfiguration request frame includes two (inherited) complete per-STA profiles and one per-STA profile subelement. Each of the (inherited) complete per-STA profiles corresponding to a non-AP STA of each link requested to be added to ML setup includes complete information for each corresponding non-AP STA. In this case, the first complete per-STA profile subelement includes all complete information, but the second (inherited) complete per-STA profile subelement does not include some elements. It is considered (indicated/interpreted) that a specific element not included in the second (inherited) complete per-STA profile subelement is indicated by the same value as the same element (the element having the same element ID and extended element ID as the specific element) included in the first complete per-STA profile subelement. Consequently, the second complete per-STA profile subelement includes the same level of information as the first complete per-STA profile subelement, but inheritance is applied to some elements, and thus the second complete per-STA profile subelement has a smaller size than that of the first complete per-STA profile subelement.

According to another embodiment of the present disclosure, an element of a reporting STA (AP STA or non-AP STA) for transmitting a reconfiguration request/response frame may be inherited to the (complete) per-STA profile subelement included in the frame. In this case, the reporting STA means the STA having transmitted the corresponding frame.

However, in this case, the inherited element of the reporting STA may be an element of a reporting STA, which has been already exchanged between two MLDs in the previous ML setup procedure (probe req/resp, (re) association req/resp, reconfiguration req/resp, etc.), instead of being included in the corresponding reconfiguration request/response frame. More specifically, since the non-AP MLD and the AP MLD for exchanging the reconfiguration request frame and the reconfiguration response frame from each other have already performed ML setup, the information (element/parameter, etc.) having been exchanged in the previously performed ML setup may be inherited to the reconfiguration process and utilized. That is, a specific element not indicated in the complete per-STA profile subelement (having the complete profile subfield configured as 1) included in the reconfiguration request/response frame may be indicated/interpreted to have the same value as the specific element of the reporting STA transmitting the reconfiguration request/response frame. That is, the information of the specific element of the reporting STA may be inherited to the information on the specific element not included in the complete per-STA profile subelement included in the reconfiguration request/reconfiguration response frame. In this case, the information on the specific element, which is to be inherited, means the information most recently indicated/configured of the reporting STA. That is, the most recently indicated value of the specific element corresponding to the reporting STA is inherited.

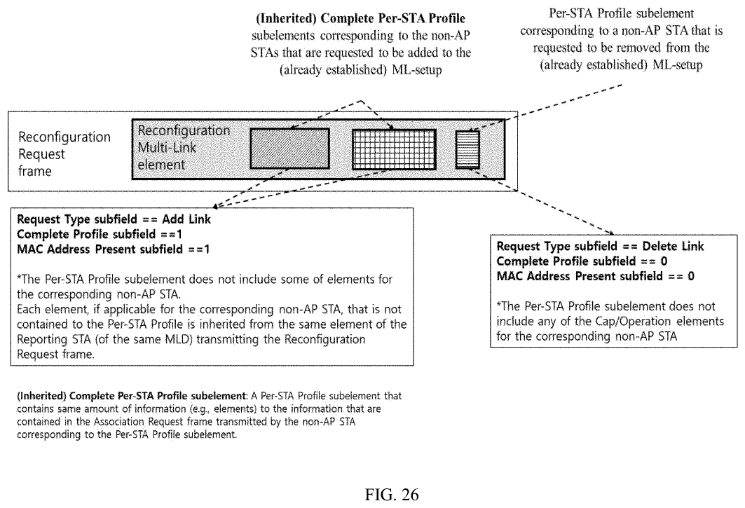

FIG. 26 illustrates an example of a case in which information on a reporting STA, included in a reconfiguration multi-link element, is inherited to information on reported STAs according to an embodiment of the present disclosure.

Hereinafter, a description identical/similar to those made in FIGS. 24 and 25 is omitted, but is applicable to this embodiment. Referring to FIG. 26, a reconfiguration multi-link element included in a reconfiguration request frame includes two (inherited) complete per-STA profiles and one per-STA profile subelement. Each of the (inherited) complete per-STA profiles corresponding to a non-AP STA of each link requested to be added to ML setup includes complete information for each corresponding non-AP STA. In this case, each of the (inherited) complete per-STA profile subelements does not include some elements. In this case, it is considered (indicated/interpreted) that a specific element not included in the (inherited) complete per-STA profile subelement is indicated by the same value as the same element (the element having the same element ID and extended element ID as the specific element) of the STA transmitting the reconfiguration request frame. In this case, information related to the specific element of the reporting STA has been already exchanged between the AP MLD and the non-AP MLD, the information is indicated/interpreted without being separately included in the corresponding reconfiguration request frame. If the specific element for the reporting STA has been exchanged more than one time, the lastly exchanged information of the specific element is inherited to each per-STA profile subfield of the reconfiguration multi-link element.

According to another embodiment of the present disclosure, an element for an STA (AP STA or non-AP STA) of another link for which association has been already established may be inherited to the (complete) per-STA profile subelement included in the reconfiguration request/response frame. In this case, the link for which the association has been already established means a link in which another STA belonging to the same MLD as the STA (AP or non-AP) for transmitting the reconfiguration req/resp frame operates.

That is, the complete information for STAs of the link for which new association is established as a result of exchange of reconfiguration req/resp frame may be indicated/interpreted in a scheme of inheriting information on STAs of another link for which association has been already established. For example, the reconfiguration request frame transmitted by the non-AP MLD may include a link indicator indicating a link subject to inheritance. In this case, the link indicator indicates only an ID of another link for which association with the AP MLD has been already established. When a specific element is not included in a specific (complete) per-STA profile subelement included in the corresponding reconfiguration request frame, a value of the specific element of an STA operating in the link indicated by the link indicator is inherited by the specific (complete) per-STA profile subelement. That is, the specific element of the STA operating in the link indicated by the link indicator may be considered (indicated/interpreted) the same as that included in the (complete) per-STA profile subelement. Similarly, the reconfiguration response frame transmitted by the AP MLD may include a link indicator indicating a link subject to inheritance. In this case, the link indicator indicates only an ID of another link for which association with the non-AP MLD has been already established. When a specific element is not included in a specific (complete) per-STA profile subelement included in the corresponding reconfiguration response frame, a value of the specific element of the AP operating in the link indicated by the link indicator is inherited by the specific (complete) per-STA profile subelement. That is, the specific element of the AP operating in the link indicated by the link indicator may be considered (indicated/interpreted) the same as that included in the (complete) per-STA profile subelement. However, when the AP MLD determines the link subject to inheritance in the reconfiguration response frame, the same link as the link subject to inheritance, indicated by the reconfiguration request frame received from the non-AP MLD, may need to be selected. That is, if the reconfiguration request frame received from the non-AP MLD has indicated/utilized a specific link as a link subject to inheritance, the AP MLD may need to determine the link subject to inheritance as the specific link when responding with the reconfiguration response frame for the request frame. That is, in a situation in which such a rule is applied, even though no separate heritance link indicator is included in the reconfiguration response frame transmitted by the AP MLD as a response, it may be implicitly indicated/interpreted that the same link as that for the reconfiguration request frame is indicated.

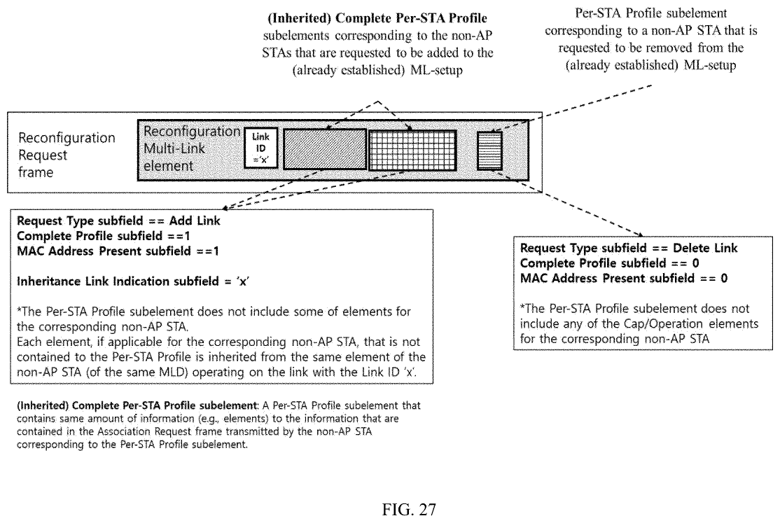

FIG. 27 illustrates an example of a case in which information on an STA for a link reconfigured by a reconfiguration multi-link element is inherited to information on another STA of another reconfigured link according to an embodiment of the present disclosure.

Hereinafter, a description identical/similar to those made in FIGS. 24 to 26 is omitted, but is applicable to this embodiment.

Referring to FIG. 27, a reconfiguration multi-link element included in a reconfiguration request frame includes two (inherited) complete per-STA profile and one per-STA profile subelement. Each of the (inherited) complete per-STA profiles corresponding to a non-AP STA of each link requested to be added to ML setup includes complete information of each corresponding non-AP STA. In this case, each of the (inherited) complete per-STA profile subelements does not include some elements. In this case, it may be considered (indicated/interpreted) that a specific element not included in the (inherited) complete per-STA profile subelement is indicated by the same value as the same element (an element having the same element ID and extended element ID as the specific element) of an STA (belonging to the same MLD) operating in link “x” subject to inheritance, indicated by the reconfiguration request frame. In this case, “x” is one of IDs of links for which an association is already made between the AP MLD and the non-AP MLD. Information related to the specific element of the STA operating in link “x” subject to inheritance has been already between the AP MLD and the non-AP MLD, and thus the information is indicated/interpreted without being separately included in the corresponding reconfiguration request frame. If the specific element for the STA operating in link “x” subject to inheritance is exchanged more than one time, the lastly exchanged information of the specific element is inherited in the per-STA profile subfield of the reconfiguration multi-link element.

In addition, an additional element for inheritance may be included in the reconfiguration request/response frame, in addition to the (complete) per-STA profile subelement of the link for which association is requested. More specifically, an additional element commonly inherited to one or more per-STA profile subelements may be included in the reconfiguration request/response frame. In this case, the additional element is not included in the per-STA profile subelement, but is a separate element indicated for inheritance, rather than an element corresponding to a reporting STA for transmitting the corresponding reconfiguration frame. In this case, if a specific element included in the reconfiguration req/resp frame (not included in the per-STA profile) is not included in a first per-STA profile subelement, it may be interpreted that the specific element is inherited to the first per-STA profile. If the specific element is neither included in a second per-STA profile subelement, it is interpreted that the specific element is also inherited in the second per-STA profile subelement. In this case, the element indicated for inheritance may be included within the reconfiguration multi-link element (but outside the per-STA profile subfield), or included outside the reconfiguration multi-link element.

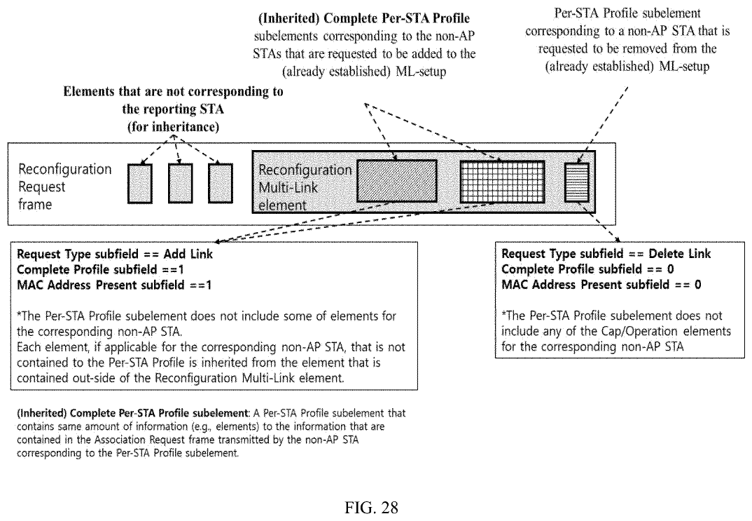

FIG. 28 illustrates an example of a case where an element positioned outside a reconfiguration multi-link element included in a reconfiguration request frame is inherited to information of other STAs according to an embodiment of the prevent invention.

Hereinafter, a description identical/similar to those made in FIGS. 24 to 27 is omitted, but is applicable to this embodiment.

Referring to FIG. 28, a reconfiguration multi-link element included in a reconfiguration request frame includes two (inherited) complete per-STA profiles and one per-STA profile subelement. In addition, the reconfiguration request frame includes, outside the multi-link element, additional elements which can be inherited by each per-STA profile subelement.

Each of the (inherited) complete per-STA profiles corresponding to a non-AP STA of each link requested to be added to ML setup includes complete information of each corresponding non-AP STA. In this case, each of the (inherited) complete per-STA profile subelements does not includes some elements. In this case, it is considered (indicated/interpreted) that a specific element not included in the (inherited) complete per-STA profile subelement is indicated by the same value as the same element (an element having the same element ID and extended element ID as the specific element) indicated outside the reconfiguration multi-link element. That is, the specific element indicated outside the reconfiguration multi-link element may be inherited to each of the two (inherited) complete per-STA profile subelements, and the overhead of the reconfiguration request frame is reduced.

### <Reconfiguration Procedure Proceeding Method and Restriction>

A non-AP MLD for adding a new link (to the existing ML setup) in 2.4 GHz and 5 Ghz through a reconfiguration procedure may include, in a reconfiguration req/response frame transmitted through an STA (i.e., STA 6G) operating in a 6 GHz band, an HT/VHT cap/operation element. In this case, the HT/VHT cap/operation element is included in a per-STA profile subelement corresponding to an STA operating in 2.4 GHz and 5 GHz and transmitted. In this case, the per-STA profile subelement which can include the HT/VHT cap/operation element may be limited to a per-STA profile subelement including complete information. That is, the reconfiguration procedure is a procedure in which an STA (an AP STA of an AP MLD and a non-AP STA of a non-AP MLD) operating in 6 GHz transmits an HT/VHT cap/operation element.

The AP MLD may need to always accept a link deletion request (delete link) of a non-AP MLD, requested through the configuration procedure. This may be a natural operation in consideration the existing association state in which releasing of association between two devices can be established through determination by only one device between the two deices. That is, when the non-AP MLD has requested to delete a specific link, there is no reason for the AP MLD to refuse to release the association in the specific link, and the request may be a request which needs to be naturally accepted. Accordingly, when the non-AP MLD transmits a reconfiguration request frame and request only association releasing (delete link) for a link for which the association has been already established, the AP MLD may not include, in a reconfiguration response frame, a per-STA profile subelement corresponding to the link for which the association releasing is requested. That is, the AP MLD may include, in the reconfiguration response frame, only a per-STA profile subelement corresponding to a link performing a new association (including complete info of an AP operating in the link), and may not include a per-STA profile subelement corresponding to a link, the association of which is released.

When the per-STA profile subelement of the link for which association releasing is requested is not included in the reconfiguration response frame received from the AP MLD, the non-AP MLD may interpret that the association releasing has been accepted. Moreover, when the non-AP MLD transmits a reconfiguration request frame and requests only association releasing (delete link) for a link for which the association has been already established, the AP MLD may response with an ack or block ack frame rather than the reconfiguration response frame. In this case, the non-AP MLD having received a response of the ack/block ack frame from the AP MLD may interpret that the association releasing of the link, requested by the non-AP MLD itself, has been accepted.

In addition, the AP MLD may need to respond with a reconfiguration response frame through a link through which the reconfiguration request frame is received. This may be a reconfiguration response frame response link restriction of the AP MLD to allow the non-AP MLD having transmitted the reconfiguration request frame to receive the response frame in a predictable link.

That is, the AP MLD may transmit the reconfiguration response frame through the same link as a link through which the reconfiguration request frame is received.

When the non-AP MLD has purpose of requesting association releasing for a specific link by transmitting a reconfiguration request frame to the AP MLD, the non-AP MLD is not allowed to transmit the reconfiguration request frame in the specific link subject to association releasing. That is, the non-AP MLD may need to transmit the reconfiguration request frame through an STA of a link, the association of which is not released (the association state of which is not changed) through the reconfiguration procedure. This may be a reconfiguration request frame transmission link restriction for the non-AP MLD to enable an STA of the non-AP MLD subject to association releasing to be switched to a power-off state as soon as possible.

In other words, after the non-AP MLD sets up one or more links through link setup with the AP MLD, the non-AP MLD or the AP MLD may reconfigure the one or more links that have been set up. In this case, the non-AP MLD or the AP MLD may transmit a link reconfiguration request frame requesting reconfiguration of the one or more links that have been set up, and may receive a link reconfiguration response frame in response thereto. If a link reconfiguration request frame is transmitted to request the disconnection or deletion of links that have been set up, and if two or more links are set up and some of the links are to be disconnected or deleted, the link reconfiguration request frame is not transmitted on the links that are disconnected or deleted. That is, the link reconfiguration request frame may be transmitted on a link that is not disconnected or deleted. However, if one link is set up, a link reconfiguration request frame may be transmitted on a link that is disconnected or deleted. Also, a link reconfiguration response frame may be transmitted only on a link on which a link reconfiguration request frame was transmitted.

In other words, when the non-AP MLD has only one setup link, the non-AP MLD may transmit a link reconfiguration request frame on a link to be removed. In this case, the non-AP MLD may transmit the frame for the purpose of deleting the link to be removed and simultaneously requesting the addition of another link.

That is, the non-AP MLD may use a link reconfiguration request frame to remove the setup of a link that is already in the setup state and request the setup of another link that is not already set up. In this case, the number of setup links of the non-AP MLD does not change after the link removal/addition requested in the link reconfiguration request frame.

Thus, in a state in which the non-AP MLD has only one setup link, it is possible to switch the one setup link to another link by transmitting a link reconfiguration frame. (That is, one of multiple links on which the AP MLD operates APs is set up, and the link that has been set up is switched to one link.) In this case, a link reconfiguration request frame transmitted by the non-AP MLD on a specific link indicates the removal of the specific link, but may exceptionally be transmitted on the specific link. In this case, the non-AP MLD removes the specific link after receiving a link reset response frame on the specific link, and transitions to the setup state on another link that the non-AP MLD requested to add.

### <Conflicted Information Management Method>

Information indicated through a reconfiguration request frame transmitted by a non-AP MLD may be conflicted with information that an AP MLD already holds. In this case, the AP MLD may need to interpret that the information already held is updated by the information indicated through the reconfiguration request frame.

For example, the AP MLD may recognize that a first link and a second link of a specific AP MLD, which are multi-link associated, are an STR link pair. This may be meaningless information for a link pair including the second link, in which the second link is a link not included in the previously performed multi-link setup and a relationship between the indicated first link and second link does not exist. However, it may be indicated that the reconfiguration request frame received by the non-AP MLD is for request for addition of an association for a second link and a relationship between a first link and the second link indicated in the per-STA profile subelement for an STA operating in the second link is an NSTR link pair. In this case, the AP MLD needs to determine reliable information from among the previously acquired information indicating that the first link and the second link are an STR link pair and newly acquired information indicating that the first link and the second link are an NSTR link pair. According to an embodiment of the prevent invention, when the information received through the reconfiguration procedure is not matched to the previously acquired information, the AP MLD and the non-AP MLD need to perform an operation of determining that the information received through the reconfiguration procedure is correct. That is, in the example above, the AP MLD needs to consider that the first link of the non-AP MLD and the second link to be newly added are an NSTR link pair.

Additional elements or fields may be included in the reconfiguration request/response frame, rather than the per-STA profile subelement. An example of the included element/field may include a TID-to-link mapping element and an EML control field. In this case, the elements and fields included in the reconfiguration req/response frame need to be configured in consideration of the multi-link association state after completion of the reconfiguration procedure. For example, when the ML setup state after completion of the reconfiguration procedure is the state in which the AP MLD and the non-AP MLD are associated with each other through a first link and a second link, the TID-to-link mapping needs to be configured so that TID is amped only to the first link and the second link. Similarly, the EML control field needs to indicate that only the first link and the second links are links to which an EMLSR/EMLMR mode is applied.

When it is determined that an ML setup state between two MLDs after the reconfiguration procedure is an associated state through only a single link, the non-AP MLD/AP MLD for transmitting the reconfiguration request frame/reconfiguration response frame is not allowed to include the TID-to-link mapping element in the reconfiguration req/resp frame. Similarly, when it is determined that only one link is in the associated state after the reconfiguration procedure, the EML control field is neither allowed to be included in the reconfiguration req/resp frame. That is, the non-AP MLD may include the TID-to-link mapping element or the EML control field in the reconfiguration request frame only when an ML setup state to be changed by the reconfiguration request frame transmitted by the non-AP MLD itself is the state in which the non-AP MLD is associated with the AP MLD through two or more links.

For better understanding, the characteristics of the EML control field and the TID-to-link mapping element are simply described.

An EML control field is a field including whether EMLSR and EMLMR modes is activated and information on a link to which the EMLSR and EMLMR modes are applied. The EMLSR and EMLMR modes are operation modes in which an MLD supports more enhanced capability one of two or more links operating in the EMLSR/EMLSR mode at a specific time point. The links operating in the EMLSR mode support only reception of a specific format of frame and CCA, but supports frame exchange of enhanced capability for a link in which a promised frame (initial control frame) is received. That is, a non-AP MLD is associated with the AP MLD through more links than the number of links for which the non-AP MLD can support enhanced capability, and then operates a specific link set in the EMLSR mode, thereby supporting enhanced capability only for one link at one moment for links operating in the EMLSR mode. Accordingly, when operating the EMLSR mode, the non-AP MLD indicates two or more links as EMLSR mode operating links. The EMLSR mode also has similar characteristics to the EMLSR mode and is a mode in which two or more links need to be indicated, and thus a detailed description is omitted.

TID-to-link mapping is a negotiation performed between two MLDs having performed multi-link setup, and is a method of determining the type of traffic to be transmitted/received through each link associated through the multi-link setup. For a simple example, if the non-AP MLD performs mapping between a first link and TID 0 to TID 3 and mapping between a second link and TID 4 to TID 7 for a direction in which a UL PPDU is transmitted by the non-AP MLD itself, the non-AP MLD performs transmission only through the first link when transmitting a frame having a TID corresponding to 0. That is, a TID-to-link mapping element is an element including TID-to-link mapping information indicating a correspondence relationship between each TID and link. If a specific TID is not mapped to any link among links associated between two MLDs, a frame having the specific TID cannot be transmitted in any link. Accordingly, the state in which all TIDs are mapped to one link needs to be maintained between two MLDs associated through the one link. In this case, the state in which all TIDs are mapped to one link is a basic TID-to-link mapping state when there is only one setup link between two MLDs, and other types of TID-to-link mapping states are not allowed.

### <AP Addition/Deletion Procedure and Operation Restriction>

As described above, a non-AP MLD may perform a reconfiguration procedure to add/delete a setup link with an AP MLD. This means that the non-AP MLD can change an ML setup state as necessary, and accordingly, the number of operating non-AP STAs can be adjusted.

Similarly, the AP MLD may also perform a procedure of adjusting the number of APs operated by the AP MLD itself. That is, the AP MLD may perform a procedure for increasing or reducing the number of APs that the AP MLD itself is operating. In this case, the adjusting procedure in which the AP MLD adjusts the number of its affiliated APs may be referred to as an ML reconfiguration procedure.

When the AP MLD desires to add an AP, the AP MLD may indicate, through management frames transmitted by the existing APs, information (link number, operating channel information, etc.) on the added AP. The non-AP MLDs in the association state with the AP MLD may recognize, through the management frame received in the existing setup link, that the AP MLD has added a new AP, and may perform the above-operation such as transmitting a reconfiguration request frame to perform additional association with the new AP.

Similarly, the AP MLD may delete some of APs operated by the AP MLD itself in each link according to the operation purpose. This may be a selective operation according to the operation purpose of the AP MLD. However, when the AP MLD deletes some APs, the AP MLD may need to notify in advance not only non-AP STAs associated with the deleted APs but also non-AP MLDs having performed the ML setup by including the deleted AP of a plan for the AP MLD to delete the APs. This is because the operation of deleting some APs of the AP MLD causes amendment of various types of agreements (for example, TID-to-link mapping, TWT agreements, etc.) established between the AP MLD and the non-AP MLD and is a big change which means disassociation from the only associated AP in a case of the non-AP STA rather than the MLD. The AP MLD and the non-AP MLD having been set up through multiple links including links of the deleted APs are changed to the state in which the MLDs are associated only through a setup link remaining after excluding the link of the AP after the deletion of the AP. That is, when an AP of a link in which the non-AP MLD has performed the ML setup is deleted, the non-AP MLD needs to operate by recognizing that the link of the AP is no longer included in the link set in which the ML setup has been performed.

When the AP MLD has a plan to delete an AP operated in a specific link, the AP MLD needs to notify such a plan for a sufficiently long time to enable the associated non-AP STA and the associated non-AP MLDs to recognize the AP deletion plan in advance. In this case, the sufficiently long time means a period in which STAs operating in a power save mode may receive the notification at least one time.

As such, when the AP MLD has a plan to delete the AP, the AP MLD needs to notify the AP deletion plan in advance, and the operation of the AP MLD and the non-AP MLD during the notification period may be partially restricted in consideration of the AP deletion. More specifically, during a period in which it is notified that a specific AP is to be deleted, a negotiation including a link of the specific AP may be restricted. That is, during a period in which deletion of a specific AP among APs of the AP MLD is notified, an MLD desiring to perform a TID-to-link mapping negotiation is not allowed to request TID mapping from the link of the specific AP. That is, when the AP MLD includes reconfiguration-related information in a management frame to delete the AP, an MLD for transmitting the TID-to-link mapping request frame needs to request TID-to-link mapping corresponding to no mapping of a TID to a link of the deleted AP. In addition, an MLD for counter-proposing a preferred TID-to-link mapping state while refusing a requested TID-to-link mapping state is not allowed to propose, as TID-to-link mapping, mapping of a TID to a link which is to be deleted. That is, an MLD indicating a preferred TID-to-link mapping state needs to transmit a TID-to-link mapping element for requesting mapping of no TID to a link to be deleted.

In this case, if a specific TID is not indicated by the TID-to-link mapping element, the MLD having received the element needs to interpret that a mapping link proposed (requested) for the specific TID is a setup link remaining after excluding a link of the AP to be deleted.

In addition, if the AP MLD includes reconfiguration-related information in a management frame to delete an AP, the non-AP MLD is not allowed to request enabling an EMLSR/EMLMR mode in a link of an AP indicated to be deleted. That is, an EML operating mode notification frame for causing the non-AP STA operating in a link to be deleted to switch to an EMLSR/EMLMR mode is not to be transmitted. The EML operation mode notification frame is a frame transmitted by the non-AP MLD to change the EMLSR/EMLMR operation state, and includes whether to enable an EMLSR or EMLMR mode and a link indicator (bitmap) for applying the corresponding mode. Accordingly, the non-AP MLD having received the notification that an AP of a specific link is to be deleted by the AP MLD is not allowed to indicate the specific link through the link indicator included in the EML operating mode notification frame. That is, the EML operating mode notification frame having a bit corresponding to the specific link configured as 1 is not be transmitted.

The TID-to-link mapping negotiation and restriction on the EML operating mode change are provided as an example, and a similar restriction can be applied to other types of negotiations and notifications performed while the AP MLD notifies that the specific AP is planned to be deleted.

### <Method of Proposing/Accepting/Refusing (Counter-Proposing) TID-to-Link Mapping Negotiation>

A more detailed description is made on the above-described TID-to-link mapping negotiation. A TID-to-link mapping negotiation may be performed using a TID-to-link mapping element between MLDs. An initiating MLD may indicate TID-link mapping proposed (preferred) by the initiating MLD by utilizing a TID-to-link mapping element included in a request frame (TID-to-link mapping request frame or (re) association request frame). A responding MLD may receive a request frame from the initiating MLD, and then may determine whether to accept TID-link mapping indicated by the TID-to-link mapping element. To perform a TID-to-link mapping negotiation, the responding MLD and the initiating MLD may utilize a TID-to-link mapping request frame, a TID-to-link mapping response frame, a TID-to-link mapping teardown frame, etc.

The TID-to-link mapping req/resp/teardown frames may be frame formats corresponding a TID-to-link mapping action frame. That is, a value indicating a TID-to-link mapping action frame may be indicated in a category field of the action frame, and a value for distinguishing among the TID-to-link mapping request frame, the TID-to-link mapping response frame, and the TID-to-link mapping teardown frame may be indicated in action details field. For example, the TID-to-link mapping action frame may be indicated by a category value between 32 to 125 remaining to be reserved in 11ax. In this case (e.g., 32), the TID-to-link mapping req/resp/teardown frames may be indicated by 0, 1, and 2, respectively, in 1 octet immediately after the category field and distinguished. That is, when a value of the category field of the action frame is indicated as 32 and an octet immediately after the category field indicates 0 (0000 0000), the corresponding action frame may be a TID-to-link mapping request frame.

If the responding MLD refuses all or some of the TID-link mapping method proposed by the initiating MLD, the responding MLD responding by including a TID-to-link mapping element in a response frame (TID-to-link mapping response frame and (re) association response frame) to refuse the TID-link mapping proposed by the initiating MLD. That is, when the TID-to-link mapping element is included in the response frame and transmitted as a response, it may be understood that the TID-to-link mapping negotiation between the initiating MLD and the responding MLD has not be completed. In this case, a TID-to-link mapping info field included in the TID-to-link mapping element of the response frame may indicate TID-link mapping information counter-proposed to the initiating MLD by the responding MLD. For example, when the initiating MLD has proposed (indicated/requested) to map TID 0 to link 1 (through a request frame) and the responding MLD has indicated to map TID 0 to link 2 through a request frame, the initiating MLD may interpret that the responding MLD has (counter) proposed mapping of TID 0 to link 2.

In addition, the responding MLD may indicate (counter-propose) only a part of TID-link mapping among TID-link mapping proposed (requested) by the initiating MLD so as to accept a request (indicated (proposed) through a request frame) for mapping of a link to a TID remaining after excluding the indicated TID. In other words, the TID-link mapping of the initiating MLD for the TID not indicated by the responding MLD through a response frame may be understood to be accepted by the responding MLD. Accordingly, when link mapping to a specific TID is indicated by a TID-to-link mapping element of a request frame and then the specific TID is not indicated by a TID-to-link mapping element of a response frame, the initiating MLD needs to interpret that the link mapping request proposed for the specific TID has been accepted by the responding MLD.

As described above, the responding MLD may have a function of implicitly accepting the proposed TID-link mapping by not indicating information of some TIDs in the TID-to-link mapping element included in the response frame. In a similar method, the initiating MLD may also implicitly proposes a method of link mapping to some TIDs by not indicating information on some TIDs in the TID-to-link mapping element included in the request frame.

In this case, the implicit proposal may be proposal of mapping, to all links, a TID not indicated in the TID-to-link mapping element. That is, when the initiating MLD does not indicates a specific TID in the TID-to-link mapping element included in the request frame, the specific TID may be (implicitly) indicated/requested to be mapped to all links.

Alternatively, for a TID not indicated in the TID-to-link mapping element, the implicit proposal may be proposal for remaining the already negotiated link mapping state for the corresponding TID. That is, when the initiating MLD does not indicate a specific TID in the TID-to-link mapping element included in the request frame, it may be (implicitly) indicated/requested to the specific TID that the TID-link mapping state already established before transmission of the request frame including the corresponding TID-to-link mapping element is to be maintained.

That is, when TID-link mapping requested through the previously transmitted request frame is accepted for a specific TID, the initiating MLD may maintain the link mapping state already accepted for the specific TID, by not indicating information on the specific TID in the next transmitted request frame.

Alternatively, when there is a TID-to-link mapping mode (including a default TID-to-link mapping mode) which has been already negotiated and a change in the link mapping state for a specific TID is not desired, the initiating MLD may maintain the link mapping state for the specific TID by not indicating information on the specific TID in the request frame. In this case, the state in which there is a TID-to-link mapping mode which has been already negotiated may be the state in which a default TID-to-link mapping mode is applied between tow MLDs after association, or the state in which a TID-to-link mapping response frame most recently transmitted/received between MLDs does not include a TID-to-link mapping element.

If the responding MLD desires to accept all TID-link mapping (explicitly/implicitly) proposed by the initiating MLD, the responding MLD may respond with a TID-to-link mapping response frame not including the TID-to-link mapping element after receiving the TID-to-link mapping request frame from the initiating MLD. In other words, the responding MLD may accept the TID-to-link mapping indicated (proposed) by the initiating MLD by not performing TID-link mapping counter-proposing through the response frame. When receiving the TID-to-link mapping response frame not including the TID-to-link mapping element from the responding MLD, the initiating MLD may identify that the TID-to-link mapping negotiation has been completed. In addition, from the time point at which the TID-to-link mapping negotiation is completed, TID-link mapping accepted by the responding MLD may be applied.

When refusing the TID-to-link mapping state included in the association request frame transmitted by the non-AP MLD and requested, the AP MLD may respond by including the TID-to-link mapping element in the association response frame. In this case, the non-AP MLD having received the association response frame including the TID-to-link mapping element after transmitting the association request frame by including the TID-to-link mapping element in the association request frame needs to recognize that the TID-to-link mapping state requested by the non-AP MLD is refused by the AP and the TID-to-link mapping state included in the association response frame is a TID-to-link mapping state counter-proposed by the AP. In this case, the non-AP STA MLD may need to interpret the counter-proposed TID-to-link mapping state in consideration of the state of a link for which ML setup has been completed through the association response frame. More specifically, when link mapping information of a specific TID is not indicated in a TID-to-link mapping element included in an association response frame, the non-AP MLD may need to interpret that the AP has counter-proposed mapping of the specific TID to all links for which setup is performed (completed) through the association response frame. That is, a non-AP MLD having requested ML setup for three links through an association request frame including a TID-to-link mapping element and received acceptance of only setup for two links from an AP needs to interpret that the AP has counter-proposed mapping of a TID, which is not indicated in the TID-to-link mapping element included in an association response frame received from the AP, to two links for which the setup has been accepted.

### <Channel Switch of MLD and Reconfiguration Rules According Thereto>

In conventional Wi-Fi, an operating channel frequency of a BSS may be changed according to a procedure pre-agreed between an AP and a STA. In this case, the conventional Extended Channel Switching (ECS) operation may be utilized, or a channel switching mechanism newly defined in 11be may be utilized. When the AP determines to change the operating channel of the BSS, the AP may transmit a beacon frame, a probe response frame, an Extended Channel Switch Announcement frames, etc. to notify the same so that associated STAs can switch to a new channel or operating class while maintaining association. In this case, the AP transmits an (Extended) Channel Switch Announcement element through the beacon frame, and a Channel Switch Count field of the element indicates information about which numbered beacon frame will be transmitted before channel switching (operating channel switching) is performed. If the AP includes a MAX Channel Switch Time element in the beacon frame together with the extended Channel Switch Announcement element, the AP needs to transmit the first beacon frame within a Switch Time field (of the MAX Channel Switch Time element) on a new channel. That is, the beacon frame transmitted on the new channel needs to be transmitted with a time interval that is less than the time interval indicated by the last beacon frame transmitted on the current channel and the Switch Time field.

Referring to the above-described channel switching operation of the conventional Wi-Fi BSS, the AP of the BSS may use the beacon frame transmitted on the current channel to instruct the STA on information about a new channel (a new operating channel), information about the time at which channel switching is performed, and information related to a time point of a beacon frame first transmitted on the new channel. The STA of the BSS may move to a new channel in a predetermined time interval (a time interval indicated by the AP) on the basis of the channel switching-related information included in the beacon frame transmitted by the AP, thereby completing the channel switching while maintaining the association with the AP. Thus, the channel switching procedure of the conventional Wi-Fi BSS may be performed in a scheme in which information (a channel switch mode, a new operating class, a new channel number, a channel switch count, etc.) required for channel switching is provided through the beacon frame transmitted by the AP.

However, the AP MLD and the non-AP MLD may be connected via multiple links, and the non-AP MLD is permitted to receive only a beacon frame transmitted on a specific link among the multiple links as necessary. Therefore, in order to help the non-AP MLD receiving the beacon frame via the specific link to obtain information about channel switch performed on another link, the AP MLD may include an element related to the channel switch performed on the other link in the frame transmitted by the specific link and transmit the same. More specifically, when the AP MLD plans to change the operating channel of the BSS operating through an AP of a first link, the AP MLD transmits an (Extended) Channel Switch Announcement element related to a channel switch of the first link through a Management frame transmitted by an AP of a second link. In this case, the (Extended) Channel Switch Announcement Element is configured to be the same as an (Extended) Channel Switch Announcement element transmitted through the AP of the first link. In this case, the AP of the second link transmits the (Extended) Channel Switch Announcement element related to the channel switch of the first link through a Per-STA profile corresponding to a first AP included in the Management frame transmitted by the AP of the second link. Therefore, after receiving the Management frame transmitted by the AP of the second link, the non-AP MLD may check the Per-STA profile corresponding to the AP of the first link to obtain information about a time point of initiating the channel switch of the BSS of the first link and about the new operating channel/class.

As described above, the operating channel of the BSS operated by the AP may be switched through a channel switch procedure performed via the (Extended) Channel Switch announcement element, and when the channel switch is completed, the STAs of the BSS will operate on a different channel than before.

In a non-AP MLD that has performed a multi-link setup with an AP MLD, when a channel switch is performed by an AP operating on one of multiple setup links, an operating channel of a BSS operated by the AP and an operating channel of another BSS (a BSS operated by an AP on another link on which a multi-link setup has been performed) may overlap. That is, as a result of the channel switch performed by the AP in the AP MLD, operating channels of multiple links in which a multi-link setup has been performed may overlap each other. In this case, STAs of BSSs operated in the overlapping operating channels may be significantly affected by each other's operations. For example, when an AP and an STA of a specific BSS perform transmission, APs and STAs of other BSSs having operating channels overlapping those of the specific BSS may not perform channel access. This implies that the rule that when requesting/accepting a Multi-Link setup (transmitting Association Request and Association Response frames), an AP MLD and a non-AP MLD performing the Multi-Link setup should manage, together, operating channels of links of which the setup is requested/accepted so that the operating channels do not overlap each other may be broken as a result of channel switching.

Therefore, when performing a channel switch (operating channel switching) of a BSS operated on a specific link, the AP MLD and non-AP MLD should manage to ensure that operating channels of multiple links on which the multi-link setup has been performed do not overlap each other as a result of the channel switch.

In this case, overlap of operating channels of two links implies that some or all of BSS operating channels of APs operating on the two links are identical (partially overlap or fully overlap).

Specifically, when, after each of multiple APs in an AP MLD has set up a link with each of multiple non-AP MLDs, a specific AP desires to switch an operating channel for a linked non-AP MLD, the specific AP should select a channel, which does not overlap (in whole or in part) with an operating channel for another AP in the AP MLD and another non-AP MLD, as an operating channel to be switched.

That is, when an AP MLD selects a new operating channel in order to switch an operating channel of each AP, constraints on the operating channel selected may be applied. Specifically, when an AP MLD intends to switch an operating channel of a BSS operated by one of multiple APs that the AP MLD operates, the AP MLD may need to configure (select) a new operating channel such that the new operating channel does not overlap with an operating channel of another AP. For example, when an AP MLD is operating an AP on a first link and an AP on a second link, it may be necessary to ensure that a new operating channel of a BSS operated by the AP on the first link does not overlap with an operating channel of a BSS operated by the AP on the second link. However, when there is no non-AP MLD which is connected via both the first link and the second link (which is in a multi-link setup via the first link and the second link) among non-AP MLDs associated with an AP MLD, the AP MLD may not consider whether the new operating channel of the BSS operated by the AP of the first link overlaps the operating channel of the BSS operated by the AP of the second link when selecting the new operating channel.

Specifically, an AP MLD and a non-AP MLD may set up at least one link. In this case, when an AP constituting the AP MLD intends to switch an operating channel of a link for a non-AP STA constituting the non-AP MLD, the AP should select an operating channel to switch from among channels that do not overlap an operating channel of link(s) for other non-AP STA(s) constituting the non-AP MLD (a first condition) and do not overlap an operating channel of another non-AP MLD which sets up multiple links with the AP MLD (a second condition).

That is, when an AP constituting the AP MLD intends to switch an operating channel of a link for a non-AP STA constituting a non-AP MLD may select an operating channel by selecting one channel from among the channels that satisfy the first condition and the second condition.

For example, multiple links may be set up between an AP MLD, which includes AP 1, AP 2, and AP 3, and a non-AP MLD, which includes non-AP SAT 1, and non-AP STA 2. In this case, link 1 may be set up between AP 1 and non-AP STA 1, and link 2 may be set up between AP 2 and non-AP STA 2. In this case, when AP 1 intends to switch an operating channel for link 1 of non-AP STA 1, the operating channel may be switched to a channel selected from among channel(s) that do not overlap an operating channel for link 2 of non-AP STA 2 (condition 1) and channel(s) that do not overlap operating channel(s) of one or more other non-AP MLDs that have set up multiple links with the AP MLD.

In summary, an AP MLD may ensure that when selecting a new operating channel of a BSS operated through an AP on a specific link, the new operating channel does not overlap an operating channel of a BSS operated through an AP on another link. However, if there is no non-AP MLD connected through both the specific link and the other link, the AP MLD may not consider, when selecting the new operating channel of the specific link, whether the new operating channel overlaps the operating channel of the BSS operated by the AP on the other link.

Therefore, when configuring an (Extended) Channel Switch Announcement element for a specific link, the AP MLD should not configure, as new channel, an operating channel that overlaps an operating channel of another link. That is, when configuring a New Channel Number (which is included in an (Extended) Channel Switch Announcement element) for a specific link, a channel number of another link should not be indicated.

That is, when an AP constituting an AP MLD intends to switch an operating channel, the AP MLD should select a new operating channel that does not overlap operating channels of other non-AP MLDs associated with the AP MLD. In this case, the other non-AP MLDs may have multiple links that have been set up.

As another method, a method for removing links having overlapping operating channels by using a reconfiguration procedure may be considered. More specifically, a method may be considered in which when an operating channel of a specific setup link overlaps an operating channel of another setup link, a link pair having the overlapping operating channels is removed by removing (terminating the setup) of one of the two links (the specific setup link and the other setup link) through a reconfiguration performed between a non-AP MLD and an AP MLD.

In this case, the non-AP MLD that receives an (Extended) Channel Switch Announcement element for the specific link transmitted by the AP MLD may request the AP MLD for a reconfiguration procedure for changing a multi-link setup state when it is identified that a new operating channel of the specific link overlaps an operating channel of another link. Furthermore, when the AP MLD transmits the (Extended) Channel Switch Announcement element for the specific link, the AP MLD may transmit a request frame for requesting a change in the multi-link setup state to the non-AP MLD that are expected to have overlapping operating channels as a result of switching the operating channel of the specific link.

That is, the AP MLD is free to select an operating channel of a BSS operated by a specific AP regardless of an operating channel of a BSS operated by another AP. However, the AP MLD and the non-AP MLD may need to manage operating channels of links, which have been set up between the AP MLD and the non-AP MLD, through a Multi-Link reconfiguration so that the operating channels do not overlap each other.

In this case, the overlap of operating channels of two links implies that some or all of BSS operating channels of APs operating on the two links are identical (partially overlap or fully overlap).

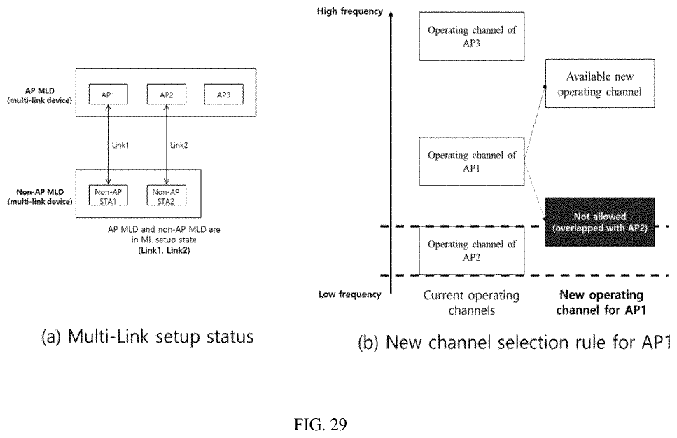

FIG. 29 illustrates an example of a method by which an AP MLD according to an embodiment of the present disclosure switches the channel of a specific link.

FIG. 29(a) illustrates the connection state of an AP MLD and a non-AP MLD. Referring to FIG. 29(a), the AP MLD operates AP 1, AP 2, and AP 3 on Link 1, Link 2, and Link 3, respectively, and the non-AP MLD is in an ML-setup state in which the non-AP MLD connected via Link 1 and Link 2.

When the AP MLD switches an operating channel of a BSS operated on Link 1, the AP MLD selects a new operating channel of the BSS operated on Link 1 so that the new operating channel does not overlap an operating channel of a BSS operated on Link 2.

FIG. 29(b) illustrates a channel that can be selected as a new operating channel of AP 1 (a BSS of Link 1) and a channel that cannot be selected as the new operating channel of AP 1. First, a channel shown in black (a black box) is an operating channel that partially overlaps an operating channel of AP 2. Therefore, the AP MLD may not switch an operating channel of AP 1 to the channel shown in black.

In this case, the AP MLD may not switch the operating channel of AP 1 to the channel shown in black (a channel overlapping an operating channel of Link 2) because there is a non-AP MLD that is set up via both Link 1 and Link 2, where AP 1 is operated.

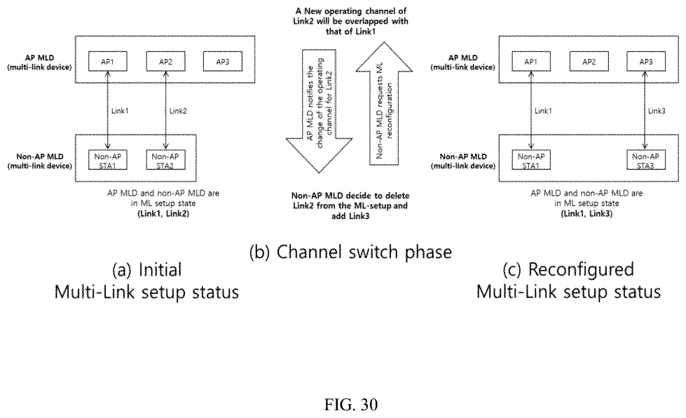

FIG. 30 illustrates an example of a method in which a multi-link reconfiguration is performed by a non-AP MLD that has performed a multi-link setup with an AP MLD according to an embodiment of the present disclosure.

FIG. 30(a) illustrates an initial connection state between an AP MLD and a non-AP MLD. Referring to FIG. 30(a), the AP MLD operates AP 1, AP 2, and AP 3 on Link 1, Link 2, and Link 3, respectively, and the non-AP MLD is in an ML-setup state in which the non-AP MLD is connected via Link 1 and Link 2.

Referring to FIG. 30(b), the AP MLD transmits a notification (an (Extended) Channel Switch Announcement element) frame to switch an operating channel of a BSS operated by AP 1, and the non-AP MLD recognizes that a new operating channel of AP 1 overlaps an operating channel of AP 2. In this case, the non-AP MLD determines to release connection of Link 2 (connection with AP 2) and additionally connect Link 3. The non-AP MLD transmits a Reconfiguration Request frame to the AP MLD to request a change in the state of the multi-link connection that the non-AP MLD makes with the AP MLD (Link 1, Link 2=>Link 1, Link 3).

FIG. 30(c) illustrates the connection state of the AP MLD and non-AP MLD after a reconfiguration is complete. The AP MLD and non-AP MLD release the connection of Link 2 to prevent a new operating channel of Link 1 from overlapping Link 2 in a setup state. In addition, the non-AP MLD may utilize an STA connected with Link 2 to be connected to Link 3, thus maintaining a multi-link setup state in which the non-AP MLD has been connected through Link 1 and Link 3.

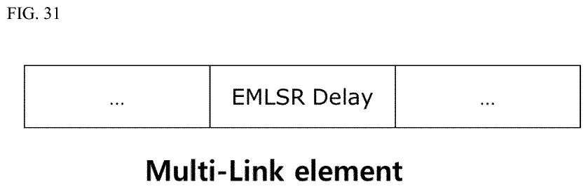

FIG. 31 illustrates an example of a Multi-Link element that includes a padding value to be included in an initial trigger frame of a frame exchange procedure according to an embodiment of the present disclosure.

Referring to FIG. 31, an EMLSR MLD may indicate an EMLSR Delay field via a Multi-Link element. In this case, the EMLSR Delay field may indicate a padding value to be included in an initial trigger frame of a frame exchange procedure.

In order to initiate a frame exchange procedure with a specific EMLSR MLD, an AP MLD may need to generate a trigger frame in consideration of a padding value indicated by the specific EMLSR MLD via an EMLSR Delay field of a multi-link element. More specifically, the AP MLD may need to include a padding, which has a length equal to or greater than the indicated padding value, in the trigger frame that the AP MLD transmits to the EMLSR MLD.

### <TXOP Management for EMLSR MLD>

As described above, when the EMLSR MLD performs a packet exchange sequence via a specific link, the EMLSR MLD may have limited operational capability over another link. In this case, the limited operational capability may be the inability to support the transmission/reception of a data packet. Furthermore, the limited operational capability may include monitoring capabilities (CCA, Preamble Detection (PD), etc.) for the link (the other link). In this case, the time period in which the operational capability is limited may be an interval including RF switching back delay after a packet exchange sequence is terminated as well as when performing the packet exchange sequence through the specific link.

That is, when the EMLSR MLD performs a packet exchange sequence via a specific link, it is not possible for the EMLSR MLD to transmit/receive packets via another link. Therefore, when the EMLSR MLD needs to support transmitting/receiving packets via another link, the EMLSR MLD and another STA operating the packet exchange sequence with the EMLSR MLD should manage TXOP so that the EMLSR MLD can transmit/receive packets via the other link.

According to an embodiment of the present disclosure, when the EMLSR MLD intends to receive a DTIM beacon frame via another link, TXOP on a specific link on which the EMLSR MLD is a TXOP holder or a TXOP responder may need to be terminated before (the expected time of reception of the DTIM beacon frame to be received-RF switching back delay).

More specifically, when the EMLSR MLD intends to receive a DTIM beacon frame via another STA, TXOP in which a specific STA of the EMLSR MLD is a TXOP holder or a TXOP responder may need to be terminated before a target beacon transmission time (TBTT)-RF switching back delay, which corresponds to the (DTIM) beacon frame.

Therefore, when an EMLSR MLD or a device that intends to operate a packet exchange sequence with the EMLSR MLD acquires TXOP before TBTT of another link, the TXOP may need to be terminated earlier than the TBTT of the other link if the EMLSR MLD intends to receive a beacon frame via the other link. In this case, the TXOP terminated earlier than the TBTT should ensure that the EMLSR MLD can be ready to receive the beacon frame from the other link after the TXOP termination. That is, the TXOP terminated earlier than the TBTT may be limited to be terminated at a time that is at least as early as RF switching (back) delay before TBTT of the beacon frame that the EMLSR MLD intends to receive. To this end, a TXOP holder, with an STA of the EMLSR MLD as a TXOP responder, may need to terminate TXOP before a TBTT of a link on which the EMLSR MLD operates another STA (TBTT-RF switching delay). In this case, the TBTT may be a TBTT related to the DTIM beacon frame. In this case, when the AP MLD is a TXOP holder, the AP MLD may determine whether to terminate TXOP, in which the AP MLD is the TXOP holder, before the TBTT of the other link on the basis of information indicating that the EMLSR MLD is scheduled to perform a reception operation on the other link (the other link on which the packet exchange sequence is not in operation). In this case, the information indicating that the EMLSR MLD is scheduled to perform the reception operation on the other link may be indicated by a method pre-agreed between the AP MLD and the EMLSR MLD. In this case, the information indicating that the EMLSR MLD is scheduled to perform the reception operation on the other link may be implicitly indicated when a beacon of the other link is a DTIM beacon. That is, when the beacon frame of the other link is a DTIM beacon frame, the AP MLD may terminate the TXOP, for which the AP MLD is the TXOP holder (the TXOP responder is the EMLSR MLD), at the time of ensuring that the EMLSR MLD can receive the DTIM beacon frame, even when the EMLSR MLD does not perform separate indication.

However, the EMLSR MLD that has received an Initial Control frame (e.g., ML-RTS, Buffer Status Report Poll (BSRP) frame) from the AP MLD may not respond to the Initial Control frame. For example, the EMLSR MLD that has received an ML (MU)-RTS as an Initial Control frame for initiating a packet exchange procedure may not initiate the packet exchange procedure by not responding with CTS. This may be an operation allowed when the EMLSR MLD intends to receive a frame (e.g., a beacon frame) which is received (or is to be received) on another link instead of initiating the packet exchange procedure. That is, even when the EMLSR MLD has received an Initial Control frame from the AP MLD via a specific link, the EMLSR MLD may not respond to the received Initial Control frame due to an operation that the EMLSR MLD intends to perform on another link.

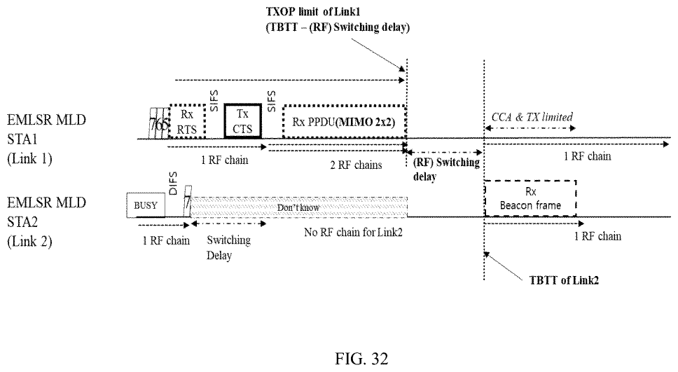

FIG. 32 illustrates an example of a TXOP operation method managed in consideration of the characteristics of an EMLSR MLD according to an embodiment of the present disclosure.

Referring to FIG. 32, STA 1 of the EMLSR MLD may have become a TXOP responder of Link 1 by responding with a CTS after receiving an RTS from an AP MLD. In this case, the AP MLD may terminate TXOP, which has been acquired on Link 1, at a time (RF) switching latency (delay) earlier (or even earlier) than TBTT of Link 2 by considering that the EMLSR MLD intends to receive a beacon frame at the TBTT of Link 2.

In this case, after the TXOP on Link 1 is terminated, the EMLSR MLD may perform RF switching during the RF switching latency, thereby completing the preparation to receive the beacon frame on Link 2.

In the opposite situation to that shown in FIG. 32, even if the STA 1 of the EMLSR MLD has acquired TXOP, the EMLSR MLD may complete the preparation to receive a beacon frame on Link 2 by terminating TXOP acquired on Link 1 at a time earlier by (RF) switching delay (or even earlier) than the TBTT of Link 2. In this case, the beacon frame may refer to a DTIM beacon frame.

### <EMLSR MLD's Reception of Beacon Frame>

An EMLSR MLD may not perform an RF Switching operation when receiving a beacon frame. This may be because a beacon frame is generally not transmitted with MIMO. That is, the EMLSR MLD does not need to perform RF Switching when receiving a beacon frame, and therefore, even while receiving a beacon frame on a specific link, the EMLSR MLD may perform monitoring (listening operation) and/or channel access operation on another link.

However, even when the EMLSR MLD performs reception without performing an RF switching operation on a specific link (as in the beacon frame reception example described above), operations and/or performance on another link may be limited while performing reception on the specific Link.

For example, while the EMLSR MLD is receiving a beacon frame on a specific Link, performing channel access may be limited even when a channel access procedure on another link has been completed. Alternatively, while the EMLSR MLD is receiving a beacon frame on a specific link, transmission and/or reception on another link may be performed only using the basic rate (6, 12, or 24 Mbps).

This may imply that the EMLSR MLD has not performed RF switching for an operation on a specific link, and thus transmission/reception and channel access operations on another links may still be possible, but the operations on the other links may be limited due to the resources consumed for the operation on the specific link.

Furthermore, as described above, while the EMLSR MLD is receiving a frame (e.g., a beacon frame) on a specific link, operations on another link may be restricted, so that a device (a terminal) that intends to initiate a packet exchange procedure with the EMLSR MLD may be restricted from initiating the packet exchange procedure while the EMLSR MLD is performing the (beacon frame) reception operation. More specifically, when an EMLSR MLD is receiving a beacon frame (or a Groupcast (Group addressed) frame) on a specific link, an AP MLD may not transmit an Initial Control frame to the EMLSR MLD via another link. This may be a restriction imposed because it is obvious that the EMLSR MLD having received an Initial Control frame cannot perform an RF switching operation after receiving the Initial Control frame (because an RF of the other link is being utilized to receive the beacon frame). In this case, the beacon frame may be a DTIM beacon frame.

### <EMLSR Operation and TXOP Management Method Considering the Operational Intent of EMLSR MLD>

A TXOP management method considering the aforementioned RF switching delay is a method considering that when an EMLSR MLD intends to receive a Beacon frame/Group addressed frame scheduled on a specific EMLSR link, the EMLSR MLD prepares for reception on the specific EMLSR link immediately after TXOP of another link has been terminated.

In summary, immediately after terminating a packet exchange sequence (a frame exchange, or a frame exchange sequence) on a specific EMLSR link, the EMLSR MLD may prepare for reception of a frame (e.g., a Beacon/Group addressed frame) scheduled on another EMLSR link, instead of transitioning to a listening operation (i.e., a state in which CCA, etc. for EMLSR links are supported). In this case, terminating the frame exchange on a specific EMLSR link and then preparing for reception on another EMLSR link may imply a series of operations for utilizing, on the other EMLSR link, at least one of RF Chains utilized on the specific EMLSR link and a transmission/reception function for a non-initial control frame (i.e., a frame other than an initial control frame). This may be an exception to application of the operational restriction that the EMLSR MLD should transition to a listening operation for EMLSR links when the frame exchange sequence which the EMLSR MLD is performing/participating in on an EMLSR link is terminated. That is, the EMLSR MLD should transition to a listening operation for EMLSR links when the frame exchange sequence which the EMLSR MLD is performing/participating in on a specific EMLSR link is terminated, but may not transition to the listening operation for EMLSR links when the EMLSR MLD intends to receive a Beacon/Group addressed frames on another EMLSR links. In this case, the EMLSR MLD may operate for RX support for the other EMLSR link instead of transitioning to the listening operation for the EMLSR links.

Furthermore, when the frame exchange sequence in which the EMLSR MLD is performing/participating in on a specific EMLSR link has been terminated, the EMLSR MLD may maintain a reception support state on the specific EMLSR link without transitioning to a listening operation if the EMLSR MLD intends to receive another frame that is scheduled to be received on the specific EMLSR link. This is another exception to the operational restriction that requires transitioning to a listening operation, and will be described in more detail later through an embodiment of the present disclosure described later.

Additionally, when a frame exchange sequence which the EMLSR MLD is performing/participating in on a specific EMLSR link has been terminated, the EMLSR MLD may continue to perform a channel access procedure on the specific EMLSR link without transitioning to a listening operation if the EMLSR MLD intends to initiate the frame exchange sequence on the specific EMLSR link. This may be an additional exception to the operational restriction that requires transitioning to a listening operation.

Alternatively, during the transition to the listening operation after determining that the frame exchange sequence which the EMLSR MLD is performing/participating in on a specific EMLSR link has been terminated, the EMLSR MLD may receive an Initial Control frame again on the specific EMLSR link. This situation may occur when the EMLSR MLD is able to support the reception of the Initial Control frame on some EMLSR links during an EMLSR Transition operation. In this case, the EMLSR MLD may cancel the EMLSR Transition operation (transition to a listening operation) being performed in order to support the frame exchange sequence for the specific EMLSR link on which the Initial Control frame was received again. That is, the EMLSR MLD, which has determined the frame exchange sequence to have been terminated and has received the Initial Control frame while performing the EMLSR Transition, may not perform the transition to a listening operation.

In another method, an EMLSR MLD, which receives an Initial Control frame while transitioning to a listening operation after determining that a frame exchange sequence which the EMLSR MLD is performing/participating in on a specific EMLSR link is terminated, may not respond to the received Initial Control frame. For example, an EMLSR MLD that has received MU-RTS and BSRP trigger frames, which are Initial Control frames, may not transmit a response frame to the received Initial Control frames if the EMLSR MLD is in the process of transitioning to a listening operation.

Thus, because an EMLSR MLD that is transitioning to a listening operation may not respond to an Initial control frame, an Initial Control frame transmission restrict may be applied to an AP. In other words, the AP may not be allowed to transmit the Initial Control frame to the EMLSR MLD that is transitioning to the listening operation. In this case, a method by which the AP determines whether a specific EMLSR MLD is transitioning to a listening operation may be based on whether a time equal to EMLSR Transition Delay (as indicated by the specific EMLSR MLD) has elapsed since the specific EMLSR MLD determined that a frame exchange sequence performed with the specific EMLSR MLD has been terminated. More specifically, the AP may determine that a specific EMLSR MLD is performing a transition to a listening operation if a time equal to EMLSR Transition Delay has not elapsed after the condition that the specific EMLSR MLD determines a frame exchange sequence, in which a specific EMLSR MLD participated, to have been terminated has been satisfied. If the time equal to the EMLSR Transition Delay has elapsed, the AP may determine that the EMLSR MLD has completed the transition to the listening operation.

When an STA (an affiliated STA) that the EMLSR MLD operates on a specific EMLSR link is a TXOP holder, the EMLSR MLD may immediately start preparing to utilize resources (hardware resources such as processing power and RF chains), which were utilized in the specific EMLSR link, on another EMLSR link after terminating the TXOP. On the other hand, if an STA of a specific EMLSR link is a TXOP responder (if an AP has initiated a frame exchange procedure), an EMLSR MLD may start preparing to utilize resources utilized on the specific EMLSR link on another EMLSR link when the frame exchange on the specific EMLSR link is determined to have been terminated (e.g., when after responding with a Response frame, no next frame is received from an AP until aSIFSTime+aSlotTime+aRxPHYStartDelay has elapsed).

An EMLSR MLD identifies the termination of a frame exchange sequence performed on a specific EMLSR link and then will start preparing for reception on another EMLSR link, and thus an AP MLD should terminate a frame exchange sequence with the EMLSR MLD (performed on the specific EMLSR link) at least aSIFSTime+aSlotTime+aRxPHYStartDelay+EMLSR Transition Delay (RF Switching back latency) earlier than a Beacon/Group addressed frame to be transmitted on the other EMLSR link. In this case, the AP MLD may need to follow the frame exchange sequence termination rule only when the EMLSR MLD is expected to receive the Beacon/Group addressed frame to be transmitted on the other EMLSR link. In this case, the aSIFSTime+aSlotTime+aRxPHYStartDelay is the time taken for the EMLSR MLD to determine the termination of the frame exchange sequence. In this case, since the AP MLD does not know aRxPHYStartDelay of the EMLSR MLD, the AP MLD may determine a frame exchange sequence termination time point by considering that aRxPHYStartDelay of the AP MLD is the same as the aRxPHYStartDelay of the EMLSR MLD. However, since aRxPHYStartDelay typically has a small time interval within 1 us to 2 us, it is possible for the AP to ignore the aRxPHYStartDelay (and consider only the aSIFSTime+aSlotTime+EMLSR Transition Delay) when determining the time point at which the frame exchange sequence is terminated.

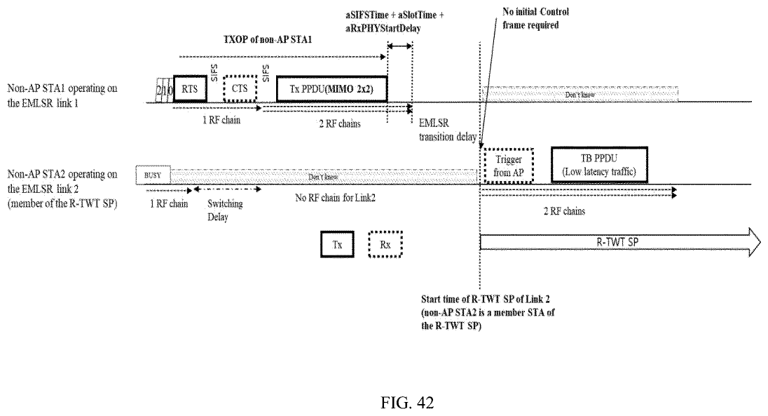

The TXOP termination method considering the scheduled reception time point of the beacon frame may be similarly applied even before the start time point of a restricted target wake time (R-TWT) service period (SP). The method for managing TXOP in consideration of the R-TWT SP is described in more detail along with reference to an embodiment in FIG. 42 that will be described later.

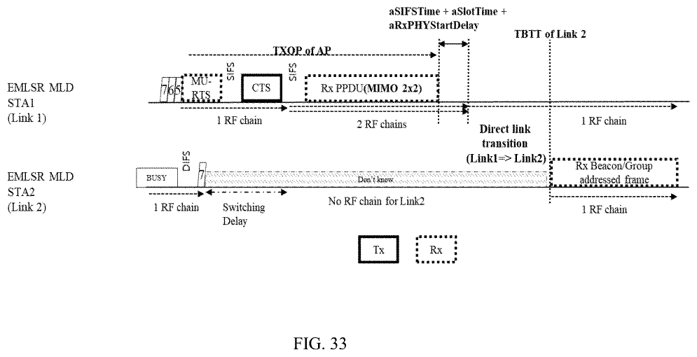

FIG. 33 illustrates an example of an operation in which an EMLSR MLD according to an embodiment of the present disclosure switches to a reception (transmission/reception) support mode for another EMLSR link after a frame exchange procedure is terminated on a specific EMLSR link.

Referring to FIG. 33, the EMLSR MLD operates STA 1 and STA 2 on Link 1 and Link 2, respectively. An AP transmits an MU-RTS frame as an initial control frame on Link 1, and the EMLSR MLD responds with a CTS frame via STA 1, and then receives, using two RF chains, a PPDU transmitted from the AP.

After receiving the PPDU from the AP, the EMLSR MLD, which has identified that no additional PPDUs are received during aSIFSTime+aSlotTime+aRxPHYStartDelay, determines that a frame exchange sequence on Link 1 has been terminated.

After the frame exchange sequence on Link 1 has been terminated, the EMLSR MLD immediately transitions to a reception mode for Link 2, instead of transitioning to a listening operation, for the purpose of receiving a Beacon frame/Group addressed frame scheduled on Link 2. However, since the Beacon frame/Group addressed frame is not transmitted in MIMO, the reception operation supported by Link 2 may be supported using only one RF chain.

In FIG. 33, the AP MLD has predicted that the EMLSR MLD will intend to receive the Beacon frame/Group addressed frame scheduled on a TBTT of Link 2, and has terminated TXOP (the frame exchange sequence) of Link 1 earlier by aSIFSTime+aSlotTime+aRxPHYStartDelay+EMLSR Transition Delay (RF switching back delay) than a TBTT of Link 2 to allow (induce) the EMLSR MLD to start the reception support (preparation) operation for Link 2.

In some embodiments, the EMLSR MLD may not be supported in immediately changing an operation in order to, while supporting a frame exchange sequence for a specific EMLSR link, support a frame exchange sequence for another EMLSR link, or may not be allowed to immediately change a frame exchange sequence support link in order to reduce the operational complexity of a non-AP MLD operating in an EMLSR mode and an AP MLD serving the non-AP MLD. In other words, in order to, while supporting a frame exchange sequence for a specific EMLSR link, support a frame exchange sequence for another EMLSR link, the EMLSR MLD may need to first transition to a listening operation (a state in which CCA, Initial Control frame reception, etc. are supported) for each EMLSR link after the frame exchange sequence performed on the specific EMLSR link is terminated, and then prepare the frame exchange sequence support (transmission/reception support) for the other EMLSR link. In this case, when the frame exchange sequence performed by the specific EMLSR link is terminated, the EMLSR MLD that intends to receive a Beacon/Group addressed frame on the other EMLSR link may transition to a reception (or transmission/reception) support mode for the other EMLSR link without receiving a separate Initial Control frame on the other link.

In this case, before transmitting a Beacon (a Target Beacon Transmit Time (TBTT) related to the Beacon)/Group addressed frame scheduled on a specific link, the AP MLD should manage a frame exchange sequence (and/or TXOP) of another link in consideration of both the time for the EMLSR MLD to transition to a listening operation and the time required to support reception on the specific link. In this case, the AP MLD may need to additionally consider the time taken for the EMLSR MLD to determine the termination of the frame exchange sequence (e.g., aSIFSTime+aSlotTime+aRxPHYStartDelay, PIFS+aRxPHYStartDelay, or PIFS (aSIFSTime+aSlotTime)). However, the AP MLD may apply the frame exchange sequence management method as described above only when the EMLSR MLD is expected to receive the Beacon/Group addressed frame scheduled on the specific link. If the AP MLD predicts that a Beacon/Group addressed frame scheduled on a specific link will be received by multiple EMLSR MLDs participating in a frame exchange sequence on another link (e.g., being TXOP responders), the AP MLD should terminate the frame exchange sequence on the other link in consideration of the EMLSR MLD among the multiple EMLSR MLDs that requires the longest preparation time (e.g., the EMLSR MLD that indicates the largest value for EMLSR Transition Delay or RF Switching back latency). In another method, the AP MLD may terminate the frame exchange sequence on the other link by considering the largest value of the EMLSR Transition Delays of all associated EMLSR MLDs, rather than considering the largest value of the EMLSR Transition Delays of the multiple EMLSR MLDs. In still another method, the AP MLD may terminate a frame exchange sequence on another link by considering the largest value of EMLSR Transition Delays of all EMLSR MLDs that are participating in the frame exchange sequence on the other link, rather than considering the largest value of EMLSR Transition Delay of the multiple EMLSR MLDs (EMLSR MLDs that have participated in the frame exchange sequence on the other link and are expected to receive a Beacon/Group addressed frame scheduled on a specific link). In this case, the operation of the AP MLD described in the other method and in the still another method is provided to allow the AP MLD to determine a time point of termination of the frame exchange sequence in a simpler way in consideration of the operational complexity of the AP MLD.

Likewise, when the EMLSR MLD intends to receive a Beacon/Group addressed frame scheduled on a specific EMLSR link, the EMLSR MLD should terminate TXOP operating on another EMLSR link in advance in consideration of the time required to support the frame reception on the specific EMLSR link. In this case, the EMLSR MLD should terminate the TXOP of the other EMLSR link in consideration of both the time to transition to a listening operation for each EMLSR link after terminating the TXOP of the other EMLSR link and the time required to support the frame reception on the specific EMLSR link. For example, when an EMLSR MLD intends to receive a DTIM beacon scheduled on a specific EMLSR link, the EMLSR MLD may need to terminate, based on a TBTT related to the DTIM beacon, TXOP of another EMLSR link at least as early as (the time required to transition to a listening operation+the time required to transition an operation to support frame reception on the specific link).

However, when a frame that the EMLSR MLD intends to receive on a specific EMLSR link can be received in a listening operation state, the EMLSR MLD may terminate TXOP of another EMLSR link only as early as the time required to transition to the listening operation (RF Switching back delay, EMLSR Transition Delay). That is, Operations supported on a specific EMLSR link, on which the different EMLSR MLDs are in listening operations, are different, the different EMLSR MLDs may apply different criteria to the time to terminate a TXOP operated by another EMLSR link. For example, when a first EMLSR MLD supports beacon frame reception on a link in which the first EMLSR MLD is in a listening operation, the first EMLSR MLD may terminate TXOP of another link early in consideration of only the time required to transition to the listening operation. In contrast, when a second EMLSR MLD does not support beacon frame reception on a link in which the second EMLSR MLD is in a listening operation, the second EMLSR MLD should terminate TXOP of another link earlier in consideration of both the time required to transition to the listening operation+the operation change time for supporting the beacon frame reception.

Accordingly, a non-AP MLD may indicate, to the AP MLD, capability information related to whether the non-AP MLD is capable of receiving a beacon frame (or a frame other than an Initial Control frame) while maintaining an EMLSR link in a listening operation. The capability information related to the beacon frame reception may be indicated as “supported” by indicating a specific bit of an EML Capabilities subfield (contained in a multi-link element) transmitted by the non-AP MLD as 1, and may be indicated as “not supported” by indicating the specific bit as 0.

Furthermore, it may be possible for the non-AP MLD to support the reception of a beacon frame (or a frame other than an Initial Control frame) during the listening operation for only one of EMLSR links on which pre-agreement has been made with the AP MLD. This implies that while supporting a listening operation for each EMLSR link, the non-AP MLD may maintain supporting the reception of normal frames (not only an Initial Control frame but also other frames including beacon and group addressed frames) for a specific one EMLSR link. This may be an operation achieved by a non-AP MLD, which is operated in an EMLSR mode, utilizing transmission/reception support capability for one pre-agreed EMLSR link while no frame exchange sequence is being performed on another EMLSR link.

In this case, the non-AP MLD supports frame reception on the one pre-agreed EMLSR link even when the non-AP MLD is in a listening operation, and thus, when the non-AP MLD intends to receive a Beacon/Group addressed frame on the one pre-agreed EMLSR link, the non-AP MLD may terminate a frame exchange sequence in progress on another link in consideration of only the time for transitioning to the listening operation. Similarly, when an EMLSR MLD is predicted to receive a Beacon/Group addressed frame on one pre-agreed link, an AP MLD may manage a frame exchange sequence on another link in consideration of only the time for the EMLSR MLD to transition to a listening operation. Furthermore, when the AP MLD transmits a Group addressed frame that the EMLSR MLD should receive, the AP MLD may transmit the Group addressed frame through one specific link on which the EMLSR MLD has promised to support the reception of normal frames during the listening operation.

In this case, to indicate, to the AP, information about the link that supports the reception (transmission/reception) of normal frames in the listening operation state, the non-AP MLD may indicate Link ID information by including the Link ID in the EML Capabilities subfield (contained in the multi-link element) that is to be transmitted to the AP MLD. For example, EML Capabilities subfield may include a Link ID subfield. In this case, when a value corresponding to a specific link is indicated via the Link ID subfield, the specific link may be a link which has been indicated by the non-AP as a link that supports reception of normal frames during a listening operation.

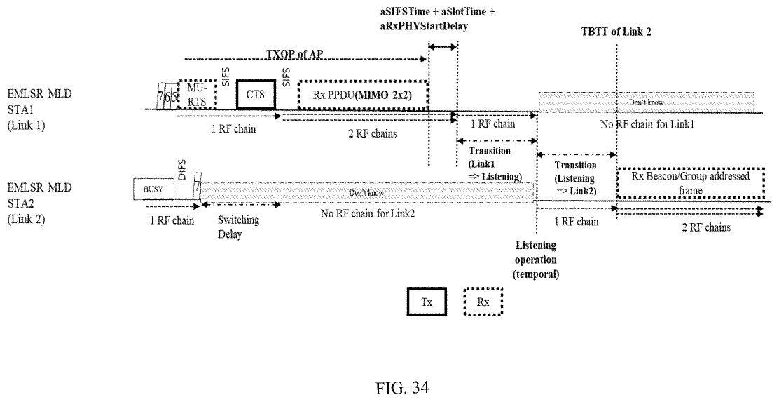

FIG. 34 illustrates an example of a TXOP (frame exchange sequence) management method on an EMLSR link according to an embodiment of the present disclosure.

Referring to FIG. 34, the EMLSR MLD operates STA 1 and STA 2 on Link 1 and Link 2, respectively. An AP transmits an MU-RTS frame as an initial control frame on Link 1, and the EMLSR MLD responds with a CTS frame through STA 1, and then receives a PPDU, transmitted from the AP, by using two RF chains.

After receiving the PPDU from the AP, the EMLSR MLD, which has identified that no additional PPDUs are received during aSIFSTime+aSlotTime+aRxPHYStartDelay, determines that a frame exchange sequence on Link 1 has been terminated.

After the frame exchange sequence on Link 1 is terminated, the EMLSR MLD intends to receive a Beacon/Group addressed frame scheduled on Link 2, transitions to a listening operation to receive the Beacon/Group addressed frame on Link 2, and then transitions to a reception (transmission/reception, frame exchange sequence) support mode for Link 2. In this case, the EMLSR MLD has not received a separate Initial Control frame on Link 2, but intends to receive the Beacon/Group addressed frame scheduled on Link 2, so the EMLSR MLD transitions to the reception support mode for Link 2 by itself.

In FIG. 34, the AP MLD has predicted that the EMLSR MLD will intend to receive the Beacon frame/Group addressed frame scheduled at a TBTT of Link 2, and has terminated TXOP (the frame exchange sequence) of Link 1 earlier by aSIFSTime+aSlotTime+aRxPHYStartDelay+EMLSR Transition Delay (RF Switching back delay (to listening operation))+EMLSR Transition Delay (RF Switching delay to support RX on Link 2) than a TBTT of Link 2 to allow (induce) the EMLSR MLD to start the reception support (preparation) operation for Link 2.

Meanwhile, there may be another exception to the operational restriction that an EMLSR MLD should transition to a listening operation for EMLSR links when a frame exchange sequence in which an EMLSR MLD is performing/participating on an EMLSR link is terminated.

An EMLSR MLD may intend to receive a Beacon/Group addressed frame scheduled on a specific link when a frame exchange sequence in which the EMLSR MLD is participating as a TXOP holder or a TXOP responder on a specific link is terminated. In this case, when the expected reception time point of the Beacon/Group addressed frame scheduled on the specific link is sufficiently close to the termination time point of the frame exchange sequence, the EMLSR MLD may choose to maintain a reception waiting state on the specific link instead of transitioning to the listening operation. In this case, a method by which the EMLSR MLD determines whether to transition to a listening operation or to maintain a reception waiting state (or transmission/reception-ready state) on a link on which a frame exchange sequence has been just operated may be based on whether the difference between the termination time point of the frame exchange sequence (or TXOP) and the expected reception (start) time point of the Beacon/Group addressed frame (e.g., a corresponding TBTT in the case of a Beacon frame) is greater than a pre-agreed/preset time interval. In a more specific method, the EMLSR MLD may not transition to the listening operation if, at the time point of identifying that the frame exchange sequence has been terminated on a specific EMLSR link, a TBTT of a beacon frame scheduled on the specific EMLSR link is scheduled to be after a time interval that is shorter than a preset time interval. The EMLSR MLD may transition to the listening operation if, at the time point when the EMSLR MLD identifies that a frame exchange sequence has been terminated on a specific EMLSR link, a TBTT of a beacon frame to be received is scheduled within the preset time interval.

Additionally, after the termination of a frame exchange sequence in which the EMLSR MLD is participating as a TXOP holder or TXOP responder on a specific link, the EMLSR MLD may intend to initiate a new frame exchange sequence on the specific link. In this case, when the time point at which the EMLSR MLD predicts that the EMLSR MLD will complete channel access on the specific link is sufficiently close to the termination time point of the frame exchange sequence in which the EMLSR MLD is participating on the specific link, the EMLSR MLD may continue the channel access operation on the specific link instead of transitioning to a listening operation. In this case, the method by which the EMLSR MLD determines whether to transition to a listening operation or whether to continue a channel access procedure on a link on which a frame exchange sequence has been operated just before may be based on whether the difference between the termination time point of a frame exchange sequence (or TXOP) and the expected completion time point of the channel access procedure (e.g., the time point at which a backoff counter is predicted to reach zero, or the time point at which it is predicted that transmission will be initiated according to a channel access procedure utilizing EDCA) is greater than a pre-agreed/preset time interval. In a more specific method, an EMLSR MLD may not transition to the listening operation if, at the time point of identifying that a frame exchange sequence has been terminated on a specific EMLSR link, the time point at which the EMLSR MLD is expected to complete channel access on the specific EMLSR link is expected to be after a time interval that is shorter than the preset time interval. If, at the time point of identifying that a frame exchange sequence has been terminated on a specific EMLSR link, the EMSLR MLD is not expected to complete the channel access procedure on the specific EMLSR link within the preset time interval, the EMLSR MLD may transition to the listening operation.

According to an embodiment of the present disclosure, after terminating a frame exchange sequence on a specific EMLSR link, the EMLSR MLD may determine whether to transition to a listening operation or to maintain a reception waiting (transmission/reception support) state on the specific EMLSR link, based on whether the expected time point of reception of a Beacon/Group addressed frame to be received is scheduled to be after a time interval greater than EMLSR Transition Delay (RF Switching Back Delay) (or after a time interval greater than EMLSR Transition Delay+aSIFSTime+aSlotTime+aRxPHYStartDelay). In this case, the reason why the EMLSR MLD performs the determination based on the EMLSR Transition Delay (or EMLSR Transition Delay+aSIFSTime+aSlotTime+aRxPHYStartDelay) may be to determine whether there is an expected reception time point after the termination of the frame exchange sequence on the specific Link but before transitioning to the listening operation. This may be because when the transmission of a Beacon/Group addressed frame is started (by an AP on the other link) while the EMLSR MLD is transitioning to the listening operation (i.e., before the EMLSR Transition Delay has elapsed), the EMLSR MLD cannot support the reception of that frame.

According to another embodiment of the present disclosure, after terminating a frame exchange sequence on a specific EMLSR link, the EMLSR MLD may determine whether to transition to a listening operation or to maintain a reception waiting (transmission/reception support) state on the specific EMLSR link, based on whether the expected time point of reception of a Beacon/Group addressed frame to be received is scheduled to be after a time interval greater than twice EMLSR Transition Delay (or after a time interval greater than EMLSR Transition Delay*2+aSIFSTime+aSlotTime+aRxPHYStartDelay). In this case, the reason why the EMLSR MLD performs the determination based on 2 times the EMLSR Transition Delay (or EMLSR Transition Delay*2+aSIFSTime+aSlotTime+aRxPHYStartDelay) may be to determine whether there is an expected reception time point after the termination of a frame exchange sequence on a specific link but before transitioning to a reception support mode for another link. This may be because when the transmission of a Beacon/Group addressed frame is started at an AP side (an AP on the other link) while the EMLSR MLD is in the process of switching to the reception support state on the other link (i.e., during the change of transmission/reception support for the specific Link=>listening operation=>transmission/reception support for the other link), the EMLSR MLD cannot support the reception of the frame.

According to an embodiment of the present disclosure, after terminating a frame exchange sequence on a specific EMLSR link, the EMLSR MLD may determine whether to transition to a listening operation or to maintain a reception waiting (transmission/reception support) state on the specific EMLSR link, based on whether the expected time point of reception of a Beacon/Group addressed frame to be received on the specific EMLSR link is scheduled to be after a time interval greater than EMLSR Transition Delay (RF Switching Back Delay)+MediumSyncDelay. In this case, the reason why the EMLSR MLD performs the determination based on the EMLSR Transition Delay may be to determine whether the expected time point of reception of the Beacon/Group addressed frame on the specific EMLSR link arrives before the expiration of a MediumSyncDelay timer of another EMLSR link started after the transition to the listening operation. More specifically, when additional reception is expected to be performed on a specific EMLSR link, which has already been operating a frame exchange sequence, before the restriction on channel access is released on another EMLSR link, the EMLSR MLD may maintain a reception waiting state on the specific EMLSR link without transitioning to a listening operation even if the frame exchange sequence on the specific EMLSR link is terminated.

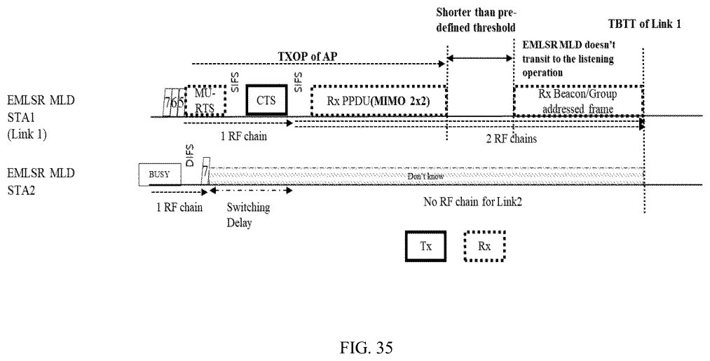

FIG. 35 illustrates an example in which an EMLSR MLD according to an embodiment of the present disclosure transitions to a listening operation when receiving a specific frame in a specific link.

Referring to FIG. 35, the EMLSR MLD operates STA 1 and STA 2 on Link 1 and Link 2, respectively. An AP transmits an MU-RTS frame as an initial control frame on Link 1, and the EMLSR MLD responds with a CTS frame via STA 1, and then receives, using two RF chains, a PPDU transmitted from the AP.

After receiving the PPDU from the AP, the EMLSR MLD, which has identified that no additional PPDUs are received during aSIFSTime+aSlotTime+aRxPHYStartDelay, determines that a frame exchange sequence on Link 1 has been terminated.

After the termination of the frame exchange sequence already performed on Link 1, the EMLSR MLD intends to receive a Beacon/Group addressed frame scheduled on the same link (Link 1 in FIG. 54), and therefore maintains a reception waiting state (transmission/reception-ready state) on Link 1 without transitioning to a listening operation even when it is identified that the frame exchange sequence on Link 1 has been terminated. In this case, the EMLSR MLD may have determined to maintain the reception waiting state on Link 1 instead of transitioning to the listening operation, based on that the termination time point of the frame exchange sequence already performed on Link 1 and the expected time point of reception of the Beacon/Group addressed frame intended to be received on Link 1 are less than a preset threshold.

In FIG. 35, an AP MLD predicts that the EMLSR MLD will intend to receive a Beacon frame/Group addressed frame that is scheduled to be transmitted on Link 1, and may consider that the EMLSR MLD will not require any additional preparation time to receive the Beacon/Group addressed frame. This may be a determination of the AP MLD based on that the EMLSR MLD will maintain a transmission/reception support state on a link (Link 1) on which the EMLSR MLD intends to receive the Beacon/Group addressed frame. Therefore, the AP MLD may not terminate a frame exchange procedure (TXOP) already performed on Link 1 earlier by EMLSR Transition Delay (as indicated by the EMLSR MLD) than the transmission time point (TBTT) of the Beacon/Group addressed frame to be transmitted on Link 1.

### <EMLSR/EMLMR Mode Configuration>

As described above, EMLSR/EMLMR may be an operation mode of an MLD that is not a characteristic determined by the MLD's capability. Therefore, an MLD, while associated with a counterpart MLD, may transition to an EMLSR/EMLMR mode or terminate (release) an EMLSR/EMLMR mode in operation. An MLD that intends to transition to an EMLSR/EMLMR mode or terminate an EMLSR/EMLMR mode in operation should instruct a counterpart MLD that the MLD will change the state thereof related to the EMLSR/EMLMR mode. In this case, a method by which the MLD instructs the counterpart MLD that a change will be made to the state of the MLD related to the EMLSR/EMLMR mode may be to transmit an EML Control field including an EMLSR mode subfield and an EMLSR mode subfield. When an EMLSR mode subfield of an EML Control field transmitted by a specific MLD is set to 1, this implies that the specific MLD is operating in an EMLSR mode (has an STA operating in an EMLSR mode or has an EMLSR link set), and when the EMLSR mode subfield is set to 0, this implies that the specific MLD is not operating in the EMLSR mode. The interpretation of the EMLMR mode subfield is the same as the interpretation of the EMLSR mode subfield (EMLMR mode subfield of 1 implies operating in EMLMR mode, EMLMR mode subfield of 0 implies not operating in EMLMR mode).

However, a specific MLD is not allowed to operate in an EMLSR mode and an EMLMR mode simultaneously, so when the EMLSR mode subfield is set to 1, the EMLMR mode subfield cannot be set to 1. Similarly, when the EMLMR mode subfield is set to 1, the EMLSR mode subfield cannot be set to 1.

Furthermore, because the AP MLD does not operate an AP, operated by the AP MLD, in an EMLSR and an EMLMR mode, the AP MLD may not transmit an EML Control field having an EMLSR mode subfield or an EMLMR mode subfield that has been set to 1. Furthermore, the restriction of not transmitting the EML Control field may be applied to the AP MLD.

In one example, an MLD that intends to transition to an EMLSR mode may set an EMLSR mode subfield of an EML Control field, which is transmitted to a counterpart MLD, to 1. If a non-AP MLD transmits an EML Control field having an EMLSR mode subfield that has been set to 1, an AP MLD receiving the same may recognize that the non-AP MLD will operate with the EML Control field. If the EMLSR mode value of the EML Control field previously received by the AP MLD from the non-AP MLD was 1, and the EMLSR mode value of a newly received EML Control field is 0, the AP MLD may recognize that the non-AP MLD will not operate in an EMLSR mode after the Transition Timeout. Conversely, if the EMLSR mode value of an EML Control field previously received by the AP MLD from the non-AP MLD was 0 and the EMLSR mode value of a newly received EML Control field is 1, the AP MLD may recognize that the non-AP MLD will operate in an EMLSR mode after the Transition Timeout has elapsed. In this case, the Transition Timeout may be a mode change time required to transition to an EMLSR mode or to release (terminate) an EMLSR mode, and the corresponding delay value is EMLSR-related capability information indicated to the AP MLD from the non-AP MLD.

### <EMLSR Link Set Configuration>

As described above, an MLD may operate only some of STAs, operated by the MLD, in EMLSR/EMLMR mode. In this case, a link of an STA, among STAs operated by a specific MLD, which operates in an EMLSR/EMLMR mode may be referred to as an EMLSR/EMLMR link. That is, it may be understood that an MLD may have an EMLSR/EMLMR link set (pair) and an STA operating on an EMLSR/EMLMR link operates in an EMLSR/EMLMR mode.

Thus, a specific MLD having an EMLSR/EMLMR link set should indicate, to a counterpart MLD, information about a link on which the specific MLD operates in EMLSR or EMLMR, and a counterpart MLD may determine, based on EMLSR/EMLMR link set information indicated by the specific MLD, whether to perform transmission and whether to manage TXOP, when performing communication in the EMLSR link set. In this case, a method for determining whether to perform transmission and manage TXOP with respect to EMLSR/EMLMR has been described through the above-described embodiments of the present disclosure, so a detailed description thereof will be omitted (see, for example, embodiments in FIGS. 51 to 54).

Furthermore, for simplicity of description, the following description and embodiments primarily focus on an EMLSR mode, but the same invention may be utilized for an EMLMR mode.

An MLD that intends to operate an EMLSR link set (i.e., an MLD that intends to operate all or some of STAs, operated thereby, in EMLSR mode) may signal EMLSR link information to a counterpart MLD that intends to operate in EMLSR mode by including the EMLSR link information in an EML Control field. For example, a non-AP MLD that intends to operate an EMLSR link set may transmit a frame including an EML Control field to an AP MLD to indicate the EMLSR link set.

The EMLSR link set may be indicated using an EMLSR link Bitmap subfield included in the EML Control field. The EMLSR link Bitmap subfield is a subfield having a size of 16 bits (2 octets), wherein the first bit corresponds to Link0, the second bit corresponds to Link 1, and the fifteenth bit corresponds to Link 14. If each bit of the EMLSR link Bitmap subfield is set to 1, this implies that an STA of the corresponding link is operating in an EMLSR mode. That is, a link corresponding to a bit indicated as 1 in the EMLSR Link Bitmap subfield is a link included in the EMLSR link set. If the non-AP MLD sets each of the first bit and the second bit of the EMLSR Link Bitmap subfield to 1, the non-AP MLD indicates that Link0 and Link 1 are an EMLSR link set, and if there is an additional STA operating on another link, the additional STA is an STA that does not operate in an EMLSR mode. In this case, the EMLSR Link Bitmap subfield may be meaningful only when the EMLSR mode subfield is indicated as 1. That is, the EMLSR Link Bitmap subfield of the EML Control field, having the EMLSR mode subfield indicated as 0, may be reserved. (Each bit may be set to either 0 or 1). However, since the total number of links on which the MLD can operate an STA is limited to 15, the EMLSR Link Bitmap subfield may be configured to be 15 bits instead of 16 bits. A more detailed EMLSR Link Bitmap subfield configuration method will be described through an embodiment in FIG. 55 that will be described later.

### <EMLSR Primary Link Setup>

As described above, links (STAs) operating in an EMLSR mode may support transmission/reception on only one link at a time. Due to this performance limitation, an STA (e.g., an AP of an AP MLD) that performs transmission to an STA (e.g., a non-AP STA of a non-AP MLD) in EMLSR mode determines whether to perform transmission to the STA in the EMLSR mode by considering whether another STA in the same EMLSR link pair as the STA in the EMLSR mode is performing transmission/reception. Furthermore, an STA that is performing frame exchange with an STA in an EMLSR mode should terminate the frame exchange before the transmission time of a Beacon frame and/or a Group addressed frame (more specifically, before the frame transmission time-EMLSR Transition Delay) when it is predicted that another STA operating in the same EMLSR link pair as the STA in the EMLSR mode intends to receive the Beacon frame and/or the Group addressed frame. In this case, a method for predicting that the STA in EMLSR mode will intend to receive the beacon frame and/or the Group addressed frame is not determined by the specification, but may depend on the implementation of an MLD associated with an MLD in EMLSR mode.

However, an MLD operating an STA in EMLSR mode may indicate, to a counterpart MLD, information about a link on which the MLD intends to receive a Beacon frame/a Group addressed frame, thereby helping a counterpart MLD to more accurately predict the reception intent of the MLD (i.e., the intent to receive a Beacon frame and/or a Group addressed frame). That is, when an MLD operating an STA in EMLSR mode indicates a specific link on which the MLD intends to receive a Beacon/Group addressed frame, a counterpart MLD may predict that the MLD in the EMLSR mode intends to receive the Beacon/Group addressed frame transmitted on the specific Link. In this case, TXOP in which a specific STA of the EMLSR MLD is a TXOP holder or a TXOP responder may need to be terminated before (a target beacon transmission time (TBTT)-RF switching back delay) corresponding to a (DTIM) beacon frame of a link that the EMLSR MLD has indicated as a primary link. The TXOP management methods by the AP MLD and the EMLSR MLD for performing such TXOP management have been described through the embodiments in FIGS. 32 to 35 and a detailed description will be omitted.

For example, when a non-AP MLD operates Link 1 and Link 2 in EMLSR mode and indicates that the non-AP MLD intends to receive a Beacon/Group addressed frame on Link 1, an AP MLD may predict, before transmitting a beacon frame on Link 1, that the non-AP MLD will receive the beacon frame on Link 1, and terminate frame exchange on Link 2. On the other hand, when the AP MLD intends to transmit a beacon frame on Link 2, the AP MLD may predict that the non-AP MLD will not receive the beacon frame transmitted on Link 2, and may not terminate frame exchange on Link 1.

Thus, the non-AP MLD may indicate, in addition to information about a link operating in EMLSR mode (EMLSR link set information), information about a link on which the non-AP MLD intends to receive a Beacon/Group addressed frame. In this case, the link on which the non-AP MLD intends to receive the Beacon/Group addressed frame may be referred to as a primary link of an EMLSR link set. That is, the primary link has a higher priority in transmission/reception support than other EMLSR links.

The primary link may be indicated using an EMLSR Primary Link subfield, and links that may be indicated as the Primary Link are numbered from Link0 to Link 14 (15 in total). In view thereof, the EMLSR Primary Link subfield may be configured to be 4 bits.

When a non-AP MLD indicates a primary link through an EMLSR Primary Link subfield, the non-AP MLD should indicate only a link that is indicated as an EMLSR link through an EMLSR Link Bitmap subfield of the same EMLSR Control field. In other words, a non-AP MLD should indicate, through the EMLSR Primary Link subfield, only a link ID of a link that corresponds to a bit indicated as 1 in the EMLSR Link Bitmap subfield. That is, only an EMLSR link may be indicated as a primary link. For example, when the non-AP MLD has set a 2-octet EMLSR Link Bitmap subfield to 1110 0000 0000 0000 (indicate Link 0, Link 1, and Link 2 as an EMLSR link set), the non-AP MLD should indicate only 0, 1, or 2 (1, 2, or 3) through an EMLSR Primary Link subfield.

Furthermore, as with the above-described EMLSR Link Bitmap subfield, the EMLSR Primary Link subfield may be meaningful only when the EMLSR mode subfield is indicated as 1. That is, an EMLSR Primary Link subfield of an EML Control field, having an EMLSR mode subfield indicated as 0, may be reserved (may be set to 0 or a preset value (e.g., 15)).

When a non-AP MLD indicates an EMLSR Primary Link, the non-AP MLD is indicating that the non-AP MLD intends to receive a Beacon/Group addressed frame on the primary link. Therefore, the non-AP MLD may need to keep a link indicated as the primary link always in an awake state (not in a doze state due to Power Save). In other words, the non-AP MLD may be required not to perform Power Save on an STA of the primary link.

In addition, the indication of a primary link by the non-AP MLD implies that the non-AP MLD intends to prioritize supporting transmission/reception on a link indicated as the primary link over other EMLSR links. Therefore, the non-AP MLD should not indicate a disabled link (a link to which TDI is not mapped by TID-to-Link mapping) as the primary link.

Another applicable restriction may be that the non-AP MLD should operate the primary link in a Default mapping state. More specifically, the non-AP MLD may need to map all TIDs (both DL/UL directions, all of TID 0 to TID 7) to the primary link. This can be understood as a TID-to-Link mapping restriction to ensure that the primary link remains in a state in which all types of frame transmission/reception can be supported. However, transmission/reception on the primary link is restricted while transmission/reception is being performed on another EMLSR link.

Meanwhile, an MLD may have an STA that operates in EMLSR mode but may not operate/indicate a primary link separately. In this case, even when an EMLSR mode subfield of an EML Control field is set to 1, the MLD may not indicate primary link information through an EMLSR Primary Link subfield. In this case, a method for avoiding indicating EMLSR Primary Link information is to set the EMLSR Primary Link subfield to 15. This may be a method which does not indicate a primary link because there is no link corresponding to Link ID 15. Therefore, the MLD may set the EMLSR Primary Link subfield of the EML Control field to 15 when the MLD does not intend to establish a separate primary link in an EMLSR link set. If the AP MLD receives an EML Control field, which has an EMLSR mode subfield indicated as 1, from the MLD and an EMLSR Primary Link subfield of the same EML Control field is indicated as 15, the AP MLD should interpret that the MLD that transmitted the EML Control field did not indicate a separate primary link.

### <EMLSR Primary Link Setup Restriction>

Previously, it was shown that an MLD may select/indicate a primary link among an EMLSR link set, thereby helping a counterpart MLD to more accurately predict the reception intent of the MLD (the intent to receive a Beacon frame and/or a Group addressed frame).

However, there are the case in which even when a specific MLD does not indicate a primary link in an EMLSR link set, a counterpart MLD can clearly understand the specific MLD's reception intent, or the case in which it is unnecessary to determine on which link in the EMLSR link set the specific MLD intends to receive a Beacon/Group addressed frame.

For example, if a specific MLD operates another additional STA other than an STA operating in EMLSR mode, a counterpart MLD can predict that the specific MLD will receive a Beacon/Group addressed frame through the other STA which is not the STA operating in EMLSR mode.

As another example, if a specific MLD additionally operates an STA other than an STA operating in EMLSR mode, a counterpart MLD may operate without considering whether the specific MLD will receive a Beacon/Group addressed frame to be transmitted on a specific link. That is, the counterpart MLD may not terminate existing transmission or postpone a transmission start time in consideration of the Beacon/Group addressed frame transmission, and the specific MLD may receive the Beacon/Group addressed frame through the STA operating in EMLSR mode or the STA not operating in EMLSR mode.

Thus, if an MLD is operating an additional STA that is not in EMLSR mode, the MLD may not need to indicate a primary link to a counterpart MLD, and therefore, when there is an additional STA that is not in EMLSR mode, the MLD may be restricted from indicating a primary link through an EML Control field. That is, an MLD, which is associated with a counterpart MLD via an STA that is not in EMLSR mode, may not be allowed to indicate a primary link through an EML Control field.

More specifically, when a non-AP MLD transmitting an EML Control field does not set, to 1, an EMLSR Link Bitmap subfield corresponding to at least one of links on which non-AP MLD is associated with an AP MLD, the non-AP MLD may not be allowed to indicate a primary link through an EMLSR Primary Link subfield of the same EML Control field. In this case, a method for not indicating the primary link through the EMLSR Primary Link may be to set the EMLSR Primary Link subfield to a pre-agreed value.

Alternatively, the AP MLD may ignore the EMLSR Primary Link subfield when an EMLSR Link Bitmap subfield of the EML Control field received from the non-AP MLD does not indicate at least one associated link as an EMLSR link set (that is, when a bit corresponding to at least one associated link is indicated as 0). In this case, ignoring the EMLSR Primary Link subfield may be equivalent to considering the subfield to be reserved.

However, when all STAs other than STAs operating in EMLSR mode are in a doze state due to Power Save, the MLD may be allowed to transmit an EML Control field indicating that one of links of the STAs operating in EMLSR mode is a primary link. Similarly, when all STAs other than STAs operating in EMLSR mode are disabled by TID-to-Link mapping (when there are no TIDs mapped to links on which the other STAs operate), the MLD may be allowed to transmit an EML Control field indicating that one of links of the STAs operating in EMLSR mode is a primary link.

In the same context, even when the EMLSR Link Bitmap subfield of the EML Control field received from the non-AP MLD does not indicate at least one associated link as an EMLSR link set, the AP MLD may need to recognize a primary link of the non-AP MLD based on the value indicated in the EMLSR Primary Link subfield of the EML Control field received from the non-AP MLD, if all non-AP STAs (STAs of the non-AP MLD) of the associated links are in a Doze state due to Power Save. Similarly, even when the EMLSR Link Bitmap subfield of the EML Control field received from the non-AP MLD does not indicate at least one Associated Link as an EMLSR link set, AP MLD may need to recognize a primary link of the non-AP MLD based on the value indicated in the EMLSR Link Bitmap subfield of the EML Control field received from the non-AP MLD, if links on which non-AP STAs of the associated links operate are disabled.

Meanwhile, if a link that was not in the association state when the non-AP MLD transmitted a specific EML control field is additionally associated (through a re-setup procedure between the non-AP MLD and the AP MLD), the primary link indicated by the specific EML control field may be released. In this case, the primary link may be released as described above only when the non-AP STA of the additionally associated link is not operating in EMLSR mode. This can be understood as implying that the non-AP MLD has changed a state to having an associated STA other than an STA operating in EMLSR mode, as previously considered, so that the information about the previously indicated/configured primary link is no longer valid.

### <EML Control Field Format Embodiment>

The EML Control field may include the EMLSR mode, the EMLMR mode, the EMLSR link Bitmap, and the EMLSR Primary Link subfield, which have been described above. The EML Control field may be transmitted to operate in EMLSR/EMLMR mode, or to release an EMLSR/EMLMR mode in operation, and may be included in an EML Operating Mode Notification frame, which is an EHT Action frame, and transmitted. The EML Operating Mode Notification frame is a type of EHT Action frame, and is a frame distinguished in that the value of an EHT Action field of the EHT Action frame is indicated as 1. The EML Operating Mode Notification frame is an EHT Action frame including a Category field (set to a value of 36), an EHT Action field (set to a value of 1), a Dialog Token field (set to a non-zero value), and an EML Control field. The configuration of the EML Operating Mode Notification frame is independent of an EML Control field format configuration method intended to be provided by the present disclosure, so a detailed description will be omitted.

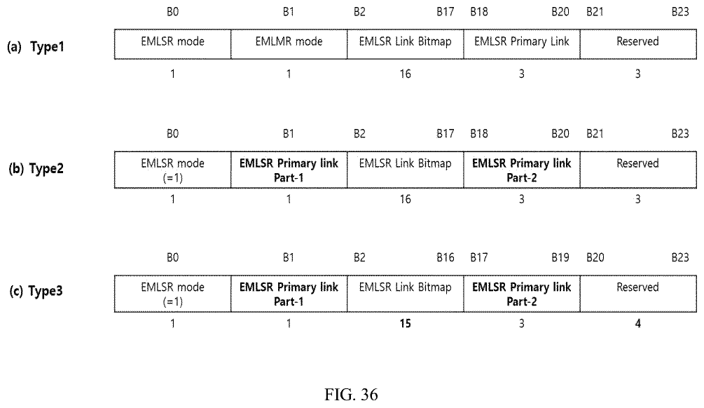

FIG. 36 illustrates various EML control field formats according to embodiments of the present disclosure.

Referring to FIG. 36(a), an EML Control field may have a 3-octet format including an EMLSR mode subfield (1-bit), an EMLMR mode subfield (1-bit), an EMLSR Link Bitmap subfield (16-bit), an EMLSR Primary Link subfield (3-bit), and a Reserved subfield (3-bit).

The EMLSR mode subfield may be set to 1 and transmitted when an MLD transmitting the EML Control field intends to operate in EMLSR mode, and may be set to 0 and transmitted when the MLD does not intend to operate in EMLSR mode. That is, a non-AP MLD may indicate whether to operate in EMLSR mode by setting the EMLSR mode subfield to 1 or 0. If an EMLSR mode subfield received from a specific non-AP MLD is indicated as 1, an AP MLD should, when performing frame exchange through a specific link in an EMLSR link set (indicated through an EMLSR Link Bitmap subfield) on which the specific non-AP MLD operates in EMLSR mode, determine the initiation/termination of the frame exchange in consideration of an operation performed or to be performed on another EMLSR link in the EMLSR link set (see FIGS. 32 to 35).

The EMLMR mode subfield may be set to 1 and transmitted when an MLD transmitting an EML Control field intends to operate in EMLMR mode, or may be set to 0 and transmitted when the MLD does not intend to operate in EMLMR mode. That is, a non-AP MLD may indicate whether to operate in EMLMR mode by setting the EMLMR mode subfield to 1 or 0.

The EMLSR Link Bitmap subfield is a subfield having a 16-bit (2-octet) size, wherein the first bit corresponds to Link0, the second bit corresponds to Link 1, and the fifteenth bit corresponds to Link 14. When each bit of the EMLSR Link Bitmap subfield is set to 1, this implies that an STA of the corresponding link is operated in EMLSR mode. In this case, the EMLSR Link Bitmap subfield may be meaningful only when the EMLSR mode subfield is indicated as 1. That is, the EMLSR Link Bitmap subfield of the EML Control field, which has the EMLSR mode subfield indicated as 0, may be reserved (all may be set to 0 or 1)

The EMLSR Primary Link subfield may be configured as 3 bits, and may indicate an ID of a link to operate as a primary link. For example, when the EMLSR Primary Link subfield is set to 1, a link corresponding to Link ID 1 is indicated as a primary link. Therefore, a non-AP MLD may set the EMLSR Primary Link subfield to a value of one of 0 to 7 to indicate a link corresponding to the Link ID as a primary link. However, a link that is indicated as a primary link through the EMLSR Primary Link subfield may need to be a link that corresponds to a bit indicated as 1 in the EMLSR Link Bitmap subfield of the same EML Control field. Also, the values that can be indicated by the EMLSR Primary Link subfield having a 3-bit size are limited to 0 to 7. Therefore, the non-AP MLD should determine/select/indicate one of links corresponding to Link ID 0 to Link ID 7 as a primary link.

Referring to FIG. 36(b), an EML Control field may have a 3-octet format including an EMLSR mode subfield (1-bit), an EMLSR Primary link Part-1 subfield (1-bit), an EMLSR Link Bitmap subfield (16-bit), an EMLSR Primary link Part-2 subfield (3-bit), and a Reserved subfield (3-bit).

A configuration method and an interpretation method for each subfield having the same size as that in FIG. 36(a) will be omitted.

In the above description of the EMLSR/EMLMR mode subfield, it was mentioned that when the EMLSR mode subfield is set to 1, the EMLMR mode subfield should be set to 0. This is a non-AP MLD operation restriction that an EMLSR mode and an EMLMR mode cannot be operated simultaneously, and therefore, both an EMLSR mode subfield and an EMLMR mode subfield included in a single EML Control field cannot be set to 1. Therefore, if an EMLSR mode subfield is set to 1, an EML Control field format in which an EMLMR mode subfield is omitted may be utilized. More specifically, when an EMLSR mode subfield is set to 1, a bit (B1 in FIG. 36) originally used as an EMLMR mode subfield may be used for a purpose other than its original purpose.

In the format embodiment shown in FIG. 36(a), since the size of the EMLSR Primary Link subfield is limited to 3 bits, there is a problem that the Link ID that can be indicated as a primary link is limited to 7 or less, so a method for utilizing a bit (B1), which is used as the EMLMR mode subfield, to indicate a primary link may be considered. That is, in an EML Control field having an EMLSR mode subfield that is set to 1, an EMLSR Primary Link Part-1 subfield is indicated instead of the EMLMR mode subfield, and the EMLSR Primary Link Part-1 subfield may be combined with an EMLSR Primary Link Part-2 subfield to indicate values corresponding to Link 0 to Link 15. In this case, a non-AP MLD may use the EMLSR Primary Link Part-1 and the EMLSR Primary Link Part-2 together to indicate an ID of a link that the non-AP MLD intends to indicate as a primary link. Similarly, when an EMLSR mode subfield (B0) of an EML Control field received from the non-AP MLD is indicated as 1, an AP MLD may interpret the second bit (B1 in FIG. 36) of the EMLSR Control field as an EMLSR Primary Link Part-1 subfield, and may recognize an ID of a link that the non-AP MLD has indicated as a primary link, based on the EMLSR Primary Link Part-1 subfield and the EMLSR Primary Link Part-2 subfield.

In this case, a method for indicating/interpreting the EMLSR Primary Link Part-1 subfield and the EMLSR Primary Link Part-2 subfield may consider a bit in the EMLSR Primary Link Part-1 subfield as a Most Significant Bit (MSB) and consider bits of the EMLSR Primary Link Part-2 subfield to be the remaining bits (B20 in FIG. 36(b) is a Least Significant Bit (LSB)). Alternatively, a method for indicating/interpreting the EMLSR Primary Link Part-1 subfield and the EMLSR Primary Link Part-2 subfield may consider the bit of the EMLSR Primary Link Part-1 subfield as a Least Significant Bit (LSB) and consider the bits of the EMLSR Primary Link Part-2 subfield to be the remaining bits (B20 in FIG. 55(b) is a Most Significant Bit (MSB)). The number indicated by a combination of the EMLSR Primary Link Part-1 and Part-2 is the ID of a link that is indicated as a primary link by the non-AP MLD.

In this case, the method of utilizing the bit utilized as the EMLMR mode subfield in FIG. 36(a) as the EMLSR Primary Link Part-1 subfield is a format modification method using the fact that the EMLMR mode subfield is a subfield that should always be indicated as 0 when the EMLSR mode subfield is 1. More specifically, the method is a method for omitting the EMLMR mode subfield, which should always be indicated as 0, only when the EMLSR mode subfield is indicated as 1, and utilizing the bit assigned to the EMLMR mode subfield for indicating the EMLSR Primary Link. In summary, the formats of the EML control subfield, considered in the present disclosure, are different when the EMLSR mode subfield is indicated as 0 and when the EMLSR mode subfield is indicated as 1, and the bit of the EMLMR mode subfield, which are omitted because the EMLSR mode subfield is indicated as 1, is utilized to indicate EMLSR Primary Link information.

Referring to FIG. 36(c), an EML Control field may have a 3-octet format including an EMLSR mode subfield (1-bit), an EMLSR Primary link Part-1 subfield (1-bit), an EMLSR Link Bitmap subfield (15-bit), an EMLSR Primary link Part-2 subfield (3-bit), and a Reserved subfield (4-bit).

A configuration method and an interpretation method of subfields having the same sizes and positions as those in FIGS. 36(a) and 36(b) will be omitted.

For reference, an MLD may operate an STA on up to 15 links, and therefore the IDs of links on which an AP MLD operates APs have values corresponding to Link 0 to Link 14. The limit of the number of links, 15, is the number of links determined with consideration for the scalability, signaling overhead, and complexity of EHT (11be) and the subsequent generation standard, and is not a value that is derived from a limitation/problem that the number of links must be determined to be 15. The signaling of many MLD unit operations defined in the EHT includes a Link ID subfield or a Link Bitmap indicating a link to which signaling information exchanged between MLDs is related. In this case, in relation to the typically considered size of each subfield, the Link ID subfield has a 4-bit size, and the Link Bitmap subfield has a 2-octet (16-bit) size. Of these, the Link Bitmap subfield is configured in a 2-octet size because octets including the number of bits closest to the number (15) of links which an MLD can have 2 octets (16 bits), and in most MLD unit signaling, the Link Bitmap subfield (including other named subfields with bits corresponding to each link) is defined as 2 octets. However, in the case of an EML Control field having a 3-octet size, if an EMLSR/EMLSR mode subfield, an EMLSR Link Bitmap subfield, and an EMLSR Primary Link subfield are excluded, only 3 bits (as shown in FIGS. 36(a) and (b)) remain as reserved bits. In this case, if additional signaling is performed using only the 3 bits in the subsequent generation standard, usability may be reduced due to the limited number of bits.

Therefore, in the EML Control field, one additional bit may be ensured as a reserved bit by considering the EMLSR Link Bitmap subfield to be 15 bits in size. In this case, as the size of the EMLSR link Bitmap is reduced by 1 bit, the EMLSR Primary Link Part-2 subfield may be indicated using B17 to B19 of the EML Control field, and B20 to B23 may become a Reserved subfield. Alternatively, in another method, the EMLSR Primary Link Part-2 may be indicated using B18 to B20, B17 may be a first Reserved subfield, and B21 to B23 may be a second Reserved subfield (see FIG. 36(c)).

The above-described restriction that a link that can be indicated as an EMLSR Primary link must not be a disabled link (i.e., a link with no TIDs mapped by TID-to-Link mapping) may be a restriction that is applied to EMLSR links in general. In other words, it is possible for an EMLSR link to be limited to a link that is not in a disabled state, i.e., enabled. Therefore, a non-AP MLD may need to indicate/set, as/to 1, only bits corresponding to an enabled link among bits of an EMLSR Link Bitmap subfield transmitted by the non-AP MLD. This restriction may be described as an obvious EMLSR link setup restriction, given that non-AP MLD do not perform frame exchange through a disabled link.

### <TID-to-Link Mapping Management Method Related to EMLSR Operation>

In the above-described some embodiments of the present disclosure, a non-AP MLD operating in EMLSR mode has been required to apply a default TID-to-link mapping mode to EMLSR links.

However, because an EMLSR mode operation and TID-to-Link mapping provides independent functions, a non-AP MLD operating a non-AP STA in EMLSR mode may still be allowed to perform a TID-to-Link mapping negotiation. That is, the non-AP MLD may be allowed to map different TIDs to EMLSR links by performing a TID-to-Link mapping negotiation with an AP MLD, rather than applying the default TID-to-Link mapping mode to the EMLSR links.

However, even if the TID-to-link mapping negotiation for an EMLSR link is performed between the AP MLD and the non-AP MLD, the restriction that a disabled link cannot be an EMLSR link may still need to be applied. As MLD operation methods considering the restriction, there are two methods: 1. A method primarily considering EMLSR link setup, and 2. A method primarily considering TID-to-link mapping.

The MLD operation method primarily considering an EMLSR link setup, as the first method, may be to restrict a TID-to-link mapping negotiation such that the non-AP MLD's EMLSR link does not transition to a disabled state when a non-AP MLD and an AP MLD perform the TID-to-link mapping negotiation.

An MLD transmitting a TID-to-Link Mapping Request/Response frame should propose TID-to-Link mapping in which each EMLSR link is not disabled. More specifically, an MLD, which transmits a TID-to-Link Mapping element to a counterpart MLD, should transmit a TID-to-Link Mapping element that maps at least one TID to each of EMLSR links of the MLD and/or the counterpart MLD. In this case, the TID-to-Link Mapping element is an element that may be included in a TID-To-Link Mapping Request/Response frame, or an Association Request/Response frame, and is an element including link information to be mapped to each TID.

Further, even when a TID-to-link mapping negotiation between the two MLDs is completed, the completed negotiation may be invalid if the result of the completed negotiation is to switch at least one EMLSR link to a disabled state. In this case, the completion of the TID-to-link mapping negotiation implies that the MLD having transmitted a TID-To-Link Mapping Response frame accepts a TID-to-link mapping state requested by the other MLD. In this case, the presence or absence of the acceptance may be identified by a status code, included in the TID-To-Link Mapping Response frame, being set to “accept”. In this case, in a negotiation performed using an Association Request frame, the proposed TID-to-link mapping state may be accepted by not including a TID-to-link mapping element in an Association Response frame.

That is, the MLD that performed the TID-to-link mapping negotiation should determine that the TID-to-link mapping change is valid/successful only when each TID is mapped to at least one setup link or when at least one TID is mapped to each EMLSR link.

As a result, if the MLD operates according to the first method described above, the EMLSR link is prevented from transitioning to a disabled state as a result of the TID-to-link mapping negotiation.

The MLD operation method primarily considering TID-to-link mapping, as the second method, may be to release an EMLSR mode of a link that switches to a disabled state as a result of a TID-to-link mapping negotiation performed between two MLDs.

More specifically, an MLD may perform TID-to-link mapping with a counterpart MLD without considering whether each setup link is an EMLSR link. If, as a result of the TID-to-link mapping negotiation between the two MLDs, a specific EMLSR link of a non-AP MLD should transition (switch) to “Disable”, the specific EMLSR link may be switched to no longer be an EMLSR link. That is, an STA of the non-AP MLD operating on the specific EMLSR link will no longer operate in EMLSR mode. As a simple example, when a non-AP MLD having three EMLSR links (Link 1, Link 2, and Link 3) has performed a TID-to-Link mapping negotiation with an AP MLD, and when one EMLSR link (Link 1) among the three EMLSR links is transitioned to a disabled state, the non-AP MLD may operate only the remaining two links (Link 2 and Link 3) as EMLSR links, excluding the link (Link 1) transitioned to the disabled state.

Furthermore, there is a situation in which the non-AP MLD must terminate the EMLSR mode of another EMLSR link as well as an EMLSR link that is transitioned to a disabled state by TID-to-link mapping. More specifically, a non-AP MLD may need to terminate the operation of EMLSR mode if the number of the remaining EMLSR links is 1 or 0 when the EMLSR mode of an EMLSR link that is transitioned to a disabled state by TID-to-link mapping is released. That is, a non-AP MLD must terminate the EMLSR mode of all EMLSR links if the number of EMLSR links switched by TID-to-link mapping is 1 or 0. As a simple example, if a non-AP MLD having two EMLSR links performs TID-to-link mapping with an AP MLD and when one of the two EMLSR links is scheduled to be transitioned to a disabled state, the non-AP MLD should terminate (release) the EMLSR mode of the remaining EMLSR links as well as the EMLSR link that is transitioned to the disabled state. This may be an EMLSR link management method considered because an operation in EMLSR mode is meaningful when there are at least two EMLSR links. More specifically, if only one non-AP STA among non-AP STAs operated by a non-AP MLD operates in EMLSR mode, operations such as an operation of performing MIMO by using the RF of another EMLSR link cannot be performed, and consequently, only an unnecessary operation related to an Initial Control frame is added. Therefore, the non-AP MLD does not need to operate only one EMLSR link, and furthermore, it is unreasonable to operate only one EMLSR link. For this reason, when the number of EMLSR links has been changed (or should be changed) by TID-to-Link mapping, the non-AP MLD should not operate in EMLSR mode if the number of the remaining EMLSR links is 1 or 0. (The non-AP MLD should not have a non-AP STA operating in EMLSR mode.)

Alternatively, as another method, a TID-to-Link mapping restriction for preventing an EMLSR mode from being terminated may be considered. More specifically, it is allowed to perform TID-to-Link mapping for an EMLSR link, but TID-to-Link mapping in which only 1 or 0 EMLSR links are enabled as a result of a TID-to-Link mapping negotiation may be restricted (invalidated or ignored). That is, a change caused by the TID-to-Link mapping may be considered to be valid only when the TID-to-Link mapping change maintains at least 2 EMLSR links in an enabled state (at least 1 TID mapped). Therefore, when performing TID-to-Link mapping, an MLD should perform a TID-to-Link mapping in which at least two of EMLSR links thereof or EMLSR links of a counterpart MLD remain enabled. That is, the MLD should not perform TID-to-Link mapping in which zero or only one EMLSR link is enabled.

A method by which a non-AP MLD switches an EMLSR link to a link which is no longer be an EMLSR link and a method by which the non-AP MLD terminates an EMLSR mode will be described in more detail in the embodiments that will be described later.

According to an embodiment of the present disclosure, when TID-to-Link mapping in which an EMLSR link is transitioned to a disabled state has been performed (requested and accepted), a non-AP MLD should transmit, to an AP MLD, a frame excluding the disabled link from an EMLSR link set (pair). In this case, the frame excluding the disabled link from the EMLSR link set refers to a frame including an EMLSR Link Bitmap subfield in which a bit corresponding to the disabled link is set to 0, an EML Operating Mode Notification frame in which an EMLSR Mode subfield is set to 0, etc. (1. to 3. below describe the operation of a non-AP MLD according to an embodiment of the present disclosure.)

1. Firstly, in order to release the EMLSR mode of a link transitioned to a disabled state, a non-AP MLD may transmit, to the AP MLD, an EML Operating Mode Notification frame in which the bit of an EMLSR Link Bitmap subfield corresponding to the disabled link is set to 0. That is, when an EMLSR link is transitioned to a disabled state by TID-to-link mapping, the non-AP MLD may transmit, to the AP MLD, an EML Operating Mode Notification frame indicating that only links other than the disabled link are EMLSR links. In this case, the non-AP MLD may need to transmit a frame for releasing the EMLSR mode of the link being transitioned to the disabled state, together with a TID-to-link mapping Request/Response frame transmitted to transition the link to the disabled state. (The AP MLD may transmit an EML Operating Mode Notification frame to the non-AP MLD in response to the EML Operating Mode Notification frame received from the non-AP MLD.)

2. Secondly, to release the EMLSR mode of a link transitioned to a disabled state and other EMLSR links, the non-AP MLD may transmit, to the AP MLD, an EML Control field in which an EMLSR Mode subfield is set to 0. That is, when a specific EMLSR link is transitioned to a disabled state by TID-to-link mapping, the non-AP MLD may operate to release the EMLSR mode of the specific EMLSR link and all other EMLSR links so that the disabled link does not become an EMLSR link. In this case, the non-AP MLD may need to transmit a frame having an EMLSR Mode subfield set to 0 (e.g., an EML Operating Mode Notification frame, a frame including an EML Control field, etc.), together with a TID-to-link mapping Request/Response frame transmitted to transition the specific link to the disabled state.

3. Thirdly, when the number of EMLSR links other than a link transitioned to a disabled state is 1 or 0, the non-AP MLD should transmit, to the AP MLD, an EML Control field having an EMLSR Mode subfield set to 0. In this case, the non-AP MLD may need to transmit a frame having an EMLSR Mode subfield set to 0 (e.g., an EML Operating Mode Notification frame, a frame including an EML Control field, etc.), together with a TID-to-link mapping Request/Response frame transmitted to transition the specific link to the disabled state.

According to another embodiment of the present disclosure, when a TID-to-link mapping negotiation in which at least one of EMLSR links is transitioned to a disabled state is performed (requested/accepted), an EMLSR link set of a non-AP MLD may be changed even if no separate EML Operating Mode Notification frame is exchanged between MLDs.

This is because it can be understood that, in the process in which the two MLDs (the AP MLD and the non-AP MLD) perform a TID-to-link mapping negotiation, an indication/acceptance (response) for terminating the EMLSR mode of the specific EMLSR link and transitioning the specific EMLSR link to a disabled state has been exchanged between the two MLDs. That is, when a TID-to-Link mapping negotiation to transition a specific EMLSR link to a disabled state is completed (requested/accepted) between two MLDs, the two MLDs may be understood to have implicitly indicate/responded to terminating the EMLSR mode of the specific EMLSR link (ended, terminated, disabled). In this case, the non-AP MLD may need to (re) transmit, to the AP MLD, an EML Operating Mode Notification frame indicating that only links other than the disabled link are EMLSR links. This may be an operation of the non-AP MLD considering that the previously transmitted EML Operating Mode Notification frame has failed to be transmitted or failed to provide the indication. If the AP MLD further receives other EML Operating Mode Notification frames from the non-AP MLD before responding to the EML Operating Mode Notification frame received from the non-AP MLD, the AP MLD may need to consider that only the last received EML Operating Mode Notification frame is valid. That is, the AP MLD may ignore other EML Operating Mode Notification frames received before the last received EML Operating Mode Notification frame.

Furthermore, when a newly performed TID-to-Link mapping negotiation between two MLDs results in keeping only one or zero EMLSR links enabled, the EMLSR mode of the non-AP MLD is changed even if no separate EML Operating Mode Notification frame is exchanged between the MLDs. In this case, as a result of the EMLSR mode change, the non-AP MLD operates in an operation mode (a mode without an EMLSR link) other than an EMLSR mode. In this case, even when the non-AP MLD has not performed separate indication, the AP MLD should determine that the non-AP MLD has switched to an operating mode other than the EMLSR mode, and then operate. That is, when the AP MLD intends to initiate frame exchange with the non-AP MLD, the AP MLD does not need to transmit an Initial Control frame, no matter which link the AP MLD attempts the frame exchange on.

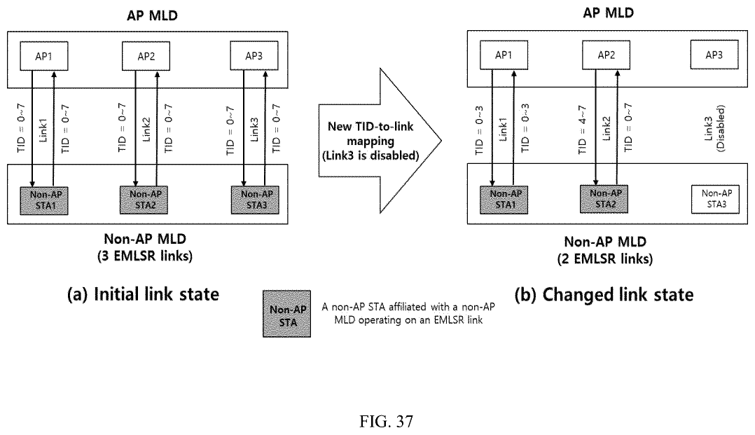

FIG. 37 illustrates an example in which an EMLSR link is removed after performing TID-to-link mapping according to an embodiment of the present disclosure.

Referring to FIG. 37(a), a non-AP MLD is connected to an AP MLD through Link 1, Link 2, and Link 3. That is, the non-AP MLD has completed a setup (association, etc.) with the AP MLD on the three links through a multi-link (re) setup. Furthermore, the non-AP MLD is operating, as EMLSR links, all of the three links on which the non-AP MLD is connected to the AP MLD. The AP MLD and non-AP MLD perform a new TID-to-link mapping negotiation procedure, and Link 3 is transitioned to a disabled state as the negotiated new TID-to-link mapping is applied.

Referring to FIG. 37(b), as Link 3 is disabled, the non-AP MLD switches Link 3 to a link that is no longer an EMLSR link. That is, non-AP STA 3 operating on Link 3 is no longer operating in EMLSR mode. In this case, the non-AP MLD may transmit, to the AP MLD, an EML Operating Mode Notification frame in which a bit corresponding to Link 3, among bits of the EMLSR Link Bitmap subfield, is set to 0 (bits corresponding to Link 1 and Link 2 are set to 1).

However, the AP MLD recognizes that Link 3 of the non-AP MLD is in a disabled state, and thus, even when no EML Operating Mode Notification frame exchange is not performed between the AP MLD and the non-AP MLD, it is possible for the non-AP MLD to release the EMLSR mode of Link 3, and for the AP MLD to perform an operation considering that Link 3 of the non-AP MLD is no longer in EMLSR mode.

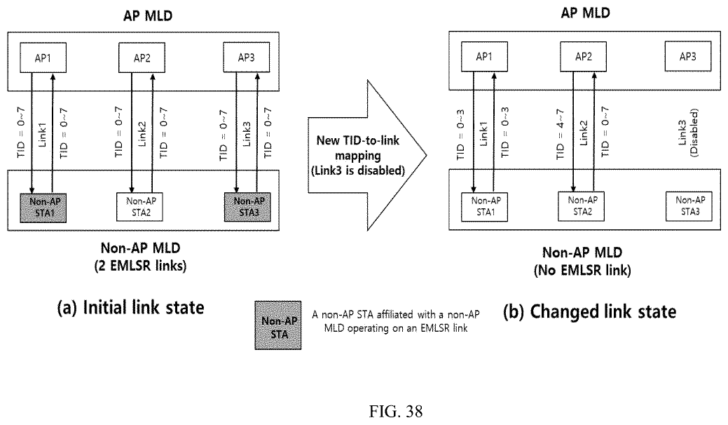

FIG. 38 illustrates an example in which an EMLSR mode of a non-AP MLD is released after performing TID-to-link mapping according to an embodiment of the present disclosure.

Referring to FIG. 38(a), a non-AP MLD is connected to an AP MLD through Link 1, Link 2, and Link 3. That is, the non-AP MLD has completed a setup (association, etc.) with the AP MLD on the three links through a Multi-link (re) setup.

Furthermore, the non-AP MLD is operating, as EMLSR links, Link 1 and Link 3 among the three links on which the non-AP MLD is connected to the AP MLD. The AP MLD and the non-AP MLD perform a new TID-to-link mapping negotiation procedure, and Link 3 is transitioned to a disabled state as the negotiated new TID-to-link mapping is applied.

Referring to FIG. 38(b), as Link 3 is disabled, the non-AP MLD transitions Link 3 to no longer be an EMLSR link. That is, non-AP STA 3 operating on Link 3 is no longer operating in EMLSR mode. Furthermore, given that there is only one remaining EMLSR link (Link 1) other than Link 3 of which EMLSR mode is released, the non-AP MLD also releases the EMLSR mode of Link 1. That is, the EMLSR mode of the non-AP MLD is released because the non-AP MLD no longer has an EMLSR link. In this case, to release the EMLSR mode, the non-AP MLD may transmit an EML Operating Mode Notification frame having an EMLSR Mode subfield set to 0 to the AP MLD.

However, because the AP MLD recognizes that Link 3 of the non-AP MLD will transition to a disabled state and that there is only one remaining EMLSR link of the non-AP MLD, it is possible for the AP MLD to determine that the EMLSR mode of the non-AP MLD will be released even when no EML Operating Mode Notification frame exchange between the AP MLD and the non-AP MLD is performed. Accordingly, the non-AP MLD may release the EMLSR mode on its own without transmitting an EML Operating Mode Notification frame for releasing the EMLSR mode, and the AP MLD may perform an operation considering that the EMLSR mode of the non-AP MLD has been released, without receiving, from the non-AP MLD, the EML Operating Mode Notification frame indicating that the EMLSR mode of the non-AP MLD has been released.

<EMLSR Link Setup and TID-to-Link Mapping Negotiation Management Method that are Simultaneously Performed>

During the time when an AP MLD and a non-AP MLD are connected via multiple links and the non-AP MLD generates and transmits an EMLSR link Bitmap subfield, the TID-to-Link mapping state between the AP MLD and the non-AP MLD may be changed. For example, before the non-AP MLD transmits the EMLSR link Bitmap subfield via a first link, the TID-to-Link mapping state between the AP MLD and the non-AP MLD may be changed by a new TID-to-Link mapping negotiation performed on another link. If the changed TID-to-Link mapping state has transitioned a link of a bit set to 1 in the EMLSR link Bitmap subfield to a disabled state, the AP MLD identifies that the bit corresponding to the disabled link of the non-AP MLD has been indicated as 1 when receiving the EMLSR link Bitmap subfield. This may occur because the TID-to-Link mapping state before the non-AP MLD sets the EMLSR link Bitmap subfield may be different from the TID-to-Link mapping state at the time when the EMLSR link Bitmap subfield is received by the AP MLD.

Therefore, the AP MLD may need to interpret the received EMLSR link Bitmap subfield in light of the current TID-to-Link mapping state of the non-AP MLD that transmitted the EMLSR link Bitmap subfield. In this case, the current TID-to-Link mapping state implies a TID-to-Link mapping state at the time when the EMLSR link Bitmap subfield is received.

In the simplest method, if the EMLSR link Bitmap subfield received from the non-AP MLD indicates that the non-AP MLD's disabled link is an EMLSR link (if the bit in the EMLSR link Bitmap subfield corresponding to the disabled link is set to 1), the AP MLD may ignore the received EMLSR link Bitmap subfield (or an EML Operating Mode Notification frame including the EMLSR link Bitmap subfield). That is, in this case, the AP MLD does not respond to the EML Operating Mode Notification frame including the received EMLSR link Bitmap subfield.

In another method, the AP MLD may consider that a bit corresponding to the disabled link of the non-AP MLD, among bits of the EMLSR link Bitmap subfield transmitted by the non-AP MLD, is reserved (i.e., may ignore the bit corresponding to the disabled link). That is, even when the EMLSR link Bitmap subfield received from the non-AP MLD indicates the disabled link of the non-AP MLD as an EMLSR link, the AP MLD may interpret the disabled link as not being indicated as an EMLSR link. In this case, the non-AP MLD may consider that among bits indicated as 1 by the non-AP MLD in the EMLSR link bitmap subfield, only links which are enabled at the time of receiving an EML Operating Mode Notification frame from the AP MLD are EMLSR links. For example, if the non-AP MLD has transmitted an EMLSR link Bitmap subfield in which three bits corresponding to three links are set to 1, but only two of the three links are enabled at the time of receiving the EML Operating Mode Notification frame from the AP MLD, the non-AP MLD may operate as if only the two links have been indicated as EMLSR links. In this case, the AP MLD may need to operate as if only a link of the non-AP MLD that is enabled at the time the AP MLD transmits the EML Operating Mode Notification frame to the non-AP MLD has been indicated as an EMLSR link. That is, in the same situation as in the above example, the AP MLD may need to operate as if, among three links indicated as EMLSR links by the non-AP MLD, only two links that remain enabled at the time the AP-MLD transmits the EML Operating Mode Notification frame were indicated as EMLSR links by the non-AP MLD. That is, the AP MLD should determine that the non-AP MLD is operating only the two links remaining enabled as EMLSR links, and should operate. In this case, in the EMLSR link Bitmap subfield of the EML Operating Mode Notification frame that the AP MLD transmits to the non-AP MLD, only two bits corresponding to the two remaining links may each be set to 1.

That is, the AP MLD may respond to the non-AP MLD with an EML Operating Mode Notification frame that has a different set value from the EML Operating Mode Notification frame received from the non-AP MLD. More specifically, the AP MLD may respond to the non-AP MLD with an EML Operating Mode Notification frame indicating that only some of EMLSR links indicated by the EMLSR Operating Mode Notification frame received from the non-AP MLD are EMLSR links.

Therefore, the non-AP MLD should operate, in EMLSR mode, only STAs of the links indicated as EMLSR links in the EML Operating Mode Notification frame received from the AP MLD, not the EMLSR links indicated in the EML Operating Mode Notification frame that the non-AP MLD has transmitted to the AP MLD.

However, when a number of EMLSR links excluding the disabled link among the links indicated as EMLSR links by an EMLSR link Bitmap subfield is less than 2 (i.e., 0 or 1), an EML Operating Mode Notification frame including the EMLSR link Bitmap subfield may be considered to be invalid. That is, the non-AP MLD operates as if the non-AP MLD did not transmit an EML Operating Mode Notification frame, and the AP MLD operates as if the AP MLD did not receive the EML Operating Mode Notification frame from the non-AP MLD. That is, in this case, an EMLSR link set (pair) of the non-AP MLD is not changed.

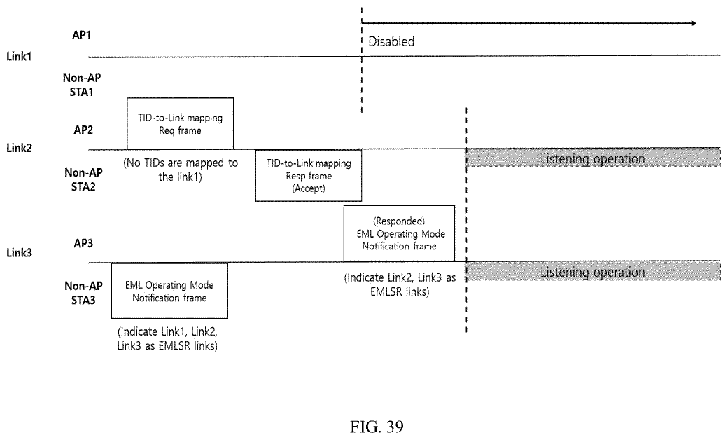

FIG. 39 illustrates an example of an operation in which a non-AP MLD and an AP MLD set up an EMLSR link in consideration of changed TID-to-link mapping according to an embodiment of the present disclosure.

Referring to FIG. 39, an AP MLD and a non-AP MLD are multilinked through three links (Link 1, Link 2, and Link 3). Non-AP STA 3, which is the STA of the non-AP MLD operating on Link 3, transmits, to the AP MLD (AP 3), an EML Operating Mode Notification frame indicating that Link 1, Link 2, and Link 3 are EMLSR links. At the same time, the AP MLD transmits a TID-to-Link mapping Request frame, which transitions the non-AP MLD's Link 1 to a disabled state (in which no TIDs are mapped to Link 1), to the non-AP MLD via AP 2. The non-AP MLD transmits a respond by using a TID-to-Link mapping Response frame that accepts TID-to-Link mapping requested by the AP MLD, so that Link 1 is transitioned to a disabled link for the non-AP MLD.

In this case, considering that the previous EML Operating Mode Notification frame, which indicated Link 1 as an EMLSR link, failed in the indication, the non-AP MLD may retransmit, to the AP MLD, an EML Operating Mode Notification frame indicating only Link 2 and Link 3 as EMLSR links. (Not shown in FIG. 39)

Considering that among the links indicated as EMLSR links in the EML Operating Mode Notification frame received from the non-AP MLD, Link 1 cannot be utilized as an EMLSR link, The AP MLD may indicate only Link 2 and Link 3 as EMLSR links in an EML Operating Mode Notification frame transmitted to the non-AP MLD as a response.

<Method for Managing EMLSR Links when the Link Configuration of an AP MLD Changes>

When a non-AP MLD transitions to EMLSR mode, the non-AP MLD transmits an EML Operating Mode Notification frame to an AP MLD, and the AP MLD transmits an EML Operating Mode Notification frame to the non-AP MLD in response to the received EML Operating Mode Notification frame. In this case, the EML Operating Mode Notification frame transmitted by the AP MLD in response should be transmitted to within a time interval indicated by the AP MLD. The time interval indicated by the AP MLD implies the time interval indicated in a Transition Timeout subfield of an EML Capabilities subfield transmitted by the AP MLD. For reference, the EML Capabilities subfield is included in a Basic Multi-Link element. For example, an AP MLD that indicates 1 TU in the Transition Timeout subfield should transmit an EML Operating Mode Notification frame to a non-AP MLD within 1 TU in response to an EML Operating Mode Notification frame received from the non-AP MLD. The Transition Timeout time that an AP MLD can indicate may range from 0 TUs to a maximum of 128 TUs.

Table 2 below shows an example of Transition Timeout indication values and the interpretation of indicated times.

TABLE 2

| Transition Timeout | | |
|---|---|---|
| subfield value | Transition timeout | |
| 0 | 0 | TUs |
| 1 | 128 | us |
| 2 | 256 | us |
| 3 | 512 | us |
| 4 | 1 | TU |
| 5 | 2 | TUs |
| 6 | 4 | TUs |
| 7 | 8 | TUs |
| 8 | 16 | TUs |
| 9 | 32 | TUs |
| 10 | 64 | TUs |
| 11 | 128 | TUs |

| | |
|---|---|
| 12-15 | Reserved |

As such, the time point at which the AP MLD transmits an EML Operating Mode Notification frame may differ by up to 100 TUs or more from the time point at which the non-AP MLD transmits an EML Operating Mode Notification frame, and thus the AP MLD's link configuration may change before the AP MLD transmits the EML Operating Mode Notification frame in response. For example, there is a situation in which a link that is operated by an AP of the AP-MLD at the time the AP MLD receives an EML Operating Mode Notification frame from the non-AP MLD is no longer operated at the time the AP MLD responds with an EML Operating Mode Notification frame. That is, the link configuration is changed or planned, such as the number of links of the AP MLD changing before responding with the EML Operating Mode Notification frame. In this case, a link that the non-AP MLD intended to transition to an EMLSR link via an EML Operating Mode Notification frame may become a link on which the AP MLD is not operating an AP (or is planning to remove the AP through a reconfiguration procedure) at a time point at which the AP MLD responds with the EML Operating Mode Notification frame.

In the following description, it is described that when the AP MLD plans to remove a specific AP through a reconfiguration procedure, the AP MLD is considered not to have a link of the specific AP.

The AP MLD may need to perform an operation considering the difference between link configurations at the time of receiving an EML Operating Mode Notification frame from the non-AP MLD and at the time of responding to the non-AP MLD with an EML Operating Mode Notification frame.

In the simplest method, if, among links that existed at the time an EML Operating Mode Notification frame was received from the non-AP MLD (i.e., links on which APs were being operated), there is a link that no longer exists at the time the AP MLD responds with an EML Operating Mode Notification frame (i.e., a link on which an AP is not operating, or an AP is planned to be removed), the AP MLD may need to refrain from responding to the received EML Operating Mode Notification frame.

In another method, if a link that existed at the time the EML Operating Mode Notification frame was received from the non-AP MLD (a link on which an AP was being operated) no longer exists at the time the AP MLD responds with an EML Operating Mode Notification frame, and the link was set up with the non-AP MLD that transmitted the EML Operating Mode Notification frame, the AP MLD may need to refrain from responding to the received EML Operating Mode Notification frame.

In another method, if a link that existed at the time an EML Operating Mode Notification frame was received from the non-AP MLD (i.e., a link on which an AP was being operated) no longer exists at the time the AP MLD responds with an EML Operating Mode Notification frame, and the link is a link that was indicated as an EMLSR link by the non-AP MLD that transmitted the EML Operating Mode Notification frame, the AP MLD may need to refrain from responding to the received EML Operating Mode Notification frame.

Additionally, if at least two of links indicated as EMLSR links by the non-AP MLD are still existing links (links on which APs are operated), the AP MLD may interpret only the still existing links as being indicated as EMLSR links and respond to the non-AP MLD with an EML Operating Mode Notification frame.

That is, the AP MLD may need to respond with an EML Operating Mode Notification frame indicating that, among links indicated as EMLSR links in an EML Operating Mode Notification frame transmitted by the non-AP MLD, only links still existing at the time the AP MLD responds with an EML Operating Mode Notification frame are EMLSR links.

In this case, the non-AP MLD should transition, to EMLSR links, only the links indicated as EMLSR link in the EML Operating Mode Notification frame received from the AP MLD, not the links indicated as EMLSR link in the EML Operating Mode Notification frame transmitted by the non-AP MLD. In this case, A method by which an EMLSR link is indicated in the EML Operating Mode Notification frame may be that a link corresponding to a bit indicated as 1 among bits of an EMLSR link Bitmap subfield included in the EML Operating Mode Notification frame is indicated as an EMLSR link.

Alternatively, the non-AP MLD, which receives information related to a Multi-Link reconfiguration indicated by the AP MLD and recognizes that a specific link will be removed, may (re)transmit, to the AP MLD, an EML Operating Mode Notification frame indicating that only links other than the specific link are EMLSR links. This may be an operation of the non-AP MLD considering that the previously transmitted EML Operating Mode Notification frame failed in transmission or in indication. When, before responding to an EML Operating Mode Notification frame received from the non-AP MLD, the AP MLD further receives another EML Operating Mode Notification frame from the non-AP MLD, the AP MLD may need to consider that only the last received EML Operating Mode Notification frame is valid. That is, other EML Operating Mode Notification frames received prior to the last EML Operating Mode Notification frame may be ignored.

Furthermore, an EMLSR mode operated by the non-AP MLD may be changed/terminated by a multi-link reconfiguration operation performed by the AP MLD. More specifically, one or more of EMLSR links operated by the non-AP MLD may be removed by a multi-link reconfiguration operation performed by the AP MLD.

In this case, the non-AP MLD should perform an operation that considers the removed link. That is, the non-AP MLD should transmit, to the AP MLD, an EML Operating Mode Notification frame indicating that the removed link (the link of the removed AP) is not an EMLSR link, or should consider that the removed link has been excluded from an EMLSR link set without separate signaling.

The operation method considering the link removed by the multi-link reconfiguration operation is the same as the operation method considering the link switched/transitioned to a disabled state by TID-to-Link mapping, so the detailed description will be omitted. The operation considering the disabled link described above can be utilized equally when the disabled link is switched to a link removed by the Multi-link reconfiguration operation. For example, a non-AP MLD that operates two EMLSR links (Link 1 and Link 2) should terminate the EMLSR mode of the remaining EMLSR link (Link 2) when one (Link 1) of the two EMLSR links is removed as a result of the Multi-Link reconfiguration performed by an AP MLD (That is, the non-AP MLD terminates the EMLSR mode).

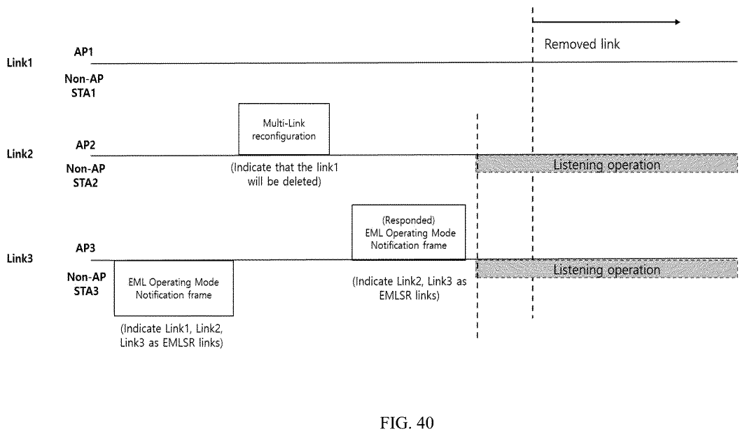

FIG. 40 illustrates one example of an operation in which a non-AP MLD and an AP MLD set up an EMLSR link in consideration of a changed link configuration of the AP MLD according to an embodiment of the present disclosure.

Referring to FIG. 40, the AP MLD and the non-AP MLD are multilinked through three links (Link 1, Link 2, and Link 3). Non-AP STA 3, which is the STA of the non-AP MLD operating on Link 3, transmits, to the AP MLD (AP 3), an EML Operating Mode Notification frame indicating that Link 1, Link 2, and Link 3 are EMLSR links. The AP MLD transmits, through Link 2, a reconfiguration multi-link element information indicating that the AP MLD will remove AP 1 operating on Link 1.

In this case, based on the reconfiguration multi-link element information received from Link 2, the non-AP MLD may recognize that Link 1 will soon be removed. Therefore, the non-AP MLD may retransmit, to the AP MLD, an EML Operating Mode Notification frame indicating that only Link 2 and Link 3 are EMLSR links. (Not shown in FIG. 39)

Considering that Link 1, among the links indicated as EMLSR links in the EML Operating Mode Notification frame received from the non-AP MLD, cannot be utilized as an EMLSR link, the AP MLD may indicate only Link 2 and Link 3 as EMLSR links in the EML Operating Mode Notification frame transmitted to the non-AP MLD in response.

### <EMLSR Mode Operation in Disabled Link>

The methods for preventing an EMLSR link from being disabled (or preventing a disabled link from becoming an EMLSR link) have been described through the forgoing embodiments of the present disclosure.

When a specific link of the non-AP MLD is disabled, frame exchange using the specific link is restricted, and thus, there is no benefit that can be obtained from operating the specific link as an EMLSR link. However, even when an EMLSR link is disabled, the non-AP MLD can continue to operate the disabled link as an EMLSR link. This may be an operation in which when the disabled state of a link is released, the link is operated as an EMLSR link again without performing separate signaling.

In this case, the non-AP MLD may differently operate EMLSR links (links in EMLSR mode) thereof depending on whether the links are enabled or disabled. First, on an enabled EMLSR link, the non-AP MLD may support the reception of an Initial Control frame and perform CCA. This is a normal EMLSR mode operation. On the other hand, the non-AP MLD may not support the reception of CCA and an Initial Control frame on a disabled EMLSR link. That is, a non-AP STA operating on a disabled link, among non-AP STAs operating in EMLSR mode, may not perform a listening operation for the EMLSR mode operation.

When a non-AP MLD has only one enabled EMLSR link (there may be another EMLSR link that is disabled), an AP MLD may not transmit an Initial Control frame at the start of a frame exchange sequence on the EMSR link of the non-AP MLD. This may be an operation of the AP MLD that is allowed because the non-AP MLD does not perform any listening operation on the other EMLSR link (disabled link), and thus frame exchange may be initiated on the enabled EMLSR link immediately without a separate RF switching operation (transition).

### <TXOP Management Method of an MLD Considering the Start Time of an R-TWT SP>

As described above, an MLD may perform, in consideration of the start time of an R-TWT SP, an operation similar/identical to a TXOP termination operation that is performed before a TBTT start time of a beacon frame.

This implies that a situation in which a TXOP on a specific EMLSR link should be terminated due to a scheduled operation on another EMLSR link may arise even in relation to an R-TWT SP. This may be an operation considered to primarily process low-latency traffic.

More specifically, an MLD having an EMLSR link and an MLD performing transmission/reception with an MLD in EMLSR mode may need to terminate a TXOP acquired on a specific EMLSR link before the Restricted Target Wake Time (R-TWT) service period (SP) of another EMLSR link. That is, a non-AP MLD and an AP MLD that acquired a TXOP on a first EMLSR link should terminate the TXOP acquired on the first EMLSR link before the start of an R-TWT SP on a second EMLSR link. This may be to ensure that an STA (a non-AP STA) operating on the second EMLSR link can support the transmission/reception of low-latency traffic when the R-TWT SP starts on the second EMLSR link.

However, as described above, even if a TXOP on a specific EMLSR link is terminated, transmission/reception on another EMLSR link is not immediately supported, and requires an additional time at least equal to the EMLSR transition delay. Furthermore, it takes an additional time equal to aSIFSTime+aSlotTime+aRxPHYStartDelay to recognize that the TXOP on the specific EMLSR link has been terminated.

Therefore, when an R-TWT SP is scheduled on a specific EMLSR link, an MLD and an AP MLD in EMLSR mode should terminate a TXOP acquired on another EMLSR link at least as early as aSIFSTime+aSlotTime+aRxPHYStartDelay+EMLSR transition delay.

Furthermore, a similar restriction may be applied before the start time of R-TWT SP even when there is an STA operating in EMLMR mode.

That is, an MLD having an EMLMR link and an MLD performing transmission/reception with an MLD in EMLMR mode may need to terminate a TXOP acquired on a specific EMLMR link before the Restricted Target Wake Time (R-TWT) SP of another EMLMR link. That is, a non-AP MLD and an AP MLD that acquired a TXOP on a first EMLMR link should terminate the TXOP acquired on the first EMLMR link before a R-TWT SP starts on a second EMLMR link. This may be to ensure that an STA (a non-AP STA) operating on the second EMLMR link can support the transmission/reception of low-latency traffic by using full capacity (EMLMR capability) when the R-TWT SP starts on the second EMLMR link.

However, even if a TXOP on a specific EMLMR link is terminated, transmission/reception on another EMLMR link is not immediately supported, and requires an additional time at least equal to the EMLMR delay. Furthermore, it takes an additional time equal to aSIFSTime+aSlotTime+aRxPHYStartDelay to recognize that the TXOP on the specific EMLMR link has been terminated.

Therefore, when an R-TWT SP is scheduled on a specific EMLMR link, an MLD and an AP MLD in EMLMR mode should terminate a TXOP acquired on another EMLMR link at least as early as aSIFSTime+aSlotTime+aRxPHYStartDelay+EMLMR delay.

That is, when there is a non-AP MLD associated on a first link and a second link, and when the first link and the second link are an EMLMR link pair of the non-AP MLD, an AP that is a TXOP holder of the second link should terminate a TXOP at least aSIFSTime+aSlotTime+aRxPHYStartDelay+EMLMR delay earlier than the start time of an R-TWT SP of the first link. In this case, an AP MLD may terminate a TXOP of the second link only when a non-AP STA of the non-AP MLD operating on the first link is a member STA of the R-TWT SP of the first link. In this case, the AP MLD may terminate the TXOP only when the non-AP STA of the non-AP MLD operating on the first link is a member STA of the R-TWT SP of the first link and a non-AP STA on the second link is not a member of an R-TWT SP of the second link that overlaps in time with the R-TWT SP of the first link.

That is, when there is a non-AP MLD associated on a first link and a second link, and when the first link and the second link are an EMLSR link pair of the non-AP MLD, a non-AP STA that is a TXOP holder of the second link (an STA of the non-AP MLD operating on the second link) should terminate a TXOP at least aSIFSTime+aSlotTime+aRxPHYStartDelay+EMLMR delay earlier than the start time of an R-TWT SP of the first link. In this case, the non-AP STA on the second link may terminate the TXOP only when a non-AP STA operating on the first link is a member STA of the R-TWT SP of the first link. In this case, the non-AP STA on the second link may terminate the TXOP only when the non-AP STA operating on the first link is a member STA of the R-TWT SP of the first link and the non-AP STA on the second link is not a member of an R-TWT SP of the second link that overlaps in time with the R-TWT SP of the first link.

The R-TWT SP is a TWT SP that is committed to primarily process low-latency traffic, and an AP and a non-AP STA primarily transmit/receive a frame of a TID, defined as low-latency traffic, during the R-TWT SP interval. In addition, the start time of R-TWT SP is set to an interval that overlaps a quiet interval, and is thus characterized as an interval in which channel access by legacy STAs is restricted.

The R-TWT SP, which is a type of broadcast TWT, may be operated on each link, and non-AP STAs may participate in each R-TWT SP as member STAs. A broadcast TWT element transmitted to establish an R-TWT SP includes a Restricted TWT Parameter Set field, wherein the Restricted TWT Parameter Set field includes a TID indicator that is considered to be low-latency traffic in the TWT SP.

Additionally, when a non-AP STA operating in EMLSR mode is a member STA of an R-TWT SP, an EMLSR MLD may need to ensure that the non-AP STA is in a reception waiting state before the start time of the R-TWT SP. In this case, the reception waiting state refers to a state in which frame exchange is possible even when an Initial Control frame is not received (a state in which the transmission/reception of an EHT PPDU is supported). That is, when an STA in EMLSR mode is a member of an R-TWT SP, the STA in EMLSR mode may need to transition to a reception waiting state at the start time of the R-TWT SP. In this case, the mode transition that occurs in connection with the start of the R-TWT SP may be performed without transmitting/receiving the Initial Control frame.

In other words, an EMLSR mode STA that is a member of an R-TWT SP may need to transition to a state in which the EMLSR mode STA can perform frame exchange without the reception of an Initial Control frame when the R-TWT SP is started. Therefore, an MLD (an AP MLD) that performs transmission to the EMLSR mode STA during the R-TWT SP may perform frame exchange with the EMLSR mode STA without transmitting the Initial Control frame.

In other words, an STA in EMLSR mode may need to transition to a state in which frame exchange is possible at the start time of an R-TWT SP having the STA as a member, regardless of whether an Initial Control frame has been received. That is, an STA in EMLSR mode may need to transition to a reception waiting mode, similarly to when an Initial control frame has been received, before the start of an R-TWT SP having the STA as a member. In this case, within the R-TWT SP, an Initial Control frame transmission/reception procedure for an EMLSR mode operation may be omitted.

Referring to FIG. 40, the AP MLD and the non-AP MLD are multilinked through three links (Link 1, Link 2, and Link 3). Non-AP STA 3, which is the STA of the non-AP MLD operating on Link 3, transmits, to the AP MLD (AP 3), an EML Operating Mode Notification frame indicating that Link 1, Link 2, and Link 3 are EMLSR links. The AP MLD transmits, over Link 2, reconfiguration multi-link element information indicating that the AP-MLD will remove AP 1 operating on Link 1.

In this case, the non-AP MLD may recognize that Link 1 will soon be removed, based on the reconfiguration multi-link element information received on Link 2. Therefore, the non-AP MLD may retransmit, to the AP MLD, an EML Operating Mode Notification frame indicating that only Link 2 and Link 3 are EMLSR links. (Not shown in FIG. 58)

Considering that Link 1, among the links indicated as EMLSR links in the EML Operating Mode Notification frame received from the non-AP MLD, cannot be utilized as an EMLSR link, the AP MLD may indicate only Link 2 and Link 3 as EMLSR links in an EML Operating Mode Notification frame transmitted to the non-AP MLD in response.

### <EMLSR Mode Operation on a Disabled Link>

The methods for preventing an EMLSR link from being disabled (or preventing a disabled link from becoming an EMLSR link) have been described through the forgoing embodiments of the present disclosure.

When a specific link of the non-AP MLD is disabled, frame exchange using the specific link is restricted, and thus, there is no benefit that can be obtained from operating the specific link as an EMLSR link. However, even when an EMLSR link is disabled, the non-AP MLD can continue to maintain the disabled link as an EMLSR link. This may be an operation by which when the disabled state of a link is released, the link is operated as an EMLSR link again without performing separate signaling.

In this case, the non-AP MLD may differently operate EMLSR links (links in EMLSR mode) thereof depending on whether the links are enabled or disabled. First, on an enabled EMLSR link, the non-AP MLD may support the reception of an Initial Control frame and perform CCA. This is a normal EMLSR mode operation. On the other hand, the non-AP MLD may not support the reception of CCA and an Initial Control frame on a disabled EMLSR link. That is, a non-AP STA operating on a disabled link, among non-AP STAs operating in EMLSR mode, may not perform a listening operation for the EMLSR mode operation.

When a non-AP MLD has only one enabled EMLSR link (there may be another EMLSR link that is disabled), an AP MLD may not transmit an Initial Control frame at the start of a frame exchange sequence on an EMSR link of the non-AP MLD. This may be an operation of the AP MLD that is allowed because the non-AP MLD does not perform any listening operation on the other EMLSR link (disabled link), and thus frame exchange may be initiated on the enabled EMLSR link immediately without a separate RF switching operation (transition).

### <TXOP Management Method of an MLD Considering the Start Time of an R-TWT SP>

As described above, an MLD may perform, in consideration of the start time of an R-TWT SP, an operation similar/identical to a TXOP termination operation that is performed before the TBTT start time of a beacon frame.

This implies that a situation in which a TXOP on a specific EMLSR link should be terminated due to a scheduled operation on another EMLSR link may arise even in relation to an R-TWT SP. This may be an operation considered to primarily process low-latency traffic.

More specifically, an MLD having an EMLSR link and an MLD performing transmission/reception with an MLD in EMLSR mode may need to terminate a TXOP acquired on a specific EMLSR link before the Restricted Target Wake Time (R-TWT) service period (SP) of another EMLSR link. That is, a non-AP MLD and an AP MLD that acquired a TXOP on a first EMLSR link should terminate the TXOP acquired on the first EMLSR link before the start of an R-TWT SP on a second EMLSR link. This may be to ensure that an STA (a non-AP STA) operating on the second EMLSR link can support the transmission/reception of low-latency traffic when the R-TWT SP starts on the second EMLSR link.

However, as described above, even if a TXOP on a specific EMLSR link is terminated, transmission/reception on another EMLSR link is not immediately supported, and requires an additional time at least equal to the EMLSR transition delay. Furthermore, it takes an additional time equal to aSIFSTime+aSlotTime+aRxPHYStartDelay to recognize that the TXOP on the specific EMLSR link has been terminated.

Therefore, when an R-TWT SP is scheduled on a specific EMLSR link, an MLD and an AP MLD in EMLSR mode should terminate a TXOP acquired on another EMLSR link at least as early as aSIFSTime+aSlotTime+aRxPHYStartDelay+EMLSR transition delay.

Furthermore, a similar restriction may be applied before the start time of R-TWT SP even when there is an STA operating in EMLMR mode.

That is, The MLD having an EMLMR link and the MLD performing transmission/reception with an MLD in EMLMR mode may need to terminate a TXOP acquired on a specific EMLMR link before the Restricted Target Wake Time (R-TWT) SP of another EMLMR link. That is, a non-AP MLD and an AP MLD that acquired a TXOP on a first EMLMR link should terminate the TXOP acquired on the first EMLMR link before a R-TWT SP starts on a second EMLMR link. This may be to ensure that an STA (a non-AP STA) operating on the second EMLMR link can support the transmission/reception of low-latency traffic by using full capacity (EMLMR capability) when the R-TWT SP starts on the second EMLMR link.

However, even if a TXOP on a specific EMLMR link is terminated, transmission/reception on another EMLMR link is not immediately supported, and requires an additional time at least equal to the EMLMR delay. Furthermore, it takes an additional time equal to aSIFSTime+aSlotTime+aRxPHYStartDelay to recognize that the TXOP on the specific EMLMR link has been terminated.

Therefore, when an R-TWT SP is scheduled on a specific EMLMR link, an MLD and an AP MLD in EMLMR mode should terminate a TXOP acquired on another EMLMR link at least as early as aSIFSTime+aSlotTime+aRxPHYStartDelay+EMLMR delay.

That is, when there is a non-AP MLD associated on a first link and a second link, and when the first link and the second link are an EMLMR link pair of the non-AP MLD, an AP that is a TXOP holder of the second link should terminate a TXOP at least aSIFSTime+aSlotTime+aRxPHYStartDelay+EMLMR delay earlier than the start time of an R-TWT SP of the first link. In this case, an AP MLD may terminate a TXOP of the second link only when a non-AP STA of the non-AP MLD operating on the first link is a member STA of the R-TWT SP of the first link. In this case, the AP MLD may terminate the TXOP only when the non-AP STA of the non-AP MLD operating on the first link is a member STA of the R-TWT SP of the first link and a non-AP STA on the second link is not a member of an R-TWT SP of the second link that overlaps in time with the R-TWT SP of the first link.

That is, when there is a non-AP MLD associated on a first link and a second link, and when the first link and the second link are an EMLSR link pair of the non-AP MLD, a non-AP STA that is a TXOP holder of the second link (an STA of the non-AP MLD operating on the second link) should terminate a TXOP at least aSIFSTime+aSlotTime+aRxPHYStartDelay+EMLMR delay earlier than the start time of an R-TWT SP of the first link. In this case, the non-AP STA on the second link may terminate the TXOP only when a non-AP STA operating on the first link is a member STA of the R-TWT SP of the first link. In this case, the non-AP STA on the second link may terminate the TXOP only when the non-AP STA operating on the first link is a member STA of the R-TWT SP of the first link and when the non-AP STA on the second link is not a member of an R-TWT SP of the second link that overlaps in time with the R-TWT SP of the first link.

The R-TWT SP is a TWT SP that is committed to primarily process low-latency traffic, and an AP and a non-AP STA primarily transmit/receive a frame of a TID, defined as low-latency traffic, during the R-TWT SP interval. In addition, the start time of R-TWT SP is set to an interval that overlaps a quiet interval, and is thus characterized as an interval in which channel access by legacy STAs is restricted.

The R-TWT SP, which is a type of broadcast TWT, may be operated on each link, and non-AP STAs may participate in each R-TWT SP as member STAs. A broadcast TWT element transmitted to establish an R-TWT SP includes a Restricted TWT Parameter Set field, wherein the Restricted TWT Parameter Set field includes a TID indicator that is considered to be low-latency traffic in the TWT SP.

Additionally, when a non-AP STA operating in EMLSR mode is a member STA of an R-TWT SP, an EMLSR MLD may need to ensure that the non-AP STA is in a reception waiting state before the start time of the R-TWT SP. In this case, the reception waiting state refers to a state in which frame exchange is possible even when an Initial Control frame is not received (a state in which the transmission/reception of an EHT PPDU is supported). That is, when an STA in EMLSR mode is a member of an R-TWT SP, the STA in EMLSR mode may need to transition to a reception waiting state at the start time of the R-TWT SP. In this case, the mode transition that occurs in connection with the start of the R-TWT SP may be performed without transmitting/receiving the Initial Control frame.

In other words, an EMLSR mode STA that is a member of an R-TWT SP may need to transition to a state in which the EMLSR mode STA can perform frame exchange without the reception of an Initial Control frame when the R-TWT SP is started. Therefore, an MLD (an AP MLD) that performs transmission to the EMLSR mode STA during the R-TWT SP may perform frame exchange with the EMLSR mode STA without transmitting the Initial Control frame.

In other words, an STA in EMLSR mode may need to transition to a state in which frame exchange is possible at the start time of an R-TWT SP having the STA as a member, regardless of whether an Initial Control frame has been received. That is, an STA in EMLSR mode may need to transition to a reception waiting mode, similarly to when an Initial control frame has been received, before the start of an R-TWT SP having the STA as a member. In this case, within the R-TWT SP, an Initial Control frame transmission/reception procedure for an EMLSR mode operation may be omitted.

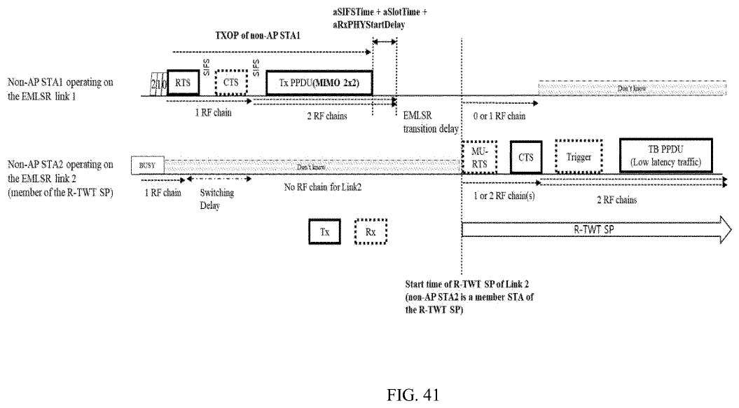

FIG. 41 illustrates an example of a method by which a non-AP STA on an EMLSR link, according to an embodiment of the present disclosure, terminates a TXOP acquired thereby in consideration of an R-TWT SP started on another EMLSR link.

Referring to FIG. 41, non-AP STA 1 and non-AP STA 2 of a non-AP MLD operate on EMLSR link 1 and EMLSR link 2, which are EMLSR link pair, respectively.

Non-AP STA 1 became a TXOP holder after the completion of a backoff procedure and performs frame exchange with an AP during a TXOP. Non-AP STA 2 is a member STA of an R-TWT SP established on EMLSR link 2, and the R-TWT SP starts after the termination time of a TXOP acquired by non-AP STA 1. In order to ensure that the non-AP STA2 can support a listening operation or an Rx operation at the start time of the R-TWT SP, non-AP STA 1 terminates the TXOP thereof aSIFSTime+aSlotTime+aRxPHYStartDelay+EMLSR transition delay earlier than the start time of the R-TWT SP starting on EMLSR link 2.

Although not illustrated in FIG. 41, when the TXOP holder of EMLSR link 1 is an AP, the AP may terminate a TXOP thereof at the same time as the time at which non-AP STA 1 terminates the TXOP thereof, thereby ensuring that non-AP STA 2 can support a listening operation or an Rx operation at the start time of the R-TWT SP established on EMLSR link 2.

FIG. 42 illustrates an example of a procedure in which a non-AP STA operating in an EMLSR link supports a frame exchange operation without receiving an Initial Control frame during an R-TWT SP according to an embodiment of the present disclosure.

Referring to FIG. 42, non-AP STA 1 became a TXOP holder after the completion of a backoff procedure and performs frame exchange with an AP during a TXOP. Non-AP STA 2 is a member STA of an R-TWT SP established on EMLSR link 2, and the R-TWT SP starts after the termination time of a TXOP acquired by non-AP STA 1. In order to ensure that non-AP STA 2 can support a listening operation or an Rx operation at the start time of the R-TWT SP, non-AP STA 1 terminates the TXOP thereof aSIFSTime+aSlotTime+aRxPHYStartDelay+EMLSR transition delay earlier than the start time of the R-TWT SP starting on EMLSR link 2.

In this case, a non-AP MLD, in response to the start of the R-TWT SP having non-AP STA 2 as a member, transitions non-AP STA 2 to the same state as if an Initial Control frame had been received, even though the Initial Control frame was not received on EMLSR link 2.

Accordingly, an AP MLD transmits a trigger frame requesting a TB PPDU response to non-AP STA 2 in EMLSR mode without transmitting an Initial Control frame and receives the TB PPDU response. In other words, within the R-TWT SP, frame exchange (excluding an Initial Control frame) with the STA in EMLSR mode is performed without transmitting the Initial Control frame.

The above operation related to an EMLSR link pair is described considering that the non-AP MLD is in EMLSR mode, but, the operation can be utilized in the same way when the AP MLD has an EMLSR link pair. That is, the operation of a non-AP STA operating in an EMLSR link pair may be appropriately modified and applied to an AP (an AP of the AP MLD) operating in the EMLSR link pair.

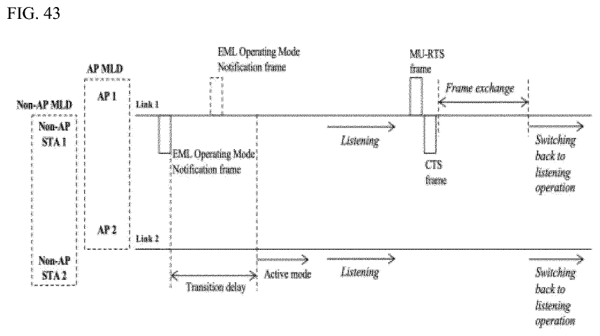

FIG. 43 illustrates an example of an EMLSR operation according to an embodiment of the present disclosure.

According to an embodiment of the present disclosure, an MLD may perform an enhanced multi-link single radio (EMLSR) operation. For example, one or more STAs belonging to the MLD may operate in EMLSR mode.

Referring to FIG. 43, AP 1 and AP 2 may belong to an AP MLD. Non-AP STA 1 and non-AP STA 2 may belong to a non-AP MLD. AP 1 and AP 2 may operate on link 1 and link 2, respectively. Non-AP STA 1 and non-AP STA 2 may operate on link 1 and link 2, respectively. The non-AP MLD may have performed a multi-link setup with AP MLDs on link 1 and link 2.

The non-AP MLD may transmit an EML Operating Mode Notification frame to the AP MLD to operate in EMLSR mode. In this case, any one STA of the non-AP MLD may transmit the EML Operating Mode Notification frame to an AP. In the embodiment of FIG. 43, the non-AP MLD may transmit the EML Operating Mode Notification frame on link 1. The non-AP MLD that has successfully transmitted the EML Operating Mode Notification frame may operate in EMLSR mode. Furthermore, the EML Operating Mode Notification frame may indicate EMLSR link(s). The EMLSR link(s) may refer to one or more links operating in EMLSR mode. For example, the EML Operating Mode Notification frame may include a bitmap indicating the EMLSR link(s). In the embodiment of FIG. 43, the EML Operating Mode Notification frame transmitted by the non-AP MLD may indicate that link 1 and link 2 are EMLSR links. The EMLSR link may refer to an enabled link operating in EMLSR mode.

Furthermore, the AP MLD that receives the EML Operating Mode Notification frame may transmit an EML Operating Mode Notification frame to the non-AP MLD. This allows the non-AP MLD to know that the EML Operating Mode Notification frame transmitted thereby was successfully received by the AP MLD.

An STA may be in either an active mode or a power save mode as a power management mode. When the STA is in the active mode, the STA may be in an awake state. Also, when the STA is in the power save mode, the STA may transition between the awake state and the doze state. When the STA is in the awake state, it is possible to transmit or receive a frame. When the STA is in the doze state, it may be impossible to transmit or receive a frame.

An STA in the non-AP MLD that transmitted an EML Operating Mode Notification frame may have been able to transmit the EML Operating Mode Notification frame because the STA was in the active mode or awake state.

Furthermore, an STA in the non-AP MLD on an EMLSR link, other than a link on which an EML Operating Mode Notification frame has been transmitted, may transition to an active mode after a transition delay from the transmission of the EML Operating Mode Notification frame. That is, in the embodiment of FIG. 43, there may be an STA 2, which is an STA of an EMLSR link, link 2, other than link 1 on which an EML Operating Mode Notification frame has been transmitted. The STA 2 may transition to an active mode after a transition delay after the transmission of the EML Operating Mode Notification frame from STA 1.

The transition delay may be indicated by an EML Capabilities field included in a Multi-Link element. For example, a Transition Timeout subfield included in the EML Capabilities field may indicate the transition delay. Transition Timeout subfield values of 0, 1, 2, 3, 4, 5, 6, 7, 8, 9, 10, and 11 may indicate transition delays of 0 TU, 128 us, 256 us, 512 us, 1 TU, 2 TUs, 4 TUs, 8 TUs, 16 TUs, 32 TUs, and 128 TUs, respectively.

Alternatively, an STA in the non-AP MLD on an EMLSR link, other than a link on which the EML Operating Mode Notification frame has been transmitted, may transition to an active mode after an EML Operating Mode Notification frame transmitted by an AP (a frame shown by the dotted line in FIG. 43).

When the two embodiments regarding the time point of the transition to active mode are used together, the transition to active mode may occur at the earlier of the time points of the transition to active mode provided by the two embodiments.

The method for enabling an EMLSR mode has been described. However, even when disabling EMLSR mode, the same operation as the described embodiment may be performed, and instead of transition to active mode, transition to power save mode may occur.

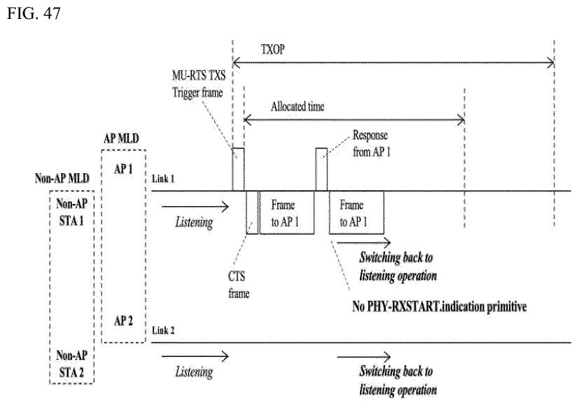

When the non-AP MLD is operating in EMLSR mode, STAs on EMLSR links, among STAs belonging to the non-AP MLD, may be able to simultaneously perform listening operations on the EMLSR links. The listening operations may include operations for receiving clear channel assessment (CCA) and an Initial Control frame. In addition, the AP MLD that transmits a frame to the non-AP MLD operating in EMLSR mode may transmit an Initial Control frame to the non-AP MLD. The Initial Control frame may be a frame having a preset type and configuration. For example, the Initial Control frame can be an MU-RTS trigger frame or a BSRP trigger frame. Furthermore, the Initial Control frame may be a non-HT PPDU or a non-HT duplicate PPDU. In addition, the Initial Control frame may be transmitted at a rate of 6, 12, or 24 Mbps. The non-AP MLD that has been performing listening operations on multiple links may receive an Initial Control frame on one link. Referring to FIG. 47, the non-AP MLD that has been performing listening operations on link 1 and link 2 may receive, through non-AP STA 1, an MU-RTS frame which is an Initial control frame transmitted by AP 1. The STA having received the Initial Control frame may transmit and receive frames on the links. In FIG. 47, non-AP STA 1 has received the MU-RTS frame and transmitted a CTS frame in response thereto, and non-AP STA 1 and AP 1 may perform frame exchange. The non-AP MLD that received and responded to the Initial Control frame on an EMLSR link may concentrate capability regarding frame transmission/reception on the link on which the Initial control frame was transmitted. Therefore, it may be impossible to transmit or receive frames on an EMLSR link (link 2 in FIG. 47) on which frame exchange is not performed. After the frame exchange is terminated, the non-AP MLD may transition to a state in which a listening operation is possible on multiple EMLSR links. That is, when an MLD is operating in EMLSR mode, a listening operation is possible on multiple links with a limited configuration, but frame transmission/reception may be possible on only one link. Therefore, the implementation cost of an MLD operating in EMLSR mode may be lower than that of an MLD that can transmit and receive frames on multiple links simultaneously.

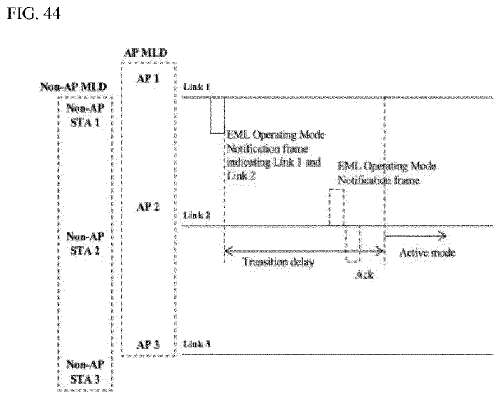

FIG. 44 illustrates another example of an EMLSR operation according to an embodiment of the present disclosure.

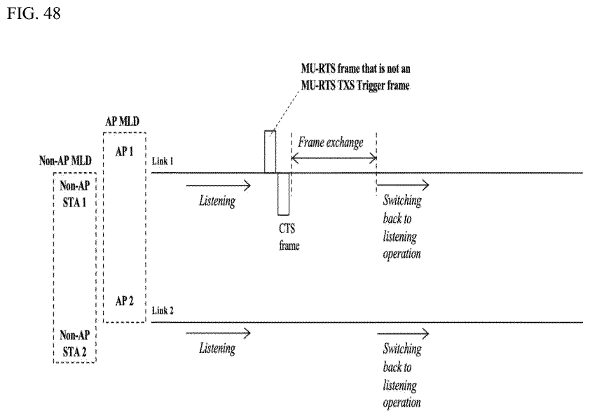

According to an embodiment of the present disclosure, it is possible to operate in EMLSR mode only on some of links on which a non-AP MLD operates. That is, only some of links on which the non-AP MLD performed a multi-link setup may be EMLSR links. In the embodiment of FIG. 48, the foregoing description may be omitted.

Referring to FIG. 44, AP 1, AP 2, and AP 3 may belong to an AP MLD. Non-AP STA 1, non-AP STA 2, and non-AP STA 3 may belong to a non-AP MLD. AP 1, AP 2, and AP 3 may operate on link 1, link 2, and link 3, respectively. Non-AP STA 1, non-AP STA 2, and non-AP STA 3 may operate on link 1, link 2, and link 3, respectively. The non-AP MLD may have performed a multi-link setup with AP MLDs on link 1, link 2, and link 3.

As illustrated in FIG. 44, the non-AP MLD may transmit an EML Operating Mode Notification frame to the AP MLD to operate in EMLSR mode. In the EML Operating Mode Notification frame, the non-AP MLD may indicate a link on which the non-AP MLD intends to operate in EMLSR mode. For example, the non-AP MLD may transmit, to the AP MLD, an EML Operating Mode Notification frame including signaling indicating that the non-AP MLD will operate in EMLSR mode on link 1 and link 2, except for link 3.

According to an embodiment of the present disclosure, the non-AP MLD may transmit an EML Operating Mode Notification frame on one of EMLSR links. For example, the non-AP MLD may transmit an EML Operating Mode Notification frame on one of EMLSR links indicated by the EML Operating Mode Notification frame when transmitting the EML Operating Mode Notification frame. Referring to FIG. 44, the non-AP MLD may transmit an EML Operating Mode Notification frame indicating that link 1 and link 2 are EMLSR links. In this case, non-AP STA 1 of link 1, which is one of the EMLSR links, transmitted the EML Operating Mode Notification frame.

Furthermore, the EML Operating Mode Notification frame transmitted by the AP MLD may be transmitted on one of the EMLSR links indicated by the non-AP MLD. Referring to FIG. 44, the AP MLD transmitted the EML Operating Mode Notification frame on link 2, which is one of link 1 and link 2 indicated by the non-AP MLD to the EMLSR link.

That is, it may not be possible for the non-AP MLD or the AP MLD to transmit the EML Operating Mode Notification frame on a link that is not an EMLSR link.

According to an embodiment of the present disclosure, an STA that has transmitted an EML Operating Mode Notification frame enabling an EMLSR mode may remain continuously in an active mode. Furthermore, an STA on an EMLSR link other than the link on which the EML Operating Mode Notification frame enabling EMLSR mode was transmitted may transition to an active mode 1) after the elapse of a transition delay after the transmission of the EML Operating Mode Notification frame or 2) after the AP MLD transmits an EML Operating Mode Notification frame. The STA on the EMLSR link other than the link on which the EML Operating Mode Notification frame enabling an EMLSR mode was transmitted may be in a power save mode or a doze state before the transition to the active mode. Therefore, according to an embodiment of the present disclosure, the AP MLD may not transmit an Initial Control frame until after the elapse of the transition delay after the transmission of an EML Operating Mode Notification frame on an EMLSR link (by the non-AP MLD) other than the link on which the non-AP MLD transmitted the EML Operating Mode Notification frame. Furthermore, if the AP MLD transmits an EML Operating Mode Notification frame after receiving an EML Operating Mode Notification frame from the non-AP MLD, it is possible to transmit an Initial Control frame after the transmission of the EML Operating Mode Notification frame on a link on which the AP MLD transmitted the EML Operating Mode Notification frame. Alternatively, on a link on which the AP MLD receives any frame from the non-AP MLD, it is possible to transmit an Initial Control frame. That is, it is possible to transmit the Initial Control frame even when the transition delay has not elapsed.

For example, in the embodiment of FIG. 44, AP 2 may not transmit an Initial Control frame on link 2 during a transition delay from receiving an EML Operating Mode Notification frame from non-AP STA 1. This is because non-AP STA 2 may not be in an active mode or an awake state during the transition delay. AP 2 may transmit an EML Operating Mode Notification frame to non-AP STA 2, and non-AP STA 2 may transmit an acknowledgment (Ack) to AP 2 in response thereto. In this case, since AP 2 has received a frame from non-AP STA 2, it is possible to transmit an Initial Control frame on link 2. That is, AP 2 may transmit the Initial Control frame before the transition delay has elapsed. This is because AP 2 may determine that non-AP STA 2 is in an awake state by receiving a frame from non-AP STA 2.

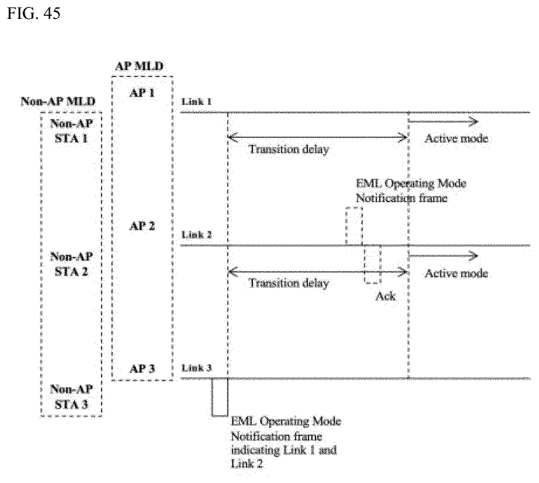

FIG. 45 illustrates another example of an EMLSR operation according to an embodiment of the present disclosure.

According to an embodiment of the present disclosure, it is possible to operate in EMLSR mode only on some of links on which a non-AP MLD operates.

That is, only some of links on which the non-AP MLD performed a multi-link setup may be EMLSR links. In the embodiment of FIG. 45, the foregoing description may be omitted.

Referring to FIG. 45, AP 1, AP 2, and AP 3 may belong to an AP MLD. Non-AP STA 1, non-AP STA 2, and non-AP STA 3 may belong to a non-AP MLD. AP 1, AP 2, and AP 3 may operate on link 1, link 2, and link 3, respectively. Non-AP STA 1, non-AP STA 2, and non-AP STA 3 may operate on link 1, link 2, and link 3, respectively. The non-AP MLD may have performed a multi-link setup with AP MLDs on link 1, link 2, and link 3.

As illustrated in FIG. 45, the non-AP MLD may transmit an EML Operating Mode Notification frame to the AP MLD to operate in EMLSR mode. In the EML Operating Mode Notification frame, the non-AP MLD may indicate a link on which the non-AP MLD intends to operate in EMLSR mode. For example, the non-AP MLD may transmit, to the AP MLD, an EML Operating Mode Notification frame including signaling indicating that the non-AP MLD will operate in EMLSR mode on link 1 and link 2, except for link 3.

According to an embodiment of the present disclosure, the non-AP MLD may transmit an EML Operating Mode Notification frame on one of links on which a multi-link setup has been performed. That is, the non-AP MLD may transmit an EML Operating Mode Notification frame on another link in addition to a link to be used as an EMLSR link. That is, the non-AP MLD may transmit an EML Operating Mode Notification frame on a link that is not indicated as an EMLSR link by the EML Operating Mode Notification frame which is transmitted. Referring to FIG. 45, the non-AP MLD may transmit an EML Operating Mode Notification frame indicating that link 1 and link 2 are EMLSR links. In this case, non-AP STA 3 of link 3, which is not an EMLSR link, transmitted the EML Operating Mode Notification frame.

Furthermore, an EML Operating Mode Notification frame transmitted by the AP MLD may be transmitted on one of links that have been set up, even if the links are not EMLSR links indicated by the non-AP MLD. Referring to FIG. 45, the AP MLD transmitted an EML Operating Mode Notification frame on link 2, which is one of links on which the non-AP MLD has performed a multi-link setup.

According to an embodiment of the present disclosure, when the non-AP MLD has successfully transmitted an EML Operating Mode Notification frame enabling an EMLSR mode on one of EMLSR links, an STA corresponding to the one link may remain continuously in an active mode. Further, according to an embodiment of the present disclosure, the STA that transmitted the EML Operating Mode Notification frame enabling the EMLSR mode may remain continuously in the active mode. Furthermore, an STA on another link, which is an EMLSR link other than the link on which the EML Operating Mode Notification frame enabling EMLSR mode was transmitted, may transition to an active mode 1) after the elapse of a transition delay after the transmission of the EML Operating Mode Notification frame or 2) after the AP MLD transmits an EML Operating Mode Notification frame. Case 2) may be limited to the case where the AP MLD transmitted the EML Operating Mode Notification frame on the other link. That is, an STA on another link that is an EMLSR link other than a link on which an EML Operating Mode Notification frame enabling an EMLSR mode was transmitted may transition to an active mode after the elapse of transition delay after the transmission of the EML Operating Mode Notification frame, when the AP MLD has not transmitted an EML Operating Mode Notification frame or when the AP MLD has transmitted an EML Operating Mode Notification frame on a link that is not an EMLSR link. Furthermore, an STA on another link that is an EMLSR link other than a link on which an EML Operating Mode Notification frame enabling an EMLSR mode was transmitted may transition to an active mode immediately when the AP MLD transmits an EML Operating Mode Notification frame on the other link. The STA of the EMLSR link other than the link on which the EML Operating Mode Notification frame enabling EMLSR mode was transmitted may be in a power save mode or in a doze state before transitioning to an active mode. Therefore, according to an embodiment of the present disclosure, the AP MLD may not transmit an Initial Control frame until after the elapse of transition delay after the transmission of an EML Operating Mode Notification frame on an EMLSR link (by the non-AP MLD) other than a link on which the non-AP MLD transmitted the EML Operating Mode Notification frame. Furthermore, if the AP MLD transmits an EML Operating Mode Notification frame after receiving an EML Operating Mode Notification frame from the non-AP MLD, it is possible to transmit, after the EML Operating Mode Notification frame transmission, an Initial Control frame on a link on which the AP MLD transmitted the EML Operating Mode Notification frame. Alternatively, on a link on which the AP MLD receives any frame from the non-AP MLD, it is possible to transmit an Initial Control frame. That is, it is possible to transmit the Initial Control frame even when the transition delay has not elapsed.

According to an embodiment of the present disclosure, there may be a case where the non-AP MLD successfully transmits an EML Operating Mode Notification frame enabling an EMLSR mode on a link which is not an EMLSR link. In this case, STAs on all EMLSR links may transition to an active mode 1) after the elapse of transition delay after the transmission of the EML Operating Mode Notification frame or 2) after the AP MLD transmits an EML Operating Mode Notification frame. Case 2) may be limited to the case in which the AP MLD transmitted the EML Operating Mode Notification frame on an EMLSR link, and an STA of the EMLSR link may transition to an active mode at the time of 2). That is, as illustrated in FIG. 45, STAs of link 1 and link 2 may operate in EMLSR mode, and an EML Operating Mode Notification frame transmitted by the non-AP MLD may be transmitted on link 3. In this case, non-AP STA 1 and non-AP STA 2 may transition to an active mode after the lapse of transition delay from the transmission of the EML Operating Mode Notification frame. However, when AP 2 transmits an EML Operating Mode Notification frame on link 2, non-AP STA 2 may transition to an active mode after the EML Operating Mode Notification frame transmitted by AP 2. More specifically, when AP 2 transmits an EML Operating Mode Notification frame on link 2, non-AP STA 2 may transition to an active mode after transmitting an acknowledgment (Ack) in response to the EML Operating Mode Notification frame transmitted by AP 2. An STA of an EMLSR link may be in a power save mode or a doze state before transition to an active mode. Therefore, according to an embodiment of the present disclosure, after receiving an EML Operating Mode Notification frame from the non-EMLSR link, the AP MLD may not transmit an Initial Control frame until after the elapse of transition delay after the transmission of an EML Operating Mode Notification frame (by the non-AP MLD) on all EMLSR links. Furthermore, if the AP MLD transmits an EML Operating Mode Notification frame on an EMLSR link after receiving an EML Operating Mode Notification frame from the non-AP MLD, it is possible to transmit, after the EML Operating Mode Notification frame transmission, an Initial Control frame on the EMLSR link on which the AP MLD transmitted the EML Operating Mode Notification frame. Alternatively, on an EMLSR link on which the AP MLD receives any frame from the non-AP MLD, it is possible to transmit an Initial Control frame. That is, it is possible to transmit the Initial Control frame even when the transition delay has not elapsed.

For example, in the embodiment of FIG. 45, AP 1 and AP 2 may not transmit an Initial Control frame on all EMLSR links, link 1 and link 2, during a transition delay after receiving an EML Operating Mode Notification frame from non-AP STA 3. This is because non-AP STA 1 and non-AP STA 2 may not be in an active mode or an awake state during the transition delay. AP 2 may transmit an EML Operating Mode Notification frame to non-AP STA 2, and non-AP STA 2 may transmit an acknowledgment (Ack) to AP 2 in response thereto. In this case, since AP 2 has received a frame from non-AP STA 2, AP 2 may transmit the Initial Control frame on link 2. That is, AP 2 may transmit the Initial Control frame before a transition delay has elapsed. This is because AP 2 may determine that non-AP STA 2 is in an awake state by receiving a frame from non-AP STA 2.

In an interval in which the Initial Control frame described in an embodiment of the present disclosure is not transmitted, a non-AP STA on the corresponding link may not be able to transmit a Power Management subfield that set to a preset value. The Power Management subfield may indicate the power management mode of the STA transmitting the Power Management subfield. The preset value may be a value indicating that the Power Management subfield is in a power save mode. The value indicating that the Power Management subfield is in the power save mode may be 1.

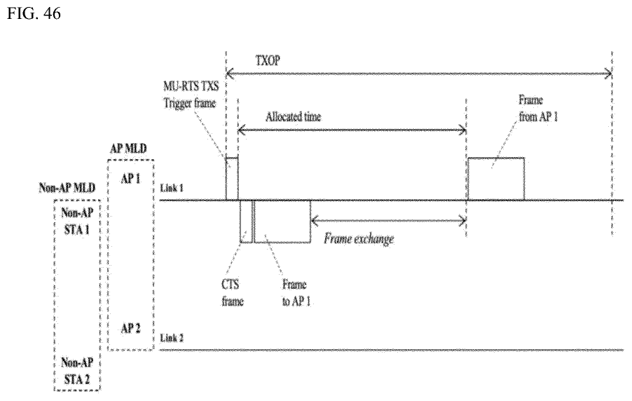

FIG. 46 illustrates an example of a triggered TXOP sharing procedure according to an embodiment of the present disclosure.

According to an embodiment of the present disclosure, an STA may be able to allocate a part or all of transmit opportunity (TXOP) or time acquired by the STA to another STA. The other STA may be able to transmit frames during the allotted time from the STA. According to an embodiment, an STA sharing or allocating TXOP may be an AP and another STA sharing or being allocated the TXOP may be a non-AP STA. The operation in which the STA allocates the TXOP and the operation or procedure in which the other STA performs the transmission for the allocated time may be referred to as a triggered TXOP sharing procedure. In the present disclosure, the terms “triggered TXOP sharing procedure”, “TXS procedure”, “TXS”, “TXOP sharing procedure”, “TXOP sharing”, “MU-RTS TXOP sharing procedure”, etc. may be used interchangeably and may have the same meaning.

Furthermore, an STA may transmit a frame indicating that a part or all of TXOP acquired by the STA is allocated to another STA. That is, the STA may transmit a frame indicating a triggered TXOP sharing procedure. The frame may be referred to as an MU-RTS TXS trigger frame. In the present disclosure, the terms “MU-RTS TXS trigger frame”, “MU-RTS TXS frame”, “TXS trigger frame”, “TXS frame”, etc. may be used interchangeably. An MU-RTS TXS trigger frame may be a type of trigger frame. More specifically, an MU-RTS TXS trigger frame may be a type of MU-RTS trigger frame (or MU-RTS frame). A Trigger Type subfield included in a trigger frame may indicate which variant of trigger frame the trigger frame is. When a trigger frame is an MU-RTS trigger frame, a Trigger Type subfield included in the trigger frame may be set to a value indicating an MU-RTS trigger frame. According to an embodiment of the present disclosure, a trigger frame may include a Triggered TXOP Sharing Mode subfield. For example, when a trigger frame is an MU-RTS trigger frame, the trigger frame may include a Triggered TXOP Sharing Mode subfield. A triggered TXOP sharing mode subfield may be bits from bit index B20 to B21 of a Common Info field of the trigger frame. A Triggered TXOP Sharing Mode subfield may indicate whether a trigger frame including the Triggered TXOP Sharing Mode subfield is a trigger frame that initiates a triggered TXOP sharing procedure. Furthermore, a Triggered TXOP Sharing Mode subfield may indicate what is the mode of a triggered TXOP sharing procedure indicated by a trigger frame containing the Triggered TXOP Sharing Mode subfield.

According to an embodiment, when the value of a Triggered TXOP Sharing Mode subfield is 0, the Triggered TXOP Sharing Mode subfield may indicate that a trigger frame including the Triggered TXOP Sharing Mode subfield is not a trigger frame that initiates the triggered TXOP sharing procedure. When the value of a Triggered TXOP Sharing Mode subfield is 1 or 2, the Triggered TXOP Sharing Mode subfield may indicate that a trigger frame including the Triggered TXOP Sharing Mode subfield is the trigger frame initiating a triggered TXOP sharing procedure. If the value of a Triggered TXOP Sharing Mode subfield is 1, the Triggered TXOP Sharing Mode subfield may indicate that a triggered TXOP sharing procedure indicated by a trigger frame including the Triggered TXOP Sharing Mode subfield is in mode 1. If the value of a Triggered TXOP Sharing Mode subfield is 2, the Triggered TXOP Sharing Mode subfield may indicate that a triggered TXOP sharing procedure indicated by a trigger frame including the Triggered TXOP Sharing Mode subfield is in mode 2. When an indicated triggered TXOP sharing procedure is in mode 1, an STA allocated a transmit opportunity may transmit, during the allotted time, a frame to only an STA that allocated the transmit opportunity. When an indicated triggered TXOP sharing procedure is in mode 2, an STA allocated a transmit opportunity may transmit, during the allotted time, a frame to an STA that allocated the transmit opportunity, or may transmit a frame to another STA (a third STA).

According to an embodiment, an MU-RTS TXS trigger frame may indicate an STA which is allocated a time in a triggered TXOP sharing procedure indicated by the MU-RTS TXS trigger frame. For example, an RA field included in the MU-RTS TXS trigger frame may indicate an MAC address of the STA to which the time is allocated. Alternatively, an AID12 subfield included in a User Info field included in the MU-RTS TXS trigger frame may indicate the STA to which the time is allocated. The AID12 subfield, which is included in the User Info field included in the MU-RTS TXS trigger frame, may indicate 12 LSBs of the AID of the STA to which the time is allocated.

Furthermore, the MU-RTS TXS trigger frame may indicate a time allocated by a triggered TXOP sharing procedure. For example, an Allocation Duration subfield included in the MU-RTS TXS trigger frame may indicate the time to be allocated. The Allocation Duration subfield may indicate the time to allocate in a preset unit (e.g., 16-us unit). The Allocation Duration subfield may be included in a User Info field.

Furthermore, the MU-RTS TXS trigger frame may include an RU Allocation subfield. The RU Allocation subfield may indicate an RU allocated in a transmit opportunity allocated in a triggered TXOP sharing procedure. Alternatively, the RU Allocation subfield may indicate a bandwidth allocated in the transmit opportunity allocated in the triggered TXOP sharing procedure. Alternatively, the RU Allocation subfield may indicate a channel on which an STA that has been allocated a transmit opportunity in the triggered TXOP sharing procedure should transmit a CTS frame in response to the MU-RTS TXS trigger frame. The RU Allocation subfield may be included in a User Info field.

When an AID12 subfield, an RU Allocation subfield, and an Allocation Duration subfield are included in one User Info field included in an MU-RTS TXS trigger frame, a triggered TXOP sharing procedure indicated by the MU-RTS TXS trigger frame may be a procedure to perform allocation to the STA indicated by the AID12 subfield, allocation via the channel indicated by the RU Allocation subfield, and allocation of the time indicated by the Allocation Duration subfield.

An STA that has been allocated TXOP by an MU-RTS TXS trigger frame may utilize the allocated time to transmit a frame immediately after transmitting a response to the MU-RTS TXS trigger frame. The response to the MU-RTS TXS trigger frame may be a CTS frame. For example, an STA that has been allocated TXOP by an MU-RTS TXS trigger frame may transmit a frame to an AP or another STA immediately after transmitting a response to the MU-RTS TXS trigger frame. Transmitting immediately may imply starting PPDU transmission after SIFS (or PIFS) from the end of a preceding PPDU.

In an embodiment of the present disclosure, it may be possible to allocate a part or all of TXOP obtained by an STA belonging to an MLD performing a multi-link operation to another STA belonging to another MLD performing a multi-link operation.

Referring to FIG. 46, there may be an AP MLD to which AP 1 and AP 2 belong. There may be a non-AP MLD to which non-AP STA 1 and non-AP STA 2 belong. Also, the AP MLD and the non-AP MLD may be in a multi-link setup. AP 1 and non-AP STA 1 may operate on link 1. AP 2 and non-AP STA 2 may operate on link 2. AP 1 may obtain a TXOP time as a transmit opportunity. AP 1 may obtain the TXOP through a backoff procedure. AP 1 may allocate a part of the obtained TXOP to non-AP STA 1. To this end, AP 1 may transmit an MU-RTS TXS trigger frame to non-AP STA 1. An AID12 subfield included in the MU-RTS TXS trigger frame may indicate non-AP STA 1. The MU-RTS TXS trigger frame may indicate the duration of the allocated time. Non-AP STA 1, which has successfully received the MU-RTS TXS trigger frame, may transmit a CTS frame in response to the MU-RTS TXS trigger frame. The allocated time may start when the reception of a PPDU including the MU-RTS TXS trigger frame is completed. PHY-RXEND.indication primitive may be generated, occur, or be issued when the reception of the PPDU is completed. Furthermore, non-AP STA 1 may transmit a frame immediately after transmitting a CTS frame. For example, PPDU transmission may start after SIFS from the end of a PPDU including the CTS frame. In the embodiment of FIG. 46, non-AP STA 1 transmitted a frame to AP 1 at an allotted time. Non-AP STA 1 may be able to transmit frames for the allotted time. When the allotted time ends, AP 1 may transmit a frame. That is, when the time allocated by AP 1 ends, AP 1 may transmit a frame in the remaining TXOP. When the time allocated by AP 1 ends, AP 1 may operate in the remaining TXOP as if AP 1 had not allocated the transmit opportunity.

There may be TXOP return signaling according to an embodiment of the present disclosure. An STA, which has been allocated a transmit opportunity in a triggered TXOP sharing procedure, may transmit TXOP return signaling when the STA no longer intends to use the allocated transmit opportunity. Therefore, the allocated time may end when the TXOP return signaling is transmitted. As a result, an STA that allocated the transmit opportunity in the triggered TXOP sharing procedure may transmit a frame after receiving the TXOP return signaling. The TXOP return signaling may be included in an MAC header of a frame. More specifically, the TXOP return signaling may be included in an HT Control field. For example, the TXOP return signaling may be an RDG/More PPDU subfield which is included in a CAS Control subfield included in an HT Control field that is an HE variant. The RDG/More PPDU subfield may be a subfield that signals a grant of the reverse direction protocol or signals whether there is a PPDU to be additionally transmitted.

FIG. 47 illustrates another example of a triggered TXOP sharing procedure on an EMLSR link according to an embodiment of the present disclosure.

Referring to FIG. 47, as described with reference to FIGS. 43 to 45, there may be an STA operating on an EMLSR link. In this embodiment, there may be a case in which an STA operating on the EMLSR link receives an MU-RTS TXS trigger frame. According to the above-described embodiments, an AP may transmit an MU-RTS trigger frame as an Initial Control frame to initiate frame exchange on the EMLSR link, and the MU-RTS TXS trigger frame may be a type of MU-RTS trigger frame. Therefore, when an STA operating in an EMLSR link receives an MU-RTS TXS trigger frame or transmits an MU-RTS TXS trigger frame to an STA operating in an EMLSR link, such an MU-RTS TXS trigger frame may be interpreted as an Initial Control frame to initiate frame exchange on the EMLSR link, or may be interpreted as an MU-RTS TXS trigger frame to allocate a transmit opportunity. In the present disclosure, problems arising from such interpretations and the corresponding solutions will be described.

Referring to FIG. 47, there may be an AP MLD to which AP 1 and AP 2 belong. There may be a non-AP MLD to which non-AP STA 1 and non-AP STA 2 belong. Furthermore, the AP MLD and the non-AP MLD may be in a multi-link setup. AP 1 and non-AP STA 1 may operate on link 1. AP 2 and non-AP STA 2 may operate on link 2. Non-AP STA 1 and non-AP STA 2 may perform listening operations on link 1 and link 2, respectively. Meanwhile, AP 1 may obtain a TXOP and transmit an MU-RTS TXS trigger frame to non-AP STA 1. Non-AP STA 1 may receive the MU-RTS TXS trigger frame transmitted by AP 1, and may transmit a CTS frame in response to the MU-RTS TXS trigger frame. However, in the triggered TXOP sharing procedure described in FIG. 46, after non-AP STA 1 transmits a CTS frame, the next frame is transmitted by non-AP STA 1 as shown in FIG. 51, whereas in the EMLSR operation described in FIGS. 43 to 45, after non-AP STA 1 transmits a CTS frame, the next frame is transmitted by AP 1. Therefore, when the protocol for this is unclear, AP 1 and non-AP STA 1 may simultaneously transmit frames immediately after CTS frames.

Furthermore, as described above, MLDs operating on EMLSR links may transition to a state where the MLDs can perform listening operations again after frame exchange is terminated. In this case, there may be conditions under which an STA operating on an EMLSR link determines that the frame exchange has ended. For example, if at least one of the following conditions (condition 1, condition 2, and condition 3) is satisfied, the STA may determine that the frame exchange has been terminated. This embodiment may be limited to the case where an AP initiated frame exchange.

(Condition 1) An MAC of an STA that received an Initial Control frame did not receive a PHY-RXSTART.indication primitive during a timeout interval from a time reference.

(Condition 2) The MAC of an STA that received an Initial Control frame received a PHY-RXSTART.indication primitive during a timeout interval from a time reference and did not detect at least one of the following frames in a PPDU corresponding to the PHY-RXSTART.indication primitive.

(Frame 1) An (individually addressed) frame with an RA field set to the MAC address of the STA

(Frame 2) A trigger frame including a User Info field addressed to the STA (i.e., a trigger frame containing a User Info field including an AID12 subfield set to a value corresponding to the STA)

(Frame 3) A CTS-to-self frame with an RA field set to the MAC address of an STA which allocated a transmit opportunity

(Frame 4) Multi-STA BlockAck frame including a Per AID TID Info field addressed to the STA

(Frame 5) A sounding NDP frame and an NDP Announcement frame including an STA Info field addressed to the STA

(Condition 3) An STA that received an Initial Control frame has not responded to the most recently received frame requiring an immediate response from an STA that allocated the transmit opportunity.

Whether or not a PHY-RXSTART.indication primitive has been received may imply whether or not the PHY-RXSTART.indication primitive has been issued or generated. The PHY-RXSTART.indication primitive may indicate that PHY has received a valid start of a PPDU. The PHY-RXSTART.indication primitive may be an indication from a PHY to an MAC. The PHY-RXSTART.indication primitive may occur when a PHY header is valid. Therefore, the PHY-RXSTART.indication primitive may not be generated until the PHY determines a PPDU format. The PHY-RXSTART.indication primitive may be generated when the PHY has successfully validated the PHY header at the start of a new PPDU. After the PHY-RXSTART.indication primitive is generated, the PHY may keep a physical medium busy during the PPDU. Furthermore, the MAC that receives the PHY-RXSTART.indication primitive may prepare for a new receive flow.

In conditions 1 and 2, the time reference may be the end of the PPDU transmitted by an STA that received an Initial Control frame in response to a frame most recently received from an STA that shared the transmit opportunity, or the end of the reception of a PPDU including a frame that do not require an immediate response (an immediate acknowledgment) received from the STA that shared the transmit opportunity.

In conditions 1 and 2, the timeout interval may be based on aSIFSTime, aSlotTime, and aRxPHYStartDelay. More specifically, the timeout interval may be (aSIFSTime+aSlotTime+aRxPHYStartDelay). Furthermore, aSIFSTime may be a short interframe space (SIFS) time. For example, aSIFSTime can be 10 us in the 2.4 GHz band, 16 us in the 5 GHz band, or 16 us in the 6 GHz band. Additionally, aSlotTime can be a slot time. For example, aSIFSTime may be 10 us in the 2.4-GHz band, 16 us in the 5-GHz band, or 16 us in the 6-GHz band. Additionally, aSlotTime may be a slot time. For example, aSlotTime may be 9 us or 9 us plus an air propagation time. Furthermore, aRxPHYStartDelay may be the time from the start of the PPDU to the generation of the PHY-RXSTART.indication primitive. Furthermore, aRxPHYStartDelay may have different values for different PHYs.

Furthermore, if condition 4 is satisfied, the STA may determine that the frame exchange has been terminated. This embodiment may be limited to a case where a non-AP STA initiated frame exchange (or TXOP).

(Condition 4) TXOP has been terminated.

In the above-described embodiment, the transition to a state where the listening operation can be performed again after the frame exchange has been terminated may need to be performed within a time indicated by the value of an EMLSR Transition Delay subfield from the time when the frame exchange is determined to have terminated. The EMLSR Transition Delay subfield may be included in a Multi-Link element and may be a value dictated by an MLD (e.g., a non-AP MLD) operating on an EMLSR link.

However, when this method of determining the termination of frame exchange is used in conjunction with a triggered TXOP sharing procedure, an STA that has been allocated a transmit opportunity may determine that frame exchange has been terminated in the middle of the allocated time, and may transition to a listening operation. However, when the STA transitions to the listening operation, the STA may not be able to properly perform the frame exchange because the STA can perform only limited operations.

For example, in the embodiment of FIG. 47, when non-AP STA 1 receives an MU-RTS TXS trigger frame, non-AP STA 1 may transition from a listening operation to a state where exchange frame is possible. After non-AP STA 1 transmits the CTS frame, non-AP STA 1 may transmit a frame in the allocated transmit opportunity. Furthermore, a response from AP 1 may be transmitted from AP 1 to non-AP STA 1 in response to the frame transmitted by non-AP STA 1 to AP 1. Since non-AP STA 1 has the remaining allotted time, non-AP STA 1 may transmit another frame, but since the frame is transmitted after receiving the response from AP 1, a PHY-RXSTART.indication primitive is not generated within a timeout interval. Therefore, as described above, non-AP STA 1 determines that the frame exchange has been terminated, and returns to the listening operation.

FIG. 48 illustrates an example of an operation on EMLSR links according to an embodiment of the present disclosure.

The embodiment of FIG. 48 may be an embodiment to solve the problems described in FIGS. 46 and 47. The content described above may be omitted.

According to an embodiment of the present disclosure, an MU-RTS TXS trigger frame may not be transmitted to an STA on the EMLSR link. For example, an AP may not transmit an MU-RTS TXS trigger frame to the STA on the EMLSR link.

Furthermore, according to an embodiment, when an Initial Control frame in an EMLSR operation is an MU-RTS trigger frame, the MU-RTS trigger frame may be an MU-RTS trigger frame which is not an MU-RTS TXS trigger frame. That is, an MU-RTS TXS trigger frame may not be used as an Initial Control frame in an EMLSR operation. That is, the Initial Control frame in the EMLSR operation may be a BSRP trigger frame or an MU-RTS trigger frame which is not an MU-RTS TXS trigger frame.

This may prevent the MU-RTS TXS trigger frame described in FIG. 47 from being interpreted as an Initial Control frame of an EMLSR operation and also as a frame allocating a transmit opportunity of a triggered TXOP sharing procedure.

According to an embodiment, when an STA is not transmitting an Initial Control frame in an EMLSR operation, the STA may transmit an MU-RTS TXS trigger frame to an STA operating on an EMLSR link.

Referring to FIG. 48, there may be an AP MLD to which AP 1 and AP 2 belong. There may be a non-AP MLD to which non-AP STA 1 and non-AP STA 2 belong. Furthermore, the AP MLD and the non-AP MLD may be in a multi-link setup. AP 1 and non-AP STA 1 may operate on link 1. AP 2 and non-AP STA 2 can operate on link 2. Non-AP STA 1 and non-AP STA 2 may perform listening operations on link 1 and link 2, respectively. Meanwhile, AP 1 may obtain TXOP and transmit a frame to non-AP STA 1. In this case, AP 1 may transmit an Initial Control frame as the first frame of the TXOP, wherein the Initial Control frame may be an MU-RTS trigger frame which is not an MU-RTS TXS trigger frame.

Furthermore, according to embodiments of the present disclosure, there may be an EMLSR Support subfield indicating whether an MLD supports an EMLSR operation. The EMLSR Support subfield may be included in a Multi-Link element. An EMLSR Support subfield value of 1 indicates that the MLD supports an EMLSR operation. An EMLSR Support subfield value of 0 may indicate that the MLD does not support an EMLSR operation.

Furthermore, according to an embodiment of the present disclosure, there may be signaling that indicates whether a triggered TXOP sharing procedure is supported. For example, signaling indicating whether a triggered TXOP sharing procedure transmitted by a non-AP STA is supported may indicate whether the non-AP STA can respond to an MU-RTS TXS trigger frame. The signaling indicating whether the triggered TXOP sharing procedure is supported may exist for each of triggered TXOP sharing procedure modes 1 and 2. For example, the signaling that indicates whether the triggered TXOP sharing procedure mode 1 is supported may be a Triggered TXOP Share Mode 1 Support subfield. Also, the signaling that indicates whether the triggered TXOP sharing procedure mode 2 is supported may be a Triggered TXOP Sharing Mode 2 Support subfield. For example, the signaling that indicates whether the triggered TXOP sharing procedure is supported, the Triggered TXOP Sharing Mode 1 Support subfield, or the Triggered TXOP Sharing Mode 2 Support subfield has a value of 1, the value may indicate that the corresponding operation or mode is supported. Furthermore, the signaling that indicates whether the triggered TXOP sharing procedure is supported, the Triggered TXOP Sharing Mode 1 Support subfield, or the Triggered TXOP Sharing Mode 2 Support subfield has a value of 0, the value may indicate that the corresponding operation or mode is not supported. The signaling that indicates whether the triggered TXOP sharing procedure is supported, the Triggered TXOP Sharing Mode 1 Support subfield, or the Triggered TXOP Sharing Mode 2 Support subfield may be included in an EHT MAC Capabilities Information field. The EHT MAC Capabilities Information field may be included in an EHT Capabilities element. Therefore, the signaling that indicates whether the triggered TXOP sharing procedure is supported, the Triggered TXOP Sharing Mode 1 Support subfield, or the Triggered TXOP Sharing Mode 2 Support subfield may be included in the EHT Capabilities element.

There may be a capability signaling setting method according to the above-described embodiments. According to an embodiment of the present disclosure, an STA on an EMLSR link may set signaling, which indicates whether a triggered TXOP sharing procedure is supported, as signaling indicating that the procedure is not supported. That is, an STA on an EMLSR link may set the Triggered TXOP Sharing Mode 1 Support subfield and the Triggered TXOP Sharing Mode 2 Support subfield to a value indicating that the corresponding modes are not supported.

Furthermore, an STA that supports a triggered TXOP sharing procedure may set an EMLSR Support subfield to a value indicating that the procedure is not supported. Alternatively, an MLD to which an STA supporting a triggered TXOP sharing procedure belongs may not indicate that a link corresponding to the STA is an EMLSR link.

When TXOP set by an AP is shared among non-AP STAs by a specific frame (e.g., the trigger frame as described above), the non-AP STAs may transmit and receive data in the shared TXOP. In this case, the non-AP STAs sharing the TXOP may return to a listening operation again from the sharing the TXOP when a specific condition is satisfied.

Specifically, when the time allocated for TXOP sharing ends and the non-AP STA returns to the listening operation, the allocated time may be 1) the time indicated by a frame indicating the TXOP sharing, and/or 2) the time based on TXOP return signaling. For example, the time allocated for TXOP sharing may indicate the time until the allocated time ends. That is, the allocated time may be whichever ends earlier between 1) the time indicated by a frame that triggers TXOP sharing, and 2) the time when the allocated time is returned due to the transmission of TXOP return signaling. For example, when 2) ends first among 1) and 2), the allocated time refers to 2), and at the end of 2), the TXOP sharing is terminated and the non-AP STAs return to the listening operation. If TXOP return signaling is not transmitted, the allocated time may be until the time indicated by the frame indicating TXOP sharing. If TXOP return signaling is transmitted, the allocated time may be until the time when the allocated time is returned due to the transmission of the TXOP return signaling.

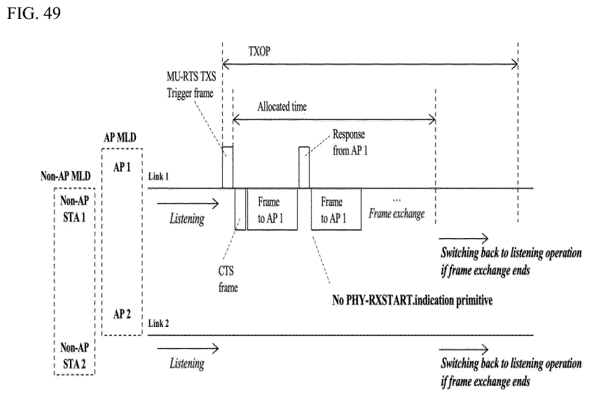

The embodiment of FIG. 49 may be an embodiment for solving the problems described with reference to FIGS. 46 and 47. In addition, the content described above may be omitted.

According to an embodiment of the present disclosure, it may be possible to transmit an MU-RTS TXS trigger frame to an STA of an EMLSR link. When an STA of an EMLSR link receives an MU-RTS TXS trigger frame, the STA may transmit a frame through a triggered TXOP sharing procedure. That is, when an STA of on EMLSR link receives an MU-RTS TXS trigger frame, it may be possible for the STA to transmit a frame immediately after transmitting a CTS frame in response to the MU-RTS TXS trigger frame. Furthermore, an STA that transmitted the MU-RTS TXS trigger frame may not transmit a frame immediately after receiving a CTS frame in response to the MU-RTS TXS trigger frame.

Specifically, when an AP (e.g., an EHT AP, etc.) successfully shares a TXOP with a non-AP STA, the AP may not transmit any PPDU unless at least one specific condition is satisfied. For example, when the AP has successfully transmitted a trigger frame to the non-AP STA that sets the value of a specific field indicating TXOP sharing to a specific value (e.g., “1” or “2”), the AP may not transmit any PPDU unless specific conditions are satisfied.

In this case, the specific conditions may include 1) receiving a PPDU requesting an immediate response from the non-AP STA, 2) When the CS mechanism indicates that the medium is idle at the TxPIFS slot boundary after the end of an immediate response or a transmission that does not require an immediate response from the STA, and/or 3) receiving a specific frame from the non-AP STA.

Furthermore, when an STA of an EMLSR link receives an MU-RTS TXS trigger frame, the STA may not transition to a listening operation for an allotted time. That is, when the STA of the EMLSR link receives an MU-RTS TXS trigger frame, the STA may determine that frame exchange has been terminated, based on the embodiment described with reference to FIG. 32 for an allotted time, and may not transition to a listening operation. More specifically, if the STA of the EMLSR link receives an MU-RTS TXS trigger frame, the STA may determine that frame exchange is terminated, based on condition 1 described with reference to FIG. 47 for the allotted time, and may not transition to the listening operation.

Thus, the condition and embodiment of determining that the frame exchange has been terminated and transitioning to a listening operation, described with reference to FIG. 47, may also be limited to cases regarding a time other than the time allotted based on a triggered TXOP sharing procedure. Furthermore, the condition and embodiment of determining that frame exchange has been terminated, based on condition 1 described in FIG. 32 and transitioning to a listening operation may also be limited to cases regarding a time other than the time allotted based on a triggered TXOP sharing procedure.

This embodiment may be limited to the case in which an STA which has been allocated a transmit opportunity transmits a frame for the allocated time. That is, when the STA which has been allocated the transmit opportunity stops frame transmission for the allocated time, or when the STA which has been allocated the transmit opportunity does not transmit a frame for the allocated time, it may be possible to determine that the frame exchange has been terminated, based on the embodiment described in FIG. 47, and transition to a listening operation.

If the STA on the EMLSR link receives an MU-RTS TXS trigger frame, it may be possible to, when the allotted time has ended, determine again that frame exchange has been terminated, based on the embodiment described in FIG. 51, and transition to a listening operation.

Referring to FIG. 49, there may be an AP MLD to which AP 1 and AP 2 belong. There may be a non-AP MLD to which non-AP STA 1 and non-AP STA 2 belong. Also, the AP MLD and the non-AP MLD may be in a multi-link setup. AP 1 and non-AP STA 1 may operate on link 1. AP 2 and non-AP STA 2 may operate on link 2. Non-AP STA 1 and non-AP STA 2 may perform listening operations on link 1 and link 2, respectively. Meanwhile, AP 1 may obtain a TXOP and transmit an MU-RTS TXS trigger frame to non-AP STA 1. Non-AP STA 1 may receive the MU-RTS TXS trigger frame transmitted by the AP 1, and may transmit a CTS frame in response to the MU-RTS TXS trigger frame. Furthermore, non-AP STA 1 may transmit a frame immediately after transmitting the CTS frame. Furthermore, non-AP STA 1 may receive a response from AP 1. In this case, an MAC of non-AP STA 1 may not transition to a listening operation even when the MAC does not receive a PHY-RXSTART.indication primitive during a timeout interval after receiving the response. If the allocated time has ended, non-AP STA 1 may transition to a listening operation. In this case, transitioning to the listening operation may be performed when AP 1 no longer continues frame exchange with non-AP STA 1 for the remaining TXOP after the allotted time has ended. That is, even after the allotted time has ended, the MLD to which non-AP STA 1 belongs may not immediately transition to a listening operation, but may transition to the listening operation when it is determined that the frame exchange has ended, based on the embodiment described in FIG. 47.

According to an embodiment of the present disclosure, it may take a time for an STA operating on an EMLSR link to transition from a listening operation to a state where frame exchange is possible. This time may be secured by the length of an Initial Control frame. For example, the Initial Control frame may include padding so that the STA operating on the EMLSR link can secure the time to transition from a listening operation to a state where frame exchange is possible. The padding may be a Padding field that may be included in a trigger frame. That is, a Padding field included in an MU-RTS trigger frame or a BSRP trigger frame may can secure the time needed for the STA operating on the EMLSR link to transition from a listening operation to a state where frame exchange is possible. The Initial Control frame may contain a Padding field that is longer than the time needed for the STA operating on the EMLSR link to transition from a listening operation to a state where frame exchange is possible.

The STA operating on the EMLSR link may signal the time required to transition from a listening operation to a state where frame exchange is possible. The signaling may be included in an EMLSR Padding Delay subfield. For example, the value indicated by the EMLSR Padding Delay subfield may be 0, 32 us, 64 us, 128 us, 256 us, etc. The EMLSR Padding Delay subfield may be included in a Multi-Link element.

According to an embodiment of the present disclosure, the time required for an STA operating on an EMLSR link to transition from a listening operation to a state where frame exchange is possible may be different between when an Initial Control frame of an EMLSR operation is an MU-RTS TXS trigger frame and when the Initial Control frame is not an MU-RTS TXS trigger frame. Therefore, the minimum required length of the Padding field may be different between when the Initial Control frame of the EMLSR operation is an MU-RTS TXS trigger frame and when the Initial Control frame is not an MU-RTS TXS trigger frame. For example, the minimum required length of the Padding field when the Initial Control frame of an EMLSR operation is an MU-RTS TXS trigger frame may be less than the minimum required length of the padding field when the Initial Control frame is not an MU-RTS TXS trigger frame. More specifically, when the Initial Control frame of the EMLSR operation is an MU-RTS TXS trigger frame, the Padding field may not be required.

Therefore, an STA transmitting an Initial Control frame that is an MU-RTS TXS trigger frame may include, in the MU-RTS TXS trigger frame, a Padding field shorter than a Padding filed included in an Initial Control frame that is not an MU-RTS TXS trigger frame. Alternatively, an STA transmitting an Initial Control frame that is an MU-RTS TXS trigger frame may not include a Padding field in the MU-RTS TXS trigger frame.

Therefore, according to an embodiment, an STA operating on an EMLSR link may separately signal the time required to transition from a listening operation to a state where frame exchange is possible, for the case where an Initial Control frame is an MU-RTS TXS trigger frame and the case where the Initial Control frame is not an MU-RTS TXS trigger frame.

This may be because a frame immediately after an STA transmits a response to an Initial Control frame of an EMLSR operation is the frame that the STA receives, and a frame immediately after an STA transmits a response to an MU-RTS TXS trigger frame in a triggered TXOP sharing procedure is the frame that the STA transmits. That is, a frame immediately after an STA transmits a response to an Initial Control frame of an EMLSR operation is the frame that the STA receives, and thus it may be difficult to know the configuration under which the frame will be transmitted. However, a frame immediately after an STA transmits a response to an MU-RTS TXS trigger frame in a triggered TXOP sharing procedure is a frame transmitted by the STA, so the frame may be transmitted under a configuration desired by the STA. For example, immediately after an STA transmits a response to an MU-RTS TXS trigger frame in a triggered TXOP sharing procedure, the STA may transmit a frame by using low capability, even when the STA has not transitioned to a state in which frame exchange can be performed using full capability.

According to another embodiment of the present disclosure, when an STA on an EMLSR link receives an MU-RTS TXS trigger frame, the STA may not recognize the MU-RTS TXS trigger frame as a frame that allocates a transmit opportunity in a triggered TXOP sharing procedure. This may be limited to the case where the MU-RTS TXS trigger frame is the first frame of a TXOP. For example, when an STA on an EMLSR link receives an MU-RTS TXS trigger frame, the STA may operate according to the triggered TXOP sharing procedure described in FIG. 43. That is, the STA may not perform the operation described in FIG. 46. Further, the STA may not transmit a frame immediately after transmitting a CTS frame in response to the MU-RTS TXS trigger frame, and may receive a frame from an STA that transmitted the MU-RTS TXS trigger frame.

In embodiments of the present disclosure, when an STA has received a frame, this implies that the frame has been addressed to the STA or that the STA is an intended receiver of the frame.

It may be possible to replace the allocation time in the embodiments described in FIGS. 48 and 49 with the time for receiving a reverse direction grant (RDG) from the reverse direction protocol and transmitting the RDG, and apply the same embodiments. For example, when an STA operating in an EMLSR link receives an Initial Control frame, responds thereto, and then receives an RDG from an STA that transmitted the Initial Control frame, it may, during frame exchange based on the RDG, neither determine that the frame exchange has been terminated, based on the embodiment described in FIG. 51, nor transition to a listening operation. The RDG may be a grant by which an STA that has obtained a TXOP provides another STA (an STA receiving the RDG) with an opportunity to transmit a frame.

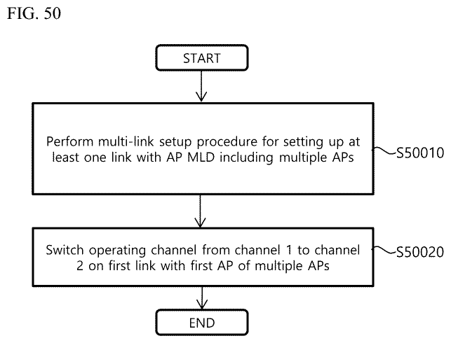

FIG. 50 is a flowchart illustrating one example of an operation performed by a non-AP MLD according to an embodiment of the present disclosure.

Referring to FIG. 50, a non-access point (AP) multi-link device (MLD) including multiple stations may perform a multi-link setup procedure for setting up at least one link with an AP MLD including multiple APs (S50010).

That is, a non-AP MLD including multiple stations may perform the above-described procedure for setting up multiple links with an AP MLD.

Then, the non-AP MLD may switch an operating channel from a first channel to a second channel on a first link with a first AP of the multiple APs through the channel switch procedure described in FIG. 29 (S50020).

In this case, the second channel may be selected from at least one channel that satisfies a first condition related to the non-AP MLD and a second condition related to at least one other non-AP MLD which has set up a link with the AP MLD.

The first condition is whether there is no overlap with an operating channel of another link, excluding the first link, among the at least one link. The second condition is whether there is no overlap with operating channels of one or more links set up in the at least one other non-AP MLD.

The non-AP MLD may receive a specific frame for switching the operating channel from the first channel to the second channel, wherein the specific frame includes a Channel Switch Announcement element or an Extended Channel Switch Announcement element for switching the operating channel.

The Channel Switch Announcement element or the Expanded Channel Switch Announcement element may include a channel switch mode field, a new channel number field indicating a channel number of the operating channel being switched, and a Channel Switch Count field.

Furthermore, the channel switch mode field may indicate information necessary for switching the operating channel, and the Channel Switch Count field may indicate the number of target beacon transmission times (TBTTs) until the operating channel is switched.

The non-AP MLD may transmit a link reconfiguration request frame for changing a configuration of the at least one link, and may receive a link reconfiguration response frame in response to the link reconfiguration request frame. The link reconfiguration response frame may be received on a specific link, among the at least one link, on which the link reconfiguration request frame has been transmitted.

When the link reconfiguration request frame requests one or more links to be deleted, the link reconfiguration request frame may be transmitted on one of links, other than the one or more links which are requested to be deleted, among the at least one link.

When the link reconfiguration request frame requests one or more links to be deleted, and when only one link is set up between the non-AP MLD and the AP MLD, the link reconfiguration request frame may be transmitted via the one link that has been set up.

The above description of the present disclosure is for illustrative purposes, and a person skilled in the art to which the present disclosure belongs will understand that modifications to other specific forms can be easily made without changing the technical idea or essential features of the present disclosure. It should therefore be understood that the above-described embodiments are illustrative and not limiting in all respects. For example, each element described in a single form may also be implemented in a distributed form, and likewise, elements described as being distributed may also be implemented in a combined form.

The scope of the present disclosure is defined by the following claims rather than by the detailed description above, and the meaning and scope of the claims and all modifications or variations derived from the equivalents thereof should be construed as being within the scope of the present disclosure.

1. A non-access point (AP) multi-link device (MLD) comprising multiple stations, wherein a processor is configured to:
perform a multi-link setup procedure for setting up at least one link with an AP MLD comprising multiple APs; and
switch an operating channel from a first channel to a second channel on a first link with a first AP among the multiple APs,
wherein the second channel is selected from at least one channel satisfying a first condition related to the non-AP MLD and a second condition related to at least one other non-AP MLD which has set up a link with the AP MLD.

2. The non-AP MLD of claim 1, wherein the first condition is whether there is no overlap with an operating channel of another link, excluding the first link, among the at least one link.

3. The non-AP MLD of claim 1, wherein the second condition is whether there is no overlap with operating channels of one or more links set up in the at least one other non-AP MLD.

4. The non-AP MLD of claim 1, wherein the processor is configured to receive a specific frame for switching the operating channel from the first channel to the second channel,
wherein the specific frame comprises a Channel Switch Announcement element or an Extended Channel Switch Announcement element for switching the operating channel.

5. The non-AP MLD of claim 4, wherein the Channel Switch Announcement element or the Expanded Channel Switch Announcement element comprises a channel switch mode field, a new channel number field indicating a channel number of the operating channel being switched, and a Channel Switch Count field.

6. The non-AP MLD of claim 5, wherein the channel switch mode field indicates information necessary for switching the operating channel, and
the Channel Switch Count field indicates the number of target beacon transmission times (TBTTs) until the operating channel is switched.

7. The non-AP MLD of claim 1, wherein the processor is configured to:
transmit a link reconfiguration request frame for changing a configuration of the at least one link; and
receive a link reconfiguration response frame in response to the link reconfiguration request frame,
wherein the link reconfiguration response frame is received on a specific link, among the at least one link, on which the link reconfiguration request frame has been transmitted.

8. The non-AP MLD of claim 7, wherein in case that the link reconfiguration request frame requests one or more links to be deleted, the link reconfiguration request frame is transmitted on one of links, other than the one or more links which are requested to be deleted, among the at least one link.

9. The non-AP MLD of claim 7, wherein in case that the link reconfiguration request frame requests one or more links to be deleted and that only one link is set up between the non-AP MLD and the AP MLD, the link reconfiguration request frame is transmitted via the one link that has been set up.

10. A method performed by a non-access point (AP) multi-link device (MLD) comprising multiple stations, the method comprising:
performing a multi-link setup procedure for setting up at least one link with an AP MLD comprising multiple APs; and
switching an operating channel from a first channel to a second channel on a first link with a first AP among the multiple APs,
wherein the second channel is selected from at least one channel satisfying a first condition related to the non-AP MLD and a second condition related to at least one other non-AP MLD which has set up a link with the AP MLD.

11. The method of claim 10, wherein the first condition is whether there is no overlap with an operating channel of another link, excluding the first link, among the at least one link.

12. The method of claim 10, wherein the second condition is whether there is no overlap with operating channels of one or more links set up in the at least one other non-AP MLD.

13. The method of claim 10, further comprising receiving a specific frame for switching the operating channel from the first channel to the second channel,
wherein the specific frame comprises a Channel Switch Announcement element or an Extended Channel Switch Announcement element for switching the operating channel.

14. The method of claim 13, wherein the Channel Switch Announcement element or the Expanded Channel Switch Announcement element comprises a channel switch mode field, a new channel number field indicating a channel number of the operating channel being switched, and a Channel Switch Count field.

15. The method of claim 14, wherein the channel switch mode field indicates information necessary for switching the operating channel, and
the Channel Switch Count field indicates the number of target beacon transmission times (TBTTs) until the operating channel is switched.

16. The method of claim 10, further comprising:
transmitting a link reconfiguration request frame for changing a configuration of the at least one link; and
receiving a link reconfiguration response frame in response to the link reconfiguration request frame,
wherein the link reconfiguration response frame is received on a specific link, among the at least one link, on which the link reconfiguration request frame has been transmitted.

17. The method of claim 16, wherein in case that the link reconfiguration request frame requests one or more links to be deleted, the link reconfiguration request frame is transmitted on one of links, other than the one or more links which are requested to be deleted, among the at least one link.

18. The method of claim 16, wherein in case that the link reconfiguration request frame requests one or more links to be deleted and that only one link is set up between the non-AP MLD and the AP MLD, the link reconfiguration request frame is transmitted via the one link that has been set up.
